(19) United States
(12) Patent Application Publication
(10) Pub. No.: US 2025/0081066 A1
(43) Pub. Date: Mar. 6, 2025

(54) Service Link Switching in a Non-Terrestrial Network (NTN)

(71) Applicant: Comcast Cable Communications, LLC, Philadelphia, PA (US)

(72) Inventors: Mohammad Ghadir Khoshkholgh Dashtaki, Burnaby (CA); Ali Cagatay Cirik, Chantilly, VA (US); Esmael Hejazi Dinan, McLean, VA (US); Hua Zhou, Vienna, VA (US); Gautham Prasad, Herndon, VA (US); Hyoungsuk Jeon, Centreville, VA (US)

(21) Appl. No.: 18/825,086

(22) Filed: Sep. 5, 2024

Related U.S. Application Data
(60) Provisional application No. 63/536,597, filed on Sep. 5, 2023.

(51) Int. Cl. H04W 36/24; H04W 36/00

(52) U.S. Cl. CPC H04W 36/249; H04W 36/0061

(57) ABSTRACT

A wireless device may change from communicating with a first node to communicating with a second node, for example, based on a switch or a handover. A wireless device that receives an indication for a switch (e.g., to a satellite or wireless communication device) and an indication for a handover may determine which to perform based on a time indicated for the switch. For example, the handover may be initiated after receiving an indication to perform the switch if the handover is initiated before the time for the switch.

### CROSS-REFERENCE TO RELATED APPLICATIONS

This application claims the benefit of U.S. Provisional Application No. 63/536,597, filed on Sep. 5, 2023. The above referenced application is hereby incorporated by reference in its entirety.

### BACKGROUND

In a wireless communication system, a base station communicates with a wireless device. Control messages are used to configure the wireless device for connection to a wireless network.

### SUMMARY

The following summary presents a simplified summary of certain features. The summary is not an extensive overview and is not intended to identify key or critical elements.

A base station may communicate with a wireless device via a non-terrestrial network, such as a satellite network. Control messages may be sent to the wireless device from the base station to configure communications. A first control message may indicate a switch without changing one or more parameters, such as if the wireless device is in a same cell before and after switching satellites. For example, a satellite switch may comprise switching from a source satellite to a target satellite without changing an identifier, such as a physical cell identifier (e.g., PCI). A second control message may direct the wireless device to handover from one node (e.g., source satellite) to another node (e.g., target satellite) that may require changing parameters, such as if the wireless device is handed over to a new cell. The wireless device may initiate the handover, for example, based on the switching being without changing an identifier and the second control message being received before initiating the satellite switch.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1A and FIG. 1B show example communication networks.

FIG. 2A shows an example user plane.

FIG. 2B shows an example control plane configuration.

FIG. 3 shows an example of protocol layers.

FIG. 4A shows an example downlink data flow for a user plane configuration.

FIG. 4B shows an example format of a Medium Access Control (MAC) subheader in a MAC Protocol Data Unit (PDU).

FIG. 5A shows an example mapping for downlink channels.

FIG. 5B shows an example mapping for uplink channels.

FIG. 6 shows example radio resource control (RRC) states and RRC state transitions.

FIG. 7 shows an example configuration of a frame.

FIG. 8 shows an example resource configuration of one or more carriers.

FIG. 9 shows an example configuration of bandwidth parts (BWPs).

FIG. 10A shows example carrier aggregation configurations based on component carriers.

FIG. 10B shows example group of cells.

FIG. 11A shows an example mapping of one or more synchronization signal/physical broadcast channel (SS/PBCH) blocks.

FIG. 11B shows an example mapping of one or more channel state information reference signals (CSI-RSs).

FIG. 12A shows examples of downlink beam management procedures.

FIG. 12B shows examples of uplink beam management procedures.

FIG. 13A shows an example four-step random access procedure.

FIG. 13B shows an example two-step random access procedure.

FIG. 13C shows an example two-step random access procedure.

FIG. 14A shows an example of control resource set (CORESET) configurations.

FIG. 14B shows an example of a control channel element to resource element group (CCE-to-REG) mapping.

FIG. 15A shows an example of communications between a wireless device and a base station.

FIG. 15B shows example elements of a computing device that may be used to implement any of the various devices described herein.

FIG. 16A, FIG. 16B, FIG. 16C, and FIG. 16D show examples of uplink and downlink signal transmission.

FIG. 17 shows an example of BWP switching on a cell.

FIG. 18 shows examples of DCI formats.

FIG. 19A shows an example of configuration parameters of a master information block of a cell.

FIG. 19B shows an example of configuration parameters of a system information block.

FIG. 20 shows an example of configuration parameters of bandwidth parts.

FIG. 21 shows an example of configuration parameters of bandwidth parts.

FIG. 22 shows an example of physical downlink shared channel configurations.

FIG. 23 shows examples of monitoring a physical downlink control channel candidates.

FIG. 24 shows an example of handover from a source base station to a target base station for a wireless device.

FIG. 25 shows an example of conditional handover.

FIG. 26 shows an example of Layer 1/Layer 2 (Layer 1/2) triggered handover.

FIG. 27 shows an example of early time advance acquisition based handover.

FIG. 28 shows an example of random-access-channel-less handover.

FIG. 29A shows an example of a non-terrestrial network.

FIG. 29B shows an example of a non-terrestrial network with a transparent payload.

FIG. 29C shows an example of assistance information.

FIG. 30A, FIG. 30B show examples of non-terrestrial networks.

FIG. 31A show an example of non-terrestrial networks.

FIG. 31B shows an example satellite switching procedure for switching from a first non-terrestrial network node (e.g., satellite) to a second non-terrestrial network node (e.g., satellite) without handover.

FIG. 32A and FIG. 32B show examples of satellite switching procedures for switching from a first non-terrestrial network node (e.g., satellite) of a cell to a second non-terrestrial network node (e.g., satellite) of the cell without handover.

FIG. 33A and FIG. 33B show examples of satellite switching procedure for switching from a first non-terrestrial network node (e.g., satellite) of a cell to a second non-terrestrial network node (e.g., satellite) of the cell without handover.

FIG. 34 shows an example flowchart of a service link switch in a non-terrestrial network.

FIG. 35 shows an example flowchart of a service link switch in a non-terrestrial network.

FIG. 36 shows an example flowchart of a service link switch in a non-terrestrial network.

FIG. 37A shows an example flowchart of a service link switch in a non-terrestrial network.

FIG. 37B shows an example flowchart of a service link switch in an non-terrestrial network.

FIG. 38 shows an example flowchart of a service link switch in a non-terrestrial network.

FIG. 39A shows an example flowchart of a handover in a non-terrestrial network.

FIG. 39B shows an example flowchart of a handover in a non-terrestrial network.

FIG. 39C shows an example flowchart of a conditional handover in a non-terrestrial network.

FIG. 40A shows an example flowchart of a handover in a non-terrestrial network.

FIG. 40B shows an example flowchart of a handover in a non-terrestrial network.

FIG. 40C shows an example flowchart of a satellite switch in a non-terrestrial network.

### DETAILED DESCRIPTION

The accompanying drawings and descriptions provide examples. It is to be understood that the examples shown in the drawings and/or described are non-exclusive, and that features shown and described may be practiced in other examples. Examples are provided for operation of wireless communication systems.

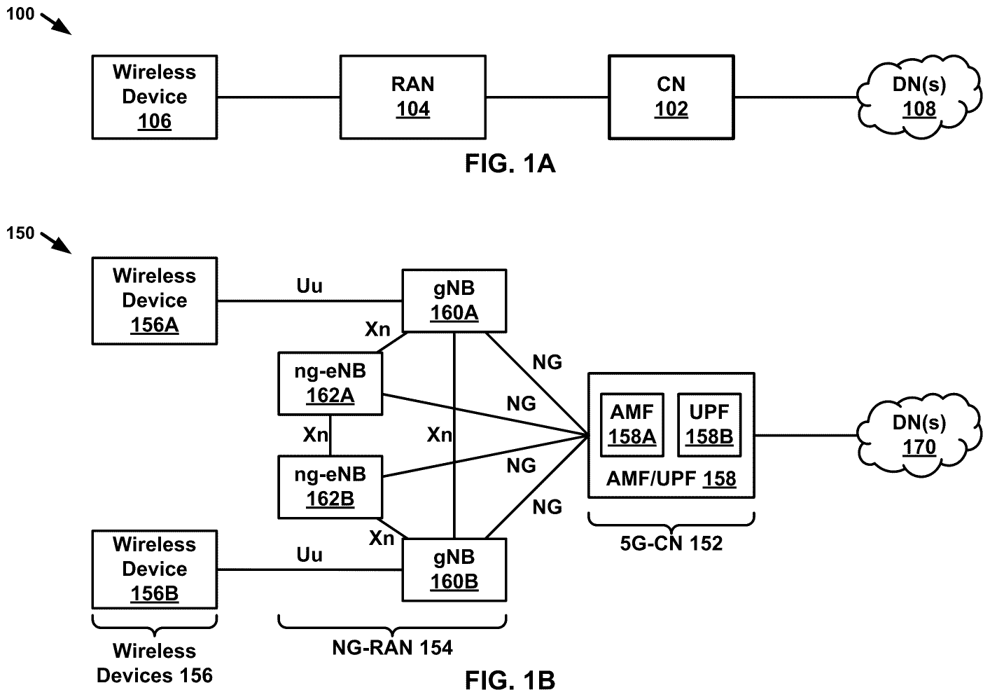

FIG. 1A shows an example communication network 100. The communication network 100 may comprise a mobile communication network). The communication network 100 may comprise, for example, a public land mobile network (PLMN) operated/managed/run by a network operator. The communication network 100 may comprise one or more of a core network (CN) 102, a radio access network (RAN) 104, and/or a wireless device 106. The communication network 100 may comprise, and/or a device within the communication network 100 may communicate with (e.g., via CN 102), one or more data networks (DN(s)) 108. The wireless device 106 may communicate with one or more DNs 108, such as public DNS (e.g., the Internet), private DNs, and/or intra-operator DNs. The wireless device 106 may communicate with the one or more DNs 108 via the RAN 104 and/or via the CN 102. The CN 102 may provide/configure the wireless device 106 with one or more interfaces to the one or more DNs 108. As part of the interface functionality, the CN 102 may set up end-to-end connections between the wireless device 106 and the one or more DNs 108, authenticate the wireless device 106, provide/configure charging functionality, etc.

The wireless device 106 may communicate with the RAN 104 via radio communications over an air interface. The RAN 104 may communicate with the CN 102 via various communications (e.g., wired communications and/or wireless communications). The wireless device 106 may establish a connection with the CN 102 via the RAN 104. The RAN 104 may provide/configure scheduling, radio resource management, and/or retransmission protocols, for example, as part of the radio communications. The communication direction from the RAN 104 to the wireless device 106 over/via the air interface may be referred to as the downlink and/or downlink communication direction. The communication direction from the wireless device 106 to the RAN 104 over/via the air interface may be referred to as the uplink and/or uplink communication direction. Downlink transmissions may be separated and/or distinguished from uplink transmissions, for example, based on at least one of: frequency division duplexing (FDD), time-division duplexing (TDD), any other duplexing schemes, and/or one or more combinations thereof.

As used throughout, the term “wireless device” may comprise one or more of: a mobile device, a fixed (e.g., non-mobile) device for which wireless communication is configured or usable, a computing device, a node, a device capable of wirelessly communicating, or any other device capable of sending and/or receiving signals. As non-limiting examples, a wireless device may comprise, for example: a telephone, a cellular phone, a Wi-Fi phone, a smartphone, a tablet, a computer, a laptop, a sensor, a meter, a wearable device, an Internet of Things (IoT) device, a hotspot, a cellular repeater, a vehicle road side unit (RSU), a relay node, an automobile, a wireless user device (e.g., user equipment (UE), a user terminal (UT), etc.), an access terminal (AT), a mobile station, a handset, a wireless transmit and receive unit (WTRU), a wireless communication device, and/or any combination thereof.

The RAN 104 may comprise one or more base stations (not shown). As used throughout, the term “base station” may comprise one or more of: a base station, a node, a Node B (NB), an evolved NodeB (eNB), a base station, an ng-eNB, a relay node (e.g., an integrated access and backhaul (IAB) node), a donor node (e.g., a donor eNB, a donor base station, etc.), an access point (e.g., a Wi-Fi access point), a transmission and reception point (TRP), a computing device, a device capable of wirelessly communicating, or any other device capable of sending and/or receiving signals. A base station may comprise one or more of each element listed above. For example, a base station may comprise one or more TRPs. As other non-limiting examples, a base station may comprise for example, one or more of: a Node B (e.g., associated with Universal Mobile Telecommunications System (UMTS) and/or third-generation (3G) standards), an Evolved Node B (eNB) (e.g., associated with Evolved-Universal Terrestrial Radio Access (E-UTRA) and/or fourth-generation (4G) standards), a remote radio head (RRH), a baseband processing unit coupled to one or more remote radio heads (RRHs), a repeater node or relay node used to extend the coverage area of a donor node, a Next Generation Evolved Node B (ng-eNB), a Generation Node B (gNB) (e.g., associated with NR and/or fifth-generation (5G) standards), an access point (AP) (e.g., associated with, for example, Wi-Fi or any other suitable wireless communication standard), any other generation base station, and/or any combination thereof. A base station may comprise one or more devices, such as at least one base station central device (e.g., a gNB Central Unit (gNB-CU)) and at least one base station distributed device (e.g., a gNB Distributed Unit (gNB-DU)).

A base station (e.g., in the RAN 104) may comprise one or more sets of antennas for communicating with the wireless device 106 wirelessly (e.g., via an over the air interface). One or more base stations may comprise sets (e.g., three sets or any other quantity of sets) of antennas to respectively control multiple cells or sectors (e.g., three cells, three sectors, any other quantity of cells, or any other quantity of sectors). The size of a cell may be determined by a range at which a receiver (e.g., a base station receiver) may successfully receive transmissions from a transmitter (e.g., a wireless device transmitter) operating in the cell. One or more cells of base stations (e.g., by alone or in combination with other cells) may provide/configure a radio coverage to the wireless device 106 over a wide geographic area to support wireless device mobility. A base station comprising three sectors (e.g., or n-sector, where n refers to any quantity n) may be referred to as a three-sector site (e.g., or an n-sector site) or a three-sector base station (e.g., an n-sector base station).

One or more base stations (e.g., in the RAN 104) may be implemented as a sectored site with more or less than three sectors. One or more base stations of the RAN 104 may be implemented as an access point, as a baseband processing device/unit coupled to several RRHs, and/or as a repeater or relay node used to extend the coverage area of a node (e.g., a donor node). A baseband processing device/unit coupled to RRHs may be part of a centralized or cloud RAN architecture, for example, where the baseband processing device/unit may be centralized in a pool of baseband processing devices/units or virtualized. A repeater node may amplify and send (e.g., transmit, retransmit, rebroadcast, etc.) a radio signal received from a donor node. A relay node may perform the substantially the same/similar functions as a repeater node. The relay node may decode the radio signal received from the donor node, for example, to remove noise before amplifying and sending the radio signal.

The RAN 104 may be deployed as a homogenous network of base stations (e.g., macrocell base stations) that have similar antenna patterns and/or similar high-level transmit powers. The RAN 104 may be deployed as a heterogeneous network of base stations (e.g., different base stations that have different antenna patterns). In heterogeneous networks, small cell base stations may be used to provide/configure small coverage areas, for example, coverage areas that overlap with comparatively larger coverage areas provided/configured by other base stations (e.g., macrocell base stations). The small coverage areas may be provided/configured in areas with high data traffic (or so-called “hotspots”) or in areas with a weak macrocell coverage. Examples of small cell base stations may comprise, in order of decreasing coverage area, microcell base stations, picocell base stations, and femtocell base stations or home base stations.

Examples described herein may be used in a variety of types of communications. For example, communications may be in accordance with the Third-Generation Partnership Project (3GPP) (e.g., one or more network elements similar to those of the communication network 100), communications in accordance with Institute of Electrical and Electronics Engineers (IEEE), communications in accordance with International Telecommunication Union (ITU), communications in accordance with International Organization for Standardization (ISO), etc. The 3GPP has produced specifications for multiple generations of mobile networks: a 3G network known as UMTS, a 4G network known as Long-Term Evolution (LTE) and LTE Advanced (LTE-A), and a 5G network known as 5G System (5GS) and NR system. 3GPP may produce specifications for additional generations of communication networks (e.g., 6G and/or any other generation of communication network). Examples may be described with reference to one or more elements (e.g., the RAN) of a 3GPP 5G network, referred to as a next-generation RAN (NG-RAN), or any other communication network, such as a 3GPP network and/or a non-3GPP network. Examples described herein may be applicable to other communication networks, such as 3G and/or 4G networks, and communication networks that may not yet be finalized/specified (e.g., a 3GPP 6G network), satellite communication networks, and/or any other communication network. NG-RAN implements and updates 5G radio access technology referred to as NR and may be provisioned to implement 4G radio access technology and/or other radio access technologies, such as other 3GPP and/or non-3GPP radio access technologies.

FIG. 1B shows an example communication network 150. The communication network may comprise a mobile communication network. The communication network 150 may comprise, for example, a PLMN operated/managed/run by a network operator. The communication network 150 may comprise one or more of: a CN 152 (e.g., a 5G core network (5G-CN)), a RAN 154 (e.g., an NG-RAN), and/or wireless devices 156A and 156B (collectively wireless device(s) 156). The communication network 150 may comprise, and/or a device within the communication network 150 may communicate with (e.g., via CN 152), one or more data networks (DN(s)) 170. These components may be implemented and operate in substantially the same or similar manner as corresponding components described with respect to FIG. 1A.

The CN 152 (e.g., 5G-CN) may provide/configure the wireless device(s) 156 with one or more interfaces to one or more DNs 170, such as public DNS (e.g., the Internet), private DNs, and/or intra-operator DNs. As part of the interface functionality, the CN 152 (e.g., 5G-CN) may set up end-to-end connections between the wireless device(s) 156 and the one or more DNs, authenticate the wireless device(s) 156, and/or provide/configure charging functionality. The CN 152 (e.g., the 5G-CN) may be a service-based architecture, which may differ from other CNs (e.g., such as a 3GPP 4G CN). The architecture of nodes of the CN 152 (e.g., 5G-CN) may be defined as network functions that offer services via interfaces to other network functions. The network functions of the CN 152 (e.g., 5G CN) may be implemented in several ways, for example, as network elements on dedicated or shared hardware, as software instances running on dedicated or shared hardware, and/or as virtualized functions instantiated on a platform (e.g., a cloud-based platform).

The CN 152 (e.g., 5G-CN) may comprise an Access and Mobility Management Function (AMF) device 158A and/or a User Plane Function (UPF) device 158B, which may be separate components or one component AMF/UPF device 158. The UPF device 158B may serve as a gateway between a RAN 154 (e.g., NG-RAN) and the one or more DNs 170. The UPF device 158B may perform functions, such as: packet routing and forwarding, packet inspection and user plane policy rule enforcement, traffic usage reporting, uplink classification to support routing of traffic flows to the one or more DNs 170, quality of service (QOS) handling for the user plane (e.g., packet filtering, gating, uplink/downlink rate enforcement, and uplink traffic verification), downlink packet buffering, and/or downlink data notification triggering. The UPF device 158B may serve as an anchor point for intra-/inter-Radio Access Technology (RAT) mobility, an external protocol (or packet) data unit (PDU) session point of interconnect to the one or more DNs, and/or a branching point to support a multi-homed PDU session. The wireless device(s) 156 may be configured to receive services via a PDU session, which may be a logical connection between a wireless device and a DN.

The AMF device 158A may perform functions, such as: Non-Access Stratum (NAS) signaling termination, NAS signaling security, Access Stratum (AS) security control, inter-CN node signaling for mobility between access networks (e.g., 3GPP access networks and/or non-3GPP networks), idle mode wireless device reachability (e.g., idle mode wireless device reachability for control and execution of paging retransmission), registration area management, intra-system and inter-system mobility support, access authentication, access authorization including checking of roaming rights, mobility management control (e.g., subscription and policies), network slicing support, and/or session management function (SMF) selection. NAS may refer to the functionality operating between a CN and a wireless device, and AS may refer to the functionality operating between a wireless device and a RAN.

The CN 152 (e.g., 5G-CN) may comprise one or more additional network functions that may not be shown in FIG. 1B. The CN 152 (e.g., 5G-CN) may comprise one or more devices implementing at least one of: a Session Management Function (SMF), an NR Repository Function (NRF), a Policy Control Function (PCF), a Network Exposure Function (NEF), a Unified Data Management (UDM), an Application Function (AF), an Authentication Server Function (AUSF), and/or any other function.

The RAN 154 (e.g., NG-RAN) may communicate with the wireless device(s) 156 via radio communications (e.g., an over the air interface). The wireless device(s) 156 may communicate with the CN 152 via the RAN 154. The RAN 154 (e.g., NG-RAN) may comprise one or more first-type base stations (e.g., base stations comprising a base station 160A and a base station 160B (collectively base stations 160)) and/or one or more second-type base stations (e.g., ng eNBs comprising an ng-eNB 162A and an ng-eNB 162B (collectively ng eNBs 162)). The RAN 154 may comprise one or more of any quantity of types of base station. The base stations 160 and ng eNBs 162 may be referred to as base stations. The base stations (e.g., the base stations 160 and ng eNBs 162) may comprise one or more sets of antennas for communicating with the wireless device(s) 156 wirelessly (e.g., an over an air interface). One or more base stations (e.g., the base stations 160 and/or the ng eNBs 162) may comprise multiple sets of antennas to respectively control multiple cells (or sectors). The cells of the base stations (e.g., the base stations 160 and the ng-eNBs 162) may provide a radio coverage to the wireless device(s) 156 over a wide geographic area to support wireless device mobility.

The base stations (e.g., the base stations 160 and/or the ng-eNBs 162) may be connected to the CN 152 (e.g., 5G CN) via a first interface (e.g., an NG interface) and to other base stations via a second interface (e.g., an Xn interface). The NG and Xn interfaces may be established using direct physical connections and/or indirect connections over an underlying transport network, such as an internet protocol (IP) transport network. The base stations (e.g., the base stations 160 and/or the ng-eNBs 162) may communicate with the wireless device(s) 156 via a third interface (e.g., a Uu interface). A base station (e.g., the base station 160A) may communicate with the wireless device 156A via a Uu interface. The NG, Xn, and Uu interfaces may be associated with a protocol stack. The protocol stacks associated with the interfaces may be used by the network elements shown in FIG. 1B to exchange data and signaling messages. The protocol stacks may comprise two planes: a user plane and a control plane. Any other quantity of planes may be used (e.g., in a protocol stack). The user plane may handle data of interest to a user. The control plane may handle signaling messages of interest to the network elements.

One or more base stations (e.g., the base stations 160 and/or the ng-eNBs 162) may communicate with one or more AMF/UPF devices, such as the AMF/UPF 158, via one or more interfaces (e.g., NG interfaces). A base station (e.g., the base station 160A) may be in communication with, and/or connected to, the UPF 158B of the AMF/UPF 158 via an NG-User plane (NG-U) interface. The NG-U interface may provide/perform delivery (e.g., non-guaranteed delivery) of user plane PDUs between a base station (e.g., the base station 160A) and a UPF device (e.g., the UPF 158B). The base station (e.g., the base station 160A) may be in communication with, and/or connected to, an AMF device (e.g., the AMF 158A) via an NG-Control plane (NG-C) interface. The NG-C interface may provide/perform, for example, NG interface management, wireless device context management (e.g., wireless device context management), wireless device mobility management (e.g., wireless device mobility management), transport of NAS messages, paging, PDU session management, configuration transfer, and/or warning message transmission.

A wireless device may access the base station, via an interface (e.g., Uu interface), for the user plane configuration and the control plane configuration. The base stations (e.g., base stations 160) may provide user plane and control plane protocol terminations towards the wireless device(s) 156 via the Uu interface. A base station (e.g., the base station 160A) may provide user plane and control plane protocol terminations toward the wireless device 156A over a Uu interface associated with a first protocol stack. A base station (e.g., the ng-eNBs 162) may provide Evolved UMTS Terrestrial Radio Access (E UTRA) user plane and control plane protocol terminations towards the wireless device(s) 156 via a Uu interface (e.g., where E UTRA may refer to the 3GPP 4G radio-access technology). A base station (e.g., the ng-eNB 162B) may provide E UTRA user plane and control plane protocol terminations towards the wireless device 156B via a Uu interface associated with a second protocol stack. The user plane and control plane protocol terminations may comprise, for example, NR user plane and control plane protocol terminations, 4G user plane and control plane protocol terminations, etc.

The CN 152 (e.g., 5G-CN) may be configured to handle one or more radio accesses (e.g., NR, 4G, and/or any other radio accesses). It may also be possible for an NR network/device (or any first network/device) to connect to a 4G core network/device (or any second network/device) in a non-standalone mode (e.g., non-standalone operation). In a non-standalone mode/operation, a 4G core network may be used to provide (or at least support) control-plane functionality (e.g., initial access, mobility, and/or paging). Although only one AMF/UPF 158 is shown in FIG. 1B, one or more base stations (e.g., one or more base stations and/or one or more ng-eNBs) may be connected to multiple AMF/UPF nodes, for example, to provide redundancy and/or to load share across the multiple AMF/UPF nodes.

An interface (e.g., Uu, Xn, and/or NG interfaces) between network elements (e.g., the network elements shown in FIG. 1B) may be associated with a protocol stack that the network elements may use to exchange data and signaling messages. A protocol stack may comprise two planes: a user plane and a control plane. Any other quantity of planes may be used (e.g., in a protocol stack). The user plane may handle data associated with a user (e.g., data of interest to a user). The control plane may handle data associated with one or more network elements (e.g., signaling messages of interest to the network elements).

The communication network 100 in FIG. 1A and/or the communication network 150 in FIG. 1B may comprise any quantity/number and/or type of devices, such as, for example, computing devices, wireless devices, mobile devices, handsets, tablets, laptops, internet of things (IoT) devices, hotspots, cellular repeaters, computing devices, and/or, more generally, user equipment (e.g., UE). Although one or more of the above types of devices may be referenced herein (e.g., UE, wireless device, computing device, etc.), it should be understood that any device herein may comprise any one or more of the above types of devices or similar devices. The communication network, and any other network referenced herein, may comprise an LTE network, a 5G network, a satellite network, and/or any other network for wireless communications (e.g., any 3GPP network and/or any non-3GPP network). Apparatuses, systems, and/or methods described herein may generally be described as implemented on one or more devices (e.g., wireless device, base station, eNB, base station, computing device, etc.), in one or more networks, but it will be understood that one or more features and steps may be implemented on any device and/or in any network.

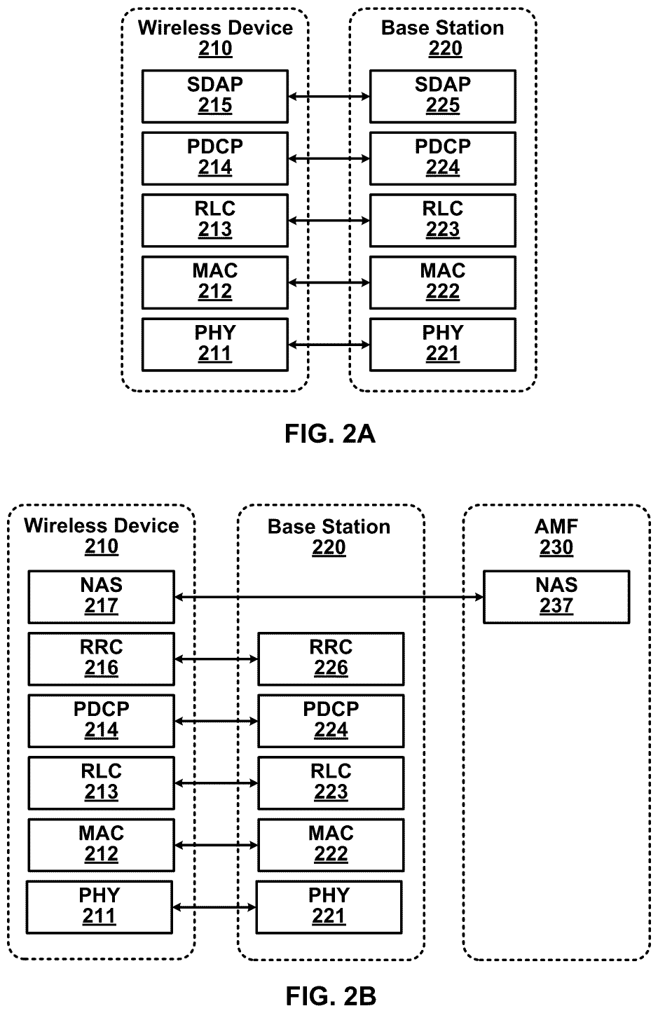

FIG. 2A shows an example user plane configuration. The user plane configuration may comprise, for example, an NR user plane protocol stack. FIG. 2B shows an example control plane configuration. The control plane configuration may comprise, for example, an NR control plane protocol stack. One or more of the user plane configuration and/or the control plane configuration may use a Uu interface that may be between a wireless device 210 and a base station 220. The protocol stacks shown in FIG. 2A and FIG. 2B may be substantially the same or similar to those used for the Uu interface between, for example, the wireless device 156A and the base station 160A shown in FIG. 1B.

A user plane configuration (e.g., an NR user plane protocol stack) may comprise multiple layers (e.g., five layers or any other quantity of layers) implemented in the wireless device 210 and the base station 220 (e.g., as shown in FIG. 2A). At the bottom of the protocol stack, physical layers (PHYs) 211 and 221 may provide transport services to the higher layers of the protocol stack and may correspond to layer 1 of the Open Systems Interconnection (OSI) model. The protocol layers above PHY 211 may comprise a medium access control layer (MAC) 212, a radio link control layer (RLC) 213, a packet data convergence protocol layer (PDCP) 214, and/or a service data application protocol layer (SDAP) 215. The protocol layers above PHY 221 may comprise a medium access control layer (MAC) 222, a radio link control layer (RLC) 223, a packet data convergence protocol layer (PDCP) 224, and/or a service data application protocol layer (SDAP) 225. One or more of the four protocol layers above PHY 211 may correspond to layer 2, or the data link layer, of the OSI model. One or more of the four protocol layers above PHY 221 may correspond to layer 2, or the data link layer, of the OSI model.

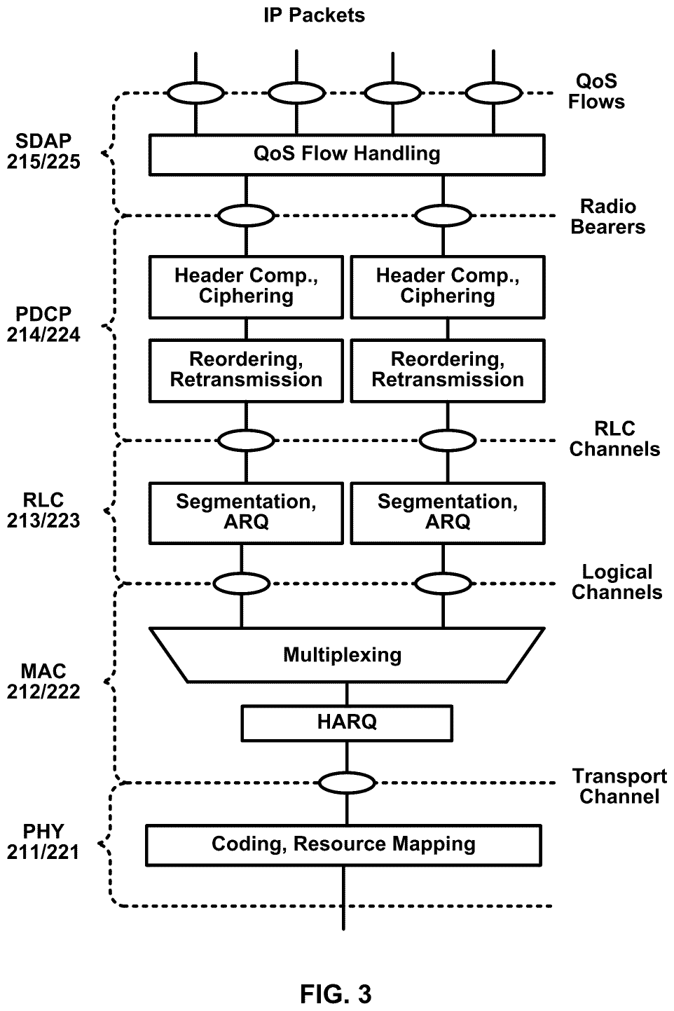

FIG. 3 shows an example of protocol layers. The protocol layers may comprise, for example, protocol layers of the NR user plane protocol stack. One or more services may be provided between protocol layers. SDAPs (e.g., SDAPS 215 and 225 shown in FIG. 2A and FIG. 3) may perform Quality of Service (QOS) flow handling. A wireless device (e.g., the wireless devices 106, 156A, 156B, and 210) may receive services through/via a PDU session, which may be a logical connection between the wireless device and a DN. The PDU session may have one or more QoS flows 310. A UPF (e.g., the UPF 158B) of a CN may map IP packets to the one or more QoS flows of the PDU session, for example, based on one or more QoS requirements (e.g., in terms of delay, data rate, error rate, and/or any other quality/service requirement). The SDAPs 215 and 225 may perform mapping/de-mapping between the one or more QoS flows 310 and one or more radio bearers 320 (e.g., data radio bearers). The mapping/de-mapping between the one or more QoS flows 310 and the radio bearers 320 may be determined by the SDAP 225 of the base station 220. The SDAP 215 of the wireless device 210 may be informed of the mapping between the QoS flows 310 and the radio bearers 320 via reflective mapping and/or control signaling received from the base station 220. For reflective mapping, the SDAP 225 of the base station 220 may mark the downlink packets with a QoS flow indicator (QFI), which may be monitored/detected/identified/indicated/observed by the SDAP 215 of the wireless device 210 to determine the mapping/de-mapping between the one or more QoS flows 310 and the radio bearers 320.

PDCPs (e.g., the PDCPs 214 and 224 shown in FIG. 2A and FIG. 3) may perform header compression/decompression, for example, to reduce the amount of data that may need to be sent (e.g., transmitted) over the air interface, ciphering/deciphering to prevent unauthorized decoding of data sent (e.g., transmitted) over the air interface, and/or integrity protection (e.g., to ensure control messages originate from intended sources). The PDCPs 214 and 224 may perform retransmissions of undelivered packets, in-sequence delivery and reordering of packets, and/or removal of packets received in duplicate due to, for example, a handover (e.g., an intra-base station handover). The PDCPs 214 and 224 may perform packet duplication, for example, to improve the likelihood of the packet being received. A receiver may receive the packet in duplicate and may remove any duplicate packets. Packet duplication may be useful for certain services, such as services that require high reliability.

The PDCP layers (e.g., PDCPs 214 and 224) may perform mapping/de-mapping between a split radio bearer and RLC channels (e.g., RLC channels 330) (e.g., in a dual connectivity example/configuration). Dual connectivity may refer to a technique that allows a wireless device to communicate with multiple cells (e.g., two cells) or, more generally, multiple cell groups comprising: a master cell group (MCG) and a secondary cell group (SCG). A split bearer may be configured and/or used, for example, if a single radio bearer (e.g., such as one of the radio bearers provided/configured by the PDCPs 214 and 224 as a service to the SDAPs 215 and 225) is handled by cell groups in dual connectivity. The PDCPs 214 and 224 may map/de-map between the split radio bearer and RLC channels 330 belonging to the cell groups.

RLC layers (e.g., RLCs 213 and 223) may perform segmentation, retransmission via Automatic Repeat Request (ARQ), and/or removal of duplicate data units received from MAC layers (e.g., MACs 212 and 222, respectively). The RLC layers (e.g., RLCs 213 and 223) may support multiple transmission modes (e.g., three transmission modes: transparent mode (TM); unacknowledged mode (UM); and acknowledged mode (AM)). The RLC layers may perform one or more of the noted functions, for example, based on the transmission mode an RLC layer is operating. The RLC configuration may be per logical channel. The RLC configuration may not depend on numerologies and/or Transmission Time Interval (TTI) durations (or other durations). The RLC layers (e.g., RLCs 213 and 223) may provide/configure RLC channels as a service to the PDCP layers (e.g., PDCPs 214 and 224, respectively), such as shown in FIG. 3.

The MAC layers (e.g., MACs 212 and 222) may perform multiplexing/demultiplexing of logical channels and/or mapping between logical channels and transport channels. The multiplexing/demultiplexing may comprise multiplexing/demultiplexing of data units/data portions, belonging to the one or more logical channels, into/from Transport Blocks (TBs) delivered to/from the PHY layers (e.g., PHYs 211 and 221, respectively). The MAC layer of a base station (e.g., MAC 222) may be configured to perform scheduling, scheduling information reporting, and/or priority handling between wireless devices via dynamic scheduling. Scheduling may be performed by a base station (e.g., the base station 220 at the MAC 222) for downlink/or and uplink. The MAC layers (e.g., MACs 212 and 222) may be configured to perform error correction(s) via Hybrid Automatic Repeat Request (HARQ) (e.g., one HARQ entity per carrier in case of Carrier Aggregation (CA)), priority handling between logical channels of the wireless device 210 via logical channel prioritization and/or padding. The MAC layers (e.g., MACs 212 and 222) may support one or more numerologies and/or transmission timings. Mapping restrictions in a logical channel prioritization may control which numerology and/or transmission timing a logical channel may use. The MAC layers (e.g., the MACs 212 and 222) may provide/configure logical channels 340 as a service to the RLC layers (e.g., the RLCs 213 and 223).

The PHY layers (e.g., PHYs 211 and 221) may perform mapping of transport channels to physical channels and/or digital and analog signal processing functions, for example, for sending and/or receiving information (e.g., via an over the air interface). The digital and/or analog signal processing functions may comprise, for example, coding/decoding and/or modulation/demodulation. The PHY layers (e.g., PHYs 211 and 221) may perform multi-antenna mapping. The PHY layers (e.g., the PHYs 211 and 221) may provide/configure one or more transport channels (e.g., transport channels 350) as a service to the MAC layers (e.g., the MACs 212 and 222, respectively).

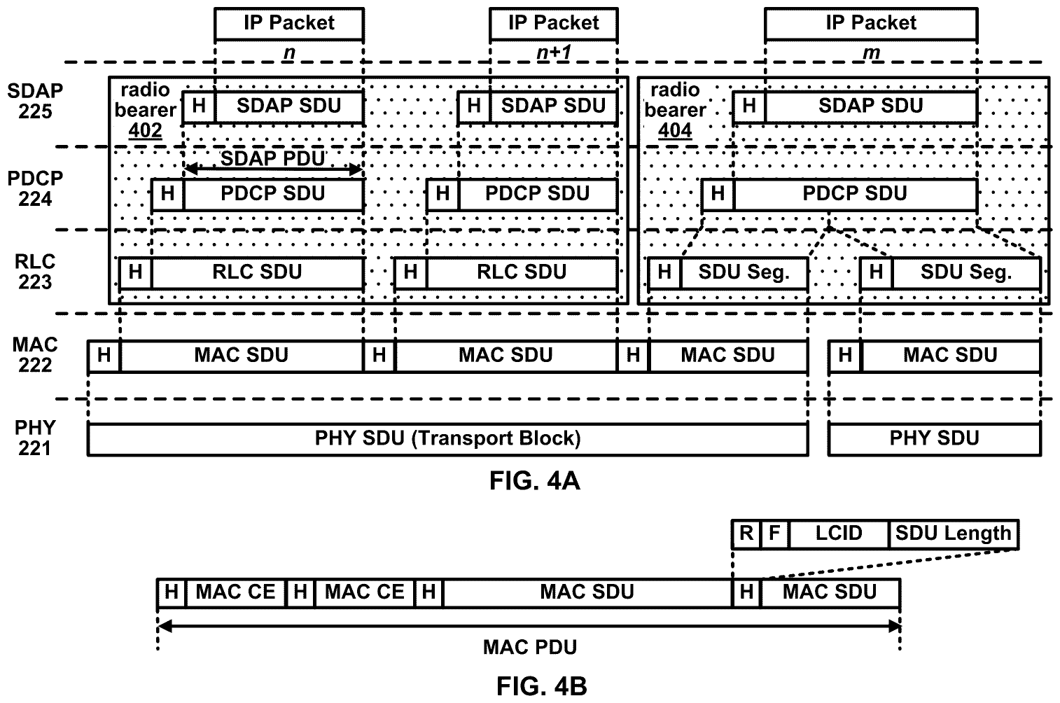

FIG. 4A shows an example downlink data flow for a user plane configuration. The user plane configuration may comprise, for example, the NR user plane protocol stack shown in FIG. 2A. One or more TBs may be generated, for example, based on a data flow via a user plane protocol stack. As shown in FIG. 4A, a downlink data flow of three IP packets (n, n+1, and m) via the NR user plane protocol stack may generate two TBs (e.g., at the base station 220). An uplink data flow via the NR user plane protocol stack may be similar to the downlink data flow shown in FIG. 4A. The three IP packets (n, n+1, and m) may be determined from the two TBs, for example, based on the uplink data flow via an NR user plane protocol stack. A first quantity of packets (e.g., three or any other quantity) may be determined from a second quantity of TBs (e.g., two or another quantity).

The downlink data flow may begin, for example, if the SDAP 225 receives the three IP packets (or other quantity of IP packets) from one or more QoS flows and maps the three packets (or other quantity of packets) to radio bearers (e.g., radio bearers 402 and 404). The SDAP 225 may map the IP packets n and n+1 to a first radio bearer 402 and map the IP packet m to a second radio bearer 404. An SDAP header (labeled with “H” preceding each SDAP SDU shown in FIG. 4A) may be added to an IP packet to generate an SDAP PDU, which may be referred to as a PDCP SDU. The data unit transferred from/to a higher protocol layer may be referred to as a service data unit (SDU) of the lower protocol layer, and the data unit transferred to/from a lower protocol layer may be referred to as a protocol data unit (PDU) of the higher protocol layer. As shown in FIG. 4A, the data unit from the SDAP 225 may be an SDU of lower protocol layer PDCP 224 (e.g., PDCP SDU) and may be a PDU of the SDAP 225 (e.g., SDAP PDU).

Each protocol layer (e.g., protocol layers shown in FIG. 4A) or at least some protocol layers may: perform its own function(s) (e.g., one or more functions of each protocol layer described with respect to FIG. 3), add a corresponding header, and/or forward a respective output to the next lower layer (e.g., its respective lower layer). The PDCP 224 may perform an IP-header compression and/or ciphering. The PDCP 224 may forward its output (e.g., a PDCP PDU, which is an RLC SDU) to the RLC 223. The RLC 223 may optionally perform segmentation (e.g., as shown for IP packet m in FIG. 4A). The RLC 223 may forward its outputs (e.g., two RLC PDUs, which are two MAC SDUs, generated by adding respective subheaders to two SDU segments (SDU Segs)) to the MAC 222. The MAC 222 may multiplex a number of RLC PDUs (MAC SDUS). The MAC 222 may attach a MAC subheader to an RLC PDU (MAC SDU) to form a TB. The MAC subheaders may be distributed across the MAC PDU (e.g., in an NR configuration as shown in FIG. 4A). The MAC subheaders may be entirely located at the beginning of a MAC PDU (e.g., in an LTE configuration). The NR MAC PDU structure may reduce a processing time and/or associated latency, for example, if the MAC PDU subheaders are computed before assembling the full MAC PDU.

FIG. 4B shows an example format of a MAC subheader in a MAC PDU. A MAC PDU may comprise a MAC subheader (H) and a MAC SDU. Each of one or more MAC subheaders may comprise an SDU length field for indicating the length (e.g., in bytes) of the MAC SDU to which the MAC subheader corresponds; a logical channel identifier (LCID) field for identifying/indicating the logical channel from which the MAC SDU originated to aid in the demultiplexing process; a flag (F) for indicating the size of the SDU length field; and a reserved bit (R) field for future use.

One or more MAC control elements (CEs) may be added to, or inserted into, the MAC PDU by a MAC layer, such as MAC 212 or MAC 222. As shown in FIG. 4B, two MAC CEs may be inserted/added before two MAC PDUs. The MAC CEs may be inserted/added at the beginning of a MAC PDU for downlink transmissions (as shown in FIG. 4B). One or more MAC CEs may be inserted/added at the end of a MAC PDU for uplink transmissions. MAC CEs may be used for in band control signaling. Example MAC CEs may comprise scheduling-related MAC CEs, such as buffer status reports and power headroom reports; activation/deactivation MAC CEs (e.g., MAC CEs for activation/deactivation of PDCP duplication detection, channel state information (CSI) reporting, sounding reference signal (SRS) transmission, and prior configured components); discontinuous reception (DRX)-related MAC CEs; timing advance MAC CEs; and random access-related MAC CEs. A MAC CE may be preceded by a MAC subheader with a similar format as described for the MAC subheader for MAC SDUs and may be identified with a reserved value in the LCID field that indicates the type of control information included in the corresponding MAC CE.

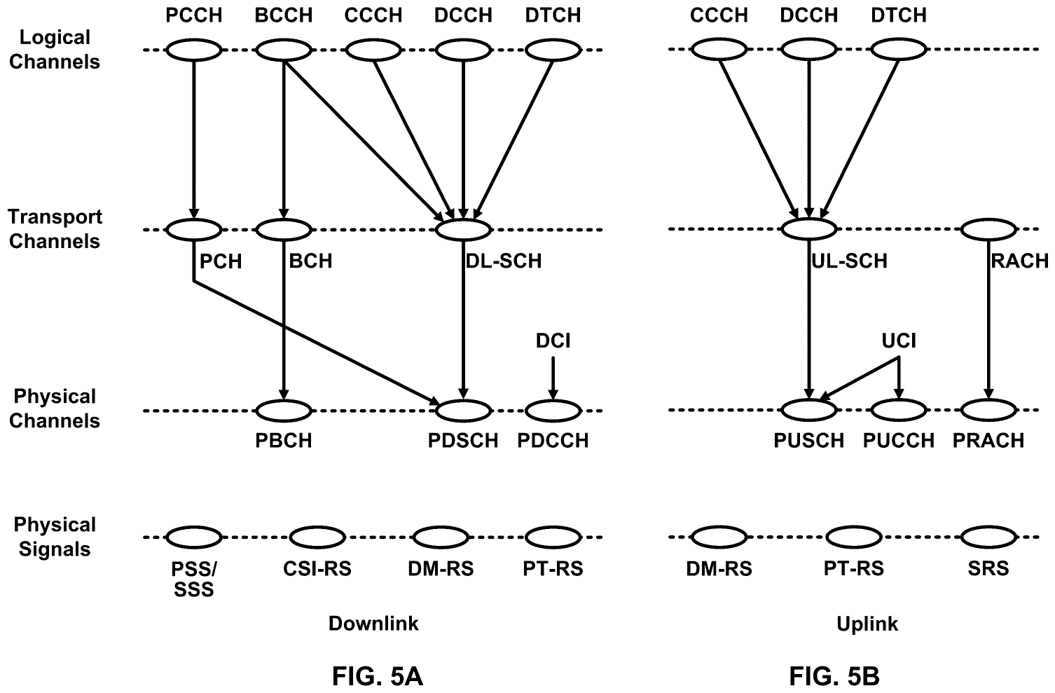

FIG. 5A shows an example mapping for downlink channels. The mapping for uplink channels may comprise mapping between channels (e.g., logical channels, transport channels, and physical channels) for downlink. FIG. 5B shows an example mapping for uplink channels. The mapping for uplink channels may comprise mapping between channels (e.g., logical channels, transport channels, and physical channels) for uplink. Information may be passed through/via channels between the RLC, the MAC, and the PHY layers of a protocol stack (e.g., the NR protocol stack). A logical channel may be used between the RLC and the MAC layers. The logical channel may be classified/indicated as a control channel that may carry control and/or configuration information (e.g., in the NR control plane), or as a traffic channel that may carry data (e.g., in the NR user plane). A logical channel may be classified/indicated as a dedicated logical channel that may be dedicated to a specific wireless device, and/or as a common logical channel that may be used by more than one wireless device (e.g., a group of wireless devices).

A logical channel may be defined by the type of information it carries. The set of logical channels (e.g., in an NR configuration) may comprise one or more channels described below. A paging control channel (PCCH) may comprise/carry one or more paging messages used to page a wireless device whose location is not known to the network on a cell level. A broadcast control channel (BCCH) may comprise/carry system information messages in the form of a master information block (MIB) and several system information blocks (SIBs). The system information messages may be used by wireless devices to obtain information about how a cell is configured and how to operate within the cell. A common control channel (CCCH) may comprise/carry control messages together with random access. A dedicated control channel (DCCH) may comprise/carry control messages to/from a specific wireless device to configure the wireless device with configuration information. A dedicated traffic channel (DTCH) may comprise/carry user data to/from a specific wireless device.

Transport channels may be used between the MAC and PHY layers. Transport channels may be defined by how the information they carry is sent/transmitted (e.g., via an over the air interface). The set of transport channels (e.g., that may be defined by an NR configuration or any other configuration) may comprise one or more of the following channels. A paging channel (PCH) may comprise/carry paging messages that originated from the PCCH. A broadcast channel (BCH) may comprise/carry the MIB from the BCCH. A downlink shared channel (DL-SCH) may comprise/carry downlink data and signaling messages, including the SIBs from the BCCH. An uplink shared channel (UL-SCH) may comprise/carry uplink data and signaling messages. A random access channel (RACH) may provide a wireless device with an access to the network without any prior scheduling.

The PHY layer may use physical channels to pass/transfer information between processing levels of the PHY layer. A physical channel may have an associated set of time-frequency resources for carrying the information of one or more transport channels. The PHY layer may generate control information to support the low-level operation of the PHY layer. The PHY layer may provide/transfer the control information to the lower levels of the PHY layer via physical control channels (e.g., referred to as L1/L2 control channels). The set of physical channels and physical control channels (e.g., that may be defined by an NR configuration or any other configuration) may comprise one or more of the following channels. A physical broadcast channel (PBCH) may comprise/carry the MIB from the BCH. A physical downlink shared channel (PDSCH) may comprise/carry downlink data and signaling messages from the DL-SCH, as well as paging messages from the PCH. A physical downlink control channel (PDCCH) may comprise/carry downlink control information (DCI), which may comprise downlink scheduling commands, uplink scheduling grants, and uplink power control commands. A physical uplink shared channel (PUSCH) may comprise/carry uplink data and signaling messages from the UL-SCH and in some instances uplink control information (UCI) as described below. A physical uplink control channel (PUCCH) may comprise/carry UCI, which may comprise HARQ acknowledgments, channel quality indicators (CQI), pre-coding matrix indicators (PMI), rank indicators (RI), and scheduling requests (SR). A physical random access channel (PRACH) may be used for random access.

The physical layer may generate physical signals to support the low-level operation of the physical layer, which may be similar to the physical control channels. As shown in FIG. 5A and FIG. 5B, the physical layer signals (e.g., that may be defined by an NR configuration or any other configuration) may comprise primary synchronization signals (PSS), secondary synchronization signals (SSS), channel state information reference signals (CSI-RS), demodulation reference signals (DM-RS), sounding reference signals (SRS), phase-tracking reference signals (PT RS), and/or any other signals.

One or more of the channels (e.g., logical channels, transport channels, physical channels, etc.) may be used to carry out functions associated with the control plan protocol stack (e.g., NR control plane protocol stack). FIG. 2B shows an example control plane configuration (e.g., an NR control plane protocol stack). As shown in FIG. 2B, the control plane configuration (e.g., the NR control plane protocol stack) may use substantially the same/similar one or more protocol layers (e.g., PHY 211 and 221, MAC 212 and 222, RLC 213 and 223, and PDCP 214 and 224) as the example user plane configuration (e.g., the NR user plane protocol stack). Similar four protocol layers may comprise the PHYs 211 and 221, the MACs 212 and 222, the RLCs 213 and 223, and the PDCPs 214 and 224. The control plane configuration (e.g., the NR control plane stack) may have radio resource controls (RRCs) 216 and 226 and NAS protocols 217 and 237 at the top of the control plane configuration (e.g., the NR control plane protocol stack), for example, instead of having the SDAPs 215 and 225. The control plane configuration may comprise an AMF 230 comprising the NAS protocol 237.

The NAS protocols 217 and 237 may provide control plane functionality between the wireless device 210 and the AMF 230 (e.g., the AMF 158A or any other AMF) and/or, more generally, between the wireless device 210 and a CN (e.g., the CN 152 or any other CN). The NAS protocols 217 and 237 may provide control plane functionality between the wireless device 210 and the AMF 230 via signaling messages, referred to as NAS messages. There may be no direct path between the wireless device 210 and the AMF 230 via which the NAS messages may be transported. The NAS messages may be transported using the AS of the Uu and NG interfaces. The NAS protocols 217 and 237 may provide control plane functionality, such as authentication, security, a connection setup, mobility management, session management, and/or any other functionality.

The RRCs 216 and 226 may provide/configure control plane functionality between the wireless device 210 and the base station 220 and/or, more generally, between the wireless device 210 and the RAN (e.g., the base station 220). The RRC layers 216 and 226 may provide/configure control plane functionality between the wireless device 210 and the base station 220 via signaling messages, which may be referred to as RRC messages. The RRC messages may be sent/transmitted between the wireless device 210 and the RAN (e.g., the base station 220) using signaling radio bearers and the same/similar PDCP, RLC, MAC, and PHY protocol layers. The MAC layer may multiplex control-plane and user-plane data into the same TB. The RRC layers 216 and 226 may provide/configure control plane functionality, such as one or more of the following functionalities: broadcast of system information related to AS and NAS; paging initiated by the CN or the RAN; establishment, maintenance and release of an RRC connection between the wireless device 210 and the RAN (e.g., the base station 220); security functions including key management; establishment, configuration, maintenance and release of signaling radio bearers and data radio bearers; mobility functions; QoS management functions; wireless device measurement reporting (e.g., the wireless device measurement reporting) and control of the reporting; detection of and recovery from radio link failure (RLF); and/or NAS message transfer. As part of establishing an RRC connection, RRC layers 216 and 226 may establish an RRC context, which may involve configuring parameters for communication between the wireless device 210 and the RAN (e.g., the base station 220).

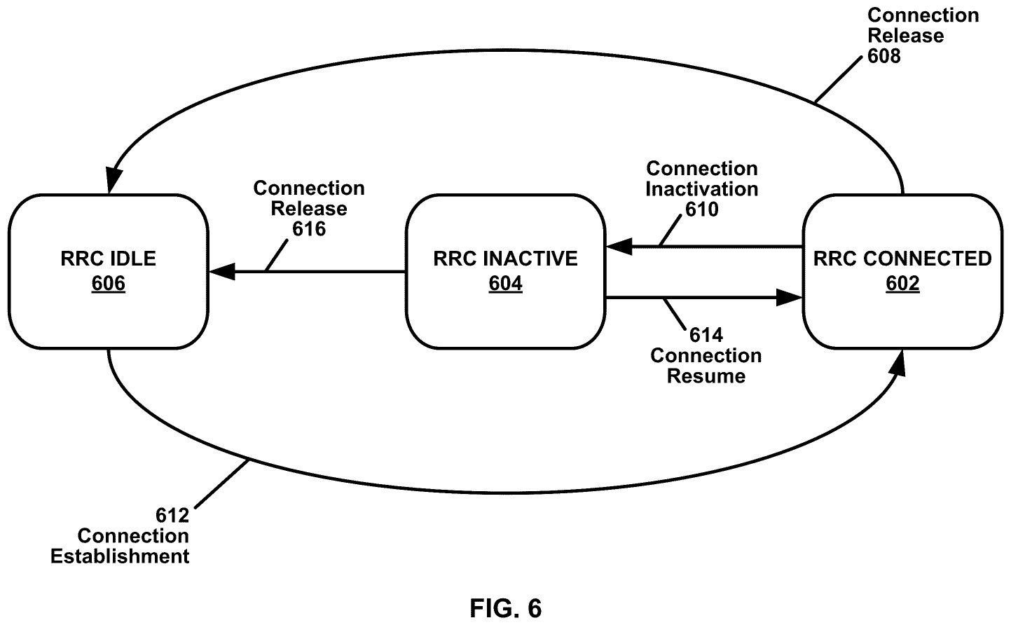

FIG. 6 shows example RRC states and RRC state transitions. An RRC state of a wireless device may be changed to another RRC state (e.g., RRC state transitions of a wireless device). The wireless device may be substantially the same or similar to the wireless device 106, 210, or any other wireless device. A wireless device may be in at least one of a plurality of states, such as three RRC states comprising RRC connected 602 (e.g., RRC_CONNECTED), RRC idle 606 (e.g., RRC_IDLE), and RRC inactive 604 (e.g., RRC_INACTIVE). The RRC inactive 604 may be RRC connected but inactive.

An RRC connection may be established for the wireless device. For example, this may be during an RRC connected state. During the RRC connected state (e.g., during the RRC connected 602), the wireless device may have an established RRC context and may have at least one RRC connection with a base station. The base station may be similar to one of the one or more base stations (e.g., one or more base stations of the RAN 104 shown in FIG. 1A, one of the base stations 160 or ng-eNBs 162 shown in FIG. 1B, the base station 220 shown in FIG. 2A and FIG. 2B, or any other base stations). The base station with which the wireless device is connected (e.g., has established an RRC connection) may have the RRC context for the wireless device. The RRC context, which may be referred to as a wireless device context (e.g., the wireless device context), may comprise parameters for communication between the wireless device and the base station. These parameters may comprise, for example, one or more of: AS contexts; radio link configuration parameters; bearer configuration information (e.g., relating to a data radio bearer, a signaling radio bearer, a logical channel, a QoS flow, and/or a PDU session); security information; and/or layer configuration information (e.g., PHY, MAC, RLC, PDCP, and/or SDAP layer configuration information). During the RRC connected state (e.g., the RRC connected 602), mobility of the wireless device may be managed/controlled by a RAN (e.g., the RAN 104 or the NG RAN 154). The wireless device may measure received signal levels (e.g., reference signal levels, reference signal received power, reference signal received quality, received signal strength indicator, etc.) based on one or more signals sent from a serving cell and neighboring cells. The wireless device may report these measurements to a serving base station (e.g., the base station currently serving the wireless device). The serving base station of the wireless device may request a handover to a cell of one of the neighboring base stations, for example, based on the reported measurements. The RRC state may transition from the RRC connected state (e.g., RRC connected 602) to an RRC idle state (e.g., the RRC idle 606) via a connection release procedure 608. The RRC state may transition from the RRC connected state (e.g., RRC connected 602) to the RRC inactive state (e.g., RRC inactive 604) via a connection inactivation procedure 610.

An RRC context may not be established for the wireless device. For example, this may be during the RRC idle state. During the RRC idle state (e.g., the RRC idle 606), an RRC context may not be established for the wireless device. During the RRC idle state (e.g., the RRC idle 606), the wireless device may not have an RRC connection with the base station. During the RRC idle state (e.g., the RRC idle 606), the wireless device may be in a sleep state for the majority of the time (e.g., to conserve battery power). The wireless device may wake up periodically (e.g., each discontinuous reception (DRX) cycle) to monitor for paging messages (e.g., paging messages set from the RAN). Mobility of the wireless device may be managed by the wireless device via a procedure of a cell reselection. The RRC state may transition from the RRC idle state (e.g., the RRC idle 606) to the RRC connected state (e.g., the RRC connected 602) via a connection establishment procedure 612, which may involve a random access procedure.

A previously established RRC context may be maintained for the wireless device. For example, this may be during the RRC inactive state. During the RRC inactive state (e.g., the RRC inactive 604), the RRC context previously established may be maintained in the wireless device and the base station. The maintenance of the RRC context may enable/allow a fast transition to the RRC connected state (e.g., the RRC connected 602) with reduced signaling overhead as compared to the transition from the RRC idle state (e.g., the RRC idle 606) to the RRC connected state (e.g., the RRC connected 602). During the RRC inactive state (e.g., the RRC inactive 604), the wireless device may be in a sleep state and mobility of the wireless device may be managed/controlled by the wireless device via a cell reselection. The RRC state may transition from the RRC inactive state (e.g., the RRC inactive 604) to the RRC connected state (e.g., the RRC connected 602) via a connection resume procedure 614. The RRC state may transition from the RRC inactive state (e.g., the RRC inactive 604) to the RRC idle state (e.g., the RRC idle 606) via a connection release procedure 616 that may be the same as or similar to connection release procedure 608.

An RRC state may be associated with a mobility management mechanism. During the RRC idle state (e.g., RRC idle 606) and the RRC inactive state (e.g., the RRC inactive 604), mobility may be managed/controlled by the wireless device via a cell reselection. The purpose of mobility management during the RRC idle state (e.g., the RRC idle 606) or during the RRC inactive state (e.g., the RRC inactive 604) may be to enable/allow the network to be able to notify the wireless device of an event via a paging message without having to broadcast the paging message over the entire mobile communications network. The mobility management mechanism used during the RRC idle state (e.g., the RRC idle 606) or during the RRC idle state (e.g., the RRC inactive 604) may enable/allow the network to track the wireless device on a cell-group level, for example, so that the paging message may be broadcast over the cells of the cell group that the wireless device currently resides within (e.g. instead of sending the paging message over the entire mobile communication network). The mobility management mechanisms for the RRC idle state (e.g., the RRC idle 606) and the RRC inactive state (e.g., the RRC inactive 604) may track the wireless device on a cell-group level. The mobility management mechanisms may do the tracking, for example, using different granularities of grouping. There may be a plurality of levels of cell-grouping granularity (e.g., three levels of cell-grouping granularity: individual cells; cells within a RAN area identified by a RAN area identifier (RAI); and cells within a group of RAN areas, referred to as a tracking area and identified by a tracking area identifier (TAI)).

Tracking areas may be used to track the wireless device (e.g., tracking the location of the wireless device at the CN level). The CN (e.g., the CN 102, the 5G CN 152, or any other CN) may send to the wireless device a list of TAIs associated with a wireless device registration area (e.g., a wireless device registration area). A wireless device may perform a registration update with the CN to allow the CN to update the location of the wireless device and provide the wireless device with a new wireless device registration area, for example, if the wireless device moves (e.g., via a cell reselection) to a cell associated with a TAI that may not be included in the list of TAIs associated with the wireless device registration area.

RAN areas may be used to track the wireless device (e.g., the location of the wireless device at the RAN level). For a wireless device in an RRC inactive state (e.g., the RRC inactive 604), the wireless device may be assigned/provided/configured with a RAN notification area. A RAN notification area may comprise one or more cell identities (e.g., a list of RAIs and/or a list of TAIs). A base station may belong to one or more RAN notification areas. A cell may belong to one or more RAN notification areas. A wireless device may perform a notification area update with the RAN to update the RAN notification area of the wireless device, for example, if the wireless device moves (e.g., via a cell reselection) to a cell not included in the RAN notification area assigned/provided/configured to the wireless device.

A base station storing an RRC context for a wireless device or a last serving base station of the wireless device may be referred to as an anchor base station. An anchor base station may maintain an RRC context for the wireless device at least during a period of time that the wireless device stays in a RAN notification area of the anchor base station and/or during a period of time that the wireless device stays in an RRC inactive state (e.g., RRC inactive 604).

A base station (e.g., base stations 160 in FIG. 1B or any other base station) may be split in two parts: a central unit (e.g., a base station central unit, such as a base station CU) and one or more distributed units (e.g., a base station distributed unit, such as a base station DU). A base station central unit (CU) may be coupled to one or more base station distributed units (DUs) using an F1 interface (e.g., an F1 interface defined in an NR configuration). The base station CU may comprise the RRC, the PDCP, and the SDAP layers. A base station distributed unit (DU) may comprise the RLC, the MAC, and the PHY layers.

The physical signals and physical channels (e.g., described with respect to FIG. 5A and FIG. 5B) may be mapped onto one or more symbols (e.g., orthogonal frequency divisional multiplexing (OFDM) symbols in an NR configuration or any other symbols). OFDM is a multicarrier communication scheme that sends/transmits data over F orthogonal subcarriers (or tones). The data may be mapped to a series of complex symbols (e.g., M-quadrature amplitude modulation (M-QAM) symbols or M-phase shift keying (M PSK) symbols or any other modulated symbols), referred to as source symbols, and divided into F parallel symbol streams, for example, before transmission of the data. The F parallel symbol streams may be treated as if they are in the frequency domain. The F parallel symbols may be used as inputs to an Inverse Fast Fourier Transform (IFFT) block that transforms them into the time domain. The IFFT block may take in F source symbols at a time, one from each of the F parallel symbol streams. The IFFT block may use each source symbol to modulate the amplitude and phase of one of F sinusoidal basis functions that correspond to the F orthogonal subcarriers. The output of the IFFT block may be F time-domain samples that represent the summation of the F orthogonal subcarriers. The F time-domain samples may form a single OFDM symbol. An OFDM symbol provided/output by the IFFT block may be sent/transmitted over the air interface on a carrier frequency, for example, after one or more processes (e.g., addition of a cyclic prefix) and up-conversion. The F parallel symbol streams may be mixed, for example, using a Fast Fourier Transform (FFT) block before being processed by the IFFT block. This operation may produce Discrete Fourier Transform (DFT)-precoded OFDM symbols and may be used by one or more wireless devices in the uplink to reduce the peak to average power ratio (PAPR). Inverse processing may be performed on the OFDM symbol at a receiver using an FFT block to recover the data mapped to the source symbols.

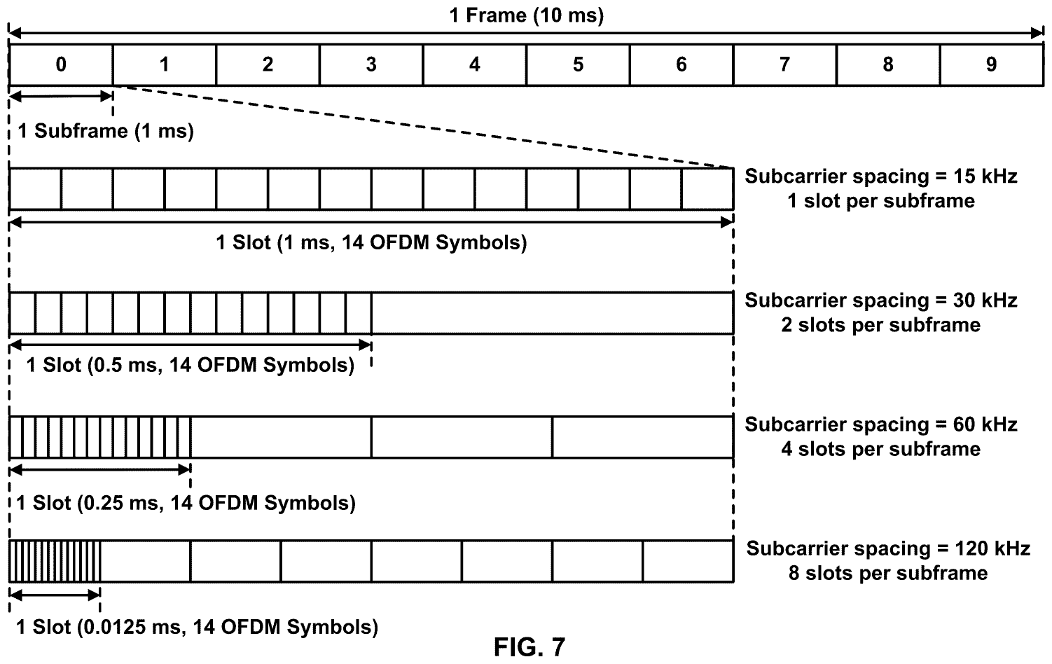

FIG. 7 shows an example configuration of a frame. The frame may comprise, for example, an NR radio frame into which OFDM symbols may be grouped. A frame (e.g., an NR radio frame) may be identified/indicated by a system frame number (SFN) or any other value. The SFN may repeat with a period of 1024 frames. One NR frame may be 10 milliseconds (ms) in duration and may comprise 10 subframes that are 1 ms in duration. A subframe may be divided into one or more slots (e.g., depending on numerologies and/or different subcarrier spacings). Each of the one or more slots may comprise, for example, 14 OFDM symbols per slot. Any quantity of symbols, slots, or duration may be used for any time interval.

The duration of a slot may depend on the numerology used for the OFDM symbols of the slot. A flexible numerology may be supported, for example, to accommodate different deployments (e.g., cells with carrier frequencies below 1 GHz up to cells with carrier frequencies in the mm-wave range). A flexible numerology may be supported, for example, in an NR configuration or any other radio configurations. A numerology may be defined in terms of subcarrier spacing and/or cyclic prefix duration. Subcarrier spacings may be scaled up by powers of two from a baseline subcarrier spacing of 15 kHz. Cyclic prefix durations may be scaled down by powers of two from a baseline cyclic prefix duration of 4.7 μs, for example, for a numerology in an NR configuration or any other radio configurations. Numerologies may be defined with the following subcarrier spacing/cyclic prefix duration combinations: 15 kHz/4.7 μs; 30 kHz/2.3 μs; 60 kHz/1.2 μs; 120 kHz/0.59 μs; 240 kHz/0.29 μs, and/or any other subcarrier spacing/cyclic prefix duration combinations.

A slot may have a fixed number/quantity of OFDM symbols (e.g., 14 OFDM symbols). A numerology with a higher subcarrier spacing may have a shorter slot duration and more slots per subframe. Examples of numerology-dependent slot duration and slots-per-subframe transmission structure are shown in FIG. 7 (the numerology with a subcarrier spacing of 240 kHz is not shown in FIG. 7). A subframe (e.g., in an NR configuration) may be used as a numerology-independent time reference. A slot may be used as the unit upon which uplink and downlink transmissions are scheduled. Scheduling (e.g., in an NR configuration) may be decoupled from the slot duration. Scheduling may start at any OFDM symbol. Scheduling may last for as many symbols as needed for a transmission, for example, to support low latency. These partial slot transmissions may be referred to as mini-slot or sub-slot transmissions.

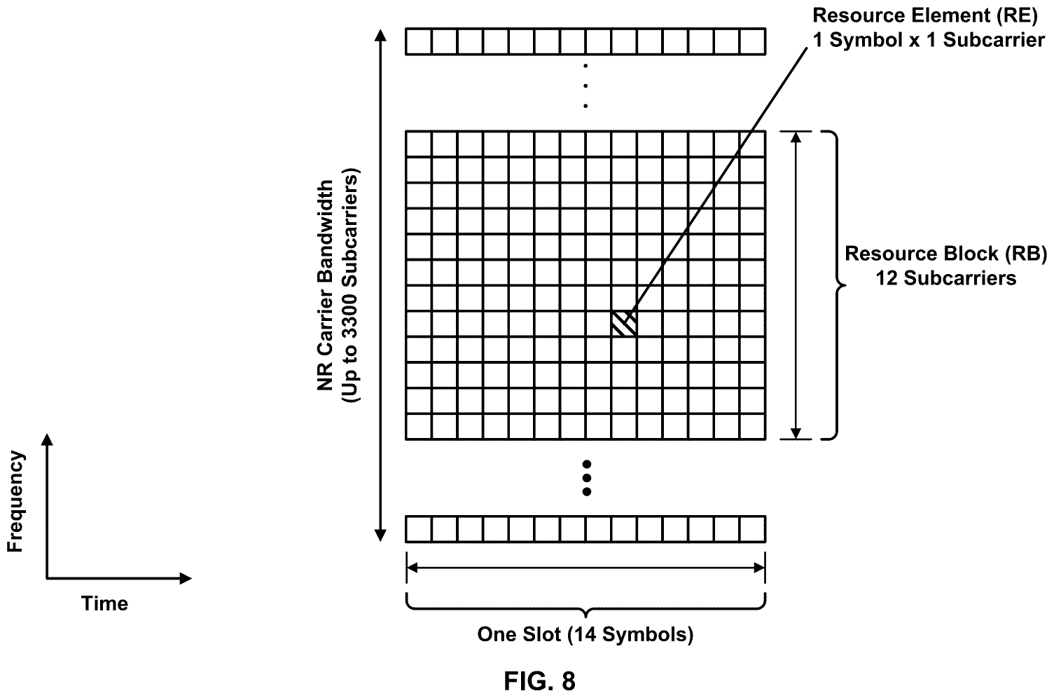

FIG. 8 shows an example resource configuration of one or more carriers. The resource configuration of may comprise a slot in the time and frequency domain for an NR carrier or any other carrier. The slot may comprise resource elements (REs) and resource blocks (RBs). A resource element (RE) may be the smallest physical resource (e.g., in an NR configuration). An RE may span one OFDM symbol in the time domain by one subcarrier in the frequency domain, such as shown in FIG. 8. An RB may span twelve consecutive REs in the frequency domain, such as shown in FIG. 8. A carrier (e.g., an NR carrier) may be limited to a width of a certain quantity of RBs and/or subcarriers (e.g., 275 RBs or 275×12=3300 subcarriers). Such limitation(s), if used, may limit the carrier (e.g., NR carrier) frequency based on subcarrier spacing (e.g., carrier frequency of 50, 100, 200, and 400 MHz for subcarrier spacings of 15, 30, 60, and 120 kHz, respectively). A 400 MHz bandwidth may be set based on a 400 MHz per carrier bandwidth limit. Any other bandwidth may be set based on a per carrier bandwidth limit.

A single numerology may be used across the entire bandwidth of a carrier (e.g., an NR such as shown in FIG. 8). In other example configurations, multiple numerologies may be supported on the same carrier. NR and/or other access technologies may support wide carrier bandwidths (e.g., up to 400 MHz for a subcarrier spacing of 120 kHz). Not all wireless devices may be able to receive the full carrier bandwidth (e.g., due to hardware limitations and/or different wireless device capabilities). Receiving and/or utilizing the full carrier bandwidth may be prohibitive, for example, in terms of wireless device power consumption. A wireless device may adapt the size of the receive bandwidth of the wireless device, for example, based on the amount of traffic the wireless device is scheduled to receive (e.g., to reduce power consumption and/or for other purposes). Such an adaptation may be referred to as bandwidth adaptation.

Configuration of one or more bandwidth parts (BWPs) may support one or more wireless devices not capable of receiving the full carrier bandwidth. BWPs may support bandwidth adaptation, for example, for such wireless devices not capable of receiving the full carrier bandwidth. A BWP (e.g., a BWP of an NR configuration) may be defined by a subset of contiguous RBs on a carrier. A wireless device may be configured (e.g., via an RRC layer) with one or more downlink BWPs per serving cell and one or more uplink BWPs per serving cell (e.g., up to four downlink BWPs per serving cell and up to four uplink BWPs per serving cell). One or more of the configured BWPs for a serving cell may be active, for example, at a given time. The one or more BWPs may be referred to as active BWPs of the serving cell. A serving cell may have one or more first active BWPs in the uplink carrier and one or more second active BWPs in the secondary uplink carrier, for example, if the serving cell is configured with a secondary uplink carrier.

A downlink BWP from a set of configured downlink BWPs may be linked with an uplink BWP from a set of configured uplink BWPs (e.g., for unpaired spectra). A downlink BWP and an uplink BWP may be linked, for example, if a downlink BWP index of the downlink BWP and an uplink BWP index of the uplink BWP are the same. A wireless device may expect that the center frequency for a downlink BWP is the same as the center frequency for an uplink BWP (e.g., for unpaired spectra).

A base station may configure a wireless device with one or more control resource sets (CORESETs) for at least one search space. The base station may configure the wireless device with one or more CORESETS, for example, for a downlink BWP in a set of configured downlink BWPs on a primary cell (PCell) or on a secondary cell (SCell). A search space may comprise a set of locations in the time and frequency domains where the wireless device may monitor/find/detect/identify control information. The search space may be a wireless device-specific search space (e.g., a wireless device-specific search space) or a common search space (e.g., potentially usable by a plurality of wireless devices or a group of wireless user devices). A base station may configure a group of wireless devices with a common search space, on a PCell or on a primary secondary cell (PSCell), in an active downlink BWP.

A base station may configure a wireless device with one or more resource sets for one or more PUCCH transmissions, for example, for an uplink BWP in a set of configured uplink BWPs. A wireless device may receive downlink receptions (e.g., PDCCH or PDSCH) in a downlink BWP, for example, according to a configured numerology (e.g., a configured subcarrier spacing and/or a configured cyclic prefix duration) for the downlink BWP. The wireless device may send/transmit uplink transmissions (e.g., PUCCH or PUSCH) in an uplink BWP, for example, according to a configured numerology (e.g., a configured subcarrier spacing and/or a configured cyclic prefix length for the uplink BWP).

One or more BWP indicator fields may be provided/comprised in Downlink Control Information (DCI). A value of a BWP indicator field may indicate which BWP in a set of configured BWPs is an active downlink BWP for one or more downlink receptions. The value of the one or more BWP indicator fields may indicate an active uplink BWP for one or more uplink transmissions.

A base station may semi-statically configure a wireless device with a default downlink BWP within a set of configured downlink BWPs associated with a PCell. A default downlink BWP may be an initial active downlink BWP, for example, if the base station does not provide/configure a default downlink BWP to/for the wireless device. The wireless device may determine which BWP is the initial active downlink BWP, for example, based on a CORESET configuration obtained using the PBCH.

A base station may configure a wireless device with a BWP inactivity timer value for a PCell. The wireless device may start or restart a BWP inactivity timer at any appropriate time. The wireless device may start or restart the BWP inactivity timer, for example, if one or more conditions are satisfied. The one or more conditions may comprise at least one of: the wireless device detects DCI indicating an active downlink BWP other than a default downlink BWP for a paired spectra operation; the wireless device detects DCI indicating an active downlink BWP other than a default downlink BWP for an unpaired spectra operation; and/or the wireless device detects DCI indicating an active uplink BWP other than a default uplink BWP for an unpaired spectra operation. The wireless device may start/run the BWP inactivity timer toward expiration (e.g., increment from zero to the BWP inactivity timer value, or decrement from the BWP inactivity timer value to zero), for example, if the wireless device does not detect DCI during a time interval (e.g., 1 ms or 0.5 ms). The wireless device may switch from the active downlink BWP to the default downlink BWP, for example, if the BWP inactivity timer expires.

A base station may semi-statically configure a wireless device with one or more BWPs. A wireless device may switch an active BWP from a first BWP to a second BWP, for example, after (e.g., based on or in response to) receiving DCI indicating the second BWP as an active BWP. A wireless device may switch an active BWP from a first BWP to a second BWP, for example, after (e.g., based on or in response to) an expiry of the BWP inactivity timer (e.g., if the second BWP is the default BWP).

A downlink BWP switching may refer to switching an active downlink BWP from a first downlink BWP to a second downlink BWP (e.g., the second downlink BWP is activated and the first downlink BWP is deactivated). An uplink BWP switching may refer to switching an active uplink BWP from a first uplink BWP to a second uplink BWP (e.g., the second uplink BWP is activated and the first uplink BWP is deactivated). Downlink and uplink BWP switching may be performed independently (e.g., in paired spectrum/spectra). Downlink and uplink BWP switching may be performed simultaneously (e.g., in unpaired spectrum/spectra). Switching between configured BWPs may occur, for example, based on RRC signaling, DCI signaling, expiration of a BWP inactivity timer, and/or an initiation of random access.

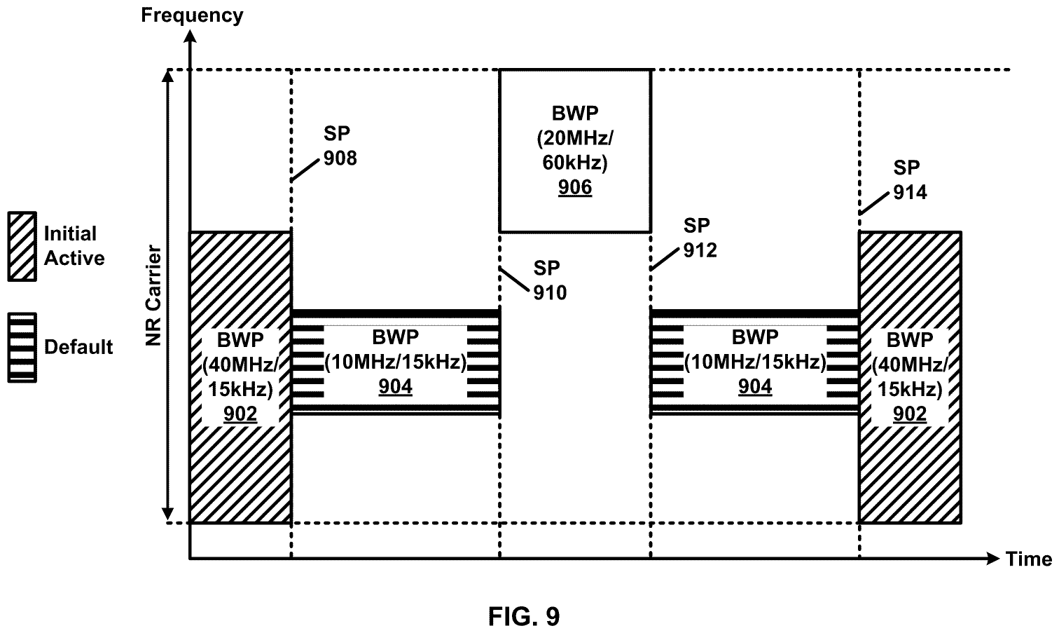

FIG. 9 shows an example of configured BWPs. Bandwidth adaptation using multiple BWPs (e.g., three configured BWPs for an NR carrier) may be available. A wireless device configured with multiple BWPs (e.g., the three BWPs) may switch from one BWP to another BWP at a switching point. The BWPs may comprise: a BWP 902 having a bandwidth of 40 MHz and a subcarrier spacing of 15 kHz; a BWP 904 having a bandwidth of 10 MHz and a subcarrier spacing of 15 kHz; and a BWP 906 having a bandwidth of 20 MHz and a subcarrier spacing of 60 kHz. The BWP 902 may be an initial active BWP, and the BWP 904 may be a default BWP. The wireless device may switch between BWPs at switching points. The wireless device may switch from the BWP 902 to the BWP 904 at a switching point 908. The switching at the switching point 908 may occur for any suitable reasons. The switching at a switching point 908 may occur, for example, after (e.g., based on or in response to) an expiry of a BWP inactivity timer (e.g., indicating switching to the default BWP). The switching at the switching point 908 may occur, for example, after (e.g., based on or in response to) receiving DCI indicating BWP 904 as the active BWP. The wireless device may switch at a switching point 910 from an active BWP 904 to the BWP 906, for example, after or based on (e.g., in response to) receiving DCI indicating BWP 906 as a new active BWP. The wireless device may switch at a switching point 912 from an active BWP 906 to the BWP 904, for example, after (e.g., based on or in response to) an expiry of a BWP inactivity timer. The wireless device may switch at the switching point 912 from an active BWP 906 to the BWP 904, for example, after or based on (e.g., in response to) receiving DCI indicating BWP 904 as a new active BWP. The wireless device may switch at a switching point 914 from an active BWP 904 to the BWP 902, for example, after or based on (e.g., in response to) receiving DCI indicating the BWP 902 as a new active BWP.

Wireless device procedures for switching BWPs on a secondary cell may be the same/similar as those on a primary cell, for example, if the wireless device is configured for a secondary cell with a default downlink BWP in a set of configured downlink BWPs and a timer value. The wireless device may use the timer value and the default downlink BWP for the secondary cell in the same/similar manner as the wireless device uses the timer value and/or default BWPs for a primary cell. The timer value (e.g., the BWP inactivity timer) may be configured per cell (e.g., for one or more BWPs), for example, via RRC signaling or any other signaling. One or more active BWPs may switch to another BWP, for example, based on an expiration of the BWP inactivity timer.

Two or more carriers may be aggregated and data may be simultaneously sent/transmitted to/from the same wireless device using carrier aggregation (CA) (e.g., to increase data rates). The aggregated carriers in CA may be referred to as component carriers (CCs). There may be a number/quantity of serving cells for the wireless device (e.g., one serving cell for a CC), for example, if CA is configured/used. The CCs may have multiple configurations in the frequency domain.

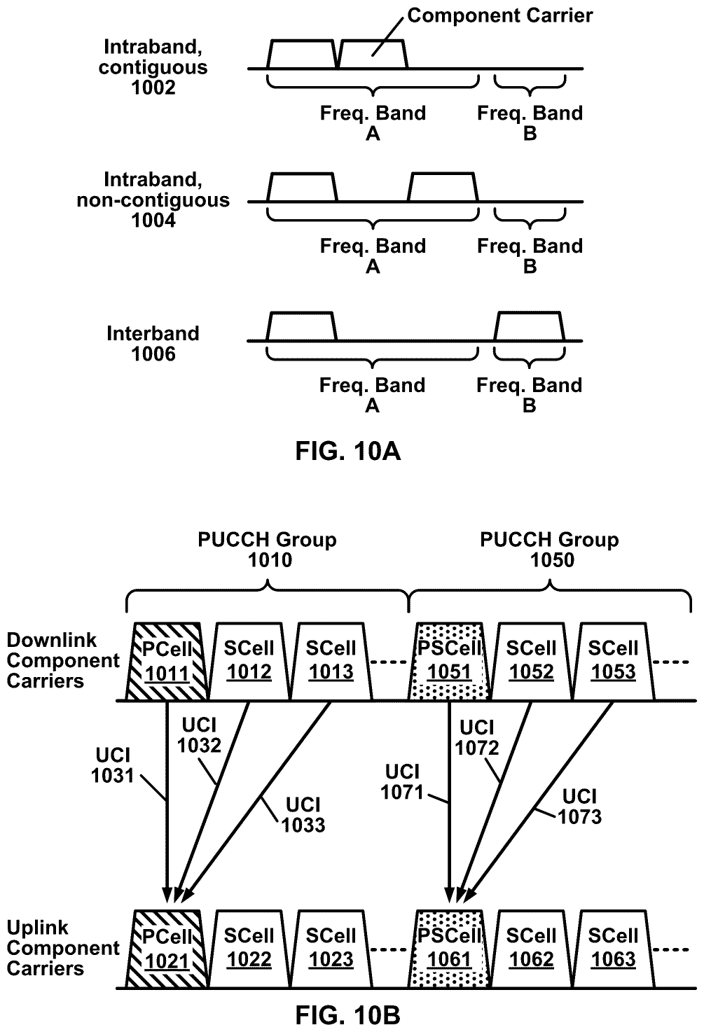

FIG. 10A shows example CA configurations based on CCs. As shown in FIG. 10A, three types of CA configurations may comprise an intraband (contiguous) configuration 1002, an intraband (non-contiguous) configuration 1004, and/or an interband configuration 1006. In the intraband (contiguous) configuration 1002, two CCs may be aggregated in the same frequency band (frequency band A) and may be located directly adjacent to each other within the frequency band. In the intraband (non-contiguous) configuration 1004, two CCs may be aggregated in the same frequency band (frequency band A) but may be separated from each other in the frequency band by a gap. In the interband configuration 1006, two CCs may be located in different frequency bands (e.g., frequency band A and frequency band B, respectively).

A network may set the maximum quantity of CCs that can be aggregated (e.g., up to 32 CCs may be aggregated in NR, or any other quantity may be aggregated in other systems). The aggregated CCs may have the same or different bandwidths, subcarrier spacing, and/or duplexing schemes (TDD, FDD, or any other duplexing schemes). A serving cell for a wireless device using CA may have a downlink CC. One or more uplink CCs may be optionally configured for a serving cell (e.g., for FDD). The ability to aggregate more downlink carriers than uplink carriers may be useful, for example, if the wireless device has more data traffic in the downlink than in the uplink.

One of the aggregated cells for a wireless device may be referred to as a primary cell (PCell), for example, if a CA is configured. The PCell may be the serving cell that the wireless initially connects to or access to, for example, during or at an RRC connection establishment, an RRC connection reestablishment, and/or a handover. The PCell may provide/configure the wireless device with NAS mobility information and the security input. Wireless device may have different PCells. For the downlink, the carrier corresponding to the PCell may be referred to as the downlink primary CC (DL PCC). For the uplink, the carrier corresponding to the PCell may be referred to as the uplink primary CC (UL PCC). The other aggregated cells (e.g., associated with CCs other than the DL PCC and UL PCC) for the wireless device may be referred to as secondary cells (SCells). The SCells may be configured, for example, after the PCell is configured for the wireless device. An SCell may be configured via an RRC connection reconfiguration procedure. For the downlink, the carrier corresponding to an SCell may be referred to as a downlink secondary CC (DL SCC). For the uplink, the carrier corresponding to the SCell may be referred to as the uplink secondary CC (UL SCC).

Configured SCells for a wireless device may be activated or deactivated, for example, based on traffic and channel conditions. Deactivation of an SCell may cause the wireless device to stop PDCCH and PDSCH reception on the SCell and PUSCH, SRS, and CQI transmissions on the SCell. Configured SCells may be activated or deactivated, for example, using a MAC CE (e.g., the MAC CE described with respect to FIG. 4B). A MAC CE may use a bitmap (e.g., one bit per SCell) to indicate which SCells (e.g., in a subset of configured SCells) for the wireless device are activated or deactivated. Configured SCells may be deactivated, for example, after (e.g., based on or in response to) an expiration of an SCell deactivation timer (e.g., one SCell deactivation timer per SCell may be configured).

DCI may comprise control information, such as scheduling assignments and scheduling grants, for a cell. DCI may be sent/transmitted via the cell corresponding to the scheduling assignments and/or scheduling grants, which may be referred to as a self-scheduling. DCI comprising control information for a cell may be sent/transmitted via another cell, which may be referred to as a cross-carrier scheduling. Uplink control information (UCI) may comprise control information, such as HARQ acknowledgments and channel state feedback (e.g., CQI, PMI, and/or RI) for aggregated cells. UCI may be sent/transmitted via an uplink control channel (e.g., a PUCCH) of the PCell or a certain SCell (e.g., an SCell configured with PUCCH). For a larger number of aggregated downlink CCs, the PUCCH of the PCell may become overloaded. Cells may be divided into multiple PUCCH groups.

FIG. 10B shows example group of cells. Aggregated cells may be configured into one or more PUCCH groups (e.g., as shown in FIG. 10B). One or more cell groups or one or more uplink control channel groups (e.g., a PUCCH group 1010 and a PUCCH group 1050) may comprise one or more downlink CCs, respectively. The PUCCH group 1010 may comprise one or more downlink CCs, for example, three downlink CCs: a PCell 1011 (e.g., a DL PCC), an SCell 1012 (e.g., a DL SCC), and an SCell 1013 (e.g., a DL SCC). The PUCCH group 1050 may comprise one or more downlink CCs, for example, three downlink CCs: a PUCCH SCell (or PSCell) 1051 (e.g., a DL SCC), an SCell 1052 (e.g., a DL SCC), and an SCell 1053 (e.g., a DL SCC). One or more uplink CCs of the PUCCH group 1010 may be configured as a PCell 1021 (e.g., a UL PCC), an SCell 1022 (e.g., a UL SCC), and an SCell 1023 (e.g., a UL SCC). One or more uplink CCs of the PUCCH group 1050 may be configured as a PUCCH SCell (or PSCell) 1061 (e.g., a UL SCC), an SCell 1062 (e.g., a UL SCC), and an SCell 1063 (e.g., a UL SCC). UCI related to the downlink CCs of the PUCCH group 1010, shown as UCI 1031, UCI 1032, and UCI 1033, may be sent/transmitted via the uplink of the PCell 1021 (e.g., via the PUCCH of the PCell 1021). UCI related to the downlink CCs of the PUCCH group 1050, shown as UCI 1071, UCI 1072, and UCI 1073, may be sent/transmitted via the uplink of the PUCCH SCell (or PSCell) 1061 (e.g., via the PUCCH of the PUCCH SCell 1061). A single uplink PCell may be configured to send/transmit UCI relating to the six downlink CCs, for example, if the aggregated cells shown in FIG. 10B are not divided into the PUCCH group 1010 and the PUCCH group 1050. The PCell 1021 may become overloaded, for example, if the UCIs 1031, 1032, 1033, 1071, 1072, and 1073 are sent/transmitted via the PCell 1021. By dividing transmissions of UCI between the PCell 1021 and the PUCCH SCell (or PSCell) 1061, overloading may be prevented and/or reduced.

A PCell may comprise a downlink carrier (e.g., the PCell 1011) and an uplink carrier (e.g., the PCell 1021). An SCell may comprise only a downlink carrier. A cell, comprising a downlink carrier and optionally an uplink carrier, may be assigned with a physical cell ID and a cell index. The physical cell ID or the cell index may indicate/identify a downlink carrier and/or an uplink carrier of the cell, for example, depending on the context in which the physical cell ID is used. A physical cell ID may be determined, for example, using a synchronization signal (e.g., PSS and/or SSS) sent/transmitted via a downlink component carrier. A cell index may be determined, for example, using one or more RRC messages. A physical cell ID may be referred to as a carrier ID, and a cell index may be referred to as a carrier index. A first physical cell ID for a first downlink carrier may refer to the first physical cell ID for a cell comprising the first downlink carrier. Substantially the same/similar concept may use to, for example, a carrier activation. Activation of a first carrier may refer to activation of a cell comprising the first carrier.

A multi-carrier nature of a PHY layer may be exposed/indicated to a MAC layer (e.g., in a CA configuration). A HARQ entity may operate on a serving cell. A transport block may be generated per assignment/grant per serving cell. A transport block and potential HARQ retransmissions of the transport block may be mapped to a serving cell.

For the downlink, a base station may send/transmit (e.g., unicast, multicast, and/or broadcast), to one or more wireless devices, one or more reference signals (RSs) (e.g., PSS, SSS, CSI-RS, DM-RS, and/or PT-RS). For the uplink, the one or more wireless devices may send/transmit one or more RSs to the base station (e.g., DM-RS, PT-RS, and/or SRS). The PSS and the SSS may be sent/transmitted by the base station and used by the one or more wireless devices to synchronize the one or more wireless devices with the base station. A synchronization signal (SS)/physical broadcast channel (PBCH) block may comprise the PSS, the SSS, and the PBCH. The base station may periodically send/transmit a burst of SS/PBCH blocks, which may be referred to as SSBs.

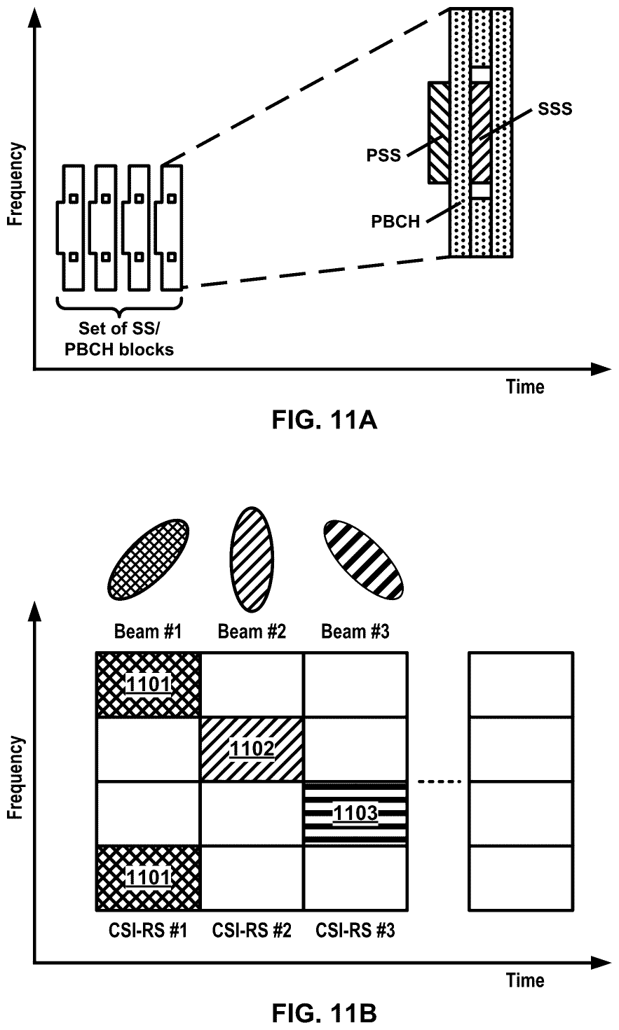

FIG. 11A shows an example mapping of one or more SS/PBCH blocks. A burst of SS/PBCH blocks may comprise one or more SS/PBCH blocks (e.g., 4 SS/PBCH blocks, as shown in FIG. 11A). Bursts may be sent/transmitted periodically (e.g., every 2 frames, 20 ms, or any other durations). A burst may be restricted to a half-frame (e.g., a first half-frame having a duration of 5 ms). Such parameters (e.g., the number of SS/PBCH blocks per burst, periodicity of bursts, position of the burst within the frame) may be configured, for example, based on at least one of: a carrier frequency of a cell in which the SS/PBCH block is sent/transmitted; a numerology or subcarrier spacing of the cell; a configuration by the network (e.g., using RRC signaling); and/or any other suitable factor(s). A wireless device may assume a subcarrier spacing for the SS/PBCH block based on the carrier frequency being monitored, for example, unless the radio network configured the wireless device to assume a different subcarrier spacing.

The SS/PBCH block may span one or more OFDM symbols in the time domain (e.g., 4 OFDM symbols, as shown in FIG. 11A or any other quantity/number of symbols) and may span one or more subcarriers in the frequency domain (e.g., 240 contiguous subcarriers or any other quantity/number of subcarriers). The PSS, the SSS, and the PBCH may have a common center frequency. The PSS may be sent/transmitted first and may span, for example, 1 OFDM symbol and 127 subcarriers. The SSS may be sent/transmitted after the PSS (e.g., two symbols later) and may span 1 OFDM symbol and 127 subcarriers. The PBCH may be sent/transmitted after the PSS (e.g., across the next 3 OFDM symbols) and may span 240 subcarriers (e.g., in the second and fourth OFDM symbols as shown in FIG. 11A) and/or may span fewer than 240 subcarriers (e.g., in the third OFDM symbols as shown in FIG. 11A).

The location of the SS/PBCH block in the time and frequency domains may not be known to the wireless device (e.g., if the wireless device is searching for the cell). The wireless device may monitor a carrier for the PSS, for example, to find and select the cell. The wireless device may monitor a frequency location within the carrier. The wireless device may search for the PSS at a different frequency location within the carrier, for example, if the PSS is not found after a certain duration (e.g., 20 ms). The wireless device may search for the PSS at a different frequency location within the carrier, for example, as indicated by a synchronization raster. The wireless device may determine the locations of the SSS and the PBCH, respectively, for example, based on a known structure of the SS/PBCH block if the PSS is found at a location in the time and frequency domains. The SS/PBCH block may be a cell-defining SS block (CD-SSB). A primary cell may be associated with a CD-SSB. The CD-SSB may be located on a synchronization raster. A cell selection/search and/or reselection may be based on the CD-SSB.

The SS/PBCH block may be used by the wireless device to determine one or more parameters of the cell. The wireless device may determine a physical cell identifier (PCI) of the cell, for example, based on the sequences of the PSS and the SSS, respectively. A person of ordinarily skill in the art would readily understand that PCI may be used to refer to a physical cell identifier and/or a physical cell identity. Accordingly, while PCI herein is used to refer to physical cell identifier, PCI herein may additionally or alternatively refer to a physical cell identity. The wireless device may determine a location of a frame boundary of the cell, for example, based on the location of the SS/PBCH block. The SS/PBCH block may indicate that it has been sent/transmitted in accordance with a transmission pattern. An SS/PBCH block in the transmission pattern may be a known distance from the frame boundary (e.g., a predefined distance for a RAN configuration among one or more networks, one or more base stations, and one or more wireless devices).

The PBCH may use a QPSK modulation and/or forward error correction (FEC). The FEC may use polar coding. One or more symbols spanned by the PBCH may comprise/carry one or more DM-RSs for demodulation of the PBCH. The PBCH may comprise an indication of a current system frame number (SFN) of the cell and/or a SS/PBCH block timing index. These parameters may facilitate time synchronization of the wireless device to the base station. The PBCH may comprise a MIB used to send/transmit to the wireless device one or more parameters. The MIB may be used by the wireless device to locate remaining minimum system information (RMSI) associated with the cell. The RMSI may comprise a System Information Block Type 1 (SIB1). The SIB1 may comprise information for the wireless device to access the cell. The wireless device may use one or more parameters of the MIB to monitor a PDCCH, which may be used to schedule a PDSCH. The PDSCH may comprise the SIB1. The SIB1 may be decoded using parameters provided/comprised in the MIB. The PBCH may indicate an absence of SIB1. The wireless device may be pointed to a frequency, for example, based on the PBCH indicating the absence of SIB1. The wireless device may search for an SS/PBCH block at the frequency to which the wireless device is pointed.

The wireless device may assume that one or more SS/PBCH blocks sent/transmitted with a same SS/PBCH block index are quasi co-located (QCLed) (e.g., having substantially the same/similar Doppler spread, Doppler shift, average gain, average delay, and/or spatial Rx parameters). The wireless device may not assume QCL for SS/PBCH block transmissions having different SS/PBCH block indexes. SS/PBCH blocks (e.g., those within a half-frame) may be sent/transmitted in spatial directions (e.g., using different beams that span a coverage area of the cell). A first SS/PBCH block may be sent/transmitted in a first spatial direction using a first beam, a second SS/PBCH block may be sent/transmitted in a second spatial direction using a second beam, a third SS/PBCH block may be sent/transmitted in a third spatial direction using a third beam, a fourth SS/PBCH block may be sent/transmitted in a fourth spatial direction using a fourth beam, etc.

A base station may send/transmit a plurality of SS/PBCH blocks, for example, within a frequency span of a carrier. A first PCI of a first SS/PBCH block of the plurality of SS/PBCH blocks may be different from a second PCI of a second SS/PBCH block of the plurality of SS/PBCH blocks. The PCIs of SS/PBCH blocks sent/transmitted in different frequency locations may be different or substantially the same.

The CSI-RS may be sent/transmitted by the base station and used by the wireless device to acquire/obtain/determine channel state information (CSI). The base station may configure the wireless device with one or more CSI-RSs for channel estimation or any other suitable purpose. The base station may configure a wireless device with one or more of the same/similar CSI-RSs. The wireless device may measure the one or more CSI-RSs. The wireless device may estimate a downlink channel state and/or generate a CSI report, for example, based on the measuring of the one or more downlink CSI-RSs. The wireless device may send/transmit the CSI report to the base station (e.g., based on periodic CSI reporting, semi-persistent CSI reporting, and/or aperiodic CSI reporting). The base station may use feedback provided by the wireless device (e.g., the estimated downlink channel state) to perform a link adaptation.

The base station may semi-statically configure the wireless device with one or more CSI-RS resource sets. A CSI-RS resource may be associated with a location in the time and frequency domains and a periodicity. The base station may selectively activate and/or deactivate a CSI-RS resource. The base station may indicate to the wireless device that a CSI-RS resource in the CSI-RS resource set is activated and/or deactivated.

The base station may configure the wireless device to report CSI measurements. The base station may configure the wireless device to provide CSI reports periodically, aperiodically, or semi-persistently. For periodic CSI reporting, the wireless device may be configured with a timing and/or periodicity of a plurality of CSI reports. For aperiodic CSI reporting, the base station may request a CSI report. The base station may command the wireless device to measure a configured CSI-RS resource and provide a CSI report relating to the measurement(s). For semi-persistent CSI reporting, the base station may configure the wireless device to send/transmit periodically, and selectively activate or deactivate the periodic reporting (e.g., via one or more activation/deactivation MAC CEs and/or one or more DCIs). The base station may configure the wireless device with a CSI-RS resource set and CSI reports, for example, using RRC signaling.

The CSI-RS configuration may comprise one or more parameters indicating, for example, up to 32 antenna ports (or any other quantity of antenna ports). The wireless device may be configured to use/employ the same OFDM symbols for a downlink CSI-RS and a CORESET, for example, if the downlink CSI-RS and CORESET are spatially QCLed and resource elements associated with the downlink CSI-RS are outside of the physical resource blocks (PRBs) configured for the CORESET. The wireless device may be configured to use/employ the same OFDM symbols for a downlink CSI-RS and SS/PBCH blocks, for example, if the downlink CSI-RS and SS/PBCH blocks are spatially QCLed and resource elements associated with the downlink CSI-RS are outside of PRBs configured for the SS/PBCH blocks.

Downlink DM-RSs may be sent/transmitted by a base station and received/used by a wireless device for a channel estimation. The downlink DM-RSs may be used for coherent demodulation of one or more downlink physical channels (e.g., PDSCH). A network (e.g., an NR network) may support one or more variable and/or configurable DM-RS patterns for data demodulation. At least one downlink DM-RS configuration may support a front-loaded DM-RS pattern. A front-loaded DM-RS may be mapped over one or more OFDM symbols (e.g., one or two adjacent OFDM symbols). A base station may semi-statically configure the wireless device with a number/quantity (e.g. a maximum number/quantity) of front-loaded DM-RS symbols for a PDSCH. A DM-RS configuration may support one or more DM-RS ports. A DM-RS configuration may support up to eight orthogonal downlink DM-RS ports per wireless device (e.g., for single user-MIMO). A DM-RS configuration may support up to 4 orthogonal downlink DM-RS ports per wireless device (e.g., for multiuser-MIMO). A radio network may support (e.g., at least for CP-OFDM) a common DM-RS structure for downlink and uplink. A DM-RS location, a DM-RS pattern, and/or a scrambling sequence may be the same or different. The base station may send/transmit a downlink DM-RS and a corresponding PDSCH, for example, using the same precoding matrix. The wireless device may use the one or more downlink DM-RSs for coherent demodulation/channel estimation of the PDSCH.

A transmitter (e.g., a transmitter of a base station) may use a precoder matrices for a part of a transmission bandwidth. The transmitter may use a first precoder matrix for a first bandwidth and a second precoder matrix for a second bandwidth. The first precoder matrix and the second precoder matrix may be different, for example, based on the first bandwidth being different from the second bandwidth. The wireless device may assume that a same precoding matrix is used across a set of PRBs. The set of PRBs may be determined/indicated/identified/denoted as a precoding resource block group (PRG).

A PDSCH may comprise one or more layers. The wireless device may assume that at least one symbol with DM-RS is present on a layer of the one or more layers of the PDSCH. A higher layer may configure one or more DM-RSs for a PDSCH (e.g., up to 3 DMRSs for the PDSCH). Downlink PT-RS may be sent/transmitted by a base station and used by a wireless device, for example, for a phase-noise compensation. Whether a downlink PT-RS is present or not may depend on an RRC configuration. The presence and/or the pattern of the downlink PT-RS may be configured on a wireless device-specific basis, for example, using a combination of RRC signaling and/or an association with one or more parameters used/employed for other purposes (e.g., modulation and coding scheme (MCS)), which may be indicated by DCI. A dynamic presence of a downlink PT-RS, if configured, may be associated with one or more DCI parameters comprising at least MCS. A network (e.g., an NR network) may support a plurality of PT-RS densities defined in the time and/or frequency domains. A frequency domain density (if configured/present) may be associated with at least one configuration of a scheduled bandwidth. The wireless device may assume a same precoding for a DM-RS port and a PT-RS port. The quantity/number of PT-RS ports may be fewer than the quantity/number of DM-RS ports in a scheduled resource. Downlink PT-RS may be configured/allocated/confined in the scheduled time/frequency duration for the wireless device. Downlink PT-RS may be sent/transmitted via symbols, for example, to facilitate a phase tracking at the receiver.

The wireless device may send/transmit an uplink DM-RS to a base station, for example, for a channel estimation. The base station may use the uplink DM-RS for coherent demodulation of one or more uplink physical channels. The wireless device may send/transmit an uplink DM-RS with a PUSCH and/or a PUCCH. The uplink DM-RS may span a range of frequencies that is similar to a range of frequencies associated with the corresponding physical channel. The base station may configure the wireless device with one or more uplink DM-RS configurations. At least one DM-RS configuration may support a front-loaded DM-RS pattern. The front-loaded DM-RS may be mapped over one or more OFDM symbols (e.g., one or two adjacent OFDM symbols). One or more uplink DM-RSs may be configured to send/transmit at one or more symbols of a PUSCH and/or a PUCCH. The base station may semi-statically configure the wireless device with a number/quantity (e.g. the maximum number/quantity) of front-loaded DM-RS symbols for the PUSCH and/or the PUCCH, which the wireless device may use to schedule a single-symbol DM-RS and/or a double-symbol DM-RS. A network (e.g., an NR network) may support (e.g., for cyclic prefix orthogonal frequency division multiplexing (CP-OFDM)) a common DM-RS structure for downlink and uplink. A DM-RS location, a DM-RS pattern, and/or a scrambling sequence for the DM-RS may be substantially the same or different.

A PUSCH may comprise one or more layers. A wireless device may send/transmit at least one symbol with DM-RS present on a layer of the one or more layers of the PUSCH. A higher layer may configure one or more DM-RSs (e.g., up to three DMRSs) for the PUSCH. Uplink PT-RS (which may be used by a base station for a phase tracking and/or a phase-noise compensation) may or may not be present, for example, depending on an RRC configuration of the wireless device. The presence and/or the pattern of an uplink PT-RS may be configured on a wireless device-specific basis (e.g., a wireless device-specific basis), for example, by a combination of RRC signaling and/or one or more parameters configured/employed for other purposes (e.g., MCS), which may be indicated by DCI. A dynamic presence of an uplink PT-RS, if configured, may be associated with one or more DCI parameters comprising at least MCS. A radio network may support a plurality of uplink PT-RS densities defined in time/frequency domain. A frequency domain density (if configured/present) may be associated with at least one configuration of a scheduled bandwidth. The wireless device may assume a same precoding for a DM-RS port and a PT-RS port. A quantity/number of PT-RS ports may be less than a quantity/number of DM-RS ports in a scheduled resource. An uplink PT-RS may be configured/allocated/confined in the scheduled time/frequency duration for the wireless device.

One or more SRSs may be sent/transmitted by a wireless device to a base station, for example, for a channel state estimation to support uplink channel dependent scheduling and/or a link adaptation. SRS sent/transmitted by the wireless device may enable/allow a base station to estimate an uplink channel state at one or more frequencies. A scheduler at the base station may use/employ the estimated uplink channel state to assign one or more resource blocks for an uplink PUSCH transmission for the wireless device. The base station may semi-statically configure the wireless device with one or more SRS resource sets. For an SRS resource set, the base station may configure the wireless device with one or more SRS resources. An SRS resource set applicability may be configured, for example, by a higher layer (e.g., RRC) parameter. An SRS resource in an SRS resource set of the one or more SRS resource sets (e.g., with the same/similar time domain behavior, periodic, aperiodic, and/or the like) may be sent/transmitted at a time instant (e.g., simultaneously), for example, if a higher layer parameter indicates beam management. The wireless device may send/transmit one or more SRS resources in SRS resource sets. A network (e.g., an NR network) may support aperiodic, periodic, and/or semi-persistent SRS transmissions. The wireless device may send/transmit SRS resources, for example, based on one or more trigger types. The one or more trigger types may comprise higher layer signaling (e.g., RRC) and/or one or more DCI formats. At least one DCI format may be used/employed for the wireless device to select at least one of one or more configured SRS resource sets. An SRS trigger type 0 may refer to an SRS triggered based on higher layer signaling. An SRS trigger type 1 may refer to an SRS triggered based on one or more DCI formats. The wireless device may be configured to send/transmit an SRS, for example, after a transmission of a PUSCH and a corresponding uplink DM-RS if a PUSCH and an SRS are sent/transmitted in a same slot. A base station may semi-statically configure a wireless device with one or more SRS configuration parameters indicating at least one of following: a SRS resource configuration identifier; a number of SRS ports; time domain behavior of an SRS resource configuration (e.g., an indication of periodic, semi-persistent, or aperiodic SRS); slot, mini-slot, and/or subframe level periodicity; an offset for a periodic and/or an aperiodic SRS resource; a number of OFDM symbols in an SRS resource; a starting OFDM symbol of an SRS resource; an SRS bandwidth; a frequency hopping bandwidth; a cyclic shift; and/or an SRS sequence ID.

An antenna port may be determined/defined such that the channel over which a symbol on the antenna port is conveyed can be inferred from the channel over which another symbol on the same antenna port is conveyed. The receiver may infer/determine the channel (e.g., fading gain, multipath delay, and/or the like) for conveying a second symbol on an antenna port, from the channel for conveying a first symbol on the antenna port, for example, if the first symbol and the second symbol are sent/transmitted on the same antenna port. A first antenna port and a second antenna port may be referred to as quasi co-located (QCLed), for example, if one or more large-scale properties of the channel over which a first symbol on the first antenna port is conveyed may be inferred from the channel over which a second symbol on a second antenna port is conveyed. The one or more large-scale properties may comprise at least one of: a delay spread; a Doppler spread; a Doppler shift; an average gain; an average delay; and/or spatial Receiving (Rx) parameters.

Channels that use beamforming may require beam management. Beam management may comprise a beam measurement, a beam selection, and/or a beam indication. A beam may be associated with one or more reference signals. A beam may be identified by one or more beamformed reference signals. The wireless device may perform a downlink beam measurement, for example, based on one or more downlink reference signals (e.g., a CSI-RS) and generate a beam measurement report. The wireless device may perform the downlink beam measurement procedure, for example, after an RRC connection is set up with a base station.

FIG. 11B shows an example mapping of one or more CSI-RSs. The CSI-RSs may be mapped in the time and frequency domains. Each rectangular block shown in FIG. 11B may correspond to a resource block (RB) within a bandwidth of a cell. A base station may send/transmit one or more RRC messages comprising CSI-RS resource configuration parameters indicating one or more CSI-RSs. One or more of parameters may be configured by higher layer signaling (e.g., RRC and/or MAC signaling) for a CSI-RS resource configuration. The one or more of the parameters may comprise at least one of: a CSI-RS resource configuration identity, a number of CSI-RS ports, a CSI-RS configuration (e.g., symbol and resource element (RE) locations in a subframe), a CSI-RS subframe configuration (e.g., a subframe location, an offset, and periodicity in a radio frame), a CSI-RS power parameter, a CSI-RS sequence parameter, a code division multiplexing (CDM) type parameter, a frequency density, a transmission comb, quasi co-location (parameters (e.g., QCL-scramblingidentity, crs-portscount, mbsfn-subframeconfiglist, csi-rs-configZPid, qcl-csi-rs-configNZPid), and/or other radio resource parameters.

One or more beams may be configured for a wireless device in a wireless device-specific configuration. Three beams are shown in FIG. 11B (beam #1, beam #2, and beam #3), but more or fewer beams may be configured. Beam #1 may be allocated with CSI-RS 1101 that may be sent/transmitted in one or more subcarriers in an RB of a first symbol. Beam #2 may be allocated with CSI-RS 1102 that may be sent/transmitted in one or more subcarriers in an RB of a second symbol. Beam #3 may be allocated with CSI-RS 1103 that may be sent/transmitted in one or more subcarriers in an RB of a third symbol. A base station may use other subcarriers in the same RB (e.g., those that are not used to send/transmit CSI-RS 1101) to transmit another CSI-RS associated with a beam for another wireless device, for example, by using frequency division multiplexing (FDM). Beams used for a wireless device may be configured such that beams for the wireless device use symbols different from symbols used by beams of other wireless devices, for example, by using time domain multiplexing (TDM). A wireless device may be served with beams in orthogonal symbols (e.g., no overlapping symbols), for example, by using the TDM.

CSI-RSs (e.g., CSI-RSs 1101, 1102, 1103) may be sent/transmitted by the base station and used by the wireless device for one or more measurements. The wireless device may measure an RSRP of configured CSI-RS resources. The base station may configure the wireless device with a reporting configuration, and the wireless device may report the RSRP measurements to a network (e.g., via one or more base stations) based on the reporting configuration. The base station may determine, based on the reported measurement results, one or more transmission configuration indication (TCI) states comprising a number of reference signals. The base station may indicate one or more TCI states to the wireless device (e.g., via RRC signaling, a MAC CE, and/or DCI). The wireless device may receive a downlink transmission with an Rx beam determined based on the one or more TCI states. The wireless device may or may not have a capability of beam correspondence. The wireless device may determine a spatial domain filter of a transmit (Tx) beam, for example, based on a spatial domain filter of the corresponding Rx beam, if the wireless device has the capability of beam correspondence. The wireless device may perform an uplink beam selection procedure to determine the spatial domain filter of the Tx beam, for example, if the wireless device does not have the capability of beam correspondence. The wireless device may perform the uplink beam selection procedure, for example, based on one or more sounding reference signal (SRS) resources configured to the wireless device by the base station. The base station may select and indicate uplink beams for the wireless device, for example, based on measurements of the one or more SRS resources sent/transmitted by the wireless device.

A wireless device may determine/assess (e.g., measure) a channel quality of one or more beam pair links, for example, in a beam management procedure. A beam pair link may comprise a Tx beam of a base station and an Rx beam of the wireless device. The Tx beam of the base station may send/transmit a downlink signal, and the Rx beam of the wireless device may receive the downlink signal. The wireless device may send/transmit a beam measurement report, for example, based on the assessment/determination. The beam measurement report may indicate one or more beam pair quality parameters comprising at least one of: one or more beam identifications (e.g., a beam index, a reference signal index, or the like), an RSRP, a precoding matrix indicator (PMI), a channel quality indicator (CQI), and/or a rank indicator (RI).

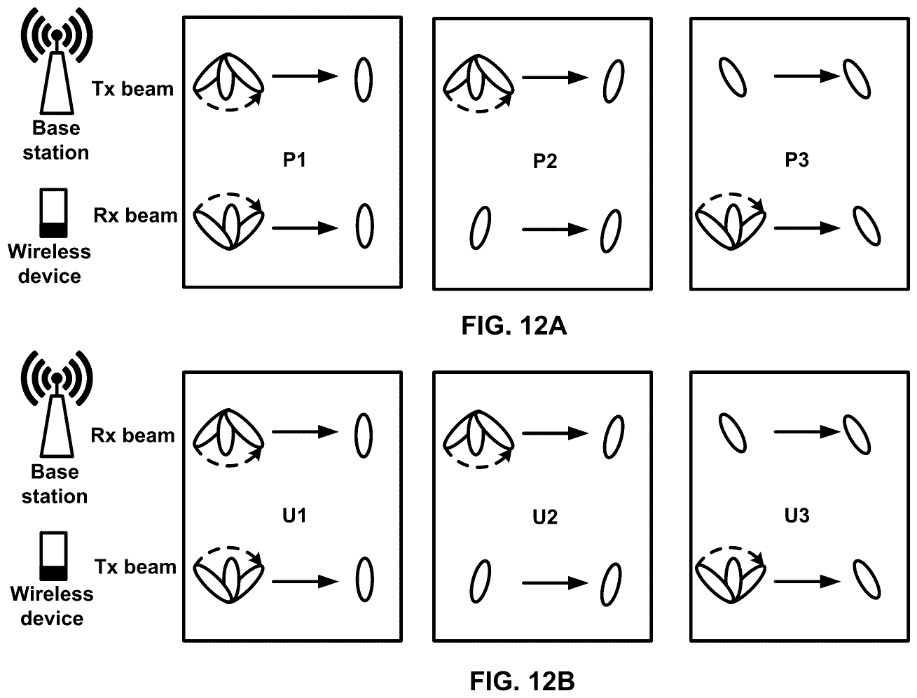

FIG. 12A shows examples of downlink beam management procedures. One or more downlink beam management procedures (e.g., downlink beam management procedures P1, P2, and P3) may be performed. Procedure P1 may enable a measurement (e.g., a wireless device measurement) on Tx beams of a TRP (or multiple TRPs) (e.g., to support a selection of one or more base station Tx beams and/or wireless device Rx beams). The Tx beams of a base station and the Rx beams of a wireless device are shown as ovals in the top row of P1 and bottom row of P1, respectively. Beamforming (e.g., at a TRP) may comprise a Tx beam sweep for a set of beams (e.g., the beam sweeps shown, in the top rows of P1 and P2, as ovals rotated in a counter-clockwise direction indicated by the dashed arrows). Beamforming (e.g., at a wireless device) may comprise an Rx beam sweep for a set of beams (e.g., the beam sweeps shown, in the bottom rows of P1 and P3, as ovals rotated in a clockwise direction indicated by the dashed arrows). Procedure P2 may be used to enable a measurement (e.g., a wireless device measurement) on Tx beams of a TRP (shown, in the top row of P2, as ovals rotated in a counter-clockwise direction indicated by the dashed arrow). The wireless device and/or the base station may perform procedure P2, for example, using a smaller set of beams than the set of beams used in procedure P1, or using narrower beams than the beams used in procedure P1. Procedure P2 may be referred to as a beam refinement. The wireless device may perform procedure P3 for an Rx beam determination, for example, by using the same Tx beam(s) of the base station and sweeping Rx beam(s) of the wireless device.

FIG. 12B shows examples of uplink beam management procedures. One or more uplink beam management procedures (e.g., uplink beam management procedures U1, U2, and U3) may be performed. Procedure U1 may be used to enable a base station to perform a measurement on Tx beams of a wireless device (e.g., to support a selection of one or more Tx beams of the wireless device and/or Rx beams of the base station). The Tx beams of the wireless device and the Rx beams of the base station are shown as ovals in the top row of U1 and bottom row of U1, respectively). Beamforming (e.g., at the wireless device) may comprise one or more beam sweeps, for example, a Tx beam sweep from a set of beams (shown, in the bottom rows of U1 and U3, as ovals rotated in a clockwise direction indicated by the dashed arrows). Beamforming (e.g., at the base station) may comprise one or more beam sweeps, for example, an Rx beam sweep from a set of beams (shown, in the top rows of U1 and U2, as ovals rotated in a counter-clockwise direction indicated by the dashed arrows). Procedure U2 may be used to enable the base station to adjust its Rx beam, for example, if the wireless device (e.g., wireless device) uses a fixed Tx beam. The wireless device and/or the base station may perform procedure U2, for example, using a smaller set of beams than the set of beams used in procedure P1, or using narrower beams than the beams used in procedure P1. Procedure U2 may be referred to as a beam refinement. The wireless device may perform procedure U3 to adjust its Tx beam, for example, if the base station uses a fixed Rx beam.

A wireless device may initiate/start/perform a beam failure recovery (BFR) procedure, for example, based on detecting a beam failure. The wireless device may send/transmit a BFR request (e.g., a preamble, UCI, an SR, a MAC CE, and/or the like), for example, based on the initiating the BFR procedure. The wireless device may detect the beam failure, for example, based on a determination that a quality of beam pair link(s) of an associated control channel is unsatisfactory (e.g., having an error rate higher than an error rate threshold, a received signal power lower than a received signal power threshold, an expiration of a timer, and/or the like).

The wireless device may measure a quality of a beam pair link, for example, using one or more reference signals (RSs) comprising one or more SS/PBCH blocks, one or more CSI-RS resources, and/or one or more DM-RSs. A quality of the beam pair link may be based on one or more of a block error rate (BLER), an RSRP value, a signal to interference plus noise ratio (SINR) value, an RSRQ value, and/or a CSI value measured on RS resources. The base station may indicate that an RS resource is QCLed with one or more DM-RSs of a channel (e.g., a control channel, a shared data channel, and/or the like). The RS resource and the one or more DM-RSs of the channel may be QCLed, for example, if the channel characteristics (e.g., Doppler shift, Doppler spread, an average delay, delay spread, a spatial Rx parameter, fading, and/or the like) from a transmission via the RS resource to the wireless device are similar or the same as the channel characteristics from a transmission via the channel to the wireless device.

A network (e.g., an NR network comprising a base station and/or an ng-eNB) and/or the wireless device may initiate/start/perform a random access procedure. A wireless device in an RRC idle (e.g., an RRC_IDLE) state and/or an RRC inactive (e.g., an RRC_INACTIVE) state may initiate/perform the random access procedure to request a connection setup to a network. The wireless device may initiate/start/perform the random access procedure from an RRC connected (e.g., an RRC_CONNECTED) state. The wireless device may initiate/start/perform the random access procedure to request uplink resources (e.g., for uplink transmission of an SR if there is no PUCCH resource available) and/or acquire/obtain/determine an uplink timing (e.g., if an uplink synchronization status is non-synchronized). The wireless device may initiate/start/perform the random access procedure to request one or more system information blocks (SIBs) (e.g., other system information blocks, such as SIB2, SIB3, and/or the like). The wireless device may initiate/start/perform the random access procedure for a beam failure recovery request. A network may initiate/start/perform a random access procedure, for example, for a handover and/or for establishing time alignment for an SCell addition.

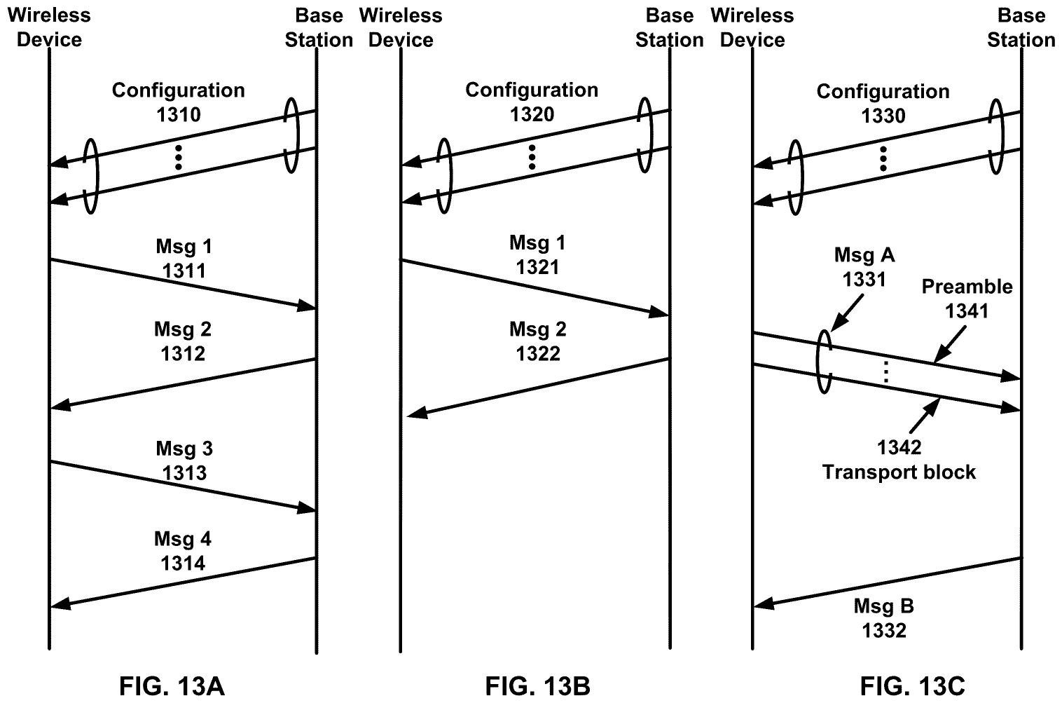

FIG. 13A shows an example four-step random access procedure. The four-step random access procedure may comprise a four-step contention-based random access procedure. A base station may send/transmit a configuration message 1310 to a wireless device, for example, before initiating the random access procedure. The four-step random access procedure may comprise transmissions of four messages comprising: a first message (e.g., Msg 1 1311), a second message (e.g., Msg 2 1312), a third message (e.g., Msg 3 1313), and a fourth message (e.g., Msg 4 1314). The first message (e.g., Msg 1 1311) may comprise a preamble (or a random access preamble). The first message (e.g., Msg 1 1311) may be referred to as a preamble. The second message (e.g., Msg 2 1312) may comprise as a random access response (RAR). The second message (e.g., Msg 2 1312) may be referred to as an RAR.

The configuration message 1310 may be sent/transmitted, for example, using one or more RRC messages. The one or more RRC messages may indicate one or more random access channel (RACH) parameters to the wireless device. The one or more RACH parameters may comprise at least one of: general parameters for one or more random access procedures (e.g., RACH-configGeneral); cell-specific parameters (e.g., RACH-ConfigCommon); and/or dedicated parameters (e.g., RACH-ConfigDedicated). The base station may send/transmit (e.g., broadcast or multicast) the one or more RRC messages to one or more wireless devices. The one or more RRC messages may be wireless device-specific. The one or more RRC messages that are wireless device-specific may be, for example, dedicated RRC messages sent/transmitted to a wireless device in an RRC connected (e.g., an RRC_CONNECTED) state and/or in an RRC inactive (e.g., an RRC_INACTIVE) state. The wireless devices may determine, based on the one or more RACH parameters, a time-frequency resource and/or an uplink transmit power for transmission of the first message (e.g., Msg 1 1311) and/or the third message (e.g., Msg 3 1313). The wireless device may determine a reception timing and a downlink channel for receiving the second message (e.g., Msg 2 1312) and the fourth message (e.g., Msg 4 1314), for example, based on the one or more RACH parameters.

The one or more RACH parameters provided/configured/comprised in the configuration message 1310 may indicate one or more Physical RACH (PRACH) occasions available for transmission of the first message (e.g., Msg 1 1311). The one or more PRACH occasions may be predefined (e.g., by a network comprising one or more base stations). The one or more RACH parameters may indicate one or more available sets of one or more PRACH occasions (e.g., prach-ConfigIndex). The one or more RACH parameters may indicate an association between (a) one or more PRACH occasions and (b) one or more reference signals. The one or more RACH parameters may indicate an association between (a) one or more preambles and (b) one or more reference signals. The one or more reference signals may be SS/PBCH blocks and/or CSI-RSs. The one or more RACH parameters may indicate a quantity/number of SS/PBCH blocks mapped to a PRACH occasion and/or a quantity/number of preambles mapped to a SS/PBCH blocks.

The one or more RACH parameters provided/configured/comprised in the configuration message 1310 may be used to determine an uplink transmit power of first message (e.g., Msg 1 1311) and/or third message (e.g., Msg 3 1313). The one or more RACH parameters may indicate a reference power for a preamble transmission (e.g., a received target power and/or an initial power of the preamble transmission). There may be one or more power offsets indicated by the one or more RACH parameters. The one or more RACH parameters may indicate: a power ramping step; a power offset between SSB and CSI-RS; a power offset between transmissions of the first message (e.g., Msg 1 1311) and the third message (e.g., Msg 3 1313); and/or a power offset value between preamble groups. The one or more RACH parameters may indicate one or more thresholds, for example, based on which the wireless device may determine at least one reference signal (e.g., an SSB and/or CSI-RS) and/or an uplink carrier (e.g., a normal uplink (NUL) carrier and/or a supplemental uplink (SUL) carrier).

The first message (e.g., Msg 1 1311) may comprise one or more preamble transmissions (e.g., a preamble transmission and one or more preamble retransmissions). An RRC message may be used to configure one or more preamble groups (e.g., group A and/or group B). A preamble group may comprise one or more preambles. The wireless device may determine the preamble group, for example, based on a pathloss measurement and/or a size of the third message (e.g., Msg 3 1313). The wireless device may measure an RSRP of one or more reference signals (e.g., SSBs and/or CSI-RSs) and determine at least one reference signal having an RSRP above an RSRP threshold (e.g., rsrp-ThresholdSSB and/or rsrp-ThresholdCSI-RS). The wireless device may select at least one preamble associated with the one or more reference signals and/or a selected preamble group, for example, if the association between the one or more preambles and the at least one reference signal is configured by an RRC message.

The wireless device may determine the preamble, for example, based on the one or more RACH parameters provided/configured/comprised in the configuration message 1310. The wireless device may determine the preamble, for example, based on a pathloss measurement, an RSRP measurement, and/or a size of the third message (e.g., Msg 3 1313). The one or more RACH parameters may indicate: a preamble format; a maximum quantity/number of preamble transmissions; and/or one or more thresholds for determining one or more preamble groups (e.g., group A and group B). A base station may use the one or more RACH parameters to configure the wireless device with an association between one or more preambles and one or more reference signals (e.g., SSBs and/or CSI-RSs). The wireless device may determine the preamble to be comprised in first message (e.g., Msg 1 1311), for example, based on the association if the association is configured. The first message (e.g., Msg 1 1311) may be sent/transmitted to the base station via one or more PRACH occasions. The wireless device may use one or more reference signals (e.g., SSBs and/or CSI-RSs) for selection of the preamble and for determining of the PRACH occasion. One or more RACH parameters (e.g., ra-ssb-OccasionMskIndex and/or ra-OccasionList) may indicate an association between the PRACH occasions and the one or more reference signals.

The wireless device may perform a preamble retransmission, for example, if no response is received after (e.g., based on or in response to) a preamble transmission (e.g., for a period of time, such as a monitoring window for monitoring an RAR). The wireless device may increase an uplink transmit power for the preamble retransmission. The wireless device may select an initial preamble transmit power, for example, based on a pathloss measurement and/or a target received preamble power configured by the network. The wireless device may determine to resend/retransmit a preamble and may ramp up the uplink transmit power. The wireless device may receive one or more RACH parameters (e.g., PREAMBLE_POWER_RAMPING_STEP) indicating a ramping step for the preamble retransmission. The ramping step may be an amount of incremental increase in uplink transmit power for a retransmission. The wireless device may ramp up the uplink transmit power, for example, if the wireless device determines a reference signal (e.g., SSB and/or CSI-RS) that is the same as a previous preamble transmission. The wireless device may count the quantity/number of preamble transmissions and/or retransmissions, for example, using a counter parameter (e.g., PREAMBLE_TRANSMISSION_COUNTER). The wireless device may determine that a random access procedure has been completed unsuccessfully, for example, if the quantity/number of preamble transmissions exceeds a threshold configured by the one or more RACH parameters (e.g., preambleTransMax) without receiving a successful response (e.g., an RAR).

The second message (e.g., Msg 2 1312) (e.g., received by the wireless device) may comprise an RAR. The second message (e.g., Msg 2 1312) may comprise multiple RARs corresponding to multiple wireless devices. The second message (e.g., Msg 2 1312) may be received, for example, after (e.g., based on or in response to) the sending/sending (e.g., transmitting) of the first message (e.g., Msg 1 1311). The second message (e.g., Msg 2 1312) may be scheduled on the DL-SCH and may be indicated by a PDCCH, for example, using a random access radio network temporary identifier (RA RNTI). The second message (e.g., Msg 2 1312) may indicate that the first message (e.g., Msg 1 1311) was received by the base station. The second message (e.g., Msg 2 1312) may comprise a time-alignment command that may be used by the wireless device to adjust the transmission timing of the wireless device, a scheduling grant for transmission of the third message (e.g., Msg 3 1313), and/or a Temporary Cell RNTI (TC-RNTI). The wireless device may determine/start a time window (e.g., ra-Response Window) to monitor a PDCCH for the second message (e.g., Msg 2 1312), for example, after sending/sending (e.g., transmitting) the first message (e.g., Msg 1 1311) (e.g., a preamble). The wireless device may determine the start time of the time window, for example, based on a PRACH occasion that the wireless device uses to send/transmit the first message (e.g., Msg 1 1311) (e.g., the preamble). The wireless device may start the time window one or more symbols after the last symbol of the first message (e.g., Msg 1 1311) comprising the preamble (e.g., the symbol in which the first message (e.g., Msg 1 1311) comprising the preamble transmission was completed or at a first PDCCH occasion from an end of a preamble transmission). The one or more symbols may be determined based on a numerology. The PDCCH may be mapped in a common search space (e.g., a Type1-PDCCH common search space) configured by an RRC message. The wireless device may identify/determine the RAR, for example, based on an RNTI. Radio network temporary identifiers (RNTIs) may be used depending on one or more events initiating/starting the random access procedure. The wireless device may use a RA-RNTI, for example, for one or more communications associated with random access or any other purpose. The RA-RNTI may be associated with PRACH occasions in which the wireless device sends/transmits a preamble. The wireless device may determine the RA-RNTI, for example, based on at least one of: an OFDM symbol index; a slot index; a frequency domain index; and/or a UL carrier indicator of the PRACH occasions. An example RA-RNTI may be determined as follows:

$$RA - RNTI = 1 + s\_id + 14 \times t\_id + 14 \times 80 \times f\_id + 14 \times 80 \times 8 \times ul\_carrier \_id$$

where s_id may be an index of a first OFDM symbol of the PRACH occasion (e.g., 0≤s_id<14), t_id may be an index of a first slot of the PRACH occasion in a system frame (e.g., 0≤t_id<80), f_id may be an index of the PRACH occasion in the frequency domain (e.g., 0≤f_id<8), and ul_carrier_id may be a UL carrier used for a preamble transmission (e.g., 0 for an NUL carrier, and 1 for an SUL carrier).

The wireless device may send/transmit the third message (e.g., Msg 3 1313), for example, after (e.g., based on or in response to) a successful reception of the second message (e.g., Msg 2 1312) (e.g., using resources identified in the Msg 2 1312). The third message (e.g., Msg 3 1313) may be used, for example, for contention resolution in the contention-based random access procedure. A plurality of wireless devices may send/transmit the same preamble to a base station, and the base station may send/transmit an RAR that corresponds to a wireless device. Collisions may occur, for example, if the plurality of wireless device interpret the RAR as corresponding to themselves. Contention resolution (e.g., using the third message (e.g., Msg 3 1313) and the fourth message (e.g., Msg 4 1314)) may be used to increase the likelihood that the wireless device does not incorrectly use an identity of another the wireless device. The wireless device may comprise a device identifier in the third message (e.g., Msg 3 1313) (e.g., a C-RNTI if assigned, a TC RNTI comprised in the second message (e.g., Msg 2 1312), and/or any other suitable identifier), for example, to perform contention resolution.

The fourth message (e.g., Msg 4 1314) may be received, for example, after (e.g., based on or in response to) the sending (e.g., transmitting) of the third message (e.g., Msg 3 1313). The base station may address the wireless on the PDCCH (e.g., the base station may send the PDCCH to the wireless device) using a C-RNTI, for example, If the C-RNTI was included in the third message (e.g., Msg 3 1313). The random access procedure may be determined to be successfully completed, for example, if the unique C RNTI of the wireless device is detected on the PDCCH (e.g., the PDCCH is scrambled by the C-RNTI). Fourth message (e.g., Msg 4 1314) may be received using a DL-SCH associated with a TC RNTI, for example, if the TC RNTI is comprised in the third message (e.g., Msg 3 1313) (e.g., if the wireless device is in an RRC idle (e.g., an RRC_IDLE) state or not otherwise connected to the base station). The wireless device may determine that the contention resolution is successful and/or the wireless device may determine that the random access procedure is successfully completed, for example, if a MAC PDU is successfully decoded and a MAC PDU comprises the wireless device contention resolution identity MAC CE that matches or otherwise corresponds with the CCCH SDU sent/transmitted in third message (e.g., Msg 3 1313).

The wireless device may be configured with an SUL carrier and/or an NUL carrier. An initial access (e.g., random access) may be supported via an uplink carrier. A base station may configure the wireless device with multiple RACH configurations (e.g., two separate RACH configurations comprising: one for an SUL carrier and the other for an NUL carrier). For random access in a cell configured with an SUL carrier, the network may indicate which carrier to use (NUL or SUL). The wireless device may determine to use the SUL carrier, for example, if a measured quality of one or more reference signals (e.g., one or more reference signals associated with the NUL carrier) is lower than a broadcast threshold. Uplink transmissions of the random access procedure (e.g., the first message (e.g., Msg 1 1311) and/or the third message (e.g., Msg 3 1313)) may remain on, or may be performed via, the selected carrier. The wireless device may switch an uplink carrier during the random access procedure (e.g., between the Msg 1 1311 and the Msg 3 1313). The wireless device may determine and/or switch an uplink carrier for the first message (e.g., Msg 1 1311) and/or the third message (e.g., Msg 3 1313), for example, based on a channel clear assessment (e.g., a listen-before-talk).

FIG. 13B shows a two-step random access procedure. The two-step random access procedure may comprise a two-step contention-free random access procedure. Similar to the four-step contention-based random access procedure, a base station may, prior to initiation of the procedure, send/transmit a configuration message 1320 to the wireless device. The configuration message 1320 may be analogous in some respects to the configuration message 1310. The procedure shown in FIG. 13B may comprise transmissions of two messages: a first message (e.g., Msg 1 1321) and a second message (e.g., Msg 2 1322). The first message (e.g., Msg 1 1321) and the second message (e.g., Msg 2 1322) may be analogous in some respects to the first message (e.g., Msg 1 1311) and a second message (e.g., Msg 2 1312), respectively. The two-step contention-free random access procedure may not comprise messages analogous to the third message (e.g., Msg 3 1313) and/or the fourth message (e.g., Msg 4 1314).

The two-step (e.g., contention-free) random access procedure may be configured/initiated for a beam failure recovery, other SI request, an SCell addition, and/or a handover. A base station may indicate, or assign to, the wireless device a preamble to be used for the first message (e.g., Msg 1 1321). The wireless device may receive, from the base station via a PDCCH and/or an RRC, an indication of the preamble (e.g., ra-PreambleIndex).

The wireless device may start a time window (e.g., ra-Response Window) to monitor a PDCCH for the RAR, for example, after (e.g., based on or in response to) sending (e.g., transmitting) the preamble. The base station may configure the wireless device with one or more beam failure recovery parameters, such as a separate time window and/or a separate PDCCH in a search space indicated by an RRC message (e.g., recoverySearchSpaceId). The base station may configure the one or more beam failure recovery parameters, for example, in association with a beam failure recovery request. The separate time window for monitoring the PDCCH and/or an RAR may be configured to start after sending (e.g., transmitting) a beam failure recovery request (e.g., the window may start any quantity of symbols and/or slots after sending (e.g., transmitting) the beam failure recovery request). The wireless device may monitor for a PDCCH transmission addressed to a Cell RNTI (C-RNTI) on the search space. During the two-step (e.g., contention-free) random access procedure, the wireless device may determine that a random access procedure is successful, for example, after (e.g., based on or in response to) sending (e.g., transmitting) first message (e.g., Msg 1 1321) and receiving a corresponding second message (e.g., Msg 2 1322). The wireless device may determine that a random access procedure has successfully been completed, for example, if a PDCCH transmission is addressed to a corresponding C-RNTI. The wireless device may determine that a random access procedure has successfully been completed, for example, if the wireless device receives an RAR comprising a preamble identifier corresponding to a preamble sent/transmitted by the wireless device and/or the RAR comprises a MAC sub-PDU with the preamble identifier. The wireless device may determine the response as an indication of an acknowledgement for an SI request.

FIG. 13C shows an example two-step random access procedure. Similar to the random access procedures shown in FIGS. 13A and 13B, a base station may, prior to initiation of the procedure, send/transmit a configuration message 1330 to the wireless device. The configuration message 1330 may be analogous in some respects to the configuration message 1310 and/or the configuration message 1320. The procedure shown in FIG. 13C may comprise transmissions of multiple messages (e.g., two messages comprising: a first message (e.g., Msg A 1331) and a second message (e.g., Msg B 1332)).

Msg A 1331 may be sent/transmitted in an uplink transmission by the wireless device. Msg A 1331 may comprise one or more transmissions of a preamble 1341 and/or one or more transmissions of a transport block 1342. The transport block 1342 may comprise contents that are similar and/or equivalent to the contents of the third message (e.g., Msg 3 1313) (e.g., shown in FIG. 13A). The transport block 1342 may comprise UCI (e.g., an SR, a HARQ ACK/NACK, and/or the like). The wireless device may receive the second message (e.g., Msg B 1332), for example, after (e.g., based on or in response to) sending (e.g., transmitting) the first message (e.g., Msg A 1331). The second message (e.g., Msg B 1332) may comprise contents that are similar and/or equivalent to the contents of the second message (e.g., Msg 2 1312) (e.g., an RAR shown in FIGS. 13A), the contents of the second message (e.g., Msg 2 1322) (e.g., an RAR shown in FIG. 13B) and/or the fourth message (e.g., Msg 4 1314) (e.g., shown in FIG. 13A).

The wireless device may start/initiate the two-step random access procedure (e.g., the two-step random access procedure shown in FIG. 13C) for a licensed spectrum and/or an unlicensed spectrum. The wireless device may determine, based on one or more factors, whether to start/initiate the two-step random access procedure. The one or more factors may comprise at least one of: a radio access technology in use (e.g., LTE, NR, and/or the like); whether the wireless device has a valid TA or not; a cell size; the RRC state of the wireless device; a type of spectrum (e.g., licensed vs. unlicensed); and/or any other suitable factors.

The wireless device may determine, based on two-step RACH parameters comprised in the configuration message 1330, a radio resource and/or an uplink transmit power for the preamble 1341 and/or the transport block 1342 (e.g., comprised in the first message (e.g., Msg A 1331)). The RACH parameters may indicate an MCS, a time-frequency resource, and/or a power control for the preamble 1341 and/or the transport block 1342. A time-frequency resource for transmission of the preamble 1341 (e.g., a PRACH) and a time-frequency resource for transmission of the transport block 1342 (e.g., a PUSCH) may be multiplexed using FDM, TDM, and/or CDM. The RACH parameters may enable the wireless device to determine a reception timing and a downlink channel for monitoring for and/or receiving second message (e.g., Msg B 1332).

The transport block 1342 may comprise data (e.g., delay-sensitive data), an identifier of the wireless device, security information, and/or device information (e.g., an International Mobile Subscriber Identity (IMSI)). The base station may send/transmit the second message (e.g., Msg B 1332) as a response to the first message (e.g., Msg A 1331). The second message (e.g., Msg B 1332) may comprise at least one of: a preamble identifier; a timing advance command; a power control command; an uplink grant (e.g., a radio resource assignment and/or an MCS); a wireless device identifier (e.g., a wireless device identifier for contention resolution); and/or an RNTI (e.g., a C-RNTI or a TC-RNTI). The wireless device may determine that the two-step random access procedure is successfully completed, for example, if a preamble identifier in the second message (e.g., Msg B 1332) corresponds to, or is matched to, a preamble sent/transmitted by the wireless device and/or the identifier of the wireless device in second message (e.g., Msg B 1332) corresponds to, or is matched to, the identifier of the wireless device in the first message (e.g., Msg A 1331) (e.g., the transport block 1342).

A wireless device and a base station may exchange control signaling (e.g., control information). The control signaling may be referred to as L1/L2 control signaling and may originate from the PHY layer (e.g., layer 1) and/or the MAC layer (e.g., layer 2) of the wireless device or the base station. The control signaling may comprise downlink control signaling sent/transmitted from the base station to the wireless device and/or uplink control signaling sent/transmitted from the wireless device to the base station.

The downlink control signaling may comprise at least one of: a downlink scheduling assignment; an uplink scheduling grant indicating uplink radio resources and/or a transport format; slot format information; a preemption indication; a power control command; and/or any other suitable signaling. The wireless device may receive the downlink control signaling in a payload sent/transmitted by the base station via a PDCCH. The payload sent/transmitted via the PDCCH may be referred to as downlink control information (DCI). The PDCCH may be a group common PDCCH (GC-PDCCH) that is common to a group of wireless devices. The GC-PDCCH may be scrambled by a group common RNTI.

A base station may attach one or more cyclic redundancy check (CRC) parity bits to DCI, for example, in order to facilitate detection of transmission errors. The base station may scramble the CRC parity bits with an identifier of a wireless device (or an identifier of a group of wireless devices), for example, if the DCI is intended for the wireless device (or the group of the wireless devices). Scrambling the CRC parity bits with the identifier may comprise Modulo-2 addition (or an exclusive-OR operation) of the identifier value and the CRC parity bits. The identifier may comprise a 16-bit value of an RNTI.

DCI messages may be used for different purposes. A purpose may be indicated by the type of an RNTI used to scramble the CRC parity bits. DCI having CRC parity bits scrambled with a paging RNTI (P-RNTI) may indicate paging information and/or a system information change notification. The P-RNTI may be predefined as “FFFE” in hexadecimal. DCI having CRC parity bits scrambled with a system information RNTI (SI-RNTI) may indicate a broadcast transmission of the system information. The SI-RNTI may be predefined as “FFFF” in hexadecimal. DCI having CRC parity bits scrambled with a random access RNTI (RA-RNTI) may indicate a random access response (RAR). DCI having CRC parity bits scrambled with a cell RNTI (C-RNTI) may indicate a dynamically scheduled unicast transmission and/or a triggering of PDCCH-ordered random access. DCI having CRC parity bits scrambled with a temporary cell RNTI (TC-RNTI) may indicate a contention resolution (e.g., a Msg 3 analogous to the Msg 3 1313 shown in FIG. 13A). Other RNTIs configured for a wireless device by a base station may comprise a Configured Scheduling RNTI (CS RNTI), a Transmit Power Control-PUCCH RNTI (TPC PUCCH-RNTI), a Transmit Power Control-PUSCH RNTI (TPC-PUSCH-RNTI), a Transmit Power Control-SRS RNTI (TPC-SRS-RNTI), an Interruption RNTI (INT-RNTI), a Slot Format Indication RNTI (SFI-RNTI), a Semi-Persistent CSI RNTI (SP-CSI-RNTI), a Modulation and Coding Scheme Cell RNTI (MCS-C RNTI), and/or the like.

A base station may send/transmit DCI messages with one or more DCI formats, for example, depending on the purpose and/or content of the DCI messages. DCI format 0_0 may be used for scheduling of a PUSCH in a cell. DCI format 0_0 may be a fallback DCI format (e.g., with compact DCI payloads). DCI format 0_1 may be used for scheduling of a PUSCH in a cell (e.g., with more DCI payloads than DCI format 0_0). DCI format 1_0 may be used for scheduling of a PDSCH in a cell. DCI format 1_0 may be a fallback DCI format (e.g., with compact DCI payloads). DCI format 1_1 may be used for scheduling of a PDSCH in a cell (e.g., with more DCI payloads than DCI format 1_0). DCI format 2_0 may be used for providing a slot format indication to a group of wireless devices. DCI format 2_1 may be used for informing/notifying a group of wireless devices of a physical resource block and/or an OFDM symbol where the group of wireless devices may assume no transmission is intended to the group of wireless devices. DCI format 2_2 may be used for transmission of a transmit power control (TPC) command for PUCCH or PUSCH. DCI format 2_3 may be used for transmission of a group of TPC commands for SRS transmissions by one or more wireless devices. DCI format(s) for new functions may be defined in future releases. DCI formats may have different DCI sizes, or may share the same DCI size.

The base station may process the DCI with channel coding (e.g., polar coding), rate matching, scrambling and/or QPSK modulation, for example, after scrambling the DCI with an RNTI. A base station may map the coded and modulated DCI on resource elements used and/or configured for a PDCCH. The base station may send/transmit the DCI via a PDCCH occupying a number of contiguous control channel elements (CCEs), for example, based on a payload size of the DCI and/or a coverage of the base station. The number of the contiguous CCEs (referred to as aggregation level) may be 1, 2, 4, 8, 16, and/or any other suitable number. A CCE may comprise a number (e.g., 6) of resource-element groups (REGs). A REG may comprise a resource block in an OFDM symbol. The mapping of the coded and modulated DCI on the resource elements may be based on mapping of CCEs and REGs (e.g., CCE-to-REG mapping).

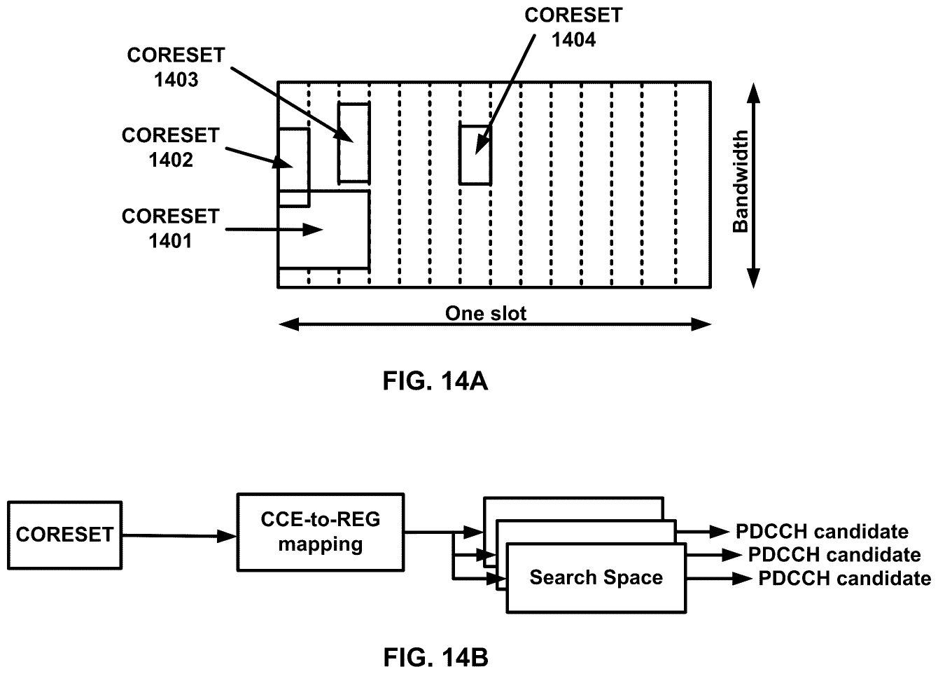

FIG. 14A shows an example of CORESET configurations. The CORESET configurations may be for a bandwidth part or any other frequency bands. The base station may send/transmit DCI via a PDCCH on one or more control resource sets (CORESETs). A CORESET may comprise a time-frequency resource in which the wireless device attempts/tries to decode DCI using one or more search spaces. The base station may configure a size and a location of the CORESET in the time-frequency domain. A first CORESET 1401 and a second CORESET 1402 may occur or may be set/configured at the first symbol in a slot. The first CORESET 1401 may overlap with the second CORESET 1402 in the frequency domain. A third CORESET 1403 may occur or may be set/configured at a third symbol in the slot. A fourth CORESET 1404 may occur or may be set/configured at the seventh symbol in the slot. CORESETs may have a different number of resource blocks in frequency domain.

FIG. 14B shows an example of a CCE-to-REG mapping. The CCE-to-REG mapping may be performed for DCI transmission via a CORESET and PDCCH processing. The CCE-to-REG mapping may be an interleaved mapping (e.g., for the purpose of providing frequency diversity) or a non-interleaved mapping (e.g., for the purposes of facilitating interference coordination and/or frequency-selective transmission of control channels). The base station may perform different or same CCE-to-REG mapping on different CORESETs. A CORESET may be associated with a CCE-to-REG mapping (e.g., by an RRC configuration). A CORESET may be configured with an antenna port QCL parameter. The antenna port QCL parameter may indicate QCL information of a DM-RS for a PDCCH reception via the CORESET.

The base station may send/transmit, to the wireless device, one or more RRC messages comprising configuration parameters of one or more CORESETs and one or more search space sets. The configuration parameters may indicate an association between a search space set and a CORESET. A search space set may comprise a set of PDCCH candidates formed by CCEs (e.g., at a given aggregation level). The configuration parameters may indicate at least one of: a number of PDCCH candidates to be monitored per aggregation level; a PDCCH monitoring periodicity and a PDCCH monitoring pattern; one or more DCI formats to be monitored by the wireless device; and/or whether a search space set is a common search space set or a wireless device-specific search space set (e.g., a wireless device-specific search space set). A set of CCEs in the common search space set may be predefined and known to the wireless device. A set of CCEs in the wireless device-specific search space set (e.g., the wireless device-specific search space set) may be configured, for example, based on the identity of the wireless device (e.g., C-RNTI).

As shown in FIG. 14B, the wireless device may determine a time-frequency resource for a CORESET based on one or more RRC messages. The wireless device may determine a CCE-to-REG mapping (e.g., interleaved or non-interleaved, and/or mapping parameters) for the CORESET, for example, based on configuration parameters of the CORESET. The wireless device may determine a number (e.g., at most 10) of search space sets configured on/for the CORESET, for example, based on the one or more RRC messages. The wireless device may monitor a set of PDCCH candidates according to configuration parameters of a search space set. The wireless device may monitor a set of PDCCH candidates in one or more CORESETs for detecting one or more DCI messages. Monitoring may comprise decoding one or more PDCCH candidates of the set of the PDCCH candidates according to the monitored DCI formats. Monitoring may comprise decoding DCI content of one or more PDCCH candidates with possible (or configured) PDCCH locations, possible (or configured) PDCCH formats (e.g., the number of CCEs, the number of PDCCH candidates in common search spaces, and/or the number of PDCCH candidates in the wireless device-specific search spaces) and possible (or configured) DCI formats. The decoding may be referred to as blind decoding. The wireless device may determine DCI as valid for the wireless device, for example, after (e.g., based on or in response to) CRC checking (e.g., scrambled bits for CRC parity bits of the DCI matching an RNTI value). The wireless device may process information comprised in the DCI (e.g., a scheduling assignment, an uplink grant, power control, a slot format indication, a downlink preemption, and/or the like).

The wireless device may send/transmit uplink control signaling (e.g., UCI) to a base station. The uplink control signaling may comprise HARQ acknowledgements for received DL-SCH transport blocks. The wireless device may send/transmit the HARQ acknowledgements, for example, after (e.g., based on or in response to) receiving a DL-SCH transport block. Uplink control signaling may comprise CSI indicating a channel quality of a physical downlink channel. The wireless device may send/transmit the CSI to the base station. The base station, based on the received CSI, may determine transmission format parameters (e.g., comprising multi-antenna and beamforming schemes) for downlink transmission(s). Uplink control signaling may comprise scheduling requests (SR). The wireless device may send/transmit an SR indicating that uplink data is available for transmission to the base station. The wireless device may send/transmit UCI (e.g., HARQ acknowledgements (HARQ-ACK), CSI report, SR, and the like) via a PUCCH or a PUSCH. The wireless device may send/transmit the uplink control signaling via a PUCCH using one of several PUCCH formats.

There may be multiple PUCCH formats (e.g., five PUCCH formats). A wireless device may determine a PUCCH format, for example, based on a size of UCI (e.g., a quantity/number of uplink symbols of UCI transmission and a number of UCI bits). PUCCH format 0 may have a length of one or two OFDM symbols and may comprise two or fewer bits. The wireless device may send/transmit UCI via a PUCCH resource, for example, using PUCCH format 0 if the transmission is over/via one or two symbols and the quantity/number of HARQ-ACK information bits with positive or negative SR (HARQ-ACK/SR bits) is one or two. PUCCH format 1 may occupy a number of OFDM symbols (e.g., between four and fourteen OFDM symbols) and may comprise two or fewer bits. The wireless device may use PUCCH format 1, for example, if the transmission is over/via four or more symbols and the number of HARQ-ACK/SR bits is one or two. PUCCH format 2 may occupy one or two OFDM symbols and may comprise more than two bits. The wireless device may use PUCCH format 2, for example, if the transmission is over/via one or two symbols and the quantity/number of UCI bits is two or more. PUCCH format 3 may occupy a number of OFDM symbols (e.g., between four and fourteen OFDM symbols) and may comprise more than two bits. The wireless device may use PUCCH format 3, for example, if the transmission is four or more symbols, the quantity/number of UCI bits is two or more, and the PUCCH resource does not comprise an orthogonal cover code (OCC). PUCCH format 4 may occupy a number of OFDM symbols (e.g., between four and fourteen OFDM symbols) and may comprise more than two bits. The wireless device may use PUCCH format 4, for example, if the transmission is four or more symbols, the quantity/number of UCI bits is two or more, and the PUCCH resource comprises an OCC.

The base station may send/transmit configuration parameters to the wireless device for a plurality of PUCCH resource sets, for example, using an RRC message. The plurality of PUCCH resource sets (e.g., up to four sets in NR, or up to any other quantity of sets in other systems) may be configured on an uplink BWP of a cell. A PUCCH resource set may be configured with a PUCCH resource set index, a plurality of PUCCH resources with a PUCCH resource being identified by a PUCCH resource identifier (e.g., pucch-Resourceid), and/or a number (e.g. a maximum number) of UCI information bits the wireless device may send/transmit using one of the plurality of PUCCH resources in the PUCCH resource set. The wireless device may select one of the plurality of PUCCH resource sets, for example, based on a total bit length of the UCI information bits (e.g., HARQ-ACK, SR, and/or CSI) if configured with a plurality of PUCCH resource sets. The wireless device may select a first PUCCH resource set having a PUCCH resource set index equal to “0,” for example, if the total bit length of UCI information bits is two or fewer. The wireless device may select a second PUCCH resource set having a PUCCH resource set index equal to “1,” for example, if the total bit length of UCI information bits is greater than two and less than or equal to a first configured value. The wireless device may select a third PUCCH resource set having a PUCCH resource set index equal to “2,” for example, if the total bit length of UCI information bits is greater than the first configured value and less than or equal to a second configured value. The wireless device may select a fourth PUCCH resource set having a PUCCH resource set index equal to “3,” for example, if the total bit length of UCI information bits is greater than the second configured value and less than or equal to a third value (e.g., 1406, 1706, or any other quantity of bits).

The wireless device may determine a PUCCH resource from the PUCCH resource set for UCI (HARQ-ACK, CSI, and/or SR) transmission, for example, after determining a PUCCH resource set from a plurality of PUCCH resource sets. The wireless device may determine the PUCCH resource, for example, based on a PUCCH resource indicator in DCI (e.g., with DCI format 1_0 or DCI for 1_1) received on/via a PDCCH. An n-bit (e.g., a three-bit) PUCCH resource indicator in the DCI may indicate one of multiple (e.g., eight) PUCCH resources in the PUCCH resource set. The wireless device may send/transmit the UCI (HARQ-ACK, CSI and/or SR) using a PUCCH resource indicated by the PUCCH resource indicator in the DCI, for example, based on the PUCCH resource indicator.

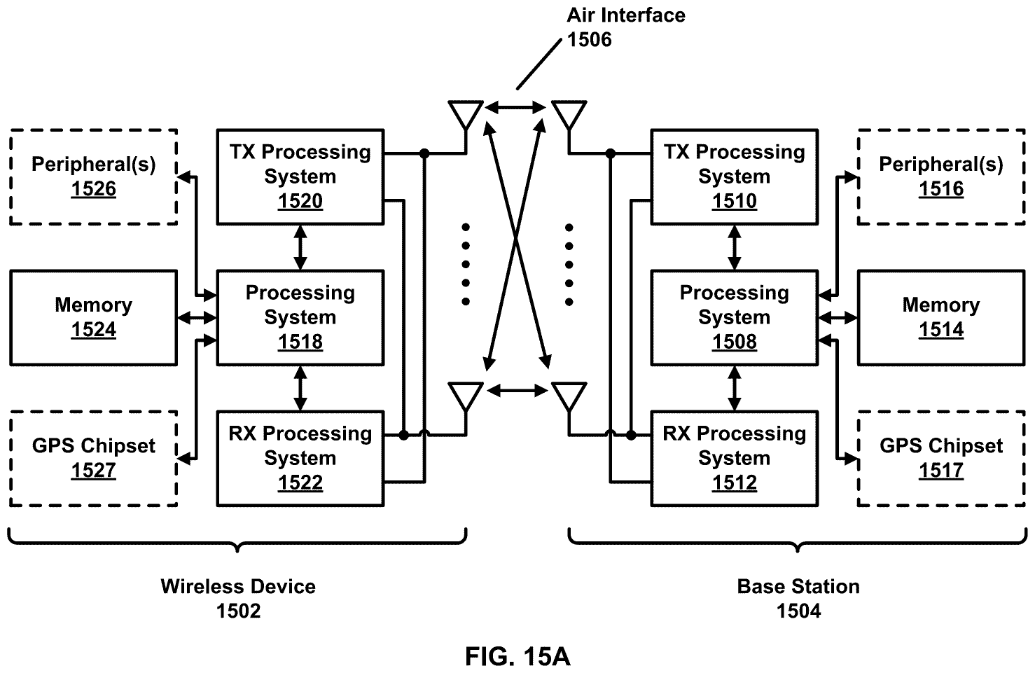

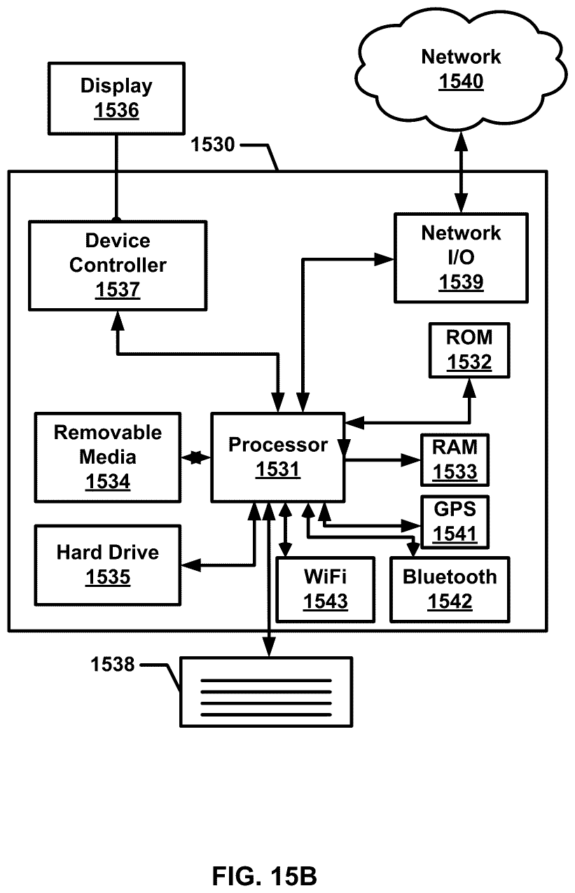

FIG. 15A shows example communications between a wireless device and a base station. A wireless device 1502 and a base station 1504 may be part of a communication network, such as the communication network 100 shown in FIG. 1A, the communication network 150 shown in FIG. 1B, or any other communication network. A communication network may comprise more than one wireless device and/or more than one base station, with substantially the same or similar configurations as those shown in FIG. 15A.

The base station 1504 may connect the wireless device 1502 to a core network (not shown) via radio communications over the air interface (or radio interface) 1506. The communication direction from the base station 1504 to the wireless device 1502 over the air interface 1506 may be referred to as the downlink. The communication direction from the wireless device 1502 to the base station 1504 over the air interface may be referred to as the uplink. Downlink transmissions may be separated from uplink transmissions, for example, using various duplex schemes (e.g., FDD, TDD, and/or some combination of the duplexing techniques).

For the downlink, data to be sent to the wireless device 1502 from the base station 1504 may be provided/transferred/sent to the processing system 1508 of the base station 1504. The data may be provided/transferred/sent to the processing system 1508 by, for example, a core network. For the uplink, data to be sent to the base station 1504 from the wireless device 1502 may be provided/transferred/sent to the processing system 1518 of the wireless device 1502. The processing system 1508 and the processing system 1518 may implement layer 3 and layer 2 OSI functionality to process the data for transmission. Layer 2 may comprise an SDAP layer, a PDCP layer, an RLC layer, and a MAC layer, for example, described with respect to FIG. 2A, FIG. 2B, FIG. 3, and FIG. 4A. Layer 3 may comprise an RRC layer, for example, described with respect to FIG. 2B.

The data to be sent to the wireless device 1502 may be provided/transferred/sent to a transmission processing system 1510 of base station 1504, for example, after being processed by the processing system 1508. The data to be sent to base station 1504 may be provided/transferred/sent to a transmission processing system 1520 of the wireless device 1502, for example, after being processed by the processing system 1518. The transmission processing system 1510 and the transmission processing system 1520 may implement layer 1 OSI functionality. Layer 1 may comprise a PHY layer, for example, described with respect to FIG. 2A, FIG. 2B, FIG. 3, and FIG. 4A. For sending/transmission processing, the PHY layer may perform, for example, forward error correction coding of transport channels, interleaving, rate matching, mapping of transport channels to physical channels, modulation of physical channel, multiple-input multiple-output (MIMO) or multi-antenna processing, and/or the like.

A reception processing system 1512 of the base station 1504 may receive the uplink transmission from the wireless device 1502. The reception processing system 1512 of the base station 1504 may comprise one or more TRPs. A reception processing system 1522 of the wireless device 1502 may receive the downlink transmission from the base station 1504. The reception processing system 1522 of the wireless device 1502 may comprise one or more antenna panels. The reception processing system 1512 and the reception processing system 1522 may implement layer 1 OSI functionality. Layer 1 may include a PHY layer, for example, described with respect to FIG. 2A, FIG. 2B, FIG. 3, and FIG. 4A. For receive processing, the PHY layer may perform, for example, error detection, forward error correction decoding, deinterleaving, demapping of transport channels to physical channels, demodulation of physical channels, MIMO or multi-antenna processing, and/or the like.

The base station 1504 may comprise multiple antennas (e.g., multiple antenna panels, multiple TRPs, etc.). The wireless device 1502 may comprise multiple antennas (e.g., multiple antenna panels, etc.). The multiple antennas may be used to perform one or more MIMO or multi-antenna techniques, such as spatial multiplexing (e.g., single-user MIMO or multi-user MIMO), transmit/receive diversity, and/or beamforming. The wireless device 1502 and/or the base station 1504 may have a single antenna.

The processing system 1508 and the processing system 1518 may be associated with a memory 1514 and a memory 1524, respectively. Memory 1514 and memory 1524 (e.g., one or more non-transitory computer readable mediums) may store computer program instructions or code that may be executed by the processing system 1508 and/or the processing system 1518, respectively, to carry out one or more of the functionalities (e.g., one or more functionalities described herein and other functionalities of general computers, processors, memories, and/or other peripherals). The transmission processing system 1510 and/or the reception processing system 1512 may be coupled to the memory 1514 and/or another memory (e.g., one or more non-transitory computer readable mediums) storing computer program instructions or code that may be executed to carry out one or more of their respective functionalities. The transmission processing system 1520 and/or the reception processing system 1522 may be coupled to the memory 1524 and/or another memory (e.g., one or more non-transitory computer readable mediums) storing computer program instructions or code that may be executed to carry out one or more of their respective functionalities.

The processing system 1508 and/or the processing system 1518 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. The processing system 1508 and/or the processing system 1518 may perform at least one of signal coding/processing, data processing, power control, input/output processing, and/or any other functionality that may enable the wireless device 1502 and/or the base station 1504 to operate in a wireless environment.

The processing system 1508 may be connected to one or more peripherals 1516. The processing system 1518 may be connected to one or more peripherals 1526. The one or more peripherals 1516 and the one or more peripherals 1526 may comprise software and/or hardware that provide features and/or functionalities, for example, a speaker, a microphone, a keypad, a display, a touchpad, a power source, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, and/or the like). The processing system 1508 and/or the processing system 1518 may receive input data (e.g., user input data) from, and/or provide output data (e.g., user output data) to, the one or more peripherals 1516 and/or the one or more peripherals 1526. The processing system 1518 in the wireless device 1502 may receive power from a power source and/or may be configured to distribute the power to the other components in the wireless device 1502. The power source may comprise one or more sources of power, for example, a battery, a solar cell, a fuel cell, or any combination thereof. The processing system 1508 may be connected to a Global Positioning System (GPS) chipset 1517. The processing system 1518 may be connected to a Global Positioning System (GPS) chipset 1527. The GPS chipset 1517 and the GPS chipset 1527 may be configured to determine and provide geographic location information of the wireless device 1502 and the base station 1504, respectively.

FIG. 15B shows example elements of a computing device that may be used to implement any of the various devices described herein, including, for example, the base station 160A, 160B, 162A, 162B, 220, 1504, 2303, 2402, 2403, 2502, 2510, 2520, 2602, 2610, 2620, 2702, 2710, 2720, 2802, 2803, 2906, 3006, 3104, 3106, 3111, 3204, and/or 3304, the wireless device 106, 156A, 156B, 210, 1502, 2301, 2401, 2501, 2605, 2705, 2805, 2905, 2955, 3005, 3105, 3205, and/or 3305, or any other base station, wireless device, AMF, UPF, network device, or computing device described herein. The computing device 1530 may include one or more processors 1531, which may execute instructions stored in the random access memory (RAM) 1533, the removable media 1534 (such as a Universal Serial Bus (USB) drive, compact disk (CD) or digital versatile disk (DVD), or floppy disk drive), or any other desired storage medium. Instructions may also be stored in an attached (or internal) hard drive 1535. The computing device 1530 may also include a security processor (not shown), which may execute instructions of one or more computer programs to monitor the processes executing on the processor 1531 and any process that requests access to any hardware and/or software components of the computing device 1530 (e.g., ROM 1532, RAM 1533, the removable media 1534, the hard drive 1535, the device controller 1537, a network interface 1539, a GPS 1541, a Bluetooth interface 1542, a WiFi interface 1543, etc.). The computing device 1530 may include one or more output devices, such as the display 1536 (e.g., a screen, a display device, a monitor, a television, etc.), and may include one or more output device controllers 1537, such as a video processor. There may also be one or more user input devices 1538, such as a remote control, keyboard, mouse, touch screen, microphone, etc. The computing device 1530 may also include one or more network interfaces, such as a network interface 1539, which may be a wired interface, a wireless interface, or a combination of the two. The network interface 1539 may provide an interface for the computing device 1530 to communicate with a network 1540 (e.g., a RAN, or any other network). The network interface 1539 may include a modem (e.g., a cable modem), and the external network 1540 may include communication links, an external network, an in-home network, a provider's wireless, coaxial, fiber, or hybrid fiber/coaxial distribution system (e.g., a DOCSIS network), or any other desired network. Additionally, the computing device 1530 may include a location-detecting device, such as a global positioning system (GPS) microprocessor 1541, which may be configured to receive and process global positioning signals and determine, with possible assistance from an external server and antenna, a geographic position of the computing device 1530.

The example in FIG. 15B may be a hardware configuration, although the components shown may be implemented as software as well. Modifications may be made to add, remove, combine, divide, etc. components of the computing device 1530 as desired. Additionally, the components may be implemented using basic computing devices and components, and the same components (e.g., processor 1531, ROM storage 1532, display 1536, etc.) may be used to implement any of the other computing devices and components described herein. For example, the various components described herein may be implemented using computing devices having components such as a processor executing computer-executable instructions stored on a computer-readable medium, as shown in FIG. 15B. Some or all of the entities described herein may be software based, and may co-exist in a common physical platform (e.g., a requesting entity may be a separate software process and program from a dependent entity, both of which may be executed as software on a common computing device).

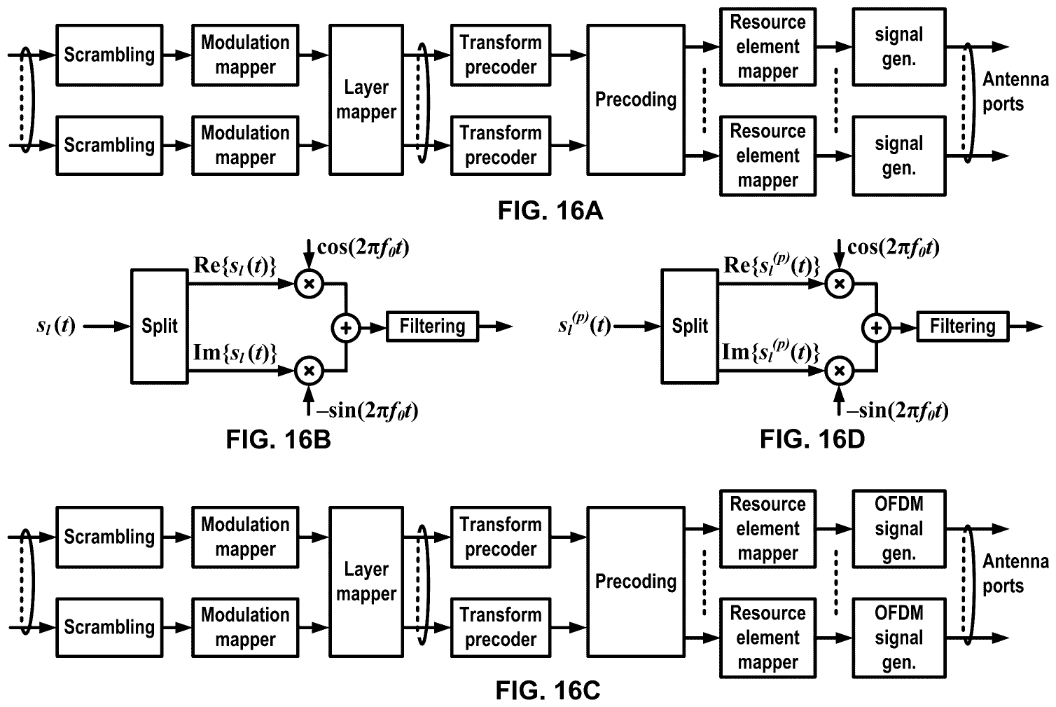

FIG. 16A shows an example structure for uplink transmission. Processing of a baseband signal representing a physical uplink shared channel may comprise/perform one or more functions. The one or more functions may comprise at least one of: scrambling; modulation of scrambled bits to generate complex-valued symbols; mapping of the complex-valued modulation symbols onto one or several transmission layers; transform precoding to generate complex-valued symbols; precoding of the complex-valued symbols; mapping of precoded complex-valued symbols to resource elements; generation of complex-valued time-domain Single Carrier-Frequency Division Multiple Access (SC-FDMA), CP-OFDM signal for an antenna port, or any other signals; and/or the like. An SC-FDMA signal for uplink transmission may be generated, for example, if transform precoding is enabled. A CP-OFDM signal for uplink transmission may be generated, for example, if transform precoding is not enabled (e.g., as shown in FIG. 16A). These functions are examples and other mechanisms for uplink transmission may be implemented.

FIG. 16B shows an example structure for modulation and up-conversion of a baseband signal to a carrier frequency. The baseband signal may be a complex-valued SC-FDMA, CP-OFDM baseband signal (or any other baseband signals) for an antenna port and/or a complex-valued Physical Random Access Channel (PRACH) baseband signal. Filtering may be performed/employed, for example, prior to transmission.

FIG. 16C shows an example structure for downlink transmissions. Processing of a baseband signal representing a physical downlink channel may comprise/perform one or more functions. The one or more functions may comprise: scrambling of coded bits in a codeword to be sent/transmitted on/via a physical channel; modulation of scrambled bits to generate complex-valued modulation symbols; mapping of the complex-valued modulation symbols onto one or several transmission layers; precoding of the complex-valued modulation symbols on a layer for transmission on the antenna ports; mapping of complex-valued modulation symbols for an antenna port to resource elements; generation of complex-valued time-domain OFDM signal for an antenna port; and/or the like. These functions are examples and other mechanisms for downlink transmission may be implemented.

FIG. 16D shows an example structure for modulation and up-conversion of a baseband signal to a carrier frequency. The baseband signal may be a complex-valued OFDM baseband signal for an antenna port or any other signal. Filtering may be performed/employed, for example, prior to transmission.

A wireless device may receive, from a base station, one or more messages (e.g. RRC messages) comprising configuration parameters of a plurality of cells (e.g., a primary cell, one or more secondary cells). The wireless device may communicate with at least one base station (e.g., two or more base stations in dual-connectivity) via the plurality of cells. The one or more messages (e.g. as a part of the configuration parameters) may comprise parameters of PHY, MAC, RLC, PCDP, SDAP, RRC layers for configuring the wireless device. The configuration parameters may comprise parameters for configuring PHY and MAC layer channels, bearers, etc. The configuration parameters may comprise parameters indicating values of timers for PHY, MAC, RLC, PCDP, SDAP, RRC layers, and/or communication channels.

A timer may begin running, for example, if it is started, and continue running until it is stopped or until it expires. A timer may be started, for example, if it is not running or restarted if it is running. A timer may be associated with a value (e.g., the timer may be started or restarted from a value or may be started from zero and expire if it reaches the value). The duration of a timer may not be updated, for example, until the timer is stopped or expires (e.g., due to BWP switching). A timer may be used to measure a time period/window for a process. With respect to an implementation and/or procedure related to one or more timers or other parameters, it will be understood that there may be multiple ways to implement the one or more timers or other parameters. One or more of the multiple ways to implement a timer may be used to measure a time period/window for the procedure. A random access response window timer may be used for measuring a window of time for receiving a random access response. The time difference between two time stamps may be used, for example, instead of starting a random access response window timer and determine the expiration of the timer. A process for measuring a time window may be restarted, for example, if a timer is restarted. Other example implementations may be configured/provided to restart a measurement of a time window.

A base station may transmit one or more MAC PDUs to a wireless device. A MAC PDU may be a bit string that is byte aligned (e.g., aligned to a multiple of eight bits) in length. In an example, bit strings may be represented by tables in which the most significant bit is the leftmost bit of the first line of the table, and the least significant bit is the rightmost bit on the last line of the table. More generally, the bit string may be read from left to right and then in the reading order of the lines. The bit order of a parameter field within a MAC PDU is represented with the first and most significant bit in the leftmost bit and the last and least significant bit in the rightmost bit. A MAC SDU may be a bit string that is byte aligned (e.g., aligned to a multiple of eight bits) in length. A MAC SDU may be included in a MAC PDU from the first bit onward. A MAC CE may be a bit string that is byte aligned (e.g., aligned to a multiple of eight bits) in length. A MAC subheader may be a bit string that is byte aligned (e.g., aligned to a multiple of eight bits) in length. A MAC subheader may be placed immediately in front of a corresponding MAC SDU, MAC CE, or padding. A MAC entity may ignore a value of reserved bits in a DL MAC PDU.

A MAC PDU may comprise one or more MAC subPDUs. A MAC subPDU of the one or more MAC subPDUs may comprise: a MAC subheader only (including padding); a MAC subheader and a MAC SDU; a MAC subheader and a MAC CE; a MAC subheader and padding, or a combination thereof. The MAC SDU may be of variable size. A MAC subheader may correspond to a MAC SDU, a MAC CE, or padding.

If a MAC subheader corresponds to a MAC SDU, a variable-sized MAC CE, or padding, the MAC subheader may comprise: a Reserve field (R field) with a one bit length; an Format field (F field) with a one-bit length; a Logical Channel Identifier (LCID) field with a multi-bit length; a Length field (L field) with a multi-bit length, indicating the length of the corresponding MAC SDU or variable-size MAC CE in bytes, or a combination thereof. In an example, F field may indicate the size of the L field.

A MAC entity of the base station may transmit one or more MAC CEs (e.g., MAC CE commands) to a MAC entity of a wireless device. The one or more MAC CEs may comprise at least one of: a SP ZP CSI-RS Resource Set Activation/Deactivation MAC CE, a PUCCH spatial relation Activation/Deactivation MAC CE, a SP SRS Activation/Deactivation MAC CE, a SP CSI reporting on PUCCH Activation/Deactivation MAC CE, a TCI State Indication for wireless device-specific PDCCH MAC CE, a TCI State Indication for wireless device-specific PDSCH MAC CE, an Aperiodic CSI Trigger State Subselection MAC CE, a SP CSI-RS/CSI-IM Resource Set Activation/Deactivation MAC CE, a wireless device contention resolution identity MAC CE, a timing advance command MAC CE, a DRX command MAC CE, a Long DRX command MAC CE, an SCell activation/deactivation MAC CE (1 Octet), an SCell activation/deactivation MAC CE (4 Octet), and/or a duplication activation/deactivation MAC CE. A MAC CE, such as a MAC CE sent/transmitted by a MAC entity of the base station to a wireless device (e.g., MAC entity of the wireless device), may have an LCID in the MAC subheader corresponding to the MAC CE. A first MAC CE may have a first LCID in the MAC subheader that may be different than the second LCID in the MAC subheader of a second MAC CE. For example, an LCID given by 111011 in a MAC subheader may indicate that the MAC CE associated with the MAC subheader is a long DRX command MAC CE.

The wireless device (e.g., MAC entity of the wireless device) may transmit to the MAC entity of the base station one or more MAC CEs. The one or more MAC CEs may comprise at least one of: a short buffer status report (BSR) MAC CE, a long BSR MAC CE, a C-RNTI MAC CE, a configured grant confirmation MAC CE, a single entry PHR MAC CE, a multiple entry PHR MAC CE, a short truncated BSR, and/or a long truncated BSR. A MAC CE may have an LCID in the MAC subheader corresponding to the MAC CE. A first MAC CE may have a first LCID in the MAC subheader that may be different than the second LCID in the MAC subheader of a second MAC CE. For example, an LCID given by 111011 in a MAC subheader may indicate that a MAC CE associated with the MAC subheader is a short-truncated command MAC CE.

A base station may send (e.g., transmit), to a wireless device, one or more messages (e.g., one or more downlink signals). The one or more messages may comprise one or more RRC messages, e.g., one or more RRC configuration/reconfiguration messages. For example, the one or more RRC messages may comprise one or more configuration parameters (e.g., one or more RRC configuration parameters). The one or more messages may comprise one or more MAC CEs and/or one or more DCIs. The one or more RRC messages may correspond to broadcast or multicast or group cast downlink messages (e.g., SIBs). The one or more RRC messages may correspond to unicast downlink messages and/or dedicated downlink messages.

A wireless device may perform a buffer status reporting (BSR) procedure, for example, to provide a base station (e.g., a serving base station) and/or a network with information about UL data volume in a wireless device (e.g., MAC entity of the wireless device). The one or more configuration parameters may comprise one or more BSR configuration parameters.

One or more BSR configuration parameters may comprise information element(s) indicating values of following parameters: a periodic BSR timer, a retransmission BSR timer, a logical channel SR delay timer, a logical channel SR-delay timer used, a logical channel SR mask, and/or a logical channel group. A logical channel (LC) may be allocated to (e.g., associated with) a logical channel group (LCG) using the logicalChannelGroup.

A wireless device may trigger a BSR, for example, if at least one of the one or more events occur. The one or more events may comprise a first event that UL data, for a logical channel which belongs to an LCG, becomes available to the wireless device (e.g., MAC entity of the wireless device), and/or the UL data may belong to the logical channel with higher priority than the priority of any logical channel containing available UL data which belong to any LCG. The one or more events may comprise a second event that UL data, for a logical channel which belongs to an LCG, becomes available to the wireless device (e.g., MAC entity of the wireless device), and/or none of logical channels which belong to an LCG may contain any available UL data, for example, if the UL data becomes available. The BSR may be triggered, for example, based on the first event and/or the second event may be referred below to as Regular BSR. The one or more events may comprise the one that UL resource(s) are allocated, and number of padding bits is equal to or larger than the size of the Buffer Status Report MAC CE plus its subheader, in which case the BSR is referred below to as Padding BSR. The one or more events may comprise the one that retxBSR-Timer expires, and/or at least one of logical channels which belong to an LCG contains UL data, in which case the BSR is referred below to as Regular BSR. The one or more events may comprise the one that periodicBSR-Timer expires, in which case the BSR is referred below to as Periodic BSR. Each logical channel may trigger one separate Regular BSR, for example, if Regular BSR triggering events occur for multiple logical channels simultaneously.

A wireless device may determine if UL-SCH resources are available for a new transmission and/or if the UL-SCH resources may accommodate a BSR MAC CE plus its subheader as a result of logical channel prioritization, for example, based on (e.g., in response to) at least one BSR being pending (e.g., having been triggered and/or not cancelled). The BSR MAC CE may comprise and/or indicate the at least one BSR.

A wireless device may perform instruct the multiplexing and assembly procedure to generate the BSR MAC CE(s), for example, if at least one BSR is pending (e.g., has been triggered and/or not cancelled), if UL-SCH resources are available for a new transmission and/or if the UL-SCH resources may accommodate a BSR MAC CE plus its subheader as a result of logical channel prioritization. The wireless device may trigger a scheduling request, for example, if at least one BSR is pending (e.g., has been triggered and/or not cancelled). The wireless device may trigger a scheduling request, for example, if at least one BSR is pending (e.g., has been triggered and/or not cancelled), if a regular BSR has been triggered.

A wireless device may determine that UL-SCH resources are available, for example, if a wireless device (e.g., MAC entity of the wireless device) has been configured with, receives, and/or determines an uplink grant. UL-SCH resources determined as available may be available for use, for example, at a point in time that the UL-SCH resources are determined as available. UL-SCH resources determined as available may not be available for use, for example, at a point in time that the UL-SCH resources are determined as available. UL-SCH resources determined as available may not be available for use at a point in time that the UL-SCH resources are determined as available, for example, if the UL-SCH resources are overlapped with other resources (e.g., SSB transmission) and/or if the UL-SCH resources are invalid.

A MAC PDU may comprise at least one (e.g., at most one) BSR MAC CE. The MAC PDU may comprise at least one (e.g., at most one) BSR MAC CE, for example, if multiple events have triggered one or more BSRs. A wireless device may select a BSR among the one or more BSRs and/or may multiplex the MAC PDU comprising the at least one (e.g., at most one) BSR MAC CE corresponding to the selecting BSR. The wireless device may select the BSR among the one or more BSRs. The wireless device may select the BSR among the one or more BSRs, for example, based on a priority among the one or more BSRs. The Regular BSR may have precedence over the padding BSR. The Periodic BSR may have precedence over the padding BSR.

A wireless device (e.g., MAC entity of the wireless device) may cancel one or more (e.g., all) triggered BSRs, for example, if the UL grant(s) may accommodate pending data (e.g., all pending data) available for transmission and/or may be not sufficient to additionally accommodate the BSR MAC CE plus its subheader. All BSRs triggered prior to MAC PDU assembly shall be cancelled if a MAC PDU is sent (e.g., transmitted) and this PDU includes a Long or Short BSR MAC CE which contains buffer status up to (and including) the last event that triggered a BSR prior to the MAC PDU assembly.

A wireless device may perform a MAC PDU assembly, for example, at any point, in time between uplink grant reception and actual transmission of the corresponding MAC PDU. The wireless device may trigger BSR and SR. The wireless device may trigger BSR and SR, for example, after or based on (e.g., in response to) the assembly of a MAC PDU which may comprise a BSR MAC CE, and/or before the transmission of this MAC PDU. The wireless device may trigger BSR and SR at/in/during MAC PDU assembly.

A wireless device may trigger and/or send (e.g., transmit) a scheduling request (SR), for example, to request UL-SCH resources for a transmission (e.g., new transmission) and/or beam failure recovery and/or consistent LBT failure or the like. The one or more configuration parameters may configure a wireless device (e.g., MAC entity of the wireless device) with zero, one, or more SR configurations. For example, the one or more configuration parameters may comprise one or more SR configuration parameters configuring one or more SR configurations. An SR configuration of the one or more SR configurations may comprise a set of PUCCH resource(s) for SR across different BWP(s) and/or cell(s).

SR configuration may correspond to one or more logical channels and/or to SCell beam failure recovery and/or to consistent LBT failure recovery. Each logical channel, SCell beam failure recovery, and/or consistent LBT failure recovery, may be mapped to zero or one SR configuration of the one or more SR configurations. The wireless device may determine the SR configuration of the logical channel that triggered a BSR or the SCell beam failure recovery or the consistent LBT failure recovery (if such a configuration exists) as corresponding SR configuration for the triggered SR. The wireless device may use any SR configuration of the one or more SR configurations for an SR triggered by Pre-emptive BSR. The SR configuration may comprise/indicate a timer (e.g., sr-ProhibitTimer) and/or a limit value (e.g., sr-TransMax).

A wireless device may maintain one or more variables used for the scheduling request procedure. For example, the one or more variables comprise a counter (e.g., SR_COUNTER), counting a number of SR triggered and/or a number of transmissions of SR triggered and/or pending. The wireless device may maintain the counter (e.g., SR_COUNTER per SR configuration. The wireless device may set the counter (e.g., SR_COUNTER) of the corresponding SR configuration to 0 (e.g., or any initial value), for example, if an SR is triggered and there are no other SRs pending corresponding to the same SR configuration. The wireless device may determine an SR as pending until it is cancelled, for example, if the SR is triggered.

A wireless device may cancel pending SR(s) (e.g., all pending SR(s)) for BSR triggered according to the BSR procedure, for example, prior to the MAC PDU assembly and/or may stop each respective timer (e.g., sr-ProhibitTimer), for example, if the wireless device sends (e.g., transmit) the MAC PDU and this PDU comprises a Long and/or Short BSR MAC CE which contains buffer status up to (and comprising) the last event that triggered a BSR prior to the MAC PDU assembly. The wireless device may cancel pending SR(s) (e.g., all pending SR(s)) for BSR triggered according to the BSR procedure and may stop each respective timer (e.g., sr-ProhibitTimer), for example, if the UL grant(s) accommodate pending data (e.g., all pending data) available for transmission. A wireless device (e.g., MAC entity of the wireless device) may, for each pending SR not triggered according to the BSR procedure for a Serving Cell, cancel the pending SR and stop the corresponding timer (e.g., sr-ProhibitTimer) (e.g., if running), for example, if this SR was triggered by Pre-emptive BSR procedure prior to the MAC PDU assembly and/or a MAC PDU comprising the relevant Pre-emptive BSR MAC CE is sent (e.g., transmitted). The wireless device (e.g., MAC entity of the wireless device) may, for each pending SR not triggered according to the BSR procedure for a Serving Cell, cancel the pending SR and stop the corresponding timer (e.g., sr-ProhibitTimer) (e.g., if running), for example, if this SR was triggered by beam failure recovery of an SCell and/or a MAC PDU is sent (e.g., transmitted) and this PDU comprises a BFR MAC CE or a Truncated BFR MAC CE which contains beam failure recovery information for this SCell. The wireless device (e.g., MAC entity of the wireless device) may, for each pending SR not triggered according to the BSR procedure for a Serving Cell, cancel the pending SR and stop the corresponding timer (e.g., sr-ProhibitTimer) (e.g., if running), for example, if this SR was triggered by beam failure recovery of an SCell and this SCell is deactivated. The wireless device (e.g., MAC entity of the wireless device) may, for each pending SR not triggered according to the BSR procedure for a Serving Cell, cancel the pending SR and stop the corresponding timer (e.g., sr-ProhibitTimer) (e.g., if running), for example, if this SR was triggered by consistent LBT failure recovery of a cell (e.g., an SCell) and a MAC PDU is sent (e.g., transmitted) and the MAC PDU comprises an LBT failure MAC CE that indicates consistent LBT failure for this cell (e.g., SCell). The wireless device (e.g., MAC entity of the wireless device) may, for each pending SR not triggered according to the BSR procedure for a Serving Cell, cancel the pending SR and stop the corresponding timer (e.g., sr-ProhibitTimer) (e.g., if running), for example, if this SR was triggered by consistent LBT failure recovery of a cell (e.g., SCell) and the triggered consistent LBT failure(s) (e.g., all the triggered consistent LBT failure(s)) for this cell (e.g., SCell) are cancelled.

A wireless device may determine that one or more PUCCH resources are valid, for example, if the one or more PUCCH resources are scheduled on a BWP which is active at the time of SR transmission occasion. The wireless device (e.g., MAC entity of the wireless device) may, for each pending SR, initiate a random access procedure on a cell (e.g., SpCell) and cancel the pending SR, for example, if at least one SR is pending and/or if the wireless device (e.g., MAC entity of the wireless device) has no valid PUCCH resource configured for the pending SR.

A wireless device (e.g., MAC entity of the wireless device) may, for each pending SR and/or for the SR configuration corresponding to the pending SR, determine whether one or more first conditions (e.g., to signal an SR on one valid PUCCH resource for SR) satisfy, for example, when (or if) at least one SR is pending, and/or when (or if) the wireless device (e.g., MAC entity of the wireless device) has valid PUCCH resource(s) configured for the pending SR, and/or when (or if) the wireless device (e.g., MAC entity of the wireless device) has an SR transmission occasion on the valid PUCCH resource for SR configured. The one or more first conditions may comprise a timer (e.g., sr-ProhibitTimer) being not running at the time of the SR transmission occasion and/or the PUCCH resource for the SR transmission occasion not overlapping with a measurement gap.

A wireless device may stop (e.g., if any) ongoing Random Access procedure due to a pending SR for BSR, which was initiated by the wireless device (e.g., MAC entity of the wireless device) prior to the MAC PDU assembly and which has no valid PUCCH resources configured, for example, if a MAC PDU is sent (e.g., transmitted) using a UL grant other than a UL grant provided by Random Access Response or a UL grant determined for the transmission of the MSGA payload, and this PDU comprises a BSR MAC CE which contains buffer status up to (and comprising) the last event that triggered a BSR prior to the MAC PDU assembly. The wireless device may stop (e.g., if any) ongoing Random Access procedure due to a pending SR for BSR, which was initiated by the wireless device (e.g., MAC entity of the wireless device) prior to the MAC PDU assembly and which has no valid PUCCH resources configured, for example, if the UL grant(s) can accommodate pending data (e.g., all pending data) available for transmission.

A wireless device may trigger/initiate an RA procedure based on (e.g., in response to) (or for): an initial access procedure (e.g., to send/transit from the RRC_IDLE state/mode to the RRC_CONNECTED state/mode), a positioning procedure, an uplink coverage recovery procedure, initiating a beam failure recovery, receiving from the base station an RRC reconfiguration message, for example, at/in/during a handover procedure, receiving from the base station a PDCCH order, re-synchronizing if new data arrives and the wireless device status is out-of-sync for UL communication/transmission, new data arrives at the buffer of the wireless device if there is no scheduling request (SR) resources (e.g., no valid PUCCH resource) for sending (e.g., transmitting) the SR are configured, and/or pending data exists in the buffer of the wireless device and the wireless device has reached a maximum allowable times for (re) sending/transmitting an SR (e.g., a SR failure). The wireless device may perform the RA procedure after performing the initial access, for example, for beam failure recovery, reporting a TA information (e.g., a wireless device-specific TA and/or a GNSS-acquired location information) of the wireless device, other SI request, and/or SCell addition. The RA procedure may be a four-step RA procedure (e.g., according to above discussions of FIG. 13A), for example, RA_TYPE being set to 4-stepRA, or a two-step RA procedure (e.g., according to above discussions of FIG. 13B and/or FIG. 13C), for example, RA_TYPE being set to 2-stepRA.

One or more configuration parameters may comprise one or more RACH configuration parameters. The one or more configuration parameters may, for example, comprise one or more RA configuration parameters (e.g., RACH-ConfigCommon, and/or RACH-ConfigCommonTwoStepRA, and/or RACH-ConfigDedicated, and/or RACH-ConfigGeneric, and/or RACH-ConfigGenericTwoStepRA). For example, the one or more RACH configuration parameters may comprise a first RACH configuration parameters (e.g., RA-ConfigCommon IE), corresponding to a four-step RA type (e.g., the RA_TYPE is the 4-stepRA), for example for performing the four-step RA procedure. The one or more RACH configuration parameters may comprise a second RACH configuration parameters (e.g., RA-ConfigCommonTwoStepRA-r16 IE and/or MsgA-PUSCH-Config IE), corresponding to a two-step RA type (e.g., the RA_TYPE is the 2-stepRA), for example, for performing the two-step RA procedure.

A RA procedure may be a contention-based RA procedure, for example, triggered by higher layers of the wireless device (e.g., the RRC sublayer or the MAC layer indicates triggering/initiating the RA procedure). The wireless device may, for example, trigger/initiate the RA procedure based on the higher layers indicating triggering/initiating the RA procedure. Triggering/initiating the RA procedure may comprise at least one of: determining a carrier (SUL or NUL) for performing the RA procedure, for example, based on a measured RSRP, determining the two-step (or 2-step or 2-stage) RA type or the four-step (4-step or 4-stage) RA type (e.g., selecting the RA type) for performing the RA procedure, and/or initializing/setting one or more RA parameters (variables) specific to the selected RA type.

A wireless device may select a default (DL) reference signal (RS) for performing the RA procedure. The default RS may be a (default) SSB. The wireless device may select/determine the (default) SSB based on the one or more RA configuration parameters (e.g., rsrp-ThresholdSSB that indicates an RSRP threshold for the selection of the SSB for the 4-step RA type and/or msgA-RSRP-ThresholdSSB that indicates an RSRP threshold for the selection of the SSB for the 2-step RA type). The default RS may be a (default) CSI-RS. The wireless device may select/determine the default CSI-RS based on the one or more RA configuration parameters (e.g., rsrp-ThresholdCSI-RS that indicates an RSRP threshold for the selection of CSI-RS for the 4-step RA type). The wireless device may select the default RS randomly with equal probability amongst one or more ROs and/or based on a possible occurrence of measurement gaps.

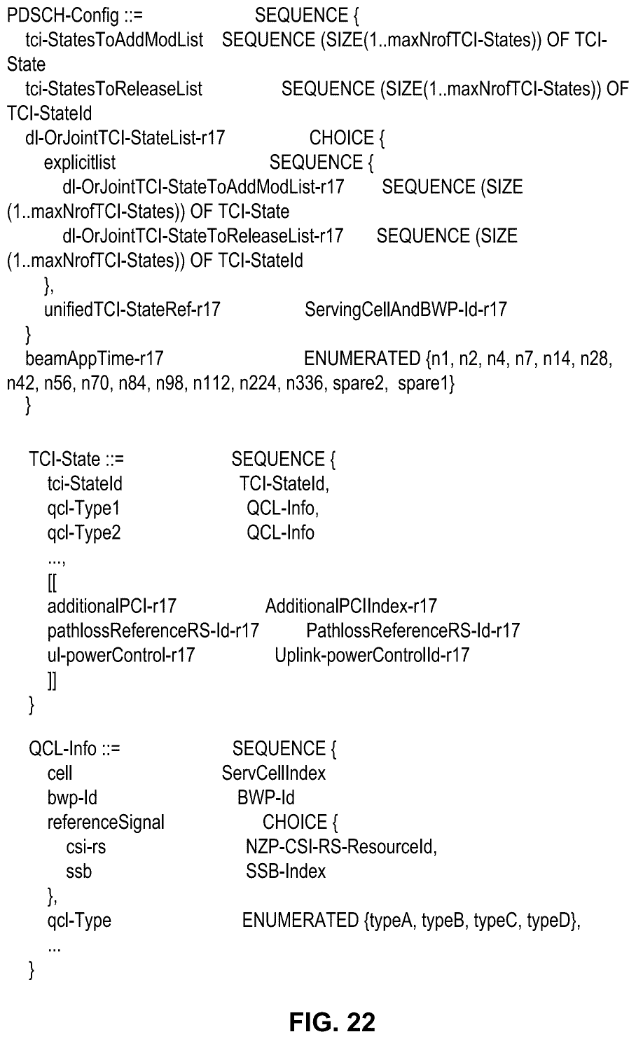

A wireless device may determine a spatial domain transmission filter of one or more uplink signals/channels (e.g., Msg3/MsgA) based on (or using) the default RS (e.g., the default DL RS, the default SSB and/or the default CSI-RS). The one or more uplink signals/channels may comprise PUSCH and/or PUCCH and/or SRS. The spatial domain transmission filter may be an uplink spatial domain transmission filter (e.g., UL TX spatial filter). For example, the spatial domain transmission filter may correspond to (or indicate or associated be) a DM-RS antenna port. The DM-RS antenna port may be quasi co-located with an RS. The RS may be the default RS, for example, the default SSB. The wireless device may determine the RS based on one or more configuration parameters (e.g., one or more TCI configuration parameters), for example, identified by a TCI state (e.g., as shown in FIG. 22).

A wireless device may determine a spatial domain transmission filter of one or more downlink signals/channels (e.g., Msg2/Msg4/MsgB) based on (or using) the default RS. The spatial domain transmission filter may be a downlink spatial domain transmission (or reception) filter. For example, the spatial domain transmission filter may correspond to (or indicate) a DM-RS antenna port associated with PDCCH receptions (of PDCCH candidates). The DM-RS antenna port may be quasi co-located with an RS (e.g., the default RS, e.g. the default SSB). The one or more downlink signals/channels may comprise PDSCH and/or PDCCH and/or CSI-RS.

A wireless device, for performing the RA procedure, may select RA resources. The RA resources may comprise a preamble 1311/1341/1321 with a preamble index (e.g., ra-PreambleIndex or PREAMBLE_INDEX), Random Access Preamble (RAP) group (e.g., preamble Group A or preamble Group B), a physical random access channel (PRACH) occasion (RO) comprising (time, frequency, and/or code) resources for sending (e.g., transmitting) the preamble, and/or one or more MsgA PUSCH occasions (POs) for MsgA payload/transport block 1342 transmission. For example, the wireless device may determine a valid RO (e.g., the next available RO) corresponding to the (default) SSB (e.g., the selected/determined SSB for a preamble transmission/first message transmission) or the (default) CSI-RS. The wireless device may randomly select the preamble (from the first RAP group or the second RAP group), set PREAMBLE_INDEX based on the preamble (e.g., the index of the preamble), select the valid RO corresponding to the preamble, and/or calculate an RA-RNTI corresponding to the valid RO (if the type of the RA procedure is the 4-stepRA) or calculate a MSGB-RNTI corresponding to the valid RO (if the type of the RA procedure is the 2-stepRA).

A wireless device may, for performing the two-step RA procedure, select the PUSCH occasion (PO) corresponding to the preamble and the valid RO, for example, if the preamble is selected by the wireless device (e.g., MAC entity of the wireless device), among the contention-based Random Access Preamble(s). The wireless device may determine an UL grant/resource for transmission of the MsgA payload according to the PUSCH configuration associated with the selected RAP group. The wireless device may identify HARQ information (e.g., New Data Indicator (NDI), Transport Block size (TBS), Redundancy Version (RV), and a HARQ process ID/number/index) associated (or corresponding to) the MsgA payload. The wireless device may, based on the preamble and the valid RO being mapped to a valid PUSCH occasion (PO), deliver the UL grant and the associated HARQ information to the HARQ entity for transmission of a first message (e.g., MsgA).

A wireless device may, using (or based on) the (selected) RA resources, send (e.g., transmit) a first message (e.g., the preamble or the MsgA). Sending (e.g., transmitting) the first message may comprise a PRACH (or a preamble) transmission of the RA procedure and/or a PUSCH transmission (e.g., the MsgA payload) of the (2-step) RA procedure. For example, the wireless device may, based on (e.g., in response to) sending (e.g., transmitting) the first message (e.g., the preamble), start a RAR window (e.g., ra-Response Window or msgB-ResponseWindow). The wireless device may, based on (e.g., in response to) the PRACH transmission (e.g., for performing a 2-step/4-step RA procedure), attempt to detect a DCI format 1_0 with CRC scrambled by a corresponding RA-RNTI at/in/during the RAR window (e.g., ra-ResponseWindow). The RAR window may start at a first/initial/earliest symbol of an earliest CORESET the wireless device is configured to receive PDCCH for Type1-PDCCH CSS set. For example, the earliest CORESET may be at least one symbol, after the last/final/ending symbol of a PRACH occasion corresponding to the PRACH transmission. The symbol duration may correspond to an SCS for Type1-PDCCH CSS set.

RA procedure may be a contention-free RA procedure (e.g., according to above discussions of FIG. 13B). For example, the wireless device may initiate/trigger the RA procedure based on the PDCCH order received from the base station. The PDCCH order may comprise an indication for the preamble (e.g., ra-PreambleIndex) and/or a SS/PBCH index (e.g., indicating an index of the default SSB) for determining the RO for transmission of the preamble. The indicated SSB may be the default SSB. The one or more RACH configuration parameters may comprise a dedicated RACH configuration message (e.g., RACH-ConfigDedicated). The dedicated RACH configuration message may comprise, among other parameters, one or more ROs for the contention-free RA procedure, and one or more PRACH mask index for RA resource selection (e.g., ra-ssb-OccasionMaskIndex).

A wireless device may, based on the PDCCH order, select the RA resources. The wireless device may set/initialize parameter PREAMBLE_INDEX based on the preamble index indicated by the PDCCH order. For example, the preamble may not be selected by the higher layers (e.g., the MAC layer) of the wireless device among the contention-based (CB) Random Access Preambles (RAPs).

A wireless device may attempt to detect a DCI format 1_0 with CRC scrambled by a corresponding MsgB-RNTI at/in/during the RAR window (e.g., msgB-Response Window), based on (e.g., in response to) a transmission of the PRACH and the PUSCH (e.g., the MsgA payload/PUSCH), or to a transmission of only the PRACH if the PRACH preamble is mapped to a valid PUSCH occasion of the (2-step) RA procedure. The RAR window may start at a first/initial/earliest symbol of an earliest CORESET the wireless device is configured to receive PDCCH for Type1-PDCCH CSS set. For example, the earliest CORESET may be at least one symbol, after the last/final/ending symbol of a PUSCH occasion corresponding to the PRACH transmission. The symbol duration may correspond to an SCS for Type1-PDCCH CSS set. The wireless device may start the msgB-Response Window at a PDCCH occasion (e.g., the earliest CORESET the wireless device is configured to receive PDCCH for Type1-PDCCH CSS set). The wireless device may start the msgB-Response Window at a PDCCH occasion (e.g., the earliest CORESET the wireless device is configured to receive PDCCH for Type1-PDCCH CSS set), for example, based on the MsgA preamble being sent (e.g., transmitted), regardless of the possible occurrence of a measurement gap. The wireless device may monitor the PDCCH of the SpCell for a Random Access Response (RAR) identified by MSGB-RNTI and/or the C-RNTI, for example, if the msgB-Response Window is running. The wireless device may monitor the PDCCH of the SpCell for Random Access Response identified by the C-RNTI, for example, if the msgB-Response Window is running, and/or if the C-RNTI MAC CE is included in the MsgA,

A wireless device may, if the RAR window is running, monitor PDCCH (e.g., the one or more PDCCH candidates) for a RAR identified by the RA-RNTI (for the four-step RA procedure) or the MSGB-RNTI (for the two-step RA procedure) and/or a C-RNTI. The wireless device may monitor the one or more PDCCH candidates based on (or using or via) a Type1-PDCCH common search space (CSS) set (e.g., indicated by ra-searchSpace in the one or more configuration parameters, e.g., PDCCH-ConfigCommon), a Type3-PDCCH CSS set (e.g., indicated by SearchSpace in the one or more configuration parameters, e.g., PDCCH-Config with searchSpaceType=common), and/or an USS set (e.g., indicated by SearchSpace in the one or more configuration parameters, e.g., PDCCH-Config with searchSpaceType=ue-Specific). The wireless device may monitor the one or more PDCCH candidates for a second PDCCH transmission (e.g., comprising/indicating a second DCI) on the search space indicated by recoverySearchSpaceId of the SpCell.

A wireless device may monitor the one or more PDCCH candidates for receiving a second DCI (e.g., PDCCH portion of the Msg2/MsgB) indicating/scheduling a downlink assignment (e.g., a PDSCH portion of the Msg2/MsgB) for receiving a transport block (TB), if the RAR window (e.g., ra-ResponseWindow or msgB-Response Window) is running. The wireless device may receive the second DCI (and/or a PDCCH comprising/carrying the second DCI) and/or the PDSCH scheduled by the second DCI based on the spatial domain transmission filter.

A wireless device may, at/in/during the RA procedure, determine a special filter (e.g., UL/DL special transmission filter) based on the default RS (e.g., the default SS/PBCH block or the default CSI-RS) resource. For example, for receiving the second DCI, the wireless device may use the default RS (e.g., the default SS/PBCH block or the default CSI-RS) resource. The wireless device may assume (or consider or determine) same DM-RS antenna port quasi co-location properties as for the default RS (e.g., the default SS/PBCH block or the default CSI-RS) resource the wireless device is used for the PRACH association, if the wireless device detects the second DCI (e.g., a DCI format 1_0 with CRC scrambled by the corresponding RA-RNTI and/or LSBs of a SFN field in the DCI format 1_0, e.g., if included and applicable, are same as corresponding LSBs of the SFN where the wireless device sent (e.g., transmitted) the PRACH), and the wireless device receives the TB in a corresponding PDSCH (e.g., the PDSCH portion of the Msg2/MsgB). The wireless device may ignore whether or not the wireless device is provided (e.g., one or more TCI configuration parameters) TCI-State for the CORESET where the wireless device receives the PDCCH with the DCI format 1_0.

A wireless device may assume that the PDCCH that includes the second DCI (e.g., the DCI format 1_0) and the PDCCH order have same DM-RS antenna port quasi co-location properties, for example, if the wireless device attempts to detect the second DCI (e.g., the DCI format 1_0 with CRC scrambled by the corresponding RA-RNTI based on (e.g., in response to) the PRACH transmission initiated by the PDCCH order that triggers a contention-free random access procedure for the SpCell). The wireless device may assume the DM-RS antenna port quasi co-location properties of the CORESET associated with the Type1-PDCCH CSS set for receiving the PDCCH that includes the DCI format 1_0, for example, if the wireless device attempts to detect the second DCI (e.g., the DCI format 1_0 with CRC scrambled by the corresponding RA-RNTI based on (e.g., in response to) the PRACH transmission initiated by a PDCCH order that triggers a contention-free random access procedure for a secondary cell).

For detecting a DCI format 1_0 with CRC scrambled by the corresponding MsgB-RNTI (e.g., or receiving/detecting the second DCI) and/or receiving the transport block within the RAR window in a corresponding PDSCH (e.g., the PDSCH scheduled by the second DCI), the wireless device may assume same DM-RS antenna port quasi co-location properties as for the RS (e.g., the default SSB, the SS/PBCH block the wireless device uses for the PRACH association). The wireless device may ignore whether or not the one or more configuration parameters indicate/configure the one or more TCI states (e.g., comprising a TCI-State for the CORESET where the wireless device receives the PDCCH with the DCI format 1_0).

TB may comprise a MAC PDU. The MAC PDU may comprise one or more MAC subPDUs (and/or optionally padding). A MAC subPDU, of the one or more MAC subPDUs, may comprise at least one of following: a MAC subheader with Backoff Indicator (BI) only; a MAC subheader with Random Access Preamble identifier (RAPID) only (e.g., acknowledgment for an SI request); a MAC subheader with the RAPID and a MAC RAR (e.g., a RAR or a fallback RAR or a success RAR). The MAC PDU may comprise one or more (MAC) RARs. A MAC subPDU may be fallbackRAR MAC subPDU or a successRAR MAC subPDU.

A RAR (of/from/among the one or more RARs) may be fixed size and may comprise at least one of the following fields: an R field that may indicate a Reserved bit, a Timing Advance Command (TAC) MAC CE field, an UL grant (or an UL grant field), and/or an RNTI field (e.g., the TC-RNTI and/or the C-RNTI) that may indicate an identity that is employed at/in/during the RA procedure. The wireless device may receive the RAR from the base station at/in/during the RAR window. The wireless device may receive the DCI scheduling the RAR at/in/during the RAR window. The wireless device may determine (or indicate or identify) a reception of the RAR (e.g., for or based on the first message or the preamble) being successful. The wireless device may consider the reception of the RAR successful based on the RAR comprising the MAC PDU with the RAPID corresponding (or matching) to the preamble with the preamble index PREAMBLE_INDEX.

RAR may indicate an UL grant (e.g., a RAR UL grant) for transmission of Msg3. The wireless device may process the UL grant and indicate it to the lower layers (e.g., the physical layer) for transmission of the Msg3 using/based on the UL grant. For example, the wireless device may send (e.g., transmit) the Msg3 using the UL grant (e.g., a PUSCH transmission scheduled by the RAR UL grant). The wireless device may send (e.g., transmit) a Msg3 PUSCH retransmission scheduled by a DCI format 0_0 with CRC scrambled by a TC-RNTI provided in the corresponding RAR message (e.g., the RAR).

A wireless device may, for detecting a DCI format 1_0 with CRC scrambled by the corresponding MsgB-RNTI (e.g., or receiving/detecting the second DCI) and/or receiving the transport block within the RAR window in a corresponding PDSCH (e.g., the PDSCH scheduled by the second DCI), start or restart a contention resolution timer. For example, the wireless device may start or restart the contention resolution timer (e.g., ra-ContentionResolutionTimer) in the first/starting/earliest/initial symbol after the end/latest/final/ending of all repetitions of the Msg3 (re-)transmission. The wireless device may monitor the PDCCH (for a TC-RNTI) if the ra-ContentionResolutionTimer is running regardless of the possible occurrence of a measurement gap. The wireless device may, if the contention resolution timer is running, determine whether contention resolution (CR) being successful or not (e.g., based on whether at least one CR condition being satisfied or not).

A wireless device may, if the contention resolution timer is running, receive a PDCCH (or detecting a DCI format) based on the default RS (e.g., the SS/PBCH block that the wireless device uses/selects for the preamble transmission (e.g., the spatial domain transmission filter). For example, the wireless device may assume the PDCCH carrying the DCI format has the same DM-RS antenna port quasi co-location properties as for the SS/PBCH block (e.g., the default RS), if receiving the PDCCH (or detecting the DCI format) based on (e.g., in response to) the Msg3 transmission (e.g., a PUSCH transmission scheduled by the RAR UL grant) or a Msg3 retransmission (e.g., PUSCH retransmission scheduled by a DCI format 0_0 with CRC scrambled by a TC-RNTI provided in the corresponding RAR message). The wireless device may ignore whether or not the one or more configuration parameters provide/indicate the one or more TCI states (e.g., comprising a TCI-State for the CORESET where the wireless device receives the PDCCH with the DCI format).

Two or more component carriers (CCs) may be aggregated in carrier aggregation (CA). The wireless device may, using the technique of CA, simultaneously receive or send (e.g., transmit) on one or more CCs, depending on capabilities of the wireless device. The wireless device may support CA for contiguous CCs and/or for non-contiguous CCs. CCs may be organized into cells. CCs may be organized into one primary cell (PCell) and one or more secondary cells (SCells). The wireless device may have one RRC connection with a network, for example, if configured with CA. In/at/during an RRC connection establishment/re-establishment/handover, a cell providing NAS mobility information may be a serving cell. In/at/during an RRC connection re-establishment/handover procedure, a cell providing a security input may be the serving cell. The serving cell may be a PCell. For example, the base station may send (e.g., transmit), to the wireless device, one or more messages (e.g., one or more downlink signals). The one or more messages may comprise one or more RRC messages, for example, one or more RRC configuration/reconfiguration messages. For example, the one or more RRC messages may comprise one or more configuration parameters (e.g., one or more RRC configuration parameters).

One or more configuration parameters may comprise configuration parameters of a plurality of one or more SCells, depending on capabilities of the wireless device. The base station and/or the wireless device may employ an activation/deactivation mechanism of an SCell to improve battery or power consumption of the wireless device, for example, if configured with CA. The base station may activate or deactivate at least one of the one or more SCells, for example, if the wireless device is configured with one or more SCells. Upon configuration of an SCell, the SCell may be deactivated unless the SCell state associated with the SCell is set to “activated” or “dormant.” The wireless device may activate/deactivate an SCell. The wireless device may activate/deactivate an SCell, for example, based on (e.g., in response to) receiving the SCell Activation/Deactivation MAC CE.

A base station may configure (e.g., via the one or more RRC messages parameters) the wireless device with uplink (UL) bandwidth parts (BWPs) and downlink (DL) BWPs to enable bandwidth adaptation (BA) on a PCell. The base station may further configure the wireless device with at least one DL BWP (e.g., there may be no UL BWP in the UL) to enable BA on an SCell, e.g., if carrier aggregation (CA) is configured. For the PCell, an initial active BWP may be a first BWP used for initial access. The base station and/or the wireless device, in paired spectrum (e.g., FDD), may independently switch a DL BWP and an UL BWP. The base station and/or the wireless device, in unpaired spectrum (e.g., TDD), may simultaneously switch a DL BWP and an UL BWP.

A serving cell may be a cell (e.g., PCell, SCell, PSCell, etc.) on which the wireless device may receive SSB/CSI-RS/PDCCH/PDSCH and/or may send (e.g., transmit) PUCCH/PUSCH/SRS etc. The serving cell may be identified, for example, by a serving cell index (e.g., ServCellIndex or SCellIndex configured/indicated by the one or more configuration parameters). There may only be one serving cell comprising a primary cell for a wireless device in RRC_CONNECTED not configured with CA/DC. For a wireless device in RRC_CONNECTED configured with CA/DC the term ‘serving cells’ may be used to denote a set of cells comprising of the Special Cell(s) and one or more (e.g., all) secondary cells. A cell providing additional radio resources on top of Special Cell may be referred to as a secondary cell for a wireless device configured with CA.

A non-serving (or neighbor) cell may be a cell on which the wireless device may not receive MIBs/SIBs/PDCCH/PDSCH and/or may not send (e.g., transmit) PUCCH/PUSCH/SRS. The non-serving cell may have a physical cell identifier (PCI), which may be different from a PCI of a serving cell. The non-serving cell may not be identified by (or associated with) a serving cell index (e.g., ServCellIndex or SCellIndex). The wireless device may rely on an SSB of a non-serving cell for Tx/Rx beam (or spatial domain filter) determination (e.g., for PDCCH/PDSCH/PUCCH/PUSCH/CSI-RS/SRS for a serving cell), for example, if a TCI state of the serving cell may be associated with (e.g., in TCI-state IE of TS 38.331) a SSB of the non-serving cell. The base station may not send (e.g., transmit) configuring resources/parameters of PDCCH/PDSCH/PUCCH/PUSCH/SRS of a non-serving cell to the wireless device.

A wireless device may support a baseline processing time/capability. For example, the wireless device may support additional aggressive/faster processing time/capability. The wireless device may report to the base station a processing capability, for example, per sub-carrier spacing. A PDSCH processing time may be considered to determine, by a wireless device, a first uplink symbol of a PUCCH (e.g., determined at least based on a HARQ-ACK timing K1 and one or more PUCCH resources to be used and including the effect of the timing advance) comprising the HARQ-ACK information of the PDSCH scheduled by a DCI. In an example, the first uplink symbol of the PUCCH may not start earlier than a time gap (e.g., T_{proc,1}) after a last symbol of the PDSCH reception associated with the HARQ-ACK information. The first uplink symbol of the PUCCH which carries the HARQ-ACK information may start no earlier than at symbol L1, where L1 is defined as the next uplink symbol with its Cyclic Prefix (CP) starting after the time gap T_{proc,1} after the end of the last symbol of the PDSCH.

A PUSCH preparation/processing time may be considered for determining the transmission time of an UL data. The wireless device may perform sending (e.g., transmitting) the PUSCH, for example, if the first uplink symbol in the PUSCH allocation for a transport block (including DM-RS) is no earlier than at symbol L2. The symbol L2 may be determined, by a wireless device, at least based on a slot offset (e.g., K2), SLIV of the PUSCH allocation indicated by time domain resource assignment of a scheduling DCI. The symbol L2 may be specified as the next uplink symbol with its CP starting after a time gap with length (e.g., T_{proc,2}) after the end of the reception of the last symbol of the PDCCH carrying the DCI scheduling the PUSCH.

A base station and/or the wireless device may switch a BWP between configured BWPs by means of a DCI or a BWP invalidity timer. The base station and/or the wireless device may switch the active BWP to a default BWP based on (e.g., in response to) the expiry of the BWP invalidity timer associated with the serving cell, for example, if the BWP invalidity timer is configured for the serving cell. The default BWP may be configured by the network. One UL BWP for each uplink carrier and one DL BWP, such as for FDD systems, may be active at a time in the active serving cell, for example, if configured with BA. One DL/UL BWP pair, such as for TDD systems, may be active at a time in the active serving cell. Operating on one UL BWP and one DL BWP (or one DL/UL pair) may improve the wireless device battery consumption. One or more BWPs other than the active UL BWP and the active DL BWP, which the wireless device may work on, may be deactivated. On the deactivated one or more BWPs, the wireless device may: not monitor PDCCH; and/or not send (e.g., transmit) on PUCCH, PRACH, and UL-SCH. The wireless device (e.g., MAC entity of the wireless device) may use normal operations on the active BWP for an activated serving cell configured with a BWP comprising: sending (e.g., transmitting) on UL-SCH; sending (e.g., transmitting) on RACH; monitoring a PDCCH; sending (e.g., transmitting) PUCCH; receiving DL-SCH; and/or (re-)initializing any suspended configured uplink grants of configured grant Type 1 according to a stored configuration, if any. The wireless device (e.g., MAC entity of the wireless device), on the inactive/idle BWP for each activated serving cell configured with a BWP, may: not send (e.g., transmit) on UL-SCH; not send (e.g., transmit) on RACH; not monitor a PDCCH; not send (e.g., transmit) PUCCH; not send (e.g., transmit) SRS, not receive DL-SCH; clear any configured downlink assignment and configured uplink grant of configured grant Type 2; and/or suspend any configured uplink grant of configured Type 1.

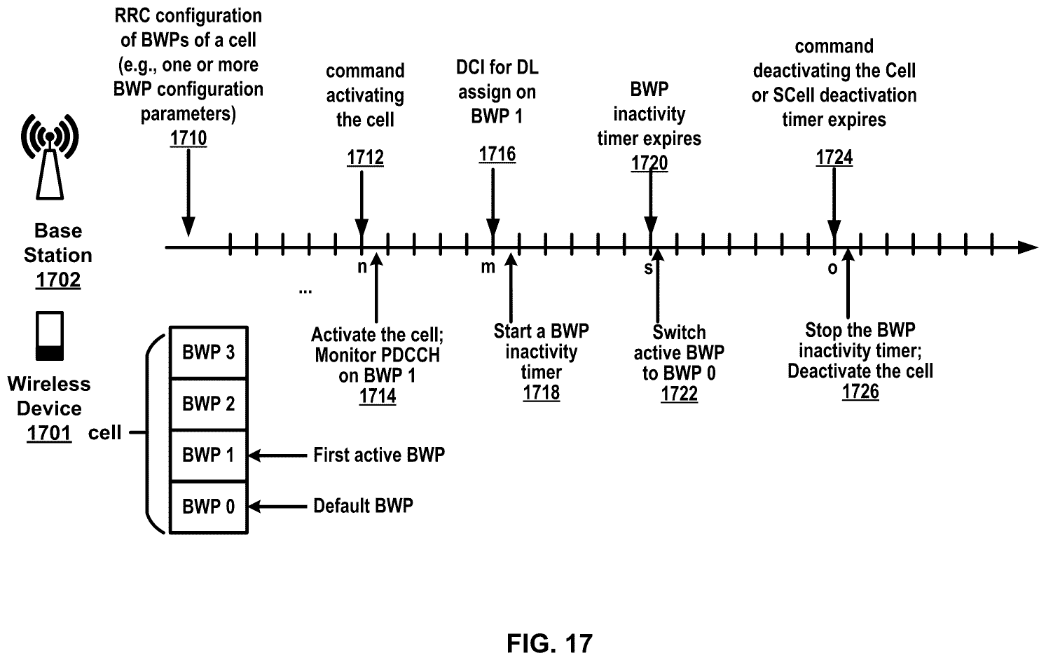

FIG. 17 shows an example of BWP switching on a cell (e.g., PCell or SCell). The one or more configuration parameters may comprise configuration parameters of one or more BWPs (e.g., one or more BWP configuration parameters). The one or more BWP configuration parameters may comprise parameters of a cell and one or more BWPs associated with the cell. Among the one or more BWPs, at least one BWP may be configured as the first active BWP (e.g., BWP 1), one BWP as the default BWP (e.g., BWP 0). The wireless device 1701 may receive a command 1712 (e.g., RRC message, MAC CE or DCI) to activate the cell at an nth slot. In case the cell is a PCell, the wireless device 1701 may not receive the command activating the cell, for example, the wireless device 1701 may activate the PCell 1714 if the wireless device 1701 receives RRC message comprising configuration parameters of the PCell 1710. The wireless device 1701 may start monitoring a PDCCH on BWP 1. The wireless device 1701 may start monitoring a PDCCH on BWP 1, for example, based on (e.g., in response to) activating the cell.

A wireless device 1701 may start (or restart) a BWP inactivity timer (e.g., bwp-InactivityTimer) at an m-th slot. The wireless device 1701 may start (or restart) the BWP inactivity timer (e.g., bwp-InactivityTimer) at an m-th slot, for example, based on (e.g., in response to) receiving a DCI indicating DL assignment on BWP 1 1716. The wireless device 1701 may switch back to the default BWP (e.g., BWP 0) as an active BWP 1722 if the BWP inactivity timer expires 1720, at s-th slot. The wireless device 1701 may deactivate the cell and/or stop the BWP inactivity timer 1726 if the timer (e.g., sCellDeactivationTimer) expires 1724 (e.g., if the cell is a SCell). The wireless device 1701 may not deactivate the cell and may not use the sCellDeactivationTimer on the PCell. The wireless device 1701 may not deactivate the cell and may not use the sCellDeactivationTimer on the PCell, for example, based on (e.g., in response to) the cell being a PCell.

A wireless device 1701 (e.g., MAC entity of the wireless device) may use normal operations on an active BWP for an activated serving cell configured with a BWP comprising: sending (e.g., transmitting) on UL-SCH; sending (e.g., transmitting) on RACH; monitoring a PDCCH; sending (e.g., transmitting) PUCCH; receiving DL-SCH; and/or (re-)initializing any suspended configured uplink grants of configured grant Type 1 according to a stored configuration, if any. A MAC entity, on an inactive BWP for each activated serving cell configured with a BWP, may: not send (e.g., transmit) on UL-SCH; not send (e.g., transmit) on RACH; not monitor a PDCCH; not send (e.g., transmit) PUCCH; not send (e.g., transmit) SRS, not receive DL-SCH; clear any configured downlink assignment and configured uplink grant of configured grant Type 2; and/or suspend any configured uplink grant of configured Type 1.

A wireless device 1701 may perform the BWP switching to a BWP indicated by the PDCCH, for example, if a MAC entity receives a PDCCH for a BWP switching of a serving cell and/or a Random Access procedure associated with this serving cell is not ongoing. The bandwidth part indicator field value may indicate the active DL BWP, from the configured DL BWP set, for DL receptions, for example, if a bandwidth part indicator field is configured in DCI format 1_1. The bandwidth part indicator field value may indicate the active UL BWP, from the configured UL BWP set, for UL transmissions, for example, if a bandwidth part indicator field is configured in DCI format 0_1.

A wireless device 1701, for a primary cell, may be provided by a higher layer parameter Default-DL-BWP a default DL BWP among the configured DL BWPs. The default DL BWP is the initial active DL BWP, for example, if a wireless device 1701 is not provided a default DL BWP by the higher layer parameter Default-DL-BWP. A wireless device 1701 may be provided by higher layer parameter bwp-Inactivity Timer, a timer value for the primary cell. The wireless device 1701, if configured, may increment the timer, if running, every interval of 1 millisecond for frequency range 1 or every 0.5 milliseconds for frequency range 2 if the wireless device 1701 may not detect a DCI format 1_1 for paired spectrum operation or if the wireless device 1701 may not detect a DCI format 1_1 or DCI format 0_1 for unpaired spectrum operation at/in/during the interval.

A wireless device 1701 procedures on the secondary cell may be same as on the primary cell using the timer value for the secondary cell and the default DL BWP for the secondary cell, for example, if the wireless device 1701 is configured for a secondary cell with higher layer parameter Default-DL-BWP indicating a default DL BWP among the configured DL BWPs and the wireless device 1701 is configured with higher layer parameter bwp-InactivityTimer indicating a timer value. The wireless device 1701 may use the indicated DL BWP and the indicated UL BWP on the secondary cell as the respective first active DL BWP and first active UL BWP on the secondary cell or carrier, for example, if a wireless device 1701 is configured by higher layer parameter Active-BWP-DL-SCell a first active DL BWP and by higher layer parameter Active-BWP-UL-SCell a first active UL BWP on a secondary cell or carrier.

DCI addressed to an RNTI may comprise a CRC of the DCI being scrambled with the RNTI. The wireless device 1701 may monitor PDCCH addressed to (or for) the RNTI for detecting the DCI. For example, the PDCCH may carry (or be with) the DCI. In an example, the PDCCH may not carry the DCI.

A set of PDCCH candidates for a wireless device 1701 to monitor may be defined in terms of PDCCH search space sets. A search space set comprises a CSS set or a USS set. A wireless device 1701 may monitor PDCCH candidates in one or more of the following search spaces sets: a Type0-PDCCH CSS set configured by pdcch-ConfigSIB1 in MIB or by searchSpaceSIB1 in PDCCH-ConfigCommon or by searchSpaceZero in PDCCH-ConfigCommon for a DCI format with CRC scrambled by a SI-RNTI on the primary cell of the MCG, a Type0A-PDCCH CSS set configured by searchSpaceOtherSystemInformation in PDCCH-ConfigCommon for a DCI format with CRC scrambled by a SI-RNTI on the primary cell of the MCG, a Type1-PDCCH CSS set configured by ra-SearchSpace in PDCCH-ConfigCommon for a DCI format with CRC scrambled by a RA-RNTI, a MsgB-RNTI, or a TC-RNTI on the primary cell, a Type2-PDCCH CSS set configured by pagingSearchSpace in PDCCH-ConfigCommon for a DCI format with CRC scrambled by a P-RNTI on the primary cell of the MCG, a Type3-PDCCH CSS set configured by SearchSpace in PDCCH-Config with searchSpaceType=common for DCI formats with CRC scrambled by INT-RNTI, SFI-RNTI, TPC-PUSCH-RNTI, TPC-PUCCH-RNTI, TPC-SRS-RNTI, CI-RNTI, or PS-RNTI and, only for the primary cell, C-RNTI, MCS-C-RNTI, or CS-RNTI(s), and a USS set configured by SearchSpace in PDCCH-Config with searchSpaceType=ue-Specific for DCI formats with CRC scrambled by C-RNTI, MCS-C-RNTI, SP-CSI-RNTI, CS-RNTI(s), SL-RNTI, SL-CS-RNTI, or SL-L-CS-RNTI.

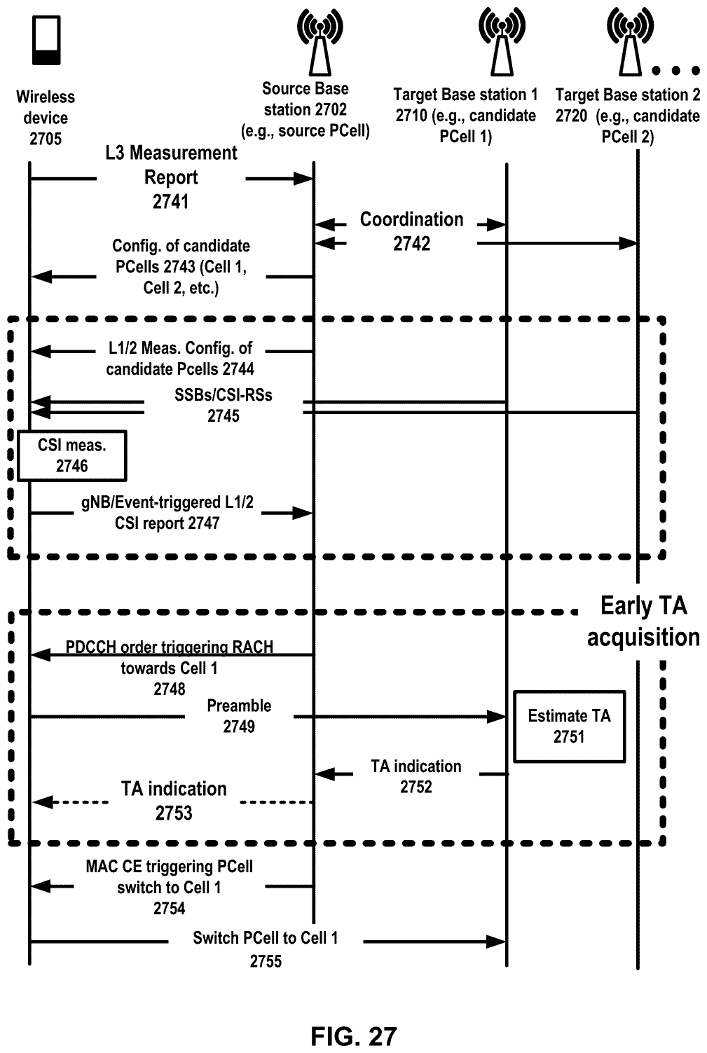

A wireless device 1701 may determine a PDCCH monitoring occasion on an active DL BWP based on one or more PDCCH configuration parameters comprising: a PDCCH monitoring periodicity, a PDCCH monitoring offset, and a PDCCH monitoring pattern within a slot. The wireless device 1701, for a search space set (SS s), may determine that a PDCCH monitoring occasion(s) exists in a slot with number n_{s,f}^{μ} in a frame with number n_{f} if (n_{f}·Nₛₗₒₜ^{frame,μ}+n_{s,f}^{μ}−oₛ) mod kₛ=0. Nₛₗₒₜ^{frame,μ} is a number of slots in a frame if numerology μ is configured. oₛ is a slot offset indicated in the PDCCH configuration parameters (e.g., based on examples from FIG. 27). kₛ is a PDCCH monitoring periodicity indicated in the one or more PDCCH configuration parameters. The wireless device 1701 may monitor PDCCH candidates for the search space set for Tₛ consecutive slots, starting from slot n_{s,f}^{μ}, and does not monitor PDCCH candidates for search space set s for the next kₛ−Tₛ consecutive slots. USS at CCE aggregation level L∈{1, 2, 4, 8, 16} may be defined by a set of PDCCH candidates for CCE aggregation level L.

A wireless device 1701 may decide, for a search space set s associated with CORESET p, CCE indexes for aggregation level L corresponding to PDCCH candidate m_{s,n}_{_{CI}} of the search space set in slot n_{s,f}^{μ} for an active DL BWP of a serving cell corresponding to carrier indicator field value n_{CI} as

$$L \cdot \{ ( {Y}_{p , {n}_{s , f}^{μ}} + ⌊ \frac{{m}_{s , {n}_{C , I}} \cdot {N}_{CCB , p}}{L \cdot {M}_{s , max}^{( L )}} ⌋ + {n}_{C I} ) mod ⌊ {N}_{CCB , p} / L ⌋ \} + i ,$$

where, Y_{p,n}_{_{s,f}}_{^{μ}}=0 for any CSS; Y_{p,n}_{_{s,f}}_{^{μ}}=(Aₚ·Y_{p,n}_{_{s,f}}_{^{μ}}₋₁) mod D for a USS, Y_{p,-1}=n_{RNTI}≠0, Aₚ=39827 for p mod 3=0, Aₚ=39829 for p mod 3=1, Aₚ=39839 for p mod 3=2, and D=65537; i=0, . . . , L−1; N_{CCE,p} is the number of CCEs, numbered from 0 to N_{CCE,p}−1, in CORESET p; n_{CI} is the carrier indicator field value if the wireless device 1701 is configured with a carrier indicator field by CrossCarrierSchedulingConfig for the serving cell on which PDCCH is monitored; otherwise, including for any CSS, n_{CI}=0; m_{s,n}_{_{CI}}=0, . . . , M_{s,n}_{_{CI}}^{(L)}−1, where M_{s,n}_{_{CI}}^{(L)} is the number of PDCCH candidates the wireless device 1701 is configured to monitor for aggregation level L of a search space set s for a serving cell corresponding to n_{CI}; for any CSS, M_{s,max}^{(L)}=M_{s,0}^{(L)}; for a USS, M_{s,max}^{(L)} is the maximum of M_{s,n}_{_{CI}}^{(L)} over all configured n_{CI} values for a CCE aggregation level L of search space set s; and the RNTI value used for n_{RNTI} is the C-RNTI.

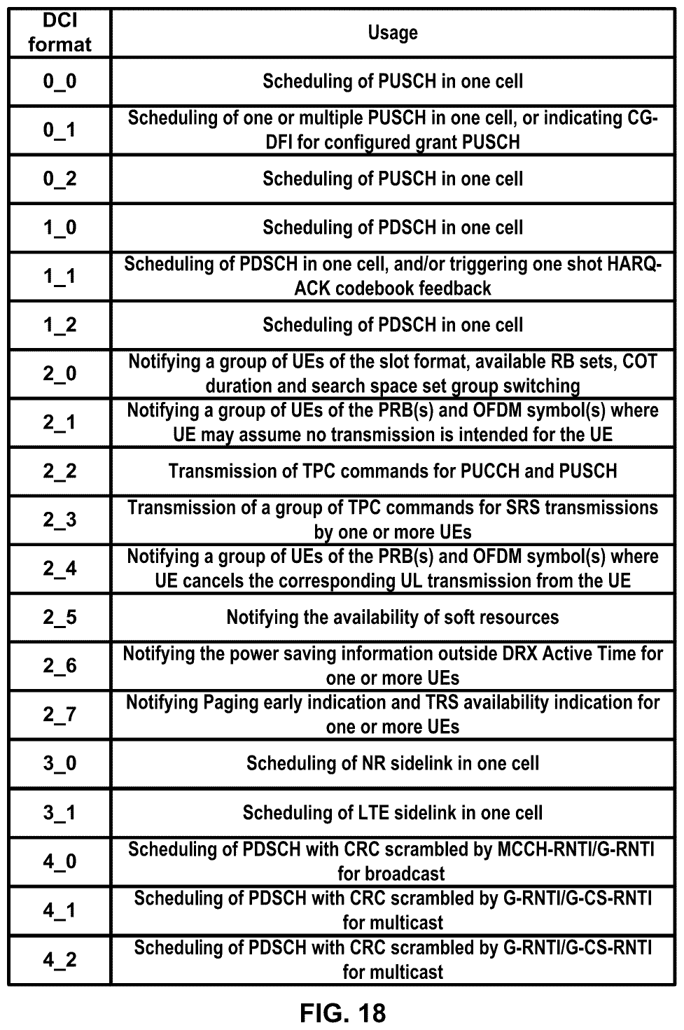

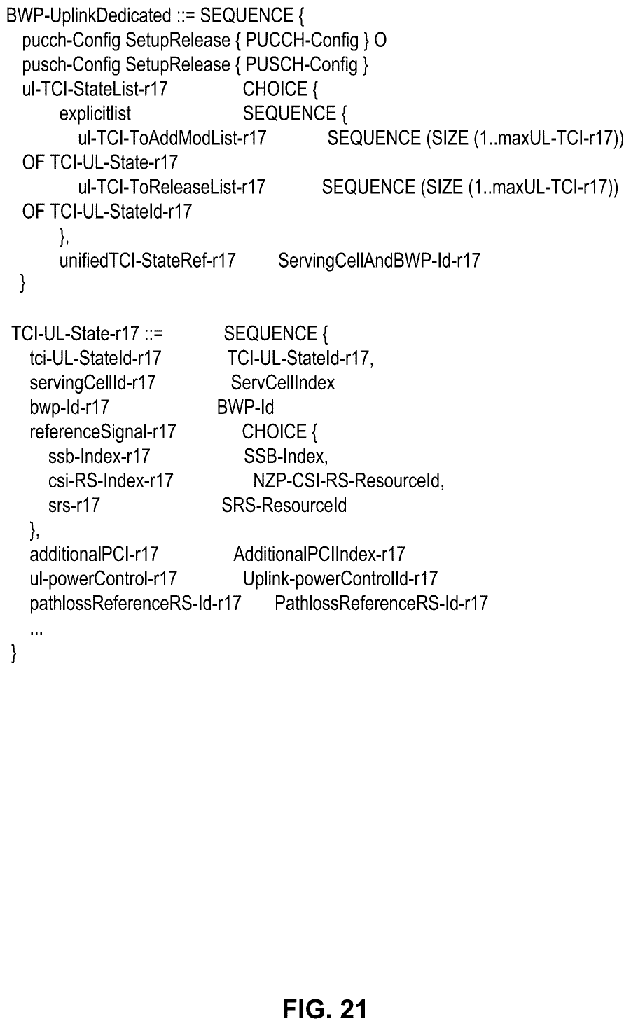

One or more configuration parameters may comprise one or more search space set (SSS) configuration parameters. For example, a wireless device 1701 may monitor a set of PDCCH candidates according to configuration parameters of a search space set (e.g., the one or more SSS configuration parameters) comprising a plurality of search spaces (SSs). The wireless device 1701 may monitor a set of PDCCH candidates in one or more CORESETs for detecting one or more DCIs. A CORESET may be configured based on examples from FIG. 21. Monitoring may comprise decoding one or more PDCCH candidates of the set of the PDCCH candidates according to the monitored DCI formats. Monitoring may comprise decoding a DCI content of one or more PDCCH candidates with possible (or configured) PDCCH locations, possible (or configured) PDCCH formats (e.g., number of CCEs, number of PDCCH candidates in common SSs, and/or number of PDCCH candidates in the wireless device-specific SSs) and possible (or configured) DCI formats. The decoding may be referred to as blind decoding. The possible DCI formats may be based on examples from FIG. 18.

FIG. 18 shows examples of DCI formats which may be used by a base station send (e.g., transmit) control information to a wireless device or used by the wireless device for PDCCH monitoring. Different DCI formats may comprise different DCI fields and/or have different DCI payload sizes. Different DCI formats may have different signaling purposes. In an example, DCI format 0_0 may be used to schedule PUSCH in one cell. DCI format 0_1 may be used to schedule one or multiple PUSCH in one cell or indicate CG-DFI (configured grant-Downlink Feedback Information) for configured grant PUSCH, etc. The DCI format(s) which the wireless device may monitor in a SS may be configured.

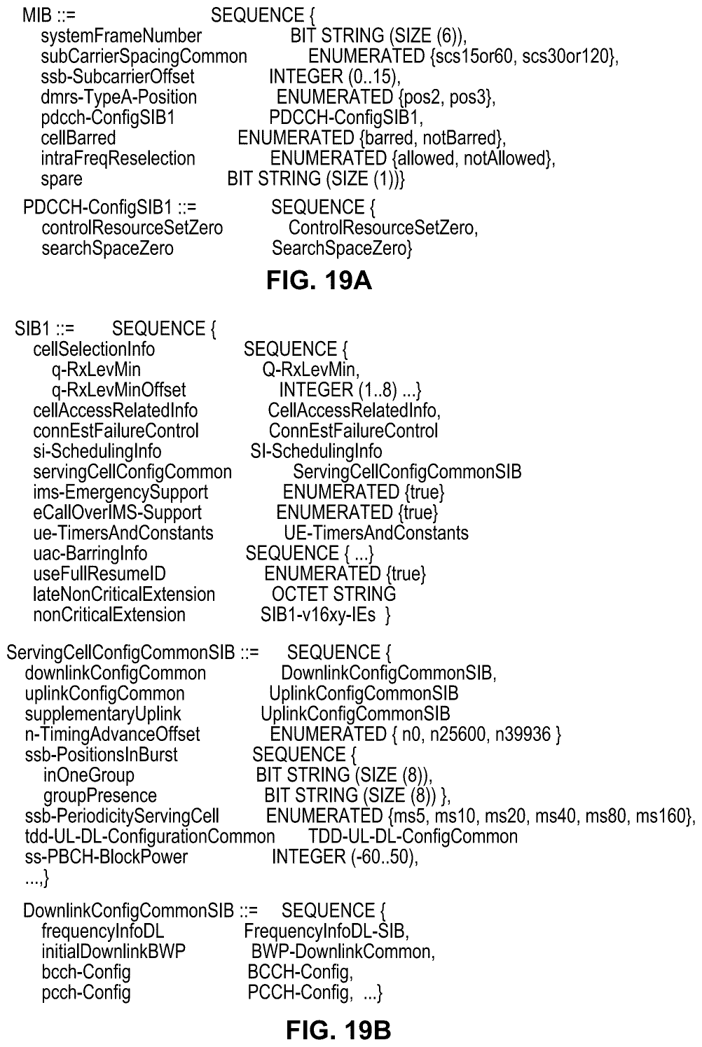

FIG. 19A shows an example of configuration parameters of a master information block (MIB) of a cell (e.g., PCell). The one or more configuration parameters may comprise the configuration parameters of the MIB. In an example, a wireless device may receive a MIB via a PBCH. The wireless device may receive a MIB via a PBCH, for example, based on receiving primary synchronization signal (PSS) and/or secondary synchronization signal (SSS). The configuration parameters of a MIB may comprise six bits (systemFrameNumber) of system frame number (SFN), subcarrier spacing indication (subCarrierSpacingCommon), a frequency domain offset (ssb-SubcarrierOffset) between SSB and overall resource block grid in number of subcarriers, an indication (cellBarred) indicating whether the cell is bared, a DMRS position indication (dmrs-TypeA-Position) indicating position of DMRS, parameters of CORESET and SS of a PDCCH (pdcch-ConfigSIB1) comprising a common CORESET, a common search space and necessary PDCCH parameters, etc.

A pdcch-ConfigSIB1 may comprise a first parameter (e.g., controlResourceSetZero) indicating a common ControlResourceSet (CORESET) with ID #0 (e.g., CORESET #0) of an initial BWP of the cell. controlResourceSetZero may be an integer between 0 and 15. Each integer between 0 and 15 may identify a configuration of CORESET #0. The pdcch-ConfigSIB1 may comprise a second parameter (e.g., searchSpaceZero) indicating a common search space with ID #0 (e.g., SS #0) of the initial BWP of the cell. searchSpaceZero may be an integer between 0 and 15. Each integer between 0 and 15 may identify a configuration of SS #0.

A wireless device may monitor PDCCH via SS #0 of CORESET #0 for receiving a DCI scheduling a system information block 1 (SIB1). The wireless device may monitor the PDCCH, based on receiving a MIB. The wireless device may receive the DCI with CRC scrambled with a system information radio network temporary identifier (SI-RNTI) dedicated for receiving the SIB1.

FIG. 19B shows an example of configuration parameters of system information block (SIB). The one or more configuration parameters may comprise the configuration parameters of SIB. A SIB (e.g., SIB1) may be sent (e.g., transmitted) to all wireless devices in a broadcast way. The SIB may contain information relevant if evaluating if a wireless device is allowed to access a cell, information of paging configuration and/or scheduling configuration of other system information. A SIB may contain radio resource configuration information that is common for all wireless devices and barring information used to a unified access control.

One or more configuration parameters may comprise one or more SIB information (e.g., configuration parameters). For example, the one or more configuration parameters may comprise/indicate the one or more SIB information. As shown in FIG. 19B, the one or more SIB configuration parameters may comprise: one or more parameters (e.g., cellSelectionInfo) for cell selection related to a serving cell, one or more configuration parameters of a serving cell (e.g., in ServingCellConfigCommonSIB IE), and one or more other parameters. The ServingCellConfigCommonSIB IE may comprise at least one of: common downlink parameters (e.g., in DownlinkConfigCommonSIB IE) of the serving cell, common uplink parameters (e.g., in UplinkConfigCommonSIB IE) of the serving cell, and/or other parameters.

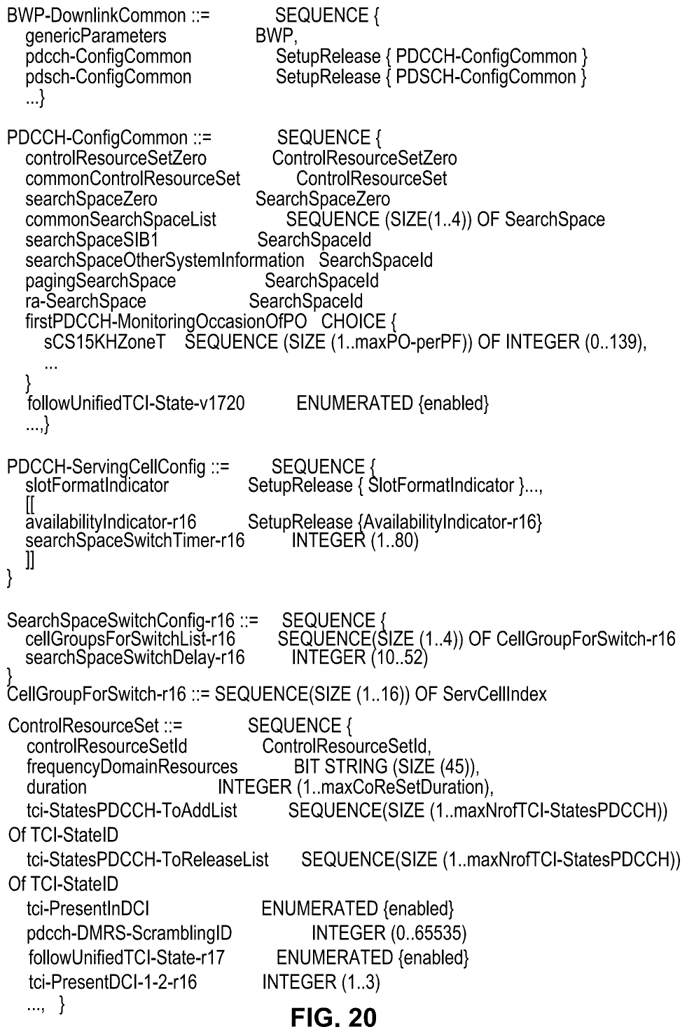

FIG. 20 and FIG. 21 show examples of configuration parameters of bandwidth parts. FIG. 20 shows an example of DL BWP configuration (e.g., common configuration of BWP of the serving cell). Similar to FIG. 20, the one or more configuration parameters may comprise common UL BWP configuration of the serving cell (e.g., via UplinkConfigCommonSIB IE). For example, 21 shows an example of UL BWP configuration (e.g., dedicated configuration of UL BWP of the wireless device). Similar to FIG. 21, the one or more configuration parameters may comprise dedicated DL BWP configuration of the serving cell (e.g., BWP-DownlinkDedicated).

One or more configuration parameters may comprise the one or more WBP configuration parameters. The one or more WBP configuration parameters may comprise one or more DL BWP configuration parameters (e.g., the BWP-DownlinkDedicated and/or the BWP-DownlinkCommon IE). The one or more WBP configuration parameters may comprise one or more UL BWP configuration parameters (e.g., the BWP-UplinkDedicated and/or the BWP-UplinkCommon IE).

One or more configuration parameters (e.g., the one or more WBP configuration parameters) may comprise one or more TCI configuration parameters. For example, the one or more TCI configuration parameters may configure one or more TCI states (e.g., for UL/DL transmissions).

As shown in FIG. 21, the BWP-UplinkDedicated may comprise configurations for PUCCH (e.g., pucch-Config) and/or configurations for PUSCH (e.g., pusch-Config) and/or one or more UL TCI configuration parameters (e.g., ul-TCI-StateList). The one or more UL TCI configuration parameters may configure/indicate one or more second TCI states (e.g., UL TCI states). The example of FIG. 21 may show configurations of an UL TCI state (e.g., TCI-UL-State) of the one or more second TCI states. The UL TCI state may indicate TCI state information for UL transmission (e.g., PUCCH/PUSCH/SRS). As shown in FIG. 21, the UL TCI state may indicate an associate (or corresponding) RS index (e.g., SSB index and/or CSI-RS index and/or SRS resource ID). For example, the one or more configuration parameters may configure/comprise one or more UL TCI states (e.g., ul-TCI-StateList-r17 IE of the BWP-UplinkDedicated), e.g., the applicable UL TCI states for PUCCH, PUSCH and SRS.

FIG. 22 shows an example of PDSCH configurations as per an aspect of the present disclosure. For example, FIG. 22 may show an example of TCI configurations. The one or more TCI configuration parameters may further comprise the TCI configurations of the PDSCH-Config (e.g., tci-StatesToAddModList and/or dl-OrJointTCI-StateList). For example, the one or more TCI configuration parameters configure/indicate one or more first TCI states (e.g., tci-StatesToAddModList and/or dl-OrJointTCI-StateList), e.g., for PDSCH and/or PDCCH reception. FIG. 22, further shows an example of TCI state and an example of QCL information.

A wireless device may decode/receive PDSCH scheduled by a PDCCH. The wireless device may decode/receive the PDSCH, based on the one or more first TCI states. As shown in FIG. 22, each TCI-State of the one or more first TCI states may comprise/contain parameters for configuring a quasi co-location relationship between one or two downlink reference signals and the DM-RS ports of the PDSCH, the DM-RS port of PDCCH or the CSI-RS port(s) of a CSI-RS resource. The quasi co-location relationship may be a qcl-Type1 for a first DL RS and a qcl-Type2 for a second DL RS (if configured).

The dl-OrJointTCI-StateList in the PDSCH-Config may indicate/comprise a list of up to 128 TCI-State configurations (e.g., a cardinality of the one or more first TCI states may be up to 128), for example, for providing/configuring/indicating a reference signal (RS) for the quasi co-location for DM-RS of PDSCH and DM-RS of PDCCH in a BWP/CC, for CSI-RS. The dl-OrJointTCI-StateList in the PDSCH-Config may indicate/comprise reference(s) for determining UL TX spatial filter (e.g., uplink spatial domain transmission filter) for dynamic-grant and configured-grant based PUSCH and PUCCH resource in a BWP/CC, and/or SRS.

The configuration of the BWP may be the one or more BWP configuration parameters (e.g., the DownlinkConfigCommonSIB IE) may comprise parameters of an initial downlink BWP (initialDownlinkBWP IE) of the serving cell (e.g., SpCell). The parameters of the initial downlink BWP may be comprised in a BWP-DownlinkCommon IE (see, FIG. 19B). The BWP-DownlinkCommon IE may be used to configure common parameters of a downlink BWP of the serving cell. The base station may configure the locationAndBandwidth so that the initial downlink BWP contains the entire CORESET #0 of this serving cell in the frequency domain. The wireless device may use the locationAndBandwidth upon reception of this field (e.g., to determine the frequency position of signals described in relation to this locationAndBandwidth) but it keeps CORESET #0 until after reception of RRCSetup/RRCResume/RRCReestablishment.

The DownlinkConfigCommonSIB IE may comprise parameters of a paging channel configuration. The parameters may comprise a paging cycle value (T, by defaultPagingCycle IE), a parameter (nAndPagingFrameOffset IE) indicating total number N) of paging frames (PFs) and paging frame offset (PF_offset) in a paging DRX cycle, a number (Ns) for total paging occasions (POs) per PF, a first PDCCH monitoring occasion indication parameter (firstPDCCH-MonitoringOccasionofPO IE) indicating a first PDCCH monitoring occasion for paging of each PO of a PF. The wireless device may monitor PDCCH for receiving paging message. The wireless device may monitor the PDCCH, based on parameters of a PCCH configuration. The parameter first-PDCCH-MonitoringOccasionOfPO may be signaled in SIB1 for paging in initial DL BWP. For paging in a DL BWP other than the initial DL BWP, the parameter first-PDCCH-MonitoringOccasionOfPO may be signaled in the corresponding BWP configuration.

As shown in FIG. 19B, the one or more BWP configuration parameters may comprise BWP-DownlinkCommon IE. As shown in FIG. 20, the one or more BWP configuration parameters may comprise the one or more PDCCH configuration parameters (e.g., pdcch-ConfigCommon IE) and/or one or more PDSCH configuration parameters (e.g., pdsch-ConfigCommon IE). The pdsch-ConfigCommon IE may comprise cell specific parameters for the PDSCH of the downlink BWP (e.g., in pdsch-ConfigCommon IE), and one or more other parameters.

The pdcch-ConfigCommon IE be may specific parameters for PDCCH of the downlink BWP. As shown in FIG. 20, the pdcch-ConfigCommon IE may comprise parameters of CORESET #0 (e.g., controlResourceSetZero) which may be used in any common or wireless device-specific search spaces. A value of the controlResourceSetZero may be interpreted like the corresponding bits in MIB pdcch-ConfigSIB1. A pdcch-ConfigCommon IE may comprise parameters (e.g., in commonControlResourceSet) of an additional common control resource set which may be configured and used for any common or wireless device-specific search space. A ControlResourceSetId other than 0 for this ControlResourceSet may be used, for example, if the network configures this field. The network may configure the commonControlResourceSet in SIB1 so that it is contained in the bandwidth of CORESET #0. A pdcch-ConfigCommon IE may comprise parameters (e.g., in commonSearchSpaceList) of a list of additional common search spaces. The pdcch-ConfigCommon IE may indicate, from a list of search spaces, a search space for paging (e.g., pagingSearchSpace), a search space for random access procedure (e.g., ra-SearchSpace), a search space for SIB1 message (e.g., searchSpaceSIB1), a common search space #0 (e.g., searchSpaceZero), and one or more other search spaces.

As shown in FIG. 20, the one or more PDCCH configuration parameters may comprise one or more control resource set (CORESET) configuration parameters configuring indicating at least one CORESET. A CORESET of the at least one CORESET may be associated with a CORESET index (e.g., ControlResourceSetId). The CORESET may be implemented based on examples as described herein with respect to FIG. 14A and/or FIG. 14B. The CORESET index with a value of 0 may identify a common CORESET configured in MIB and in ServingCellConfigCommon (controlResourceSetZero) and may not be used in the ControlResourceSet IE. The CORESET index with other values may identify CORESETs configured by dedicated signaling or in SIB1. The controlResourceSetId is unique among the BWPs of a serving cell. A CORESET may be associated with coresetPoolIndex indicating an index of a CORESET pool for the CORESET. A CORESET may be associated with a time duration parameter (e.g., duration) indicating contiguous time duration of the CORESET in number of symbols. In an example, as shown in FIG. 20, the one or more CORESET configuration parameters of a CORESET may comprise at least one of: frequency resource indication (e.g., frequencyDomainResources), a CCE-REG mapping type indicator (e.g., cce-REG-MappingType), one or more third TCI states, an indicator indicating whether a TCI is present in a DCI, and the like. The frequency resource indication, comprising a number of bits (e.g., 45 bits), may indicate frequency domain resources, each bit of the indication corresponding to a group of 6 RBs, with grouping starting from the first RB group in a BWP of a cell (e.g., SpCell, SCell). The first (left-most/most significant) bit may correspond to the first RB group in the BWP, and so on. A bit that is set to 1 may indicate that an RB group, corresponding to the bit, belongs to the frequency domain resource of this CORESET. Bits corresponding to a group of RBs not fully contained in the BWP within which the CORESET is configured may be set to zero. The one or more configuration parameters may comprise configuration parameters of CORESETs.

One or more third TCI states may comprise at least one of: tci-StatesPDCCH-ToAddList and/or tci-StatesPDCCH-ToReleaseList and/or one or more indications (e.g., tci-PresentInDCI and/or followUnifiedTCI-State-r17 and/or tci-PresentDCI-1-2-r16). For example, the one or more third TCI states may comprise a subset of the one or more first TCI states (e.g., corresponding to a TCI-StateId) defined in the one or more PDSCH configuration parameters (e.g., pdsch-Config), for example, see FIG. 22. A subset of the one or more third TCI states defined in the one or more PDSCH (e.g., pdsch-Config) may correspond to tci-configuration parameters (e.g., StatesToAddModList or dl-OrJointTCI-StateList of the pdsch-Config of the one or more BWP configuration parameters (e.g., BWP-DownlinkDedicated corresponding to the serving cell and to the DL BWP to which the ControlResourceSet belong to).

One or more third TCI states may provide/define/configure QCL information/relationship (e.g., an example shown in FIG. 22) between DL RS (e.g., SSB and/or CSI-RS) in one RS Set (TCI-State) and the PDCCH DM-RS ports, for example, downlink spatial domain transmission filter. For example, the wireless device may receive/monitor the PDCCH based on (one of) the one or more third TCI states. The wireless device may determine monitoring occasions for PDCCH candidates of the Type0/0A/2-PDCCH CSS set (e.g., as describe above), for example, if the one or more configuration parameters configures/provides a zero value for searchSpaceID in the PDCCH-ConfigCommon for a Type0/0A/2-PDCCH CSS set (or a zero value for searchSpaceMCCH or searchSpaceMTCH). The base station may indicate a C-RNTI to the wireless device (e.g., the C-RNTI is available at the wireless device). The wireless device may monitor PDCCH candidates (or receive PDCCH) only at monitoring occasions associated with a first SS/PBCH block (SSB).

A wireless device may monitor PDCCH candidates (or receive PDCCH) based on a first SS/PBCH block (SSB). For example, the first SSB (e.g., the default SSB) may be an SS/PBCH block that is determined by the most recent of a random access procedure, for example, for initial access. The RA procedure may not be initiated by a PDCCH order that triggers a contention-free random access procedure. As shown the wireless device may send (e.g., transmit) the PRACH based on the first SSB. The first SSB may be an SS/PBCH block that is determined by the most recent of a MAC CE activation command indicating (or for) a TCI state (e.g., of the one or more third TCI states and/or the one or more first TCI states) of the active BWP that includes a CORESET with index 0. The TCI-state may include a CSI-RS that is quasi-co-located with the first SSB. The MAC CE activation command may be a TCI State Indication for wireless device-specific PDCCH MAC CE (and/or TCI States Activation/Deactivation for wireless device-specific PDSCH MAC CE).

A wireless device may determine/assume that the DM-RS antenna port associated with PDCCH receptions in the CORESET configured by the pdcch-ConfigSIB1 in MIB (e.g., see FIG. 19A), the DM-RS antenna port (e.g., the spatial domain transmission/reception filter) associated with corresponding PDSCH receptions, and the corresponding SS/PBCH block are quasi co-located with respect to average gain, quasi co-location ‘typeA’ and ‘typeD’ properties. The one or more configuration parameters may not indicate/configure a TCI state indicating quasi co-location information of the DM-RS antenna port for PDCCH reception in a CORESET.

A wireless device may not expect (or consider error) to monitor a PDCCH in a Type0/0A/0B/2/3-PDCCH CSS set or in a USS set if a DM-RS for monitoring a PDCCH in a Type1-PDCCH CSS set is not configured with same qcl-Type set to ‘typeD’ properties with a DM-RS for monitoring the PDCCH in the Type0/0A/0B/2/3-PDCCH CSS set or in the USS set, and if the PDCCH or an associated PDSCH overlaps in at least one symbol with a PDCCH the wireless device monitors in a Type1-PDCCH CSS set or with an associated PDSCH.

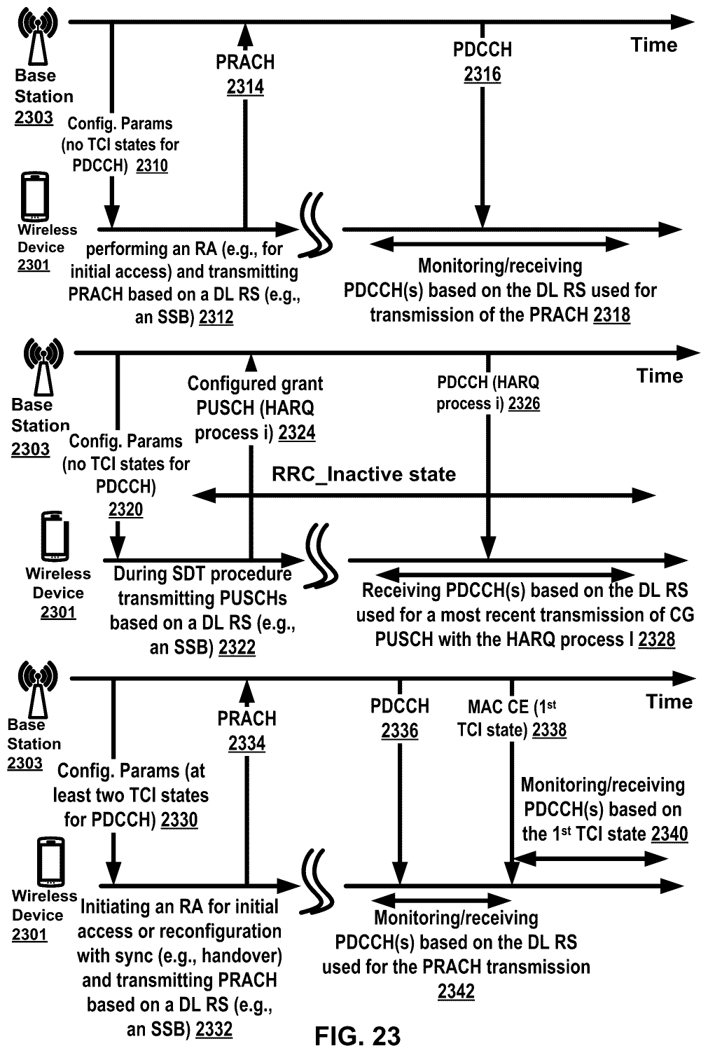

FIG. 23 shows examples of monitoring PDCCH candidates as per an aspect of the present disclosure. FIG. 23, may demonstrate examples of determining (downlink) spatial domain transmission/reception filters, for example, for receiving/monitoring the PDCCH (candidates). For example, the PDCCH candidates correspond more to a CORESET other than a CORESET with index 0.

FIG. 23 shows an example that the one or more configuration parameters not comprising (or configuring/indicating) the one or more third TCI states (e.g., a configuration of TCI state(s) by tci-StatesPDCCH-ToAddList and tci-StatesPDCCH-ToReleaseList for the CORESET). As shown in FIG. 23, the wireless device 2301 may determine the spatial domain transmission/reception filter for receiving PDCCH candidates based on the default RS. For example, the wireless device 2301 may assume/determine that the DM-RS antenna port associated with PDCCH receptions (of the PDCCH candidates) is quasi co-located with the default SSB (e.g., the SS/PBCH block the wireless device 2301 is identified at/in/during the initial access procedure).

As shown in FIG. 23, the default SSB may correspond to an SSB that the wireless device 2301 identifies at/in/during the RRC_INACTIVE state. For example, the wireless device 2301 may perform a small data transmission (SDT) procedure at/in/during the RRC inactive state. The SDT procedure may comprise transmissions of one or more configured grant PUSCH transmissions. The wireless device 2301 may, at/in/during the RRC_INACTIVE state, determine the default SSB based on a most recent configured grant PUSCH transmission of the one or more configured grant PUSCH transmissions of the SDT procedure for a HARQ process. The PDCCH receptions may correspond to the HARQ process.

As shown in FIG. 23, the one or more third TCI configuration parameters configuring/indicating more than one TCI states (e.g., at least two TCI states) for the CORESET by tci-StatesPDCCH-ToAddList and tci-StatesPDCCH-ToReleaseList (e.g., in FIG. 20). As shown in FIG. 23, until receiving a MAC CE activation command (e.g., the TCI States Activation/Deactivation for wireless device-specific PDSCH MAC CE and/or the TCI State Indication for wireless device-specific PDCCH MAC CE) for one of the TCI states of the at least two TCI states (e.g., a first TCI state of the at least two TCI states), the wireless device 2301 may, based on the default RS, determine the spatial domain transmission/reception filter for receiving PDCCH candidates. The wireless device 2301 may receive/monitor the PDCCH candidates based on the determined spatial domain transmission/reception filter. The wireless device 2301 may determine the default RS (e.g., the default SSB) based on the first SSB used for transmission of the PRACH 2314. The wireless device 2301 may initiate the RA procedure 2312 as part of/at/in/during the initial access. The wireless device 2301 may initiate/perform the RA procedure at/in/during (or as part of) Reconfiguration with sync procedure (e.g., handover). The wireless device 2301 may determine the spatial domain transmission/reception filter for receiving PDCCH candidates based on the indicated TCI state (e.g., the first TCI state). The wireless device 2301 may determine the spatial domain transmission/reception filter, for example, based on (e.g., in response to) receiving the MAC CE activation command. The wireless device 2301 may activate the first TCI state based on receiving the MAC CE activation command (e.g., MAC CE activation command for one of the TCI states of the one or more first TCI states).

A wireless device 2301, for a CORESET other than a CORESET with index 0, may assume that the DM-RS antenna port associated with PDCCH receptions in the CORESET is quasi co-located with the one or more DL RS configured by the TCI states, for example, if the wireless device 2301 is provided a single TCI state for a CORESET, or if the wireless device 2301 receives a MAC CE activation command for one or two of the provided TCI states for a CORESET (e.g., the first TCI state). The wireless device 2301, for a CORESET with index 0, may expect that a CSI-RS configured with qcl-Type set to ‘typeD’ in a TCI state indicated by a MAC CE activation command for the CORESET is provided by a SS/PBCH block (e.g., the first SSB).

For a time duration from a first time (e.g., corresponding to a time point/occasion) that the wireless device 2301 receives the one or more configuration parameters comprising the one or more TCI configuration parameters (e.g., the dl-OrJointTCI-StateList) with more than one TCI-State until/before/prior to a second time (e.g., corresponding to a time point/occasion before application of an indicated TCI state (e.g., the first TCI state) from configured TCI states (e.g., the one or more first TCI states and/or the one or more third TCI states)), the wireless device 2301 may assume that DM-RS of PDSCH and DM-RS of PDCCH and the CSI-RS using the indicated TCI state are quasi co-located with the SS/PBCH block the wireless device identified at/in/during a random access procedure (e.g., the default SSB). For example, the wireless device 2301 may determine the (downlink) spatial domain reception filter for receiving the PDSCH and/or the PDCCH based on the default SSB at/in/during the time duration. The random access procedure may be for the initial access procedure. The random access procedure is initiated by the Reconfiguration with sync procedure.

For a time duration from a first time (e.g., corresponding to a time point/occasion) that the wireless device 2301 receives the one or more configuration parameters comprising the one or more TCI configuration parameters (e.g., the dl-OrJointTCI-StateList) with more than one TCI-State or more than one TCI-UL-State) until/before/prior to a second time (e.g., corresponding to a time point/occasion before application of an indicated TCI state (e.g., the first TCI state) from configured TCI states (e.g., the one or more first TCI states and/or the one or more third TCI states)), the wireless device 2301 may assume that uplink spatial domain transmission filter (the UL TX spatial filter) for dynamic-grant and configured-grant based PUSCH and PUCCH, and for SRS using the indicated TCI state is the same as that for a PUSCH transmission scheduled by a RAR UL grant at/in/during a random access procedure (e.g., Msg3/MsgA). The random access procedure may be for the initial access procedure. In some implementations, the random access procedure is initiated by the Reconfiguration with sync procedure.

A wireless device 2301 may obtain/determine the QCL assumptions from the configured TCI state for DM-RS of PDSCH and DM-RS of PDCCH, and the CSI-RS using the indicated TCI stat, for example, if the dl-OrJointTCI-StateList configures/indicates a single TCI-State (that may be used by the wireless device 2301 as an indicated TCI state). The wireless device 2301 may determine the uplink spatial domain transmission filter (e.g., the UL TX spatial filter) from the configured TCI state for dynamic-grant and configured-grant based PUSCH and PUCCH, and SRS using the indicated TCI state, for example, if the dl-OrJointTCI-StateList configures/indicates a single TCI-State or a single UL TCI state (that may be used by the wireless device 2301 as an indicated TCI state).

FIG. 20 shows an example of configuration of a search space (e.g., SearchSpaceId). In an example, the one or more SSS configuration parameters may comprise one or more search space configuration parameters of a search space. The one or more search space configuration parameters of a search space, may comprise at least one of: a search space ID (searchSpaceId), a control resource set ID (controlResourceSetId), a monitoring slot periodicity and offset parameter (monitoringSlotPeriodicityAndOffset), a search space time duration value (duration), a monitoring symbol indication (monitoringSymbolsWithinSlot), a number of candidates for an aggregation level (nrofCandidates), and/or a SS type indicating a common SS type or a wireless device-specific SS type (searchSpaceType). The monitoring slot periodicity and offset parameter may indicate slots (e.g., in a radio frame) and slot offset (e.g., related to a starting of a radio frame) for PDCCH monitoring. The monitoring symbol indication may indicate on which symbol(s) of a slot a wireless device 2301 may monitor PDCCH on the SS. The control resource set ID may identify a control resource set on which a SS may be located.

A wireless device 2301, in RRC_IDLE or RRC_INACTIVE state, may periodically monitor paging occasions (POs) for receiving paging message for the wireless device 2301. Before monitoring the POs, the wireless device 2301, in RRC_IDLE or RRC_INACTIVE state, may wake up at a time before each PO for preparation and/or turn all components in preparation of data reception (warm up). The gap between the waking up and the PO may be long enough to accommodate all the processing requirements. The wireless device 2301 may perform, after the warming up, timing acquisition from SSB and coarse synchronization, frequency and time tracking, time and frequency offset compensation, and/or calibration of local oscillator. The wireless device 2301 may monitor a PDCCH for a paging DCI in one or more PDCCH monitoring occasions based on configuration parameters of the PCCH configuration configured in SIB1.

The base station 2303 may send (e.g., transmit) one or more SSBs periodically to the wireless device 2301, or a plurality of wireless devices. The wireless device 2301 (in RRC_idle state, RRC_inactive state, or RRC_connected state) may use the one or more SSBs for time and frequency synchronization with a cell of the base station 2303. An SSB, comprising a primary synchronization signal (PSS), a secondary synchronization signal (SSS), a physical broadcast channel (PBCH), a PBCH DM-RS, may be sent (e.g., transmitted) based on examples as described herein with respect to FIG. 11A. An SSB may occupy a number (e.g., 4) of OFDM symbols as shown in FIG. 11A. The base station 2303 may send (e.g., transmit) one or more SSBs in a SSB burst, for example, to enable beam-sweeping for PSS/SSS and PBCH. An SSB burst comprise a set of SSBs, each SSB potentially be sent (e.g., transmitted) on a different beam. SSBs in the SSB burst may be sent (e.g., transmitted) in time-division multiplexing fashion. For example, an SSB burst may be always confined to a 5 ms window and may be either located in first-half or in the second-half of a 10 ms radio frame. In this specification, an SSB burst may be equivalently referred to as a transmission window (e.g., 5 ms) in which the set of SSBs are sent (e.g., transmitted).

One or more configuration parameters may configure/indicate a transmission periodicity of SSB via the (e.g., ssb-PeriodicityServingCell in ServingCellConfigCommonSIB of SIB1 message). A candidate value of the transmission periodicity may be in a range of {5 ms, 10 ms, 20 ms, 40 ms, 80 ms, 160 ms}. The maximum number of candidate SSBs (Lₘₐₓ) within an SSB burst may depend upon a carrier frequency/band of the cell. In an example, Lₘₐₓ=4 if f_{c}<=3 GHz, wherein f_{c} is the carrier frequency of the cell. Lₘₐₓ=8 if 3 GHz<f_{c}<=6 GHz. Lₘₐₓ=64 if f_{c}>=6 GHz, etc.

A starting OFDM symbol index of a candidate SSB (occupying 4 OFDM symbols) within a SSB burst (5 ms) may depend on a subcarrier spacing (SCS) and a carrier frequency band of the cell. Starting OFDM symbol indexes of SSBs in a SSB burst, for a cell configured with 15 kHz and carrier frequency fc<3 GHz (Lₘₐₓ=4), may be 2, 8, 16, and 22. OFDM symbols in a half-frame are indexed with the first symbol of the first slot being indexed as 0. Starting OFDM symbol indexes of SSBs in a SSB burst, for a cell configured with 15 kHz and carrier frequency 3 GHz<fc<6 GHz (Lₘₐₓ=8), may be 2, 8, 16, 22, 30, 36, 44 and 50, etc. The base station 2303 may send (e.g., transmit) only one SSB by using the first SSB starting position, for example, if the base station 2303 is not sending (e.g., transmitting) the SSBs with beam forming.

A base station 2303 may send (e.g., transmit) to the wireless device 2301 (or a plurality of wireless devices) an SSB burst in a periodicity. A default periodicity of an SSB burst may be 20 ms, for example, before the wireless device 2301 receives the SIB1 message for initial access of the cell. The base station 2303, with 20 ms transmission periodicity of SSB (or SSB burst), may send (e.g., transmit) the SSB burst in the first 5 ms of each 20 ms. The base station 2303 may not send (e.g., transmit) the SSB burst in the rest 15 ms of the each 20 ms. The base station 2303 may send (e.g., transmit) a MIB message with a transmission periodicity of 80 millisecond (ms) to the wireless device 2301. The same MIB message may be repeated (according to the SSB periodicity) within the 80 ms. Contents of the MIB message may be same over 80 ms period. The same MIB may be sent (e.g., transmitted) over all SSBs within an SS burst. In an example, PBCH may indicate that there is no associated SIB1, in which case the wireless device 2301 may be pointed to another frequency from where to search for an SSB that is associated with a SIB1 as well as a frequency range where the wireless device 2301 may assume no SSB associated with SIB1 is present. The indicated frequency range may be confined within a contiguous spectrum allocation of the same operator in which SSB is detected.

One or more configuration parameters may (e.g., via SIB1) indicate/comprise cell specific configuration parameters of SSB transmission. The cell specific configuration parameters may comprise a value for a transmission periodicity (ssb-PeriodicityServingCell) of an SSB burst, locations of a number of SSBs (e.g., active SSBs), of a plurality of candidate SSBs, comprised in the SSB burst. The cell specific configuration parameters may comprise position indication of a SSB in a SSB burst (e.g., ssb-PositionsInBurst). The position indication may comprise a first bitmap (e.g., groupPresence) and a second bitmap (e.g., inOneGroup) indicating locations of a number of SSBs comprised in a SSB burst.

A base station 2303 may send (e.g., transmit) a SIB1 message with a periodicity of 160 ms. The base station 2303 may send (e.g., transmit) the same SIB1 message with variable transmission repetition periodicity within 160 ms. A default transmission repetition periodicity of SIB1 is 20 ms. The base station 2303 may determine an actual transmission repetition periodicity based on network implementation. SIB1 repetition transmission period, for SSB and CORESET multiplexing pattern 1, may be 20 ms. SIB1 transmission repetition period, for SSB and CORESET multiplexing pattern 2/3, may be the same as the SSB period. SIB1 may comprise information regarding the availability and scheduling (e.g., mapping of SIBs to SI message, periodicity, SI-window size) of other SIBs, an indication whether one or more SIBs are only provided on-demand and in which case, configuration parameters needed by a wireless device 2301 to perform an SI request.

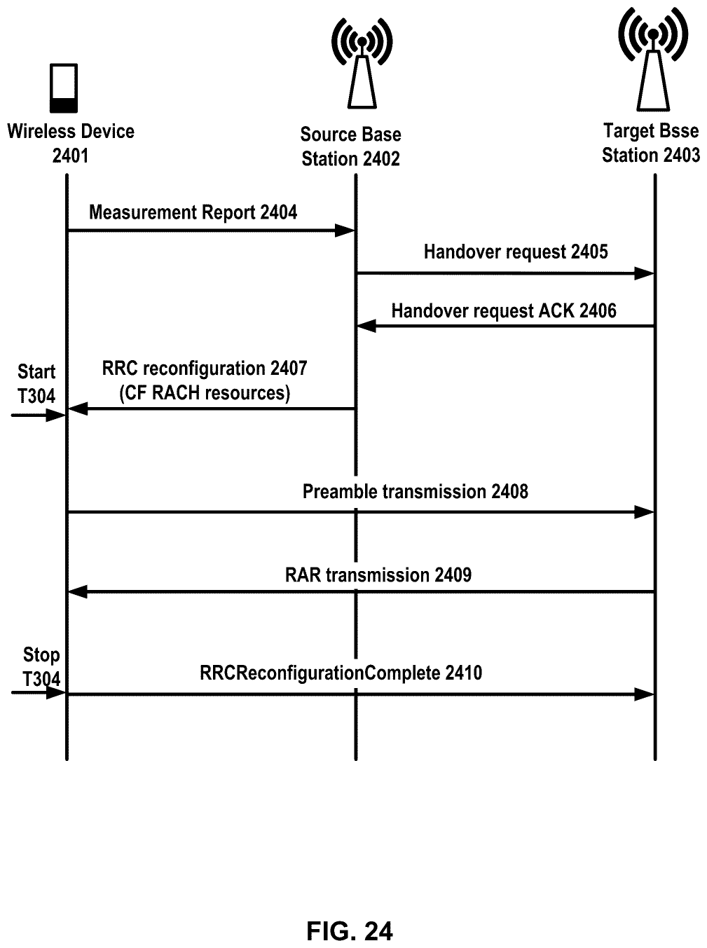

FIG. 24 shows an example of a handover procedure from a source base station 2402 (e.g., a first base station) to a target base station 2403 (e.g., a second base station) for a wireless device 2401. One or more configuration parameters may comprise an RRC reconfiguration message (e.g., RRCReconfiguration). The RRC reconfiguration message may be an RRC connection reconfiguration message. The RRC reconfiguration messages may comprise reconfiguration WithSync (in NR specifications, e.g., 3GPP Technical Specification (TS)) 38.331) and/or mobilityControlInfo in LTE specifications (e.g., 3GPP Technical Specification (TS) 36.331). The SCell(s) may be changed, for example, using the RRC connection reconfiguration message either with or without the reconfiguration WithSync or mobilityControlInfo. For example, the base station may send (e.g., transmit) the RRC reconfiguration messages to the wireless device 2401 (or each wireless device of a plurality of wireless devices) in a source cell to indicate a handover to a target/neighbor cell. In an example, for/via a network-controlled mobility procedure (e.g., the handover procedure) in an RRC_CONNECTED state of the wireless device 2401, the source cell (e.g., PCell) may be changed using the RRC connection reconfiguration message. In this specification, a handover triggered by receiving the RRC reconfiguration message (e.g., RRCReconfiguration) comprising the handover command/message (e.g., by including reconfigurationWithSync (in NR specifications) or mobilityControlInfo in LTE specifications (handover)) may be referred to as a normal handover, an unconditional handover, which is contrast with a conditional handover (CHO). The handover procedure shown in FIG. 24 may be RACH-based handover procedure.

As described with respect to FIG. 24, a network (e.g., the base station) may configure the wireless device 2401 to perform measurement reporting 2404 (possibly including the configuration of measurement gaps). The measurement reporting may be a layer 3 reporting, different from layer 1 CSI reporting. The wireless device 2401 may send (e.g., transmit) one or more measurement reports to the source base station 2402 (or a source PCell). For example, the network may initiate handover blindly, for example without having received measurement reports from the wireless device 2401. Before sending the handover message to the wireless device 2401, the source base station 2402 may prepare candidate target cells. The source base station 2402 may select a candidate target cell (e.g., a candidate target PCell) of the candidate target cells.

For example, based on the one or more measurement reports from the wireless device 2401, a source base station 2402 may provide the target base station 2403 with a list of best cells (e.g., the candidate target cells) on each frequency for which measurement information is available, for example, in order of decreasing RSRP values. The source base station 2402 may also include available measurement information for the candidate target cells (e.g., provided in the list of the best cells). The target base station 2403 may decide which cells are configured for use after handover, which may include cells other than the ones indicated by the source base station 2402. For example, the source base station 2402 may send (e.g., transmit) a handover request 2405 to the target base station 2403. The target base station 2403 may response with a handover message 2406. In an example, in the handover message, the target base station 2403 may indicate access stratum configuration to be used in the target cell(s) for the wireless device 2401.

A source base station 2402 may transparently (for example, does not alter values/content) forward the handover message/information received from the target base station 2403 to the wireless device 2401. The handover message 2407 may configure/indicate RACH resource configurations for the wireless device 2401 to access (e.g., via initiating an RA) a cell in the target base station. If appropriate, the source base station 2402 may initiate data forwarding for (a subset of) the dedicated radio bearers.

After receiving the handover message, a wireless device 2401 may start a handover timer (e.g., T304) with an initial timer value. The handover message may configure the handover timer (e.g., the handover message may indicate the initial timer value of the handover timer). Based on the handover message, the wireless device 2401 may use the RRC parameters of the target PCell and/or a cell group (MCG/SCG) associated with the target PCell of the target base station. For example, the wireless device 2401 may, based on the handover message, perform downlink synchronization to the target base station. After or based on (e.g., in response to) performing downlink synchronization (e.g., searching a suitable/detectable SSB from candidate SSBs configured on the target base station) to the target base station, the wireless device 2401 may initiate a random access (e.g., contention-free, or contention-based, based on examples of FIG. 13A, FIG. 13B and/or FIG. 13C) procedure, for example, for attempting to access the target base station and/or UL synchronization to the target cell. For example, the wireless device 2401 may perform the RA procedure (e.g., a 4-step RA procedure or a 2-step RA procedure) via an available RACH occasion according to a RACH resource selection. For example, the available RACH occasion may be configured in the RACH resource configuration (e.g., indicated by the handover message). If allocating a dedicated preamble for the random access in the target base station, RAN may ensure the preamble is available from the first RACH occasion the wireless device 2401 may use.

A wireless device 2401 may activate the uplink BWP configured with firstActiveUplinkBWP-id and the downlink BWP configured with firstActiveDownlinkBWP-id on the target PCell upon performing handover to the target PCell. Performing UL synchronization may comprise sending (e.g., transmitting) a preamble via an active uplink BWP (e.g., a BWP configured as firstActiveUplinkBWP-id) of uplink BWPs of the target cell (e.g., the target PCell), monitoring PDCCH on an active downlink BWP (e.g., a BWP configured as firstActiveDownlinkBWP-id) for receiving a RAR (e.g., comprising a TA value for transmission of UL signals, e.g., PUSCH/PUCCH, via the target cell) via the target cell. For example, the wireless device may receive the RAR from the target base station and obtain the TA of the target cell. The wireless device, by using the TA of the target cell, adjust uplink transmission timing for sending (e.g., transmitting) PUSCH/PUCCH via the target cell. The adjusting uplink transmission timing may comprise advancing or delay the transmissions (in the UL frame) by an amount indicated by a value of the TA of the target cell, for example, to ensure the uplink signals received at the target base station are aligned (in time domain) with uplink signals sent (e.g., transmitted) from other wireless devices in the target cell. The wireless device 2401 may, based on (e.g., in response to) performing UL synchronization or successfully completing the RA procedure in the target cell, release RRC configuration parameters of the source cell and an MCG/SCG associated with the source cell.

As described with respect to FIG. 24, a wireless device 2401 may send (e.g., transmit) a preamble 2408 (e.g., PRACH) to the target base station via a RACH resource/occasion. The RACH resource may be selected from a plurality of RACH resources (e.g., configured in rach-ConfigDedicated IE) based on SSBs/CSI-RSs measurements of the target base station. The wireless device 2401 may select a (best) SSB/CSI-RS of the configured SSBs/CSI-RSs of the target base station. The wireless device 2401 may select an SSB/CSI-RS, from the configured SSBs/CSI-RSs of the target base station, with a RSRP value greater than a RSRP threshold configured for the RA procedure. The wireless device 2401 may determine a RACH occasion (e.g., time domain resources, etc.) associated with the selected SSB/CSI-RS and determine the preamble associated with the selected SSB/CSI-RS.

A target base station may receive the preamble sent (e.g., transmitted) from the wireless device 2401. The target base station may send (e.g., transmit) an RAR 2409 to the wireless device 2401. The RAR may correspond to the preamble sent (e.g., transmitted) by the wireless device 2401. The RAR may further comprise a TAC MAC CE (e.g., for indicating the TA value of the target cell) to be used for uplink transmission via the target cell. Based on (e.g., in response to) receiving the RAR corresponding to (or comprising) the preamble sent (e.g., transmitted) by the wireless device 2401 on/via the target cell, the wireless device 2401 may successfully complete the random access procedure. Based on (e.g., in response to) successfully completing the random access procedure, the wireless device 2401 may stop the handover timer (T304). The wireless device 2401 may, after completing the random access procedure, send (e.g., transmit) an RRC reconfiguration complete message 2410 to the target base station. In some implementations, wireless device 2401 may, before completing the random access procedure, send (e.g., transmit) the RRC reconfiguration complete message to the target base station. The wireless device 2401, after completing the random access procedure towards the target base station, may use first parts of CQI reporting configuration, SR configuration and/or SRS configuration that do not require the wireless device 2401 to know a system frame number (SFN) of the target base station. The wireless device 2401, after completing the random access procedure towards the target PCell, may use second parts of measurement and radio resource configuration that require the wireless device 2401 to know the SFN of the target base station (e.g., measurement gaps, periodic CQI reporting, SR configuration, SRS configuration), upon acquiring the SFN of the target base station.

A RRC reconfiguration message (e.g., RRCReconfiguration-IEs) may indicate information for measurement configuration, mobility control, radio resource configuration (including RBs, MAC main configuration and physical channel configuration) and AS security configuration. The RRC reconfiguration message may comprise a configuration of a master cell group (masterCellGroup). The master cell group may be associated with a SpCell (SpCellConfig). If the SpCellConfig comprises a reconfiguration with Sync (reconfiguration WithSync), the wireless device 2401 may determine that the SpCell is a target PCell for the HO. The reconfiguration with sync (reconfiguration WithSync) may comprise cell common parameters (spCellConfigCommon) of the target PCell, a RNTI (newUE-Identity) identifying the wireless device 2401 in the target PCell, a value of the handover timer (e.g., T304), a dedicated RACH resource (rach-ConfigDedicated), etc. In an example, a dedicated RACH resource may comprise one or more RACH occasions, one or more SSBs, one or more CSI-RSs, one or more RA preamble indexes, etc.

Reconfiguration WithSync IE may comprise a dedicated RACH resource indicated by a rach-ConfigDedicated IE. The rach-ConfigDedicated IE may comprise a contention free RA resource indicated by a cfra IE. The cfra IE comprises a plurality of occasions indicated by a rach-ConfigGeneric IE, a ssb-perRACH-Occasion IE, a plurality of resources associated with SSB (indicated by a ssb IE) or CSI-RS (indicated by a csirs IE). The ssb-perRACH-Occasion IE indicates a number of SSBs per RACH occasion. The rach-ConfigGeneric IE indicates configuration of CFRA occasions. The wireless device 2401 may ignore preambleReceivedTargetPower, preambleTransMax, powerRampingStep, ra-ResponseWindow signaled within this field and use the corresponding values provided in RACH-ConfigCommon.

Resources (resources IE) comprise the ssb IE, for example, if the plurality of resources for the CFRA configured in the reconfiguration WithSync IE are associated with SSBs. The ssb IE comprises a list of CFRA SSB resources (ssb-ResourceList) and an indication of PRACH occasion mask index (ra-ssb-OccasionMaskIndex). Each of the list of CFRA SSB resources comprises a SSB index, a RA preamble index and etc. The ra-ssb-OccasionMaskIndex indicates a PRACH mask index for RA resource selection. The mask is valid for all SSB resources signaled in ssb-ResourceList.

Resources (resources IE) comprise the csirs IE, for example, if the plurality of resources for the CFRA configured in the reconfiguration WithSync IE are associated with CSI-RSs. The csirs IE comprises a list of CFRA CSI-RS resources (csirs-ResourceList) and a RSRP threshold (rsrp-ThresholdCSI-RS). Each of the list of CFRA CSI-RS resources comprises a CSI-RS index, a list of RA occasions (ra-OccasionList), a RA preamble index and etc.

Executing the handover triggered by receiving the RRC reconfiguration message comprising a reconfiguration WithSync IE may introduce handover latency (e.g., too-late handover), for example, if a wireless device 2401 is moving in a network deployed with multiple small cells (e.g., with hundreds of meters of cell coverage of a cell) and/or in a non-terrestrial network (NTN) with LEO satellites/HAPS. An improved handover mechanism, based on measurement event triggering, is proposed to reduce the handover latency (e.g., via CHO).

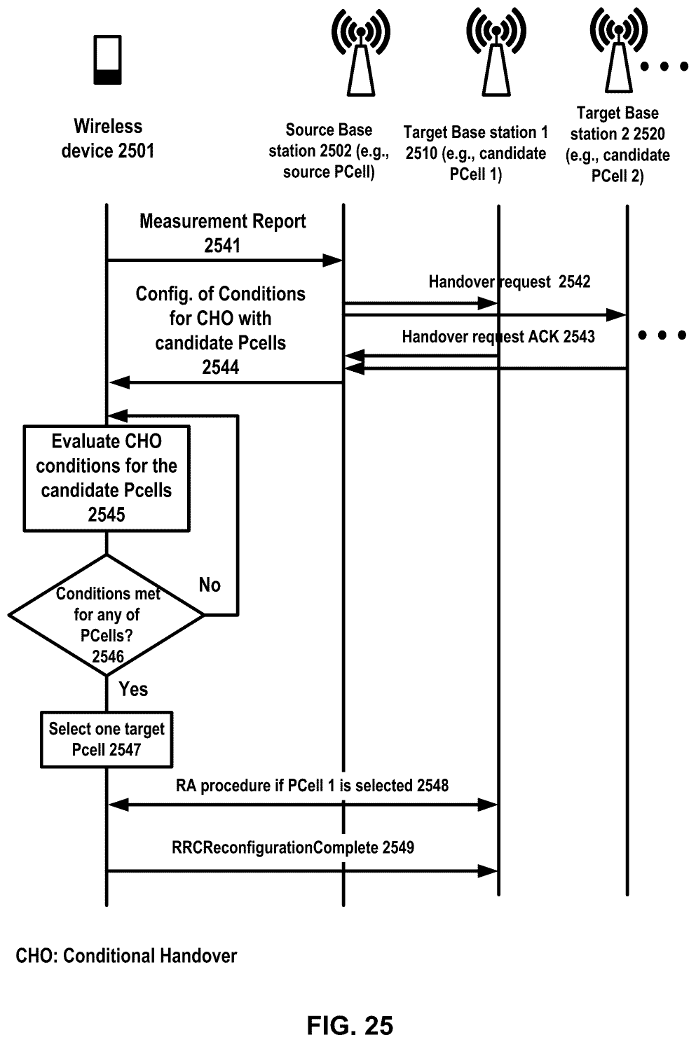

FIG. 25 shows an example of a conditional handover (CHO) procedure. For example, a network (e.g., a base station, a source base station) may configure a wireless device 2501 (e.g., via the one or more configuration parameters), for example, to perform measurement reporting (e.g., the configuration of measurement gaps) for a plurality of neighbor/candidate cells (e.g., cells from a candidate target base station 1 2510, a candidate target base station 2 2520, etc.). The measurement reporting may be a layer 3 reporting, different from a layer 1 CSI reporting. The wireless device 2501 may send (e.g., transmit) one or more measurement reports 2541 to the source base station 2502 (or source PCell).

As described with respect to FIG. 25, based on the one or more measurement reports 2541 from the wireless device 2501, the source base station 2502 may provide the target base station (e.g., target base station 1 2510 and/or target base station 2 2520) with a list of best/candidate cells on each frequency for which measurement information is available, for example, in order of decreasing RSRP. The source base station 2502 may also include available measurement information for the cells provided in the list. The target base station (e.g., target base station 1 2510 and/or target base station 2 2520) may decide which cells are configured for use after the CHO, which may include cells other than the ones indicated by the source base station. For example, the source base station 2502 may send (e.g., transmit) a handover request 2542 to the target base station (e.g., target base station 1 2510 and/or target base station 2 2520). The target base station (e.g., target base station 1 2510 and/or target base station 2 2520) may response with a handover message 2543. In an example, in the handover message, the target base station (e.g., target base station 1 2510 and/or target base station 2 2520) may indicate access stratum configuration (e.g., RRC configurations of the target cells) to be used in the target cell(s) for the wireless device 2501. For example, the source base station 2502 may transparently (for example, does not alter values/content) forward the handover (e.g., contained in RRC reconfiguration messages of the target base station (e.g., target base station 1 2510 and/or target base station 2 2520)) message/information received from the target base station (e.g., target base station 1 2510 and/or target base station 2 2520) to the wireless device 2501.

A source base station 2502 may configure a CHO procedure different from a normal HO procedure (e.g., as shown in FIG. 24), by comprising a conditional reconfiguration message (e.g., conditionalReconfiguration IE in the RRC reconfiguration message). The conditional reconfiguration message may comprise a list of candidate target cells (e.g., PCells), each candidate target cell being associated with dedicated RACH resource(s) for the RA procedure in case a CHO is executed to/toward/based on the candidate target cell of the candidate cells. The conditional reconfiguration message 2544 may configure at least one CHO execution condition. For example, a CHO execution condition (or an RRC reconfiguration condition) of at least one CHO execution condition may correspond to a candidate target cell of the candidate target cells. CHO execution condition may be an execution condition that needs to be fulfilled in order to trigger the execution of a conditional reconfiguration for CHO, CPA, intra-SN CPC without MN involvement or MN initiated inter-SN CPC.

A CHO execution condition of the at least one CHO execution condition may comprise at least one of the following: a measurement event DI (e.g., condEventD1) for a candidate cell; and/or a measurement event T1 (e.g., condEventT1) for a candidate cell; and/or a measurement event A3 (e.g., condEventA3) for a candidate cell; and/or a measurement event A4 (e.g., condEventA4) for a candidate cell; and/or a measurement event A5 (e.g., condEventA5) for a candidate cell. A first CHO execution condition (e.g., the measurement event T1) of the at least one CHO execution condition may be a time-based (or time-dependent) event for triggering/executing the (conditional) handover. In some cases, a second CHO execution condition of the at least one CHO execution condition may be a distance-based (or distance-dependent) event for triggering/executing the (conditional) handover. For example, the CHO execution condition 1944 may comprise a measurement event A3 where a candidate target cell becomes amount of offset better than the current cell, a measurement event A4 where a candidate target cell becomes better than absolute threshold configured in the RRC reconfiguration message, a measurement event A5 where the current cell becomes worse than a first absolute threshold and a candidate target cell becomes better than a second absolute threshold, etc.

As described with respect to FIG. 25, the wireless device 2501 may evaluate the (RRC) reconfiguration conditions 2545 for the list of candidate target cells and/or the current/source cell, for example, based on the received RRC reconfiguration messages comprising parameters of a CHO procedure. The wireless device 2501 may measure RSRP/RSRQ of SSBs/CSI-RSs of each candidate target cell of the list of candidate target cell. Different from the normal handover procedure described in FIG. 24, the wireless device 2501 may not execute the handover toward the target cell, for example, based on (e.g., in response to) receiving the RRC reconfiguration messages comprising the parameters of the CHO procedure. The wireless device 2501 may, for performing the CHO procedure, execute the handover to a target cell for the CHO only if the (RRC) reconfiguration condition(s) of the target cell are met (or satisfied). The wireless device 2501 may keep evaluating the reconfiguration conditions 2545 for the list of the candidate target cells, for example, until an expiry of a handover timer, or receiving a RRC reconfiguration indicating an abort of the CHO procedure.

The wireless device 2501 may execute the CHO procedure towards the first candidate target cell, for example, based on (e.g., in response to) a reconfiguration condition of a first candidate target cell (e.g., PCell 1) being met or satisfied. The wireless device 2501 may select one of multiple candidate target cells 2547 by its implementation if the multiple candidate target cells have reconfiguration conditions satisfied or met 2546.

Executing the CHO procedure towards the first candidate target cell may be same as or similar to executing the handover procedure as shown in FIG. 24. By executing the CHO procedure, the wireless device 2501 may release the RRC configuration parameters of the source cell and the MCG associated with the source cell, use the RRC configuration parameters of the PCell 1, reset MAC, perform cell group configuration for the received MCG comprised in the RRC reconfiguration message of the PCell 1, and/or perform RA procedure to the PCell 1 2548, etc.

The MCG of the RRC reconfiguration message of the PCell 1 may be associated with a SpCell (SpCellConfig) on the target base station 1 2510. If the sPCellConfig comprises a reconfiguration with Sync (reconfiguration WithSync), the wireless device 2501 may determine that the SpCell is a target PCell (PCell 1) for the handover. The reconfiguration with sync (reconfigurationWithSync) may comprise cell common parameters (spCellConfigCommon) of the target PCell, a RNTI (newUE-Identity) identifying the wireless device 2501 in the target PCell, a value of T304, a dedicated RACH resource (rach-ConfigDedicated), etc. For example, a dedicated RACH resource may comprise one or more RACH occasions, one or more SSBs, one or more CSI-RSs, one or more RA preamble indexes, etc. In an example, the wireless device 2501 may perform cell group configuration for the received master cell group comprised in the RRC reconfiguration message of the PCell 1 on the target base station 1 2510 as described herein with respect to FIG. 24.

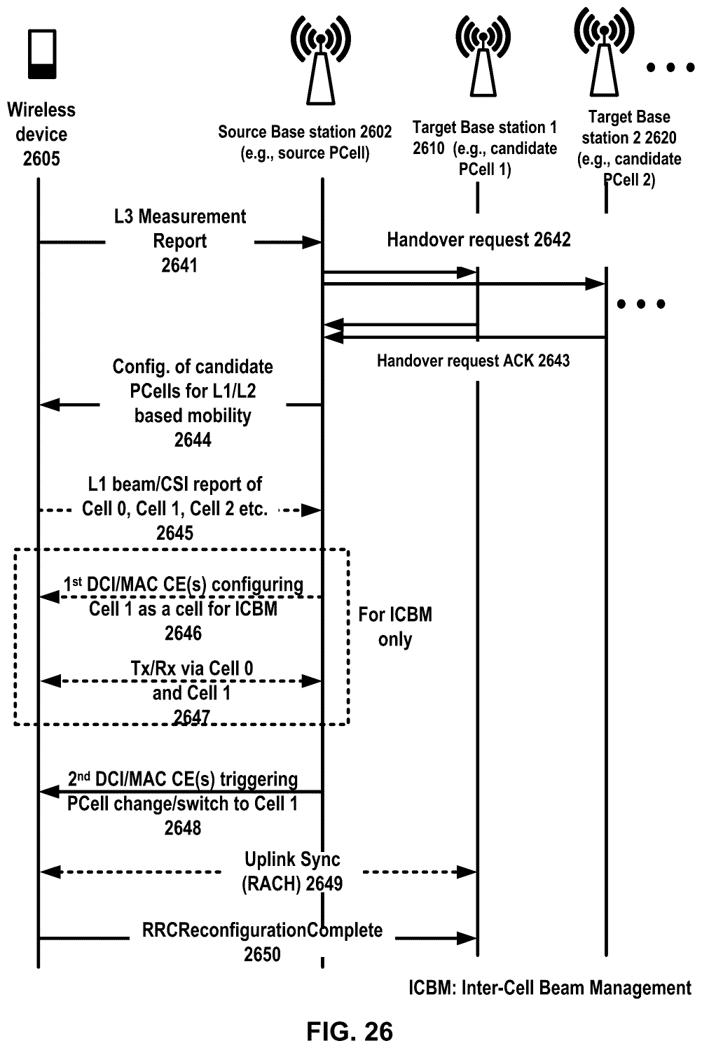

FIG. 26 shows an example of Layer 1/Layer 2 (Layer 1/2) triggered handover method. For example, the network (e.g., a base station, a source base station) may configure the wireless device 2605 to perform the measurement reporting 2641 (e.g., including the configuration of measurement gaps) for a plurality of neighbor/candidate (target) cells (e.g., cells from a candidate target base station 1, a candidate target base station 2, etc.). The wireless device 2605 may send (e.g., transmit) one or more measurement reports 2641 to the source base station (or source PCell, cell 0 in FIG. 26).

As described with respect to FIG. 26, based on the one or more measurement reports 2641 from the wireless device 2605, the source base station 2602 may provide the target base station (e.g., target base station 1 2610 and/or target base station 2 2620) with a list of best/candidate cells on each frequency for which measurement information is available, for example, in order of decreasing RSRP. The source base station 2602 may also include available measurement information for the cells provided in the list. The target base station (e.g., target base station 1 2610 and/or target base station 2 2620) may decide which cells are configured for use (as a target PCell, and/or one or more SCells) after HO, which may include cells other than the ones indicated by the source base station 2602. For example, as shown in FIG. 26, the source base station may send (e.g., transmit) a handover request 2642 to the target base station (e.g., target base station 1 2610 and/or target base station 2 2620). The target base station (e.g., target base station 1 2610 and/or target base station 2 2620) may response with a handover message 2643. In an example, in the handover message, the target base station (e.g., target base station 1 2610 and/or target base station 2 2620) may indicate access stratum configuration (e.g., RRC configurations of the target cells) to be used in the target cell(s) for the wireless device 2605. For example, the source base station may transparently (for example, does not alter values/content) forward the handover (e.g., contained in RRC reconfiguration messages of the target base station, cell group configuration IE of the target base station, and/or SpCell configuration IE of a target PCell/SCells of the target base station (e.g., target base station 1 2610 and/or target base station 2 2620)) message/information received from the target base station (e.g., target base station 1 2610 and/or target base station 2 2620) to the wireless device 2605.

The source base station 2602 may configure a Layer 1/Layer 2 (Layer 1/2) signaling based handover (PCell switching/changing, mobility, etc.) procedure different from a normal handover procedure (e.g., as shown in FIG. 24) and/or a CHO procedure (e.g., as shown in FIG. 25), by comprising a Layer 1/2 candidate cell (e.g., PCell) configuration message (e.g., candidates-L1L2-Config IE) in the one or more configuration parameters (e.g., the RRC reconfiguration message) of the source base station 2602. The Layer 1/2 candidate PCell configuration message 2644 may comprise a list of candidate target PCells, each candidate target PCell being associated with dedicated RACH resources for the RA procedure in case a Layer 1/2 signaling based handover is trigged by a Layer 1/2 signaling and executed to the candidate target PCell, etc. There may be multiple options for parameter configurations of a candidate target PCell.

For example, as a first option for the parameter configuration, for each candidate target PCell, the RRC reconfiguration message of the source base station 2602 may comprise a (capsuled) RRC reconfiguration message (e.g., RRCReconfiguration), of a candidate target base station, received by the source base station 2602 from a candidate target base station via X2/Xn interface. The (capsuled) RRC reconfiguration message, of the candidate target base station, may reuse the same signaling structure of the RRC reconfiguration message of the source base station, as shown in FIG. 24.

For example, as a second option for the parameter configuration, for each candidate target PCell, the RRC reconfiguration message of the source base station 2602 may comprise a (capsuled) cell group configuration message (e.g., CellGroupConfig), of a candidate target base station, received by the source base station 2602 from a candidate target base station via X2/Xn interface. The (capsuled) cell group configuration message, of the candidate target base station, may reuse the same signaling structure of the cell group configuration message of the source base station, as shown in FIG. 24. The second option may reduce signaling overhead of the parameter configuration of a candidate target PCell compared with the first option.

For example, as a third option for the parameter configuration, for each candidate target PCell, the RRC reconfiguration message of the source base station 2602 may comprise a (capsuled) SpCell configuration message (e.g., SpCellConfig), of a candidate target base station, received by the source base station 2602 from a candidate target base station via X2/Xn interface. The (capsuled) SpCell configuration message, of the candidate target base station, may reuse the same signaling structure of the SpCell configuration message of the source base station 2602, as shown in FIG. 18. The third option may reduce signaling overhead of the parameter configuration of a candidate target PCell compared with the second option.

For example, for each candidate target PCell, the source base station 2602 may indicate cell common and/or wireless device specific parameters (e.g., SSBs/CSI-RSs, BWPs, RACH resources, PDCCH/PDSCH/PUCCH/PUSCH resources etc.).

The wireless device 2605, according to the received RRC reconfiguration messages comprising parameters of a Layer 1/2 signaling based handover procedure, may perform Layer 1/2 measurement report (CSI/beam) for the list of candidate target PCells and/or the current PCell. The layer 1/2 measurement report may comprise layer 1 RSRP, layer 1 RSRQ, PMI, RI, layer 1 SINR, CQI, etc. In an example, the layer 1/2 measurement report 2645 may be sent (e.g., transmitted) with a periodicity configured by the source base station 2602. The layer 1/2 measurement report may be triggered if the measurement of the CSI/beam of a candidate target PCell is greater than a threshold, or (amount of offset) greater than the current PCell, etc.

As described with respect to FIG. 26, the base station may perform an inter-cell beam management (ICBM) procedure before sending (e.g., transmitting) a Layer 1/2 signaling triggering the handover procedure comprising switching PCell from the source base station 2602 to a target base station. The ICBM procedure may allow the base station and the wireless device to use resources (time/frequency/spatial) of the target base station (or a PCell/SCell of the target base station) without executing handover procedure to the target base station, therefore reducing frequently executing the handover procedure. The ICBM procedure may allow the base station and the wireless device to synchronize time/frequency/beam to a target PCell of the target base station before executing the HO, which may reduce handover latency. The ICBM may be implemented based on examples of FIG. 26 which will be described later.

Based on (e.g., in response to) the ICBM procedure being configured, the source base station 2602 may send (e.g., transmit) to the wireless device a first DCI/MAC CE 2646 configuring/indicating a first candidate target cell (e.g., Cell 1) of the candidate target cells (PCells/SCells) as a neighbor or non-serving cell, in addition to the current PCell (e.g., Cell 0), for the wireless device. The base station may select the first candidate target cell from the candidate target cells, based on layer 1/2 measurement report from the wireless device.

The first DCI/MAC CE (e.g., activating TCI states) may indicate that a reference RS (e.g., SSB/CSI-RS) associated with a first TCI state is from the first candidate target cell (Cell 1) (e.g., by associating the reference RS with an additional PCI, of Cell1, different from a PCI of the Cell 0), in addition to a reference RS associated with a second TCI state being from the current PCell (Cell 0). Activating, by a DCI/MAC CE, a TCI state with a RS of a neighbor (non-serving) cell as a reference RS, may allow the base station to use a beam of the neighbor cell to send (e.g., transmit) downlink signals/channels or to receive uplink signals/channels, and/or use a beam of the current cell for the transmissions/receptions, without performing handover to the neighbor cell for the transmissions/receptions. The wireless device 2605, based on (e.g., in response to) receiving the first DCI/MAC CE 2646, may use the first TCI state and the second TCI state for downlink reception and/or uplink transmission.

Using the first TCI state and the second TCI state for downlink reception may comprise: receiving (from Cell 1) PDCCH/PDSCH/CSI-RS with a reception beam/filter same as that for receiving the reference signal, sent (e.g., transmitted) from Cell 1, according to (or associated with) the first TCI state, and receiving (from cell 0) PDCCH/PDSCH/CSI-RS with a reception beam/filter same as that for receiving the reference signal, sent (e.g., transmitted) from Cell 0, according to (or associated with) the second TCI state.

Using the first TCI state and the second TCI state for uplink transmission may comprise: sending (e.g., transmitting) (via Cell 1) PUCCH/PUSCH/SRS with a transmission beam/filter same as that for receiving the reference signal, sent (e.g., transmitted) from Cell 1, according to (or associated with) the first TCI state, and sending (e.g., transmitting) (via cell 0) PUCCH/PUSCH/SRS with a transmission beam/filter same as that for receiving the reference signal, sent (e.g., transmitted) from Cell 0, according to (or associated with) the second TCI state.

The base station may skip performing the ICBM procedure before sending (e.g., transmitting) the Layer 1/2 signaling triggering the handover procedure. The base station may skip performing the ICBM procedure, for example, if beamforming is not used in the target PCell, or if there is no good SSB(s) from the target PCell, or if there are no available radio resources from the target PCell to accommodate the wireless device 2605, or if the wireless device 2605 may not support ICBM and/or if the base station does not support ICBM.

The source base station 2602 may determine to handover the wireless device 2605 from the source base station (Cell 0) to the target base station (Cell 1). The source base station may determine the handover based on a load/traffic condition, a CSI/beam report of the target base station, a location/trajectory of the wireless device 2605, a network energy saving strategy (e.g., the source base station determines to turn of the Cell 0 and/or one or more SCells for power saving), etc. The source base station 2602 may send (e.g., transmit) a second DCI/MAC CE 2648 indicating a PCell changing from the current PCell (Cell 0) to a new cell (e.g., Cell 1).

The new cell may be one of the neighboring (non-serving) cells used in the ICBM procedure (e.g., indicated by the first DCI/MAC CE). The new cell may be cell 1 in the example of FIG. 26. If the ICBM procedure is supported and/or configured, the wireless device 2605, before executing handover procedure indicated by the source base station, has already synchronized with the target base station regarding which beam should be used for transmission/reception via the target base station, which is different from layer 3 signaling based handover/CHO where the wireless device 2605 may need to synchronize to the target base station upon executing the handover/CHO and then obtains an indication of a new beam to be used for the target base station.

The new cell may be one of a plurality of neighbor (non-serving) cells comprised in L1 beam/CSI report, for example, with the best measurement report, with the distance closest to the wireless device 2605, etc., if the ICBM procedure is not configured/supported/indicated/activated for the new cell. The wireless device 2605 may change the PCell from cell 0 to cell 1, for example, based on (e.g., in response to) receiving the second DCI/MAC CE. The wireless device 2605 may use the (stored/received) RRC parameters (comprised in RRCReconfiguration, CellGroupConfig, and/or SpCellConfig IE) of the target PCell (cell 1) as the current PCell.

The wireless device 2605 may skip downlink (time/frequency/beam) synchronization (e.g., monitoring MIB/SSB/SIBs and/or selecting an SSB as a reference for downlink reception and/or uplink transmission) in case the wireless device 2605 has already synchronized with the target PCell based on the ICBM procedure, for example, if the ICBM may be configured/supported/indicated/activated before receiving the 2nd DCI/MAC CE. The wireless device 2605 may skip performing RA procedure towards the target PCell before sending (e.g., transmitting) to and/or receiving from the target PCell, for example, if the target PCell is close to the source PCell, or the uplink TA is same or similar for the source PCell and the target PCell, or the dedicated RACH resource is not configured in the RRC reconfiguration message of the target PCell. The wireless device 2605 may perform downlink synchronization (SSB/PBCH/SIBs monitoring) and/or uplink synchronization (RA procedure) for the layer 1/2 signaling based handover (e.g., if ICBM is not configured/indicated/supported/activated) as it does for layer 3 signaling based handover/CHO based on examples described herein with respect to FIG. 24, FIG. 25, and/or FIG. 26. The wireless device 2605, after receiving a handover command (e.g., RRC reconfiguration with a Reconfiguration WithSync IE), performs downlink synchronization and uplink synchronization, beam alignment/management via a target cell. Performing downlink synchronization, uplink synchronization and/or beam alignment may be time consuming (e.g., increase the handover latency or reduce RRC_connected mobility efficiency). To reduce handover latency, especially the latency introduced for uplink synchronization, the wireless device may perform an early TA acquisition scheme.

FIG. 27 shows an example of early TA acquisition (or ETA)-based handover procedure. For example, as shown in FIG. 27, the network (e.g., a base station, a source base station) may configure the wireless device 2705 to perform layer 3 (L3) measurement reporting 2741, which may include the configuration of measurement gaps, for a plurality of neighbor cells (e.g., Cell 1 from a candidate target base station 1, Cell 2 from a candidate target base station 2, etc.). For example, the source base station 2702 may configure (e.g., via the one or more configuration parameters) the Layer 1/2 signaling based handover (PCell switching/changing, mobility, layer 1/2 triggered mobility, LTM, etc.) procedure for the wireless device 2705 (e.g., as described with respect to the FIG. 26).

Cell 0, Cell 1 and/or Cell 2 may belong to a same gNB-DU, in which case, Cell 1 and/or Cell 2 may be configured as a part of Cell 0 which is a serving cell. The radio resources (PDCCH, PDSCH etc.) of Cell 0 are shared with Cell 1 and/or Cell 2. Cell 1 and/or Cell 2 may send (e.g., transmit) SSBs different from SSBs sent (e.g., transmitted) via Cell 0. Cell 0, Cell 1 and/or Cell 2 may belong to different gNB-DUs (which are associated with a same gNB-CU or associated with different gNB-CUs), in which case, Cell 1 and/or Cell 2 may be configured as separate cells (non-serving cell) from Cell 0. The radio resources (PDCCH, PDSCH etc.) of Cell 0 are not shared with Cell 1 and/or Cell 2. Cell 1 and/or Cell 2 may send (e.g., transmit) SSBs different from SSBs sent (e.g., transmitted) via Cell 0.

The wireless device 2705 may perform Layer 1/2 measurement report (CSI/beam) for the list of candidate target PCells and/or the current PCell. For example, the RRC configuration messages, comprising configuration parameters of L1/2 measurements for one or more candidate cells, may be the same as the RRC messages used for L3 measurement configuration or be the same as the RRC configuration messages for the candidate PCell configuration. For example, the RRC configuration messages, comprising configuration parameters of L1/2 measurements for one or more candidate cells, may be separate and/or independent from the RRC configuration messages for the candidate PCell configuration. The RRC configuration messages (e.g., the one or more RRC configuration messages), comprising the configuration parameters of L1/2 measurements, may be the same as a RRC message configuring a serving cell (Cell 0 as shown in FIG. 27), which may comprise L1/2 measurement configurations of the serving cell.

The L1/2 measurement configuration of the serving cell may comprise a plurality of SSB resource sets (CSI-SSB-ResourceSets) for CSI (CQI/PMI/RI/L1-RSRP/L1-SINR etc.) measurements. A CSI-SSB-ResourceSet is identified by a CSI-SSB-Resource set identifier (ID) and comprises a list of SSB indexes, each SSB index being associated with a ServingAdditionalPCIIndex indicating a physical cell ID of the SSB, among multiple SSBs associated with the ServingAdditionalPCIInex. If a value of the ServingAdditionalPCIIndex is zero, the PCI of the SSB index is the PCI of the serving cell (e.g., Cell 0). If a value of the ServingAdditionalPCIIndex is not zero, the ServingAdditionalPCIIndex indicates an additionalPCIIndex of an SSB-MTC-AdditionalPCI configured using the additionalPCI-ToAddModList in ServingCellConfig, and the PCI is the additionalPCI (e.g., PCI of Cell 1, PCI of Cell 2, etc.) in the SSB-MTC-AdditionalPCI. A PCI of a cell is a cell identifier uniquely identifying the cell in a wireless communication system. In an example, a CSI-SSB-Resource set of Cell 0 may indicate SSB 0 from Cell 0, SSB 1 from Cell 1, SSB 2 from Cell 2, etc.

The wireless device 2705 may measure CSI 2746 (e.g., CQI/PMI/L1-RSRP/L1-RSRQ/L1-SINR) of each SSB of the SSBs configured in the CSI-SSB-ResourceSet of Cell 0, wherein each SSB may be from different cells (or different PCIs), for example, based on the L1/2 measurement configurations of the serving cell (Cell 0). For example, if a CSI-SSB-ResourceSet of Cell 0 indicates SSB 0 from Cell 0, SSB 1 from Cell 1, SSB 2 from Cell 2, etc., the wireless device may measure SSB 0 from Cell 0, SSB 1 from Cell 1 and SSB 2 from Cell 2 for the L1/2 CSI/beam measurement for the LTM procedure. The wireless device 2705 may trigger a layer 1/2 measurement report, for example, based on the measuring CSI of each SSB of the SSBs configured in the CSI-SSB-ResourceSet of Cell 0. The triggering the layer 1/2 measurement report may be based on a triggering indication of the base station and/or a triggering event occurring at the wireless device.

The layer 1/2 measurement report may be triggered by a measurement event, for example, if the measurement of the CSI of a candidate target PCell (e.g., Cell 1, Cell 2 etc.) is greater than a threshold, or (amount of offset) greater than the current PCell (Cell 0), etc. The layer 1/2 measurement report may be triggered by receiving a triggering indication (e.g., a DCI or a MAC CE) indicating to report the layer 1/2 measurement of one or more candidate target PCell (e.g., Cell 1, Cell 2, etc.). Based on (e.g., in response to) receiving the triggering indication, the wireless device may (after performing the L1/2 measurement) send (e.g., transmit) the layer 1/2 measurement report indicating whether at least one candidate target PCell has better CSI measurement than the current PCell. Based on (e.g., in response to) no candidate target PCell having better CSI measurement than the current PCell after receiving the triggering indication, the wireless device may skip sending (e.g., transmitting) the layer 1/2 measurement of candidate target PCell (Cell 1, Cell 2, etc.) or may send (e.g., transmit) only layer 1/2 CSI measurement of the serving cell (Cell 0). The layer 1/2 measurement report may be sent (e.g., transmitted) with a periodicity configured by the source base station.

The layer 1/2 measurement report may be contained in a UCI via PUCCH/PUSCH, or a MAC CE (e.g., event-triggered, associated with a configured SR for the transmission of the MAC CE). The layer 1/2 measurement and/or reporting of a candidate target PCell, before actually switching to the candidate target PCell as a serving PCell, may be referred to as an early CSI report for a candidate target PCell, which is different from a CSI report of a serving PCell. Early CSI report for a candidate target PCell, before the wireless device performs a layer 1/2 triggered mobility procedure to switch to the candidate target PCell as the serving PCell, may enable the base station to obtain correct beam information, for example, in terms of which SSB can be used as beam reference for downlink transmission for the candidate target PCell, if later the wireless device switches to the candidate target PCell as the serving PCell, without waiting for beam management after the switching, therefore, improving (handover) latency of the PCell switching.

The wireless device 2705 may determine that Cell 1 has better channel quality (L1-RSRP/L1-SINR/L1-RSRQ, etc.) than Cell 0. The wireless device may send (e.g., transmit) the layer 1/2 measurement report indicating that Cell 1 has better channel quality than Cell 0. The source base station 2702 and/or the target base station may determine which cell is used as the target PCell. The source base station 2702, upon receiving the layer 1/2 measurement report, may coordinate (e.g., 2742 as shown in FIG. 27) with the candidate target base station (e.g., target base station 1 2710 and/or target base station 2 2720) regarding whether Cell 1 could be used as a candidate target PCell for future handover.

The source base station 2702 (e.g., according to the request of the target base station if there is no time alignment obtained before for Cell 1), may send (e.g., transmit), from Cell 0 (or an activated SCell of the wireless device) a first layer 1/2 (e.g., 1st L1/2) command (e.g., a DCI/MAC CE/RRC message comprising PDCCH order as shown in FIG. 27) triggering a preamble transmission (RACH, or other uplink signals like SRS) towards Cell 1 2748, for example, if determining Cell 1 is used as the target PCell for future handover. The DCI may be based on a PDCCH order in at least some technology.

The wireless device 2705, based on receiving the first layer 1/2 command, may send (e.g., transmit) the preamble 2749 (or SRS which is not shown in FIG. 27) to the target PCell (Cell 1). The target base station may monitor PRACH occasion for receiving the preamble to estimate the TA 2751 used for future uplink transmission from the wireless device after the wireless device switches the PCell from Cell 0 to Cell 1. The target base station may send (e.g., forward) the estimated TA for Cell 1 to the source base station 2702 2752.

The source base station 2702 may send (e.g., transmit) the sent (e.g., forwarded) TA to the wireless device 2705 2753 (e.g., via a RAR message, or via a TAC MA CE). The wireless device 2705 may monitor PDCCH (on Cell 0) for receiving the RAR message based on at least some technologies (e.g., based on examples as described herein with respect to FIG. 13A, FIG. 13B and/or FIG. 13C). The wireless device 2705 may maintain a TAT for a TAG associated with Cell 1. The wireless device 2705 may maintain Cell 1 as a non-serving cell. The TAC MAC CE may indicate (e.g., one or more bitfields of the MAC CE) whether the TAC is for a serving cell (or a TAG associated with the serving cell) or for a non-serving cell (e.g., Cell 1). The source base station 2702 may skip sending (e.g., transmitting) the forwarded TA to the wireless device. Instead, the source base station may indicate the TA together with a second layer 1/2 command indicating/triggering PCell switching from Cell 0 to Cell 1. In this case, the wireless device may skip monitoring PDCCH (on Cell 0) for receiving the RAR message.

The transmission of a preamble to a candidate target PCell, before receiving a (P) Cell switch command (with or without comprising a TA estimated by the target base station for the target PCell) indicating to switch the PCell to the target PCell, is referred to as an early TA acquisition (ETA) procedure/process/feature/scheme in this specification. By implementing the ETA, before the wireless device performs the handover, the target base station may obtain the TA to be used by the wireless device after performing the handover to the target PCell. The TA for the target PCell may be sent (e.g., transmitted) in a RAR or combined together with the L1/2 (or L1/L2) command indicating the PCell switching. The ETA procedure may reduce the latency for uplink synchronization with the target PCell upon performing handover procedure (or PCell switching procedure).

The wireless device 2705 may receive a second L1/2 command (e.g., MAC CE as shown in FIG. 27) indicating the PCell switching from Cell 0 to Cell 1. The second L1/2 command may further indicate the TA (forwarded from the target base station to the source base station and used for the target PCell in future), for example, if the TA is not received before receiving the second L1/2 command. The second L1/2 command may further indicate a beam information (a TCI state and/or a SSB index, which may be obtained in the early CSI report as described herein) to be used for downlink reception and/or uplink transmission over Cell 1. Based on (e.g., in response to) receiving the second L1/2 command, the wireless device 2705 may switch the PCell from Cell 0 to Cell 1 and send (e.g., transmit) PUSCH/PUCCH via Cell 1 based on the TA. The wireless device 2705 may receive downlink signals and send (e.g., transmit) uplink signals based on the indicated beam information. Switching the PCell from Cell 0 to Cell 1 may comprise at least one of: using RRC configuration parameters of Cell 1, stopping using RRC configuration parameters of Cell 0, resetting/reconfiguring MAC entity, receiving RRC messages/MIB/SSBs/SIBs/PDCCHs/PDSCHs from Cell 1 and stopping receiving RRC messages/MIB/SSBs/SIBs/PDCCHs/PDSCHs from Cell 0. A PCell switch procedure based on a L1/2 command (e.g., combined with an early CSI report and/or an ETA procedure) may be referred to as a L1/2 triggered mobility (LTM) procedure, based on examples as described herein with respect to FIG. 26 and/or FIG. 27.

The one or more RRC configuration parameters may comprise a RRC message of a serving cell (e.g., ServingCellConfig IE) comprising configuration parameters of layer 1/2 measurements (e.g., csi-MeasConfig IE) and layer 3 measurements (e.g., servingCellMO IE). A csi-MeasConfig IE may indicate a list of non-zero power CSI-RS resource (e.g., nzp-CSI-RS-ResourceToAddModList), a list of non-zero power CSI-RS resource sets (e.g., nzp-CSI-RS-ResourceSetToAddModList), a list of SSB resource sets (e.g., csi-SSB-ResourceSetToAddList), a list of CSI resource configurations (e.g., csi-ResourceConfigToAddList), a list of CSI report configurations (e.g., csi-ReportConfigToAddList) and etc. A non-zero power CSI resource (e.g., NZP-CSI-RS-Resource) is identified by an NZP-CSI-RS-ResourceId and configured with a periodicity and offset parameter (CSI-ResourcePeriodicityAndOffset) and a QCL configuration (e.g., TCI-stateId), etc. A CSI-RS resource may be implemented based on examples as described herein with respect to FIG. 11B. A non-zero power CSI resource set is identified by an NZP-CSI-RS-ResourceSetId and comprise a list of non-zero power CSI-RS resources.

A csi-SSB-ResourceSet is identified by a CSI-SSB-ResourceSetId and comprises a list of SSB indexes, each SSB index being associated with a respective ServingAdditionalPCIIndex of a list of additional PCIs (servingAdditionalPCIList). The servingAdditionalPCIList indicates the physical cell IDs (PCIs) of the SSBs in the csi-SSB-ResourceList. If the servingAdditionalPCIList is present in the csi-SSB-ResourceSet, the list has the same number of entries as csi-SSB-ResourceList. The first entry of the list indicates the value of the PCI for the first entry of csi-SSB-ResourceList, the second entry of this list indicates the value of the PCI for the second entry of csi-SSB-ResourceList, and so on. In an example, for each entry of the servingAdditionalPCIList, if the value is zero, the PCI is the PCI of the serving cell in which this CSI-SSB-ResourceSet is defined, otherwise, the value is additional PCIIndex-r17 of an SSB-MTC-AdditionalPCI-r17 configured using the additionalPCI-ToAddModList-r17 in ServingCellConfig, and the PCI is the additionalPCI-r17 in this SSB-MTC-AdditionalPCI-r17.

The one or more configuration parameters may configure/comprise, for each CSI resource configuration (CSI-ResourceConfig) identified by CSI-ResourceConfigId, a list of CSI-RS resource sets (csi-RS-ResourceSetList) comprising a list of non-zero power CSI-RS resource sets (nzp-CS-RS-ResourceSetList) and/or a list of csi-SSB-ResourceSets (csi-SSB-ResourceSetList) for CSI measurement, or comprising a list of csi-IM-Resource sets (csi-IM-ResourceSetList) for interference measurements, for example, based on the list of NZP-CSI-RS-ResourceSets and the list of csi-SSB-ResourceSets. Each CSI resource of a CSI resource configuration is located in the DL BWP identified by the higher layer parameter BWP-id of the CSI resource configuration, and all CSI Resource lists linked to a CSI Report Setting have the same DL BWP.

The one or more configuration parameters may configure/comprise, for each CSI report configuration (CSI-ReportConfig) identified by a CSI report configuration identifier (e.g., CSI-ReportConfigId), a serving cell index indicating in which serving cell the CSI-ResourceConfig are to be found (if the field is absent, the resources are on the same serving cell as this report configuration), a CSI-ResourceConfigId indicating CSI resources for channel measurement, a report type indication indicating whether the CSI report is periodic, semi-persistent CSI report on PUCCH, semi-persistent CSI report on PUSCH, or aperiodic, a report quantity indication indicating a report quantity (e.g., CRI-RSRP, SSB-index-RSRP, etc.) (wherein SSB-index-RSRP is referred to as layer 1 RSRP (L1-RSRP) in this specification), a time domain restriction indication for channel measurements (timeRestrictionForChannelMeasurements), etc. A semi-persistent CSI report on PUCCH may be triggered by a SP CSI activation/deactivation MAC CE. A semi-persistent CSI report on PUSCH may be triggered by a DCI with CRC being scrambled by SP-CSI-RNTI. An aperiodic CSI report may be indicated by a DCI scheduling a PUSCH transmission and comprising an aperiodic CSI request field.

The wireless device 2705 may measure and/and send (e.g., transmit) CSI report, for example, to the source base station 2702, for example, based on the configurations of CSI measurement and reports (e.g., via the one or more RRC configuration messages). For beam measurements, the wireless device 2705 may send (e.g., transmit) L1-RSRP report to the source base station 2702.

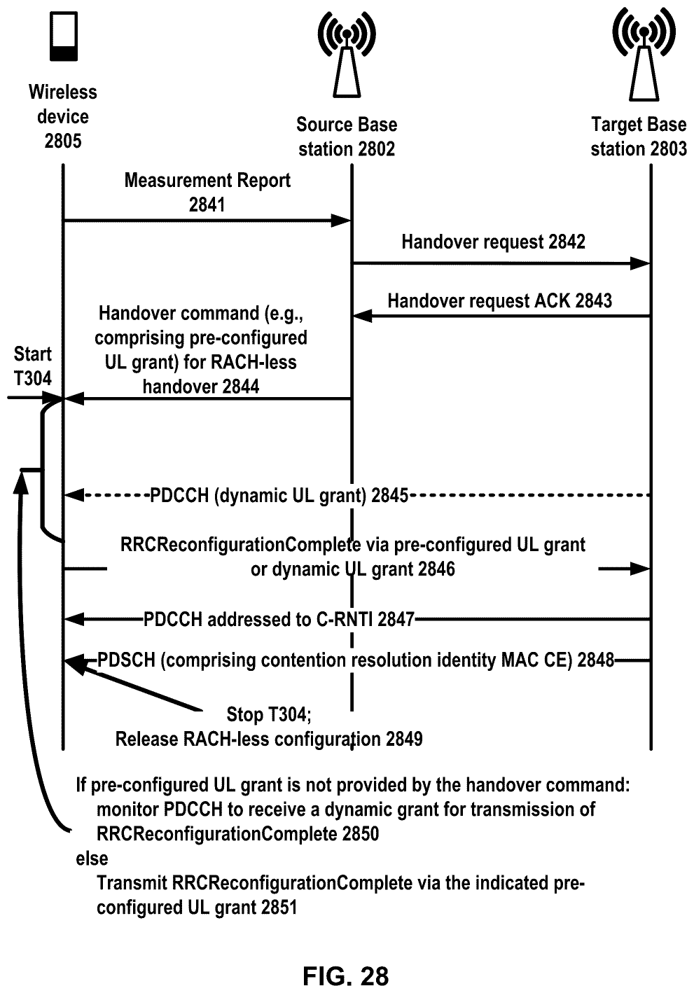

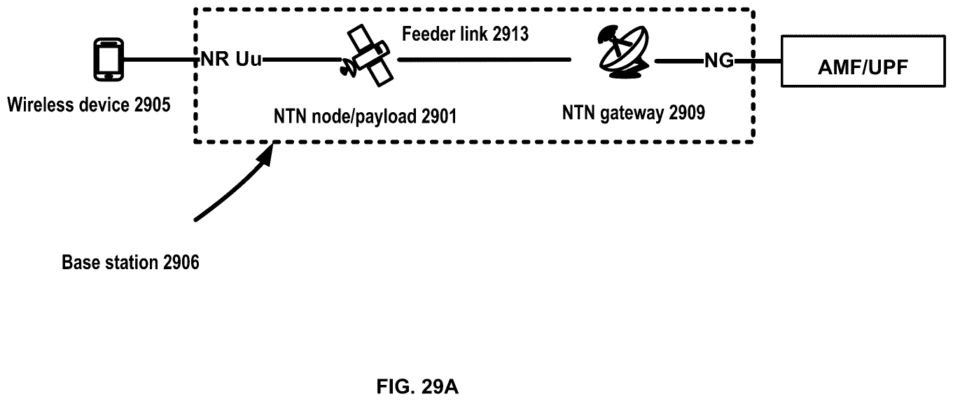

FIG. 28 shows an example of a RACH-less handover method. The wireless device 2805 may switch from a source base station 2802 (e.g., source cell) (e.g., via which the RRC reconfiguration message may be received) to a target base station 2803 (e.g., target cell), for example, without performing a RA procedure (e.g., without triggering/initiating the RA procedure and/or without sending (e.g., transmitting) a preamble on the target base station 2803 (e.g., target cell). The one or more configuration parameters may comprise configurations for skipping/avoiding RACH (e.g., rach-skip IE and/or rach-skipSCG IE), for example, parameters of RACH-less handover. Based on the one or more configuration parameters comprising the configurations for skipping/avoiding RACH, the wireless device 2805 may perform the handover without triggering/initiating (or performing the RA procedure).

The wireless device 2805 may perform RACH-less handover procedure. For example, the handover command may comprise one or more resources (e.g., pre-configured/configured/pre-allocated UL grant(s), e.g., Type1/2 configurated grants) for sending (e.g., transmitting) the RRC reconfiguration complete message on/via the target cell. The pre-allocated uplink grant may comprise periodic UL resource(s) (e.g., a periodic pre-allocated/pre-configured UL grant). The pre-allocated uplink grant may comprise semi-persistent UL resource(s) (e.g., a semi-persistent pre-allocated/pre-configured UL grant). As described herein, the “pre-configured UL grant” and/or “configured UL grant” and/or “pre-allocated UL grant” and/or “UL grant” may be used interchangeably.

The wireless device 2805 may, via the RACH-less handover procedure, reduce the handover latency and/or signaling overhead. For example, the RACH-less handover procedure may be different than the normal handover procedure of FIG. 24. The wireless device 2805 may perform the RACH-less handover procedure, for example, based on receiving the handover command 2844 (see FIG. 28) from the source base station 2802. Similar to examples of FIG. 24, FIG. 25, FIG. 26, and/or FIG. 27, the wireless device 2805 may report the one or more measurements to the source base station 2802 2841, for example, prior to receiving the handover command/RRC reconfiguration message 2844 from the source base station 2802. The wireless device 2805 may start the handover timer (T304), for example, based on (e.g., in response to) receiving the handover command 2844.

The handover command 2844 may not comprise the configured UL grant(s) for the transmission of the RRC reconfiguration complete message on/via the target cell. The wireless device 2805 may start monitoring the PDCCH (e.g., based on the RRC reconfiguration message and/or the one or more configuration parameters) for receiving dynamic UL grant(s) 2845 from the target base station 2803 (e.g., target cell). For example, the target base station 2803 (e.g., target cell) may send (e.g., transmit) one or more DCIs indicating the dynamic UL grant(s)/PUSCHs.

The wireless device 2805 may, from the target base station 2803 (e.g., via/on the target cell), receive a PDCCH addressed to a C-RNTI 2847 of the wireless device 2805, for example, based on (e.g., in response to) sending/transmitting the RRC reconfiguration complete message 2846. For example, the C-RNTI may be indicated (e.g., by the base station) via the handover command (e.g., RRC reconfiguration message). The PDCCH addressed to the C-RNTI may schedule/indicate a PDSCH transmission from the target base station (and/or the target cell). The PDSCH transmission may comprise a contention resolution identity MAC CE. The wireless device 2805 may ignore the contention resolution identity MAC CE, for example, if the wireless device may be configured with parameters of RACH-less handover (e.g., rach-skip IE and/or the rach-skipSCG IE).

The wireless device 2805 may stop a T304 timer and/or release the rach-skip IE (and/or the rach-skipSCG IE) (e.g., releasing RACH-less configurations), for example, based on (e.g., in response to) receiving the PDCCH addressed to the C-RNTI 2847 from the target base station 2803 (e.g., via/on the target cell). For example, based on (e.g., in response to) receiving the PDCCH addressed to the C-RNTI 2847 from the target base station 2803 (e.g., via/on the target cell), the wireless device 2805 may determine the RACH-less handover procedure being successfully completed. The wireless device 2805 may, based on (e.g., after/in response to) receiving the PDCCH addressed to the C-RNTI 2847 from the target base station 2803 (e.g., via/on the target cell), use first parts of CQI reporting configuration, SR configuration, and/or SRS configuration that may not require the wireless device 2805 to know a system frame number (SFN) of the target base station 2803. The wireless device 2805 may, based on (e.g., after/in response to) receiving the PDCCH addressed to the C-RNTI 2847 from the target base station 2803 (e.g., via/on the target cell), may use second parts of measurement and radio resource configuration that may require the wireless device 2805 to know the SFN of the target base station 2803 (e.g., measurement gaps, periodic CQI reporting, SR configuration, SRS configuration), upon acquiring the SFN of the target base station 2803.

The handover command may indicate a target TA value corresponding to the target base station 2803 (e.g., target cell) allowing the wireless device 2805 to acquire UL synchronization with the target base station 2803 (e.g., target cell), for example, without sending (e.g., transmitting) a preamble to the target base station 2803. The wireless device 2805 may use the target TA value of the target base station 2803 (e.g., target cell) for the transmission of a first PUSCH (e.g., via the configured UL grant or the dynamic UL grant) on/via the target cell.

The one or more configuration parameters (e.g., the handover command and/or the RRC reconfiguration message) may allow the wireless device 2805 to communicate (e.g., transmit/receive) with the source base station 2802 (e.g., source cell), for example, after receiving the handover command and before receiving the dynamic UL grant(s) (and/or before sending (e.g., transmitting) the RRC reconfiguration complete message on/via the target base station 2803 (e.g., target cell).

A non-terrestrial network (NTN) network (e.g., a satellite network) may be a network or network segment (e.g., an NG-RAN consisting of base stations) for providing non-terrestrial NR access to wireless devices. The NTN may use a space-borne vehicle to embark a transmission equipment relay node (e.g., radio remote unit or a transparent payload) or a base station (or a regenerative payload). An NTN may be a network which uses an NTN node (e.g., a satellite) as an access network, a backhaul interface network, or both, for example, if a terrestrial network is a network located on the surface of the earth. In an example, an NTN may comprise one or more NTN nodes (or payloads and/or space-borne vehicles), each of which may provide connectivity functions, between the service link and the feeder link. As shown in FIG. 23B, a base station may, via the service link, send (e.g., transmit) broadcast signals (e.g., SIBx, x=1, 2, . . . , 19, . . . ), multicast signals, and/or dedicated signals to wireless devices, e.g., in a cell.

An NTN node may embark a bent pipe payload (e.g., a transparent payload) or a regenerative payload. The NTN node with the transparent payload may comprise transmitter/receiver circuitries without the capability of on-board digital signal processing (e.g., modulation and/or coding) and connect to a base station (e.g., a base station of an NTN or the NTN base station or a non-terrestrial access point) via a feeder link.

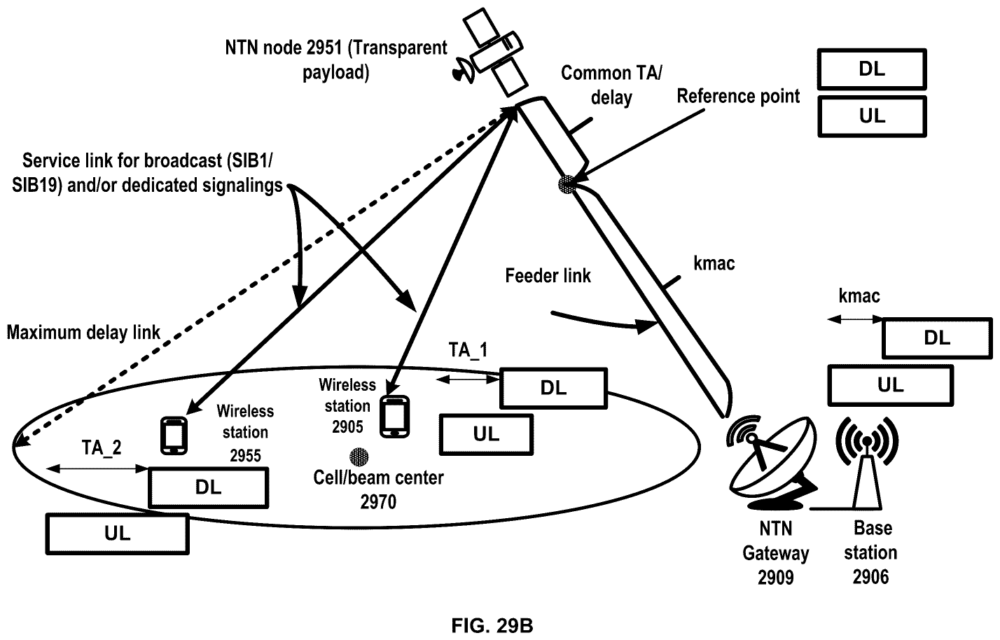

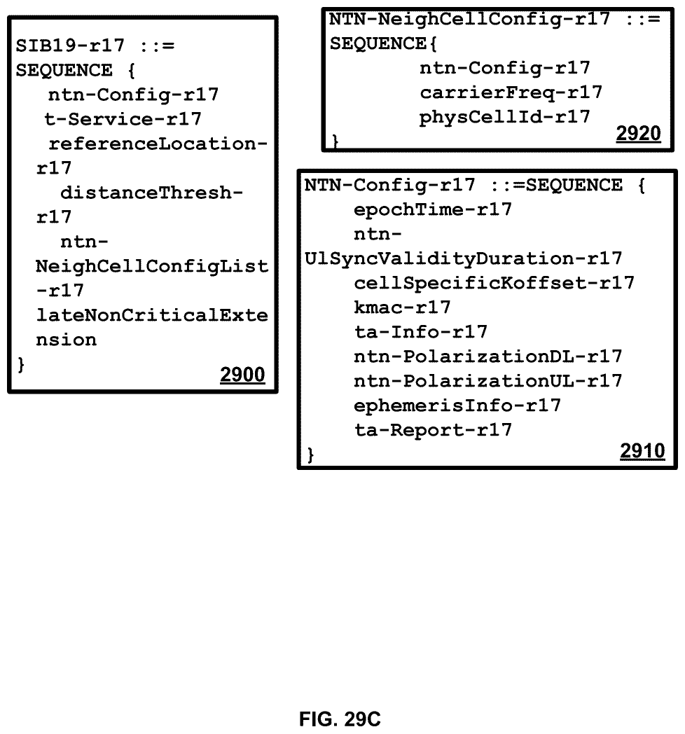

FIG. 29A shows an example non-terrestrial network (NTN). As described with respect to FIG. 29A, a base station 2906 (e.g., base station or eNB) may comprise a transparent NTN node/payload 2901, a feeder link 2913, and/or a gateway (e.g., an NTN gateway 2909). The gateway (e.g., NTN gateway 2039) may be an earth station that may be located at the surface of the earth, providing connectivity to the NTN node/payload 2901 using the feeder link 2913. The NTN node/payload 2901 with a regenerative payload (e.g., a base station of the NTN or an NTN base station) may comprise functionalities of a base station, for example, the on-board processing used to demodulate and decode the received signal and/or regenerate the signal before sending (e.g., transmitting) it back to the earth. The base station 2906 (e.g., base station) may comprise a regenerative NTN node/payload, a feeder link 2913, and/or a gateway (e.g., the NTN gateway 2909).

The NTN node/payload 2901 may be a satellite, a balloon, an air ship, an airplane, an unmanned aircraft system (UAS), an unmanned aerial vehicle (UAV), a drone, or the like. The UAS may be a blimp, a high-altitude platform station (HAPS), for example, an airborne vehicle embarking the NTN payload placed at an altitude between 8 and 50 km, or a pseudo satellite station. In an example, a satellite may be placed into a low-earth orbit (LEO) at an altitude between 250 km to 1500 km, with orbital periods ranging from 90-130 minutes. From the perspective of a given point on the surface of the earth, the position of the LEO satellite may change. In an example, a satellite may be placed into a medium-earth orbit (MEO) at an altitude between 5000 to 20000 km, with orbital periods ranging from 2 hours to 14 hours. In an example, a satellite may be placed into a geostationary satellite earth orbit (GEO) at 35,786 km altitude, and directly above the equator. From the perspective of a given point on the surface of the earth, the position of the GEO satellite may not change.

FIG. 29B shows an example of an NTN with a transparent NTN node/payload. As shown in FIG. 29B, the NTN node 2951 (e.g., the satellite) may forward a received signal from the NTN gateway 2909 on the ground back to the earth over the feeder link. For example, the NTN gateway 2909 and the base station 2906 may not be collocated. The NTN node 2951 may forward a received signal to the wireless device 2905 or the base station 2906 from another NTN node, for example, over inter-link satellite communication links.

The NTN node 2951 may generate one or more beams over a given area (e.g., a coverage area or a cell). The footprint of a beam (or the cell) may be referred to as a spotbeam. For example, the footprint of a cell/beam may move over the Earth's surface with the satellite movement (e.g., a LEO with moving cells or a HAPS with moving cells). The footprint of a cell/beam may be Earth fixed (e.g., quasi-earth-fixed) with some beam pointing mechanism used by the satellite to compensate for its motion (e.g., a LEO with earth fixed cells). The size of a spotbeam (e.g., diameter of the spotbeam and/or cell and/or coverage area) may range from tens of kilometers (e.g., 50 km-200 km) to a few thousand kilometers (e.g., 3500 km). For example, the size of the spotbeam may depend on the system design.

A propagation delay may be an amount of time it takes for the head of the signal to travel from a sender (e.g., the base station or the NTN node 2951) to a receiver (e.g., the wireless device) or vice versa. The propagation delay may vary depending on a change in distance between the sender and the receiver, for example, due to movement of the NTN node 2951, movement of the wireless device, a change of an inter-satellite link, and/or feeder link switching. One-way latency/delay may be an amount of time required to propagate through a telecommunication system from the sender (e.g., the base station) to the receiver (e.g., the wireless device). For the transparent NTN, the round-trip propagation delay (RTD or UE-gNB RTT) may comprise service link delay (e.g., between the NTN node and the wireless device), feeder link delay (e.g., between the NTN gateway and the NTN node 2951), and/or between the gateway and the base station (e.g., in the case the gateway and the NTN base station are not collocated). For example, the UE-gNB RTT (or the RTD) may be twice of the one-way delay between the wireless device and the base station. In case of a GEO satellite with the transparent payload, the RTD may be approximately 556 milliseconds. A (maximum) RTD of a LEO satellite with the transparent payload and altitude of 600 km is approximately 25.77 milliseconds and with altitude of 1200 km is approximately 41.77 milliseconds. In an example, the RTD of a terrestrial network (e.g., NR, E-UTRA, LTE) may be negligible compared to the RTD of an NTN example (e.g., the RTD of a terrestrial network may be less than 1 millisecond).

A differential delay within a beam/cell of a NTN node 2951 may depend on, for example, the maximum diameter of the beam/cell footprint at nadir. For example, the differential delay within the beam/cell may correspond to a maximum delay link in FIG. 29B. The differential delay may imply the maximum difference between communication latency that two wireless devices, for example, a first wireless device (e.g., wireless device 2905) that is located close to the center of the cell/beam and a second wireless device (e.g., wireless device 2955) that may be located close to the edge of the cell/beam as shown in FIG. 29B, may experience while communicating with the base station 2906 via the NTN node 2951. The first wireless device 2905 may experience a smaller RTD compared to the second wireless device 2955. The link with a maximum propagation delay (e.g., the maximum delay link) may experience the highest propagation delay (or the maximum RTD) in the cell/beam. The differential delay may imply a difference between the maximum delay of the cell/beam and a minimum delay of the cell/beam. The service link to a cell/beam center 2970 may experience the minimum propagation delay in the cell/beam. Depending on implementation, for a LEO satellite, the differential delay may be at least 3.12 milliseconds and may increase up to 8 milliseconds. In an example of a GEO satellite, depending on implementation, the differential delay may be as large as 32 milliseconds.

FIG. 29C shows as an example of NTN assistance information. The base station may send (e.g., transmit) to the wireless device the NTN assistance information via an NTN-specific SIB (e.g., SIB19) 2900. The NTN assistance information may comprise a first set of NTN configuration parameters. For example, the first set of NTN configuration parameters may comprise at least one NTN-config (e.g., ntn-config-r17 2920). The at least one NTN-config may correspond to the serving cell of the NTN and/or a non-serving cell of the NTN (e.g., a target cell or a neighbor cell). Each NTN-config (e.g., ntn-Config 2920) of the at least one NTN-config may correspond to a cell (e.g., the serving cell or a neighbor cell of the NTN) with a corresponding physical cell ID (PCI).

The first set of NTN configuration parameters, as shown in FIG. 29C, may comprise NTN-configs of one or more NTN neighbor cells (e.g., via ntn-NeighCellConfigList IE) 2910. Each NTN neighbor cell of the one or more NTN neighbor cells may have its unique PCI. For example, the at least one NTN-config may comprise the one or more NTN neighbor cells.

One or more configuration parameters may comprise common configuration parameters of the serving cell (e.g., IE ServingCellConfigCommon). For example, the serving cell may belong to the NTN. The wireless device may communicate with the base station via the serving cell (of the NTN). The Serving cell may be a first cell (or a source cell) with/identified by a first PCI and/or neighbor cell (or a candidate cell or a target cell or a second cell) with/identified by a second PCI. The base station may send (e.g., transmit) to the wireless device the common configuration parameters of the serving cell via a system broadcast information (e.g., SIB1). The base station may send (e.g., transmit) the common configuration parameters of the serving cell via one or more RRC messages (e.g., RRC setup message, RRC establishment message, RRC re-establishment message, and/or RRC reconfiguration message). The base station may send (e.g., transmit) the common configuration parameters of the serving cell at/in/during the initial access procedure and/or the handover procedure (e.g., similar to examples of FIGS. 24-28 as described herein). The common configuration parameters of the serving cell may comprise an NTN-config (e.g., ntn-Config-r17, e.g., corresponding to the serving cell with the first PCI) of the at least one NTN-config.

A first set of NTN configuration parameters may comprise the NTN-config of the common configuration parameters of the serving cell (e.g., a first NTN configuration parameters). The first NTN configuration parameters (e.g., a first NTN-config of the at least one NTN-config) may correspond to the first PCI or the first cell (e.g., the source cell). The NTN-config of the common configuration parameters of the serving cell may correspond to the source cell, for example, if the common configuration parameters of the serving cell correspond to the RRC setup message (and/or the RRC establishment message and/or RRC re-establishment message).

NTN-config of the common configuration parameters of the serving cell may correspond to the target cell (e.g., a second NTN configuration parameters e.g., a second NTN-config, of the at least one NTN-config), for example, if the common configuration parameters of the serving cell correspond to the RRC reconfiguration message. The second NTN configuration parameters (e.g., the second NTN-config of the at least one NTN-config) may correspond to the second PCI or the second cell (e.g., the target cell).

At least one NTN-config may comprise the first NTN-config and/or the second NTN-config. In an example, the NTN assistance information may comprise the first NTN-config and/or the second NTN-config.

Each/an NTN-config of the at least one NTN-config (e.g., NTN-config-r17 2920), as shown in FIG. 29C, may comprise at least one of the following (or a combination of thereof): corresponding ephemeris parameters (or data/information) of an NTN node (e.g., the satellite ephemeris data, e.g., ephemerisInfo); and/or one or more common delay/TA parameters (e.g., ta-Info), for example, comprising at least one of TACommon, TACommonDrift, TACommonDrift Variation, and/or a cell-specific scheduling offset (e.g., cellSpecificKoffset or Koffset, e.g., K_{cell,offset}) in number of slots for a given subcarrier spacing (e.g., μ_{Koffset}), for example, 15 KHz; and/or MAC-layer scheduling offset (e.g., k_{mac} or kmac or K-Mac or K-mac) in number of slots for a given subcarrier spacing (e.g., μ_{Kmac}), for example, 15 KHz, indicating a portion of a feeder link delay that the base station may pre-compensate, for example, if UL/DL configurations are not aligned at the base station (see, FIG. 29B); and/or epoch time for using the NTN-config (e.g., epochTime); and/or a validity duration of the NTN-config (e.g., ntn-UISync ValidityDuration) indicating a maximum duration (e.g., in seconds) that the NTN-config stays valid (e.g., a maximum duration that the wireless device stays UL synchronized with the serving cell without (re-)acquiring/reading the SIB19 of the serving cell); and/or one or more antenna polarization mode(s) (e.g., vertical horizontal, right-hand circular, or left-hand circular) for UL/DL communications (e.g., ntn-PolarizationUL/ntn-PolarizationDL); and/or a first indication/parameter (e.g., ta-Report-r17).

MAC-layer scheduling offset may be 0, for example, if the K-Mac is absent from (is not indicated/configured by) the NTN config of the serving cell. For example, the K-Mac, in an NTN example with the transparent NTN node, may be absent from the NTN-config of the serving cell, for example, if the UL frame and the DL frame are aligned at the base station. The K-Mac may indicate a scheduling offset, for example, if downlink and uplink frame timing are not aligned at the base station. The wireless device may use the K-Mac (if indicated) for determining action and assumption on downlink configuration indicated by a MAC CE command in PDSCH.

K-Mac may be a scheduling offset for application of downlink configurations, of the serving cell in the NTN, indicated by MAC CE command(s). The Network (e.g., the base station) may indicate the K-Mac in the NTN for MAC CE timing relationships enhancement. An example of MAC CE timing relationships enhancement may comprise the following (e.g., as specified in NR specification 3GPP TS 38.300):

The wireless device action and assumption on the downlink configuration shall be used starting from the first slot that is after slot n+3Nₛₗₒₜ^{subframe,μ}+2^{μ}·k_{mac}, where μ is the SCS configuration for the PUCCH, for example, if a wireless device is provided with a k_{mac} value and the wireless device would send (e.g., transmit) a PUCCH with HARQ-ACK information in uplink slot n corresponding to a PDSCH carrying a MAC CE command on a downlink configuration.

Transmissions from different wireless devices in a cell/beam (e.g., the first wireless device and the second wireless device in FIG. 29B) may need to be time-aligned at the base station and/or the NTN node (e.g., satellite) to maintain uplink orthogonality in the serving cell. The cell may be the serving cell. Time alignment/synchronization may be achieved by using different timing advance (TA) values at different wireless devices to compensate for their different propagation delays (or RTDs). As shown in FIG. 29B, for UL transmissions, the first wireless device may use the first TA value (e.g., TA_1) and the second wireless device may use the second TA value (TA_2).

A wireless device (e.g., the first wireless device or the second wireless device) may estimate/determine/measure a (current or a latest) TA value based on the at least one NTN-config. The wireless device, in communication via the first cell, may estimate/determine/measure a (current or a latest) TA value based on the first NTN-config. The wireless device, in communication via the first cell, may estimate/determine/measure a (current or a latest) TA value based on the second NTN-config.

A wireless device may calculate/measure/maintain the current (or latest available) TA (value) of the wireless device T_{TA} (e.g., corresponding to a TAG ID or a primary TAG or a secondary TAG) based on at least a combination of a closed-loop TA value (or a closed-loop TA procedure/control) and/or an open-loop TA value (or an open-loop TA procedure/control). A combination of the closed-loop TA control and the open-loop TA control may be based on adding/summing the open-loop TA value (e.g., derived/calculated based on the open-loop TA procedure/control) and the closed-loop TA value (or a portion of the closed-loop TA procedure/control). The current TA value of the first wireless device may be TA_1 and the current TA value of the second wireless device may be TA_2. The closed-loop TA procedure/control may be based on receiving at least one (absolute) TA command (TAC) MAC CE indicating a TA value (e.g., TA corresponding to the TAG ID, e.g., the primary TAG or the secondary TAG) from the base station (e.g., via Msg2 1312 and/or MsgB 1332 and/or a PDSCH). The TA value may indicate an adjustment of the closed-loop TA value (e.g., N_{TA}).

A timing advance command (e.g., the TAC MAC CE) of the at least one TA command may be a TA command of a random access response. The TA command may be an absolute timing advance command MAC CE. The TA command may indicate a value T_{A} for a TAG T_{A}=0, 1, 2, . . . , 3846. The wireless device may determine an amount of the time alignment for the TAG with SCS of 2^{μ}·15 kHz based on N_{TA}=T_{A}·16·64/2^{μ}. N_{TA} may be relative to the SCS of the first uplink transmission from the wireless device after the reception of the random access response or the absolute timing advance command MAC CE. The timing advance command (e.g., the TAC MAC CE), T_{A}, for a TAG may indicate adjustment of a current N_{TA} value, N_{TA_old}, to the new N_{TA} value, N_{TA_new}, by index values of T_{A}=0, 1, 2, . . . , 63, where for a SCS of 2^{μ}·15 kHz, N_{TA_new}=N_{TA_old}+(T_{A}−31)·16·64/2^{μ}.

Open-loop TA procedure/control may require a GNSS-acquired position (or location information) of the wireless device and/or the NTN-config of the serving cell (e.g., the first NTN-config or the second NTN-config). The wireless device may measure/determine/estimate a service link delay (e.g., RTT of the service link), and/or measure/determine/estimate a feeder link delay (e.g., RTT of the feeder link) and/or measure/determine/estimate propagation delay between the wireless device and the base station (e.g., UE-gNB RTT of the serving cell). The wireless device may measure/determine/estimate the service link delay and/or measure/determine/estimate the feeder link delay and/or measure/determine/estimate the propagation delay between the wireless device and the base station, for example, based on an implemented orbital predictor/propagator model (e.g., the GNSS-acquired position) and/or the NTN-config of the serving cell, may use the ephemeris data (and/or the GNSS-acquired position) to measure/calculate/maintain movement pattern of the satellite (corresponding to the NTN-config of the serving cell). For example, the wireless device may, based on the GNSS-acquired position and/or the NTN-config of the serving cell, adjust the current TA value (e.g., the TA of the wireless device) via the open-loop TA procedure/control. The open-loop TA procedure/control may comprise determination/estimation calculation of one or more values, for example, N_{TA,adj}^{UE} and/or N_{TA,adj}^{common}. The wireless device may determine the open-loop TA value (corresponding to the serving cell) by summing up/adding the N_{TA,adj}^{common} and N_{TA,adj}^{UE}.

A wireless device may (to determine the TA value of the wireless device) determine/estimate N_{TA,adj}^{UE} may be based on the propagation delay of the service link (e.g., between the wireless device and the NTN node). The wireless device may determine/measure/estimate N_{TA,adj}^{UE} based on the location information of the wireless device (e.g., position and/or GNSS of the wireless device) and the satellite ephemeris data (e.g., the NTN-config) of the serving cell.

A wireless device may (to determine the TA value of the wireless device) determine/estimate N_{TA,adj}^{common} may be a common delay of the cell (e.g., a portion of the feeder link delay that is not pre-compensated by the base station). The wireless device may determine the N_{TA,adj}^{common} based on the one or more common TA parameters (e.g., the NTN-config) of the serving cell.

A wireless device may use the NTN-config of a cell (e.g., the serving cell) the calculate/determinate/measurement/maintain an estimate of the UE-gNB RTT between the wireless device and a base station of the cell. The wireless device may calculate/measure/estimate the UE-gNB RTT (in ms or in number of slots) of the serving cell based on the current TA value and the K-Mac (if indicated by the NTN-config of the serving cell). For example, the UE-gNB RTT may be the summation of the current TA value and K-Mac (based on subcarrier spacing of the 15 KHz). The wireless device may determine/measure the UE-gNB RTT based on the current TA value (of the wireless device), for example, the UE-gNB RTT may be equal to the current TA value, for example, if the K-Mac is 0. The wireless device may maintain/calculate/update the open-loop TA value (or the UE-gNB RTT) over a validity duration of the NTN-config (e.g., T430 timer).

A validity duration may indicate (a maximum/longest) validity period of the (satellite) ephemeris data/information and/or the TA parameters of the NTN-config of the serving cell. For example, the wireless device may start/restart the validity (or validation) duration/timer/window/period (e.g., T430 timer) of the serving cell. The wireless device may start/restart the validity (or validation) duration/timer/window/period of the serving cell, for example, upon or based on (e.g., in response to) acquiring/receiving the NTN-config of the serving cell (e.g., upon reception of the SIB19 and/or upon reception of RRCReconfiguration message for a target cell including reconfigurationWithSync as discussed associated with FIGS. 24-28 above and/or upon conditional reconfiguration execution, for example, if using a stored RRCReconfiguration message for a target cell including reconfigurationWithSync, see, e.g., FIG. 25). The wireless device may start the validity timer based the epoch time indicated by the NTN-config of the serving cell, for example, the wireless device may start the validity timer from a subframe indicated by the epoch time. The wireless device may set an initial value of the T430 timer by ntn-UISync ValidityDuration of the NTN-config of the serving cell. The wireless device may stop the validity timer of the serving cell (e.g., a source cell or first cell) upon reception of the RRCReconfiguration message for the target cell (e.g., a second cell and/or a target serving cell) including reconfigurationWithSync and/or upon conditional reconfiguration execution, for example, if using a stored RRCReconfiguration message for the target cell including reconfigurationWithSync.

A wireless device may stop UL transmissions via the serving cell and flush HARQ buffers. The wireless device may stop the UL transmissions via the serving cell and flush HARQ buffers, for example, based on (e.g., in response to) determining that the validity duration being expired. For example, the wireless device may acquire the SIB19 of the serving cell to receive an update NTN assistance information 2900. The wireless device may receive an update (satellite) ephemeris data/information and/or update common TA parameters. The wireless device may, prior to expiry of the validity duration of the serving cell and to reduce interruption in UL transmissions, (re-) acquire the SIB19 in order to have valid (estimate of) the open-loop TA value of the serving cell (valid TA value). The wireless device may become UL unsynchronized with the base station of the serving cell, for example, for UL communication with the base station via the serving cell, after and/or upon the expiry of the validity duration of the serving cell and if the wireless device is not able to (re-) acquire the SIB19 (of the serving cell).

A base station may send (e.g., transmit) a differential Koffset MAC CE to the wireless device. The differential Koffset MAC CE may indicate a differential Koffset in a number of slots using SCS of 15 kHz. The wireless device may use the differential Koffset (indicated by the differential Koffset MAC CE) for determining transmission timing of UL signals and/or activation/deactivation time of one or more MAC CEs at the wireless device. A wireless device may determine a wireless device-specific scheduling offset K_{UE,offset} based on the differential Koffset (e.g., the wireless device-specific scheduling offset is equal to minus the differential Koffset), for example, if the differential Koffset is indicated. A wireless device may set K_{UE,offset}=0, for example, if the differential Koffset is not indicated. For example, the wireless device may determine K_{offset} based on the cell-specific scheduling offset (e.g., cellSpecificKoffset, e.g., K_{cell,offset}) of the serving cell and the wireless device-specific scheduling offset K_{UE,offset}, for example, K_{offset}=K_{cell,offset}−K_{UE,offset}.

A base station may send (e.g., transmit), to the wireless device, a DCI. The wireless device may receive the DCI at/in/during a reception occasion/time/interval (e.g., a slot/symbol). For example, the DCI may schedule/indicate/trigger a transmission of an uplink signal/channel (e.g., a PUSCH or a PUCCH or a PRACH or an SRS) to the base station via the NTN. The wireless device may send (e.g., transmit) UL data and/or UCI and/or preamble and/or SRS resource via/based on the UL signal to the base station via/at/in/during a transmission occasion/time/interval (e.g., slot/symbol).

DCI may trigger/schedule/indicate a transmission of the PUSCH (e.g., the UL data) and/or the PUCCH (e.g., the UCI, e.g., HARQ-ACK information). The wireless device may use the cell-specific scheduling offset and/or the wireless device-specific scheduling offset to determine the transmission occasion of the PUSCH/PUCCH. For example, the transmission occasion of the PUSCH may be based on

$${K}_{offset} \cdot \frac{{2}^{{μ}_{PUSCH}}}{{2}^{{μ}_{{K}_{offset}}}} ,$$

wherein K_{offset}=K_{cell,offset}−K_{UE,offset} (corresponding to the serving cell). μ_{PUSCH} is the SCS configuration of the PUSCH transmission and μ_{K}_{_{offset}} is the SCS configuration of the Koffset (e.g., μ_{K}_{_{offset}}=0 for 15 kHz or FR1). For example, the transmission occasion of the PUCCH may be based on

$${K}_{offset} \cdot \frac{{2}^{{μ}_{PUCCH}}}{{2}^{{μ}_{{K}_{offset}}}}$$

(corresponding to the serving cell) where μ_{PUCCH} is the SCS configuration of the PUCCH transmission. The wireless device may use/use the current TA value (e.g., based on the closed-loop TA value and/or the open-loop TA value) of the wireless device (corresponding to the serving cell) to send (e.g., transmit) the PUSCH/PUCCH.

The wireless device, for a TAC MAC CE received on uplink slot n, may use/adjust an uplink transmission timing (e.g., for transmission of UL signals) from a beginning/start of uplink slot n+k+1+2^{μ}·K_{offset} where k=┌Nₛₗₒₜ^{subframe,μ}·(N_{T,1}+N_{T,2}+N_{TA,max}+0.5)/T_{sf}┐, N_{T,1} is a time duration in msec of N₁ symbols corresponding to a PDSCH processing time for wireless device processing capability 1 if additional PDSCH DM-RS is configured, where N_{T,2} is a time duration in msec of N₂ symbols corresponding to a PUSCH preparation time for wireless device processing capability 1, N_{TA,max} is a maximum timing advance value in msec that can be provided by a TA command field of 12 bits, Nₛₗₒₜ^{subframe,μ} is the number of slots per subframe, T_{sf} is the subframe duration of 1 msec. N₁ and N₂ are determined with respect to the minimum SCS among the SCSs of all configured UL BWPs for all uplink carriers in the TAG and of all configured DL BWPs for the corresponding downlink carriers. For μ=0, the wireless device assumes N_{1,0}=14. Slot n and Nₛₗₒₜ^{subframe,μ} may be slot determined with respect to the minimum SCS among the SCSs of all configured UL BWPs for all uplink carriers in the TAG. N_{TA,max} is determined with respect to the minimum SCS among the SCSs of all configured UL BWPs for all uplink carriers in the TAG and for all configured initial UL BWPs provided by initialUplinkBWP. The uplink slot n may be a last/final/ending/latest slot among uplink slot(s) overlapping with the slot(s) of PDSCH reception assuming T_{TA}=0, where the PDSCH provides the timing advance command.

DCI may trigger/indicate/order a transmission of the PRACH (e.g., the UL signal may be the ordered PRACH) corresponding to a preamble index. For example, the DCI (e.g., a PDCCH order) may comprise a random access preamble index field indicating a value (e.g., that is not zero) of the preamble index. For the PRACH transmission (e.g., at/in/during/via the transmission occasion) to the base station by the wireless device, triggered by the PDCCH order, a PRACH mask index field of the DCI may indicate the PRACH occasion for the PRACH transmission. The PRACH occasions may be associated with an SS/PBCH block (e.g., SSB) index indicated by the SS/PBCH block index field of the DCI (e.g., the PDCCH order). The wireless device may use the cell-specific scheduling offset (e.g., K_{cell,offset} by cellSpecificKoffset) corresponding to the serving cell to determine the PRACH occasion. For example, the wireless device may determine the PRACH occasion being after slot n+2^{μ}·K_{cell,offset}. n may be the slot of an UL BWP for the PRACH transmission that overlaps with an end of the PDCCH order reception (e.g., assuming TA being 0, e.g., T_{TA}=0). μ may be the SCS configuration for the PRACH transmission. The PDCCH order reception may be received at/in/during the reception occasion.

The wireless device may attempt to detect a DCI format 1_0 with CRC scrambled by a corresponding RA-RNTI at/in/during a RAR window (e.g., ra-Response Window). The wireless device may attempt to detect a DCI format 1_0 with CRC scrambled by a corresponding RA-RNTI at/in/during a RAR window (e.g., ra-Response Window), for example, based on (e.g., in response to) a PRACH transmission (e.g., for performing a 2-step/4-step CFRA/CBRA procedure, e.g., for initial access and/or for beam failure recovery) by a wireless device to the base station (e.g., via the serving cell of the NTN). The PRACH transmission may be indicated by a PDCCH order and/or higher layers (e.g., MAC/RRC layer) of the wireless device. The RAR window may start at a first/initial/earliest symbol of an earliest CORESET the wireless device is configured to receive PDCCH for Type1-PDCCH CSS set. For example, the earliest CORESET may be at least one symbol, after the last/final/ending symbol of a PRACH occasion corresponding to the PRACH transmission. The symbol duration may correspond to an SCS for Type1-PDCCH CSS set.

RAR window (e.g., ra-ResponseWindow or msgB-ResponseWindow) may start after an additional UE-gNB RTT of the serving cell, for example, if communicating with the NTN (e.g., if N_{TA,adj}^{UE} or N_{TA,adj}^{common} is not zero, e.g., if the open-loop TA value of the wireless device is not zero). The wireless device may determine the UE-gNB RTT (e.g., in ms or in number of slots) of the serving cell based on the current TA value (e.g., T_{TA}) (of the serving cell) and/or the K-mac indicated by the NTN-config of the serving cell. The length of the RAR window in number of slots may be based on the SCS for Type1-PDCCH CSS set and is provided/indicated by the one or more configuration parameters (e.g., ra-ResponseWindow).

A wireless device may attempt to detect a DCI format 1_0 with CRC scrambled by a corresponding MsgB-RNTI at/in/during a RAR window (e.g., msgB-Response Window). The wireless device may attempt to detect the DCI format 1_0, for example, based on (e.g., in response to) a transmission of a PRACH and a PUSCH (e.g., for performing a 2-step CFRA/CBRA procedure, e.g., for initial access and/or for beam failure recovery) by the wireless device to the base station (e.g., via the serving cell of the NTN), or to a transmission of only a PRACH if the PRACH preamble is mapped to a valid PUSCH occasion. The PRACH transmission may be indicated by a PDCCH order and/or higher layers (e.g., MAC/RRC layer) of the wireless device. The RAR window may start at a first/initial/earliest symbol of an earliest CORESET the wireless device is configured to receive PDCCH for Type1-PDCCH CSS set. For example, the earliest CORESET may be at least one symbol, after the last/final/ending symbol of a PUSCH occasion corresponding to the PRACH transmission. The symbol duration may correspond to an SCS for Type1-PDCCH CSS set. If communicating with the NTN (e.g., if N_{TA,adj}^{UE} or N_{TA,adj}^{common} is not zero, e.g., if the open-loop TA value of the wireless device is not zero), the RAR window may start after an additional UE-gNB RTT of the serving cell. The wireless device may determine the UE-gNB RTT (e.g., in ms or in number of slots) of the serving cell based on the current TA value (e.g., T_{TA}) of the serving cell and/or the K-mac indicated by the NTN-config of the serving cell. The length of the RAR window in number of slots may be based on the SCS for Type1-PDCCH CSS set and is provided/indicated by the one or more configuration parameters (e.g., msgB-Response Window).

A wireless device, with reference to slots for a PUSCH transmission (e.g., via the serving cell of the NTN) scheduled by a RAR UL grant, may send (e.g., transmit) the PUSCH in slot n+k₂+Δ+2^{μ}·K_{cell,offset}, for example, if a wireless device receives a PDSCH with a RAR message ending in slot n for a corresponding PRACH transmission from the base station, where the k₂ and Δ are provided by NR specification (e.g., 3GPP TS 38.214) and K_{cell,offset} is indicated by cellSpecificKoffset of the serving cell; otherwise, if not provided, K_{cell,offset}=0.

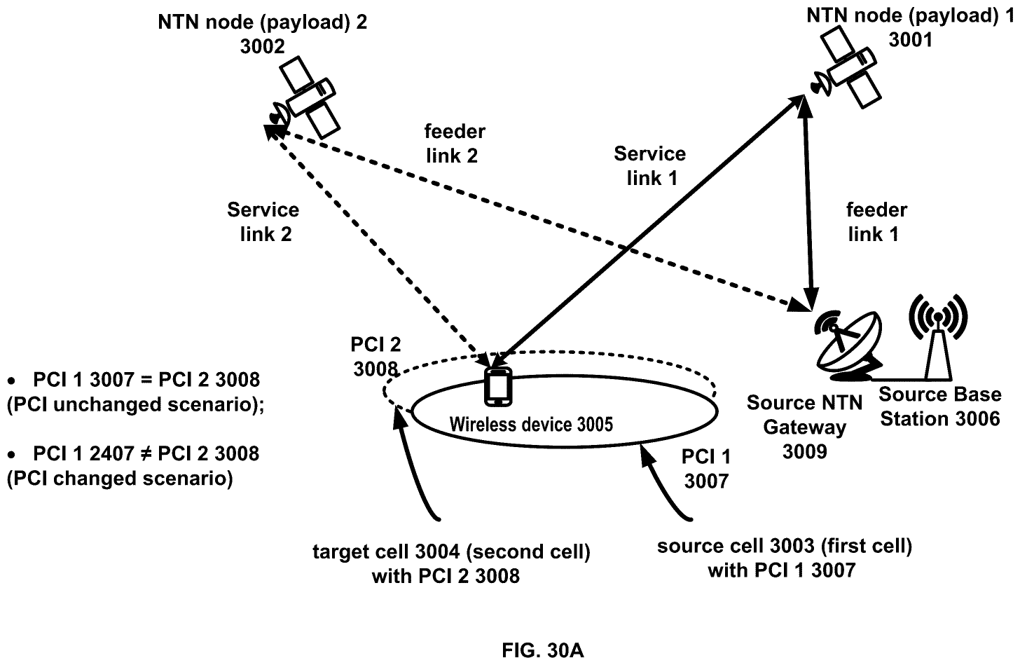

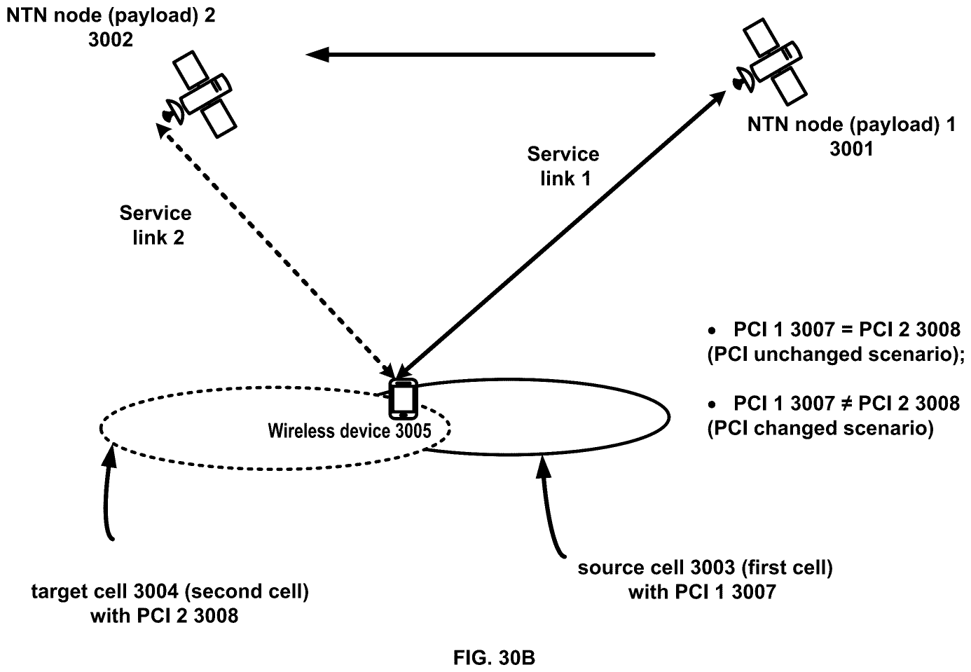

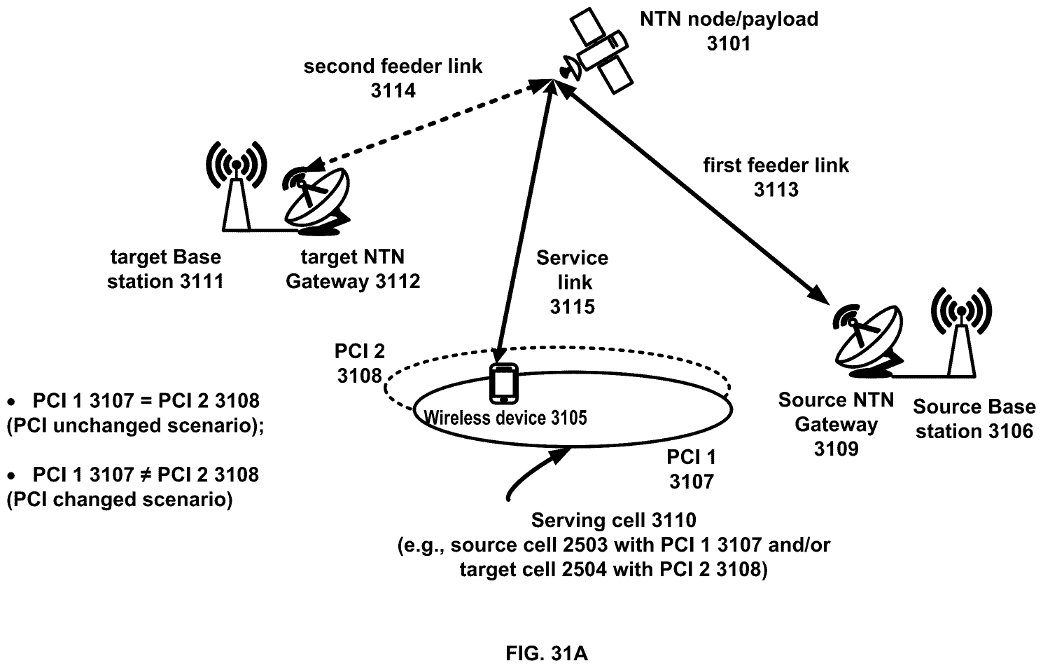

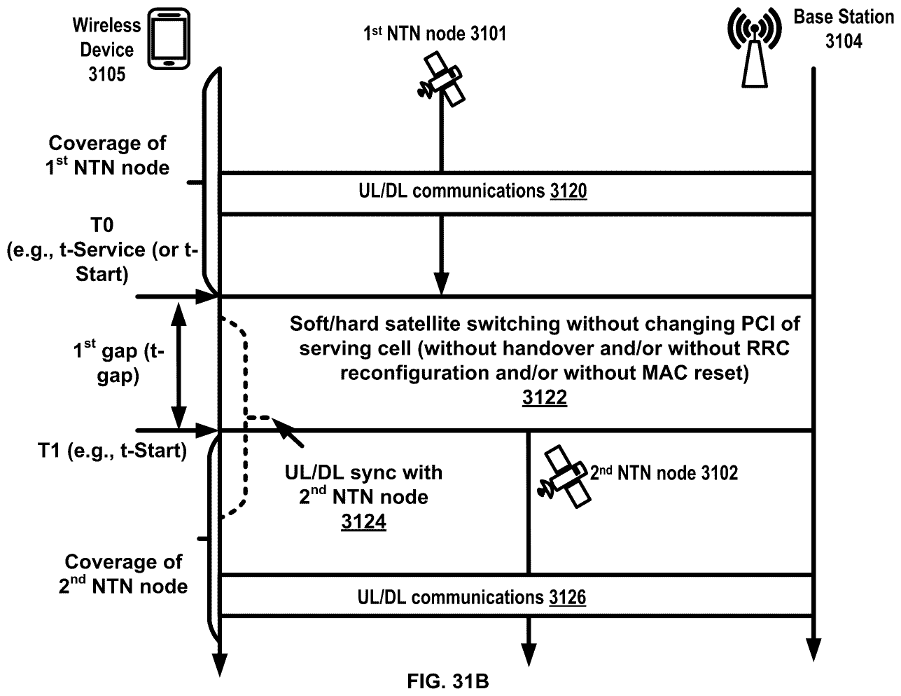

FIG. 30A, FIG. 30B, and FIG. 31A show examples of non-terrestrial networks (NTNs). Examples from FIG. 30A, FIG. 30B, and FIG. 31A may show implementations of handover in an NTN. Examples of FIG. 30A, FIG. 30B, and FIG. 31A may show implementations of a (hard or soft) service link switching/switchover (e.g., with or without handover). Examples of FIG. 30A, FIG. 30B, and FIG. 31A may show implementations a (hard or soft) feeder link switching/switchover (e.g., with or without handover) in the NTN. The source (first) cell and/or the target (second) cell may be quasi-earth-fixed cells. In some other cases, the source cell and/or the target cell may be earth-moving cells.

Examples of FIG. 30A and/or FIG. 31A may correspond to the handover (HO) procedure (or the soft/hard satellite/service link switching/switch/switchover procedure) in an Earth-fixed (or quasi-earth-fixed) example. Examples of FIG. 30B and/or FIG. 31A may correspond to (or applicable for) the handover (HO) procedure (or feeder link switching/switchover/switch procedure) in an Earth-moving example. The handover procedure examples from FIG. 30A, FIG. 30B, and FIG. 31A may be based on examples of FIGS. 24-28 discussed above.

HO procedure may comprise switching from a first (or a source) NTN node/payload (e.g., NTN node 1 3001 in FIG. 30A and/or FIG. 31A) to a second (or a target) NTN node/payload (e.g., NTN node 2 3002 in FIG. 30A and/or FIG. 31A). For example, the first NTN node (and/or the second NTN node) may be a LEO satellite (e.g., a NGEO satellite) or a MEO satellite or a GEO satellite or the like (e.g., HAPS or UAV).

Examples of FIG. 30A, FIG. 30B, and FIG. 31A may correspond to (or applicable for) at least one of the following examples/applications: an intra-satellite handover with the same feeder link (i.e., with same NTN gateway/base station or without NTN gateway/base station switch); or an intra-satellite handover with different feeder links (i.e., with NTN gateway/base station switch); or inter-satellite handover with the NTN gateway/base station switch; or inter-satellite handover without the NTN gateway/base station switch.

A wireless device 3005, in examples of in FIG. 30A and/or FIG. 30B, may, prior to performing the HO procedure (e.g., receiving the HO command via the source cell 3003), communicate (send/transmit/receive) with a source base station 3006 (e.g., of the source cell 3003) via the non-terrestrial network (NTN), for example, the wireless device 3005 and the source base station 3006 may operate in the NTN and/or the source base station 3006 may be an NTN base station and/or the source cell 3003 (e.g., a source serving cell) may be part of the NTN.

A serving cell (e.g., the first cell and/or the second cell) may have a (unique) cell ID/identification/index (e.g., physical cell ID, PCI). The source cell 3003 may correspond to a first PCI (e.g., PCI 1 3007) and the target cell 3004 may correspond to a second PCI (e.g., PCI 2 3008). As shown in FIG. 30A, FIG. 30B, and FIG. 31A, the PCI of the source cell 3003 (e.g., the first PCI, e.g., PCI 1 3007) and the PCI of the target cell 3004 (e.g., the second PCI, e.g., PCI 2 3008) may (depending on NW configuration) be different (e.g., a PCI changed example or a PCI changed HO procedure) or be the same (e.g., PCI unchanged example, e.g., a PCI unchanged HO procedure). The HO procedure may comprise a soft/hard satellite switching procedure with changing PCI of the serving cell soft/hard satellite switching procedure, for example, a first satellite switch method/procedure/scheme/protocol/approach/type.

Cell ID/identification/index of the serving cell may not change as shown in FIG. 30A, FIG. 30B, and FIG. 31A, for example, the source cell 3003 and the target cell 3004 may be the same or have the same PCI (e.g., the PCI unchanged (or fixed) example (or scheme or case or protocol or method), e.g., a second satellite switch method/procedure/scheme/protocol/approach/type). The Cell ID/identification/index of the serving cell may not change as shown in FIG. 30A, FIG. 30B, and FIG. 31A, for example, upon/based on (e.g., in response to) soft/hard satellite switching procedure (e.g., service link switching and/or feeder link switching).

The soft/hard satellite switching procedure, for the PCI unchanged example, may not comprise (executing/triggering/initiating/performing) handover. The soft/hard satellite switching procedure, for the PCI unchanged example, may not comprise (executing/triggering/initiating/performing) RRC reconfiguration procedure, for example, the one or more configuration parameters (configured by the one or more RRC messages) may be valid/applicable for communication with the base station before/during/after the soft/hard satellite switching procedure via both the first NTN node and the second NTN node. The soft/hard satellite switching procedure, for the PCI unchanged example, may not comprise/cause changing state of the wireless device 3005, for example, from RRC connected state or an RRC idle/inactive state. Compared to the HO procedure (e.g., the first satellite switch method), benefit(s) of the second satellite switch method (e.g., satellite switching procedure for switching from the first NTN node to the second NTN node without changing the PCI of the serving cell) may be an enhanced efficiency (no need to the HO message and/or RRC reconfiguration or MAC resetting) and/or lower delay. In an NTN with large cell sizes (larger than 200 km) accommodating many wireless devices (e.g., more than 100 wireless devices, e.g., 1000 wireless devices) reducing signaling by using the second satellite switch type may improve the resource efficiency compared to the first satellite switch method.

The source cell 3003 and the target cell 3004, for handover procedures, as shown in FIG. 30A, FIG. 30B, and FIG. 31A, may have different PCIs (e.g., PCI 1 3007 corresponding to the source cell 3003 and PCI 2 3008 corresponding to the target cell 3004 may not be equal), for example, the PCI changed example. For example, the HO procedure may comprise the RRC reconfiguration procedure and/or the resetting the wireless device (e.g., MAC entity of the wireless device)/base station.

A wireless device 3005 may communicate via the first NTN node with the source base station 3006 (e.g., before the HO or the satellite switching procedure). The first NTN node 3001 may have (or be associated with) a unique identification number. The first NTN node 3001 may correspond to a first ephemeris data/information (e.g., first ephemeris info of a first NTN-config).

A wireless device 3005 may, by performing the HO procedure, communicate with a target base station (e.g., of the target cell 3004 or a second cell) via the non-terrestrial network (NTN), for example, the wireless device 3005 and the target base station may operate in the NTN and/or the target base station may be an NTN base station and/or the target cell 3004 (e.g., a target serving cell) may be part of the NTN. The wireless device 3005 may, for example, switch from the first NTN node 3001 to the second NTN node 3002 for communicating with the target cell 3004 (or the target base station), for example, feeder link switching.

A wireless device 3005 may communicate via the second NTN node with the source/target base station (e.g., after/during the HO or the satellite switching procedure). The second NTN node 3002 may be different than the first NTN node 3001 (e.g., in the HO procedure and/or the satellite switching procedure). For example, the second NTN node 3002 may have (or be associated with) a unique identification number that is different than the identification number of the first NTN node 3001.

A source base station and the target base station may be a same base station (e.g., connecting to the first NTN node 3001 and/or the second NTN node via a same NTN gateway), for example, the intra-satellite handover with the same feeder link or the soft/hard satellite switch. The source base station 3106 and the target base station 3111, in a HO procedure, may not be a same base station (e.g., the source base station 3106 is connecting to the first NTN node via a first NTN gateway and/or the target base station is connecting to the second NTN node via a second NTN gateway), for example, an intra-satellite handover with different feeder links and/or inter-satellite handover with NTN gateway/base station switch.

A wireless device 3105, as shown in FIG. 31A, may communicate (send/transmit/receive) with the source base station 3106 (and/or a source NTN Gateway 3109) on the serving cell 3110 (e.g., the first cell) of the NTN. For example, the communication (or connection) between the wireless device 3105 and the source base station 3106 (and/or the source NTN Gateway 3109) may be via an NTN node/payload 3101 (e.g., the first NTN node or the second NTN node) of the NTN. The communication between the NTN node and the source NTN Gateway 3109 may be through/via a first feeder link 3113. The source NTN Gateway 3109 may be associated (or correspond to or communicate with) the source base station 3106 and/or the first feeder link 3113. The feeder link switchover procedure (e.g., a feeder link switching procedure) may be ongoing/started (e.g., by/at the NTN node 3101), for example, in order to change the feeder link from the first feeder link 3113 to a second feeder link 3114. The NTN node 3101 may switch from the source NTN Gateway 3109 to a target NTN Gateway 3112 (and/or from the source base station 3106 to the target base station 3111). The NTN node 3101 may switch from the source NTN Gateway 3109 to the target NTN Gateway 3112 (and/or from the source base station 3106 to the target base station 3111), for example, based on the feeder link switchover. The second feeder link 3114 may be associated with the target Gateway 3112/base station 3111. The wireless device's communication with the target base station 3111 (and/or the target NTN Gateway 3112) may be through the NTN node 3101 and the second feeder link 3114 (e.g., the NTN node 3101 connects to the target NTN Gateway 3112 and/or the target base station 3111), by performing/terminating the feeder link switchover.

NTN node 3101, for a hard feeder link switchover (compared to a soft feeder link switchover), may connect to only one NTN Gateway at any given time, i.e., a radio link interruption may occur at/in/during the transition between the feeder links (e.g., at/in/during the feeder link switchover procedure). For example, the NTN node 3101, for the hard feeder link switchover, may only connect to the source NTN Gateway 3109 prior to starting the feeder link switchover. The NTN node 3101 may only connect to the target NTN gateway, after finishing/performing the (hard) feeder link switchover. The radio link interruption time/window/duration may correspond for a duration/window for performing the (hard) feeder link switchover at the NTN node 3101 (and/or the network side).

A wireless device 3105 may simultaneously communicate with both the source base station 3106/NTN node 3101 (e.g., on/via a source serving cell, e.g., the source cell) and the target base station 3111/NTN node 3101 (e.g., on/via the target serving cell, e.g., the target cell) at/in/during the soft feeder link switchover procedure (being ongoing). The wireless device 3105 may simultaneously communicate with both the source base station 3106/NTN node 3101 and the target base station 3111/NTN node 3101 at/in/during the soft feeder link switchover procedure (being ongoing), for example, under/based on the soft feeder link switchover procedure. The wireless device 3105 may, under/based on the soft feeder link switchover procedure, simultaneously communicate with either the source base station 3106/NTN node 3101 (e.g., on/via a source serving cell, e.g., the source cell) or the target base station 3111/NTN node 3101 (e.g., on/via the target serving cell, e.g., the target cell) in the soft feeder link switchover procedure (being ongoing).

The service link switchover procedure (e.g., a service link switching procedure or satellite switching procedure) may be for changing the service link from the first service link (corresponding to the first NTN node) to a second service link (corresponding to the second NTN node). For example, based on the service link switchover (and/or the HO procedure), the wireless device 3105 may switch from the first NTN node to the second NTN node. For example, the second NTN node may connect to the source NTN Gateway 3109. The second service link and the first service link both are associated with the same Gateway/base station. The second service link may be associated with the second target Gateway 3112/base station 3111 and the first service link may be associated with the first source Gateway 3109/base station 3106. The wireless device 3105, for a hard service link switchover (compared to a soft service link switchover), may connect to only one NTN node 3101 (e.g., the first NTN node or the second NTN node) at any given time, i.e., a radio link interruption may occur at/in/during the transition between the service links (e.g., at/in/during the service link switchover procedure). The wireless device 3105, in the soft service link switchover, may connect to both NTN nodes simultaneously. Yet, due to limited capabilities and/or reducing complexity, based on NW implementations, at/in/during the soft service link switchover, the wireless device 3105 may be restricted to connect to only one NTN node.

FIG. 31B shows an example of satellite switching procedure for switching from the first NTN node 3101 (satellite) to the second NTN node 3102 (satellite) without handover. FIG. 31B may provide an example of the satellite switching without changing the PCI of the serving cell as discussed above (e.g., the second satellite switch method). For example, the wireless device may be in the RRC connected state (or RRC inactive state).

As shown the first satellite may initially provide (satellite) coverage for the wireless device 3105 (e.g., prior to T0, e.g., t-Service of the first satellite). Prior to T0 the wireless device 3105 may communicate with the base station 3104 (serving cell) via the first satellite 3120. The wireless device 3105, at/in/during a first gap (e.g., a satellite switch/switching/switchover gap or a service link switch/switching/switchover gap), may perform the satellite switching procedure 3122 to disconnect from the first NTN node 3101 and connect to the second NTN node 3102. The first gap may be zero (e.g., electronic beam steering, at/in the Gateway (ground station) and/or the satellite and/or the wireless device 3105), for example, if the one or more configuration parameters does not indicate/configure the t-Start and/or the first gap. The first gap may be non-zero (e.g., mechanical beam steering, e.g., at/in the Gateway and/or the satellite and/or the wireless device 3105). For example, the one or more configuration parameters may indicate/configure a length of the gap (e.g., 80 ms or 100 ms). The length of the first gap may be implicitly determined by the wireless device 3105 based on the t-Service and/or the t-Start (e.g., if the one or more configuration parameters indicate/configure the t-Start).

One or more configuration parameters may configure the first gap. The wireless device 3105 may determine the t-Start based on the first gap and the t-Service.

A first gap may start from TO (t-Service of the first NTN node 3101). The first gap may start from a first time/occasion (e.g., the t-Start/t-start). The one or more configuration parameters may configure/indicate the first time. The first time may be the t-Service of the first NTN node 3101 (e.g., t-Start coincides with the t-Service). The first time may, for example, be different than the t-Service of the first NTN node 3101 (e.g., in time domain t-Start is before/prior to the t-Service or in time domain the t-Start is after the t-Service).

A wireless device 3105, at/in/during the first gap, may not send (e.g., transmit) UL signals (PUCCH/PUSCH/SRS) to the base station 3104 (e.g., via the first NTN node 3101 and/or the second NTN node 3102) and/or receive DL signals (PDCCH/PDSCH/CSI-RS) from the base station 3104 (e.g., via the first NTN node 3101 and/or the second NTN node 3102). The first gap may comprise a duration for the base station/Gateway to switch from the first NTN node 3101 to the second NTN node 3102, for example, at/in/during the first gap no NTN node (e.g., the first NTN node 3101 and/or the second NTN node 3102) may provide coverage for the wireless device 3105. The wireless device 3105 may after an expiry of the first gap start/initiate UL/DL synchronizing with the second NTN node 3102 3124 (e.g., detecting/measuring SSBs sent (e.g., transmitted) via the second NTN node 3102) and/or receiving SIB19/SIB31 (comprising a second NTN configuration parameters associated with the second NTN node 3102) sent (e.g., transmitted) via the second NTN node 3102 and/or UL/DL communications with the base station 3104.

A wireless device 3105 may resume UL transmissions via the second NTN node 3102 of the cell at/in/during the first gap based on obtaining UL/DL synchronization of the second NTN node 3102 of the cell. The wireless device 3105 may resume UL transmissions via the second NTN node 3102 of the cell at/in/during the first gap based on obtaining UL/DL synchronization of the second NTN node 3102 of the cell, for example, to improve efficiency of the satellite switching. The wireless device 3105 may expire/stop the first gap and start/resume/initiate the UL transmissions 3126 via the second NTN node 3102 of the cell, for example, if prior to/before the expiry of the first gap the wireless device 3105 successfully obtains DL synchronization (or obtaining DL timing/frame for DL transmissions via the second NTN node 3102 of the cell) and/or UL synchronization (or obtaining UL timing/frame for UL transmissions via the second NTN node 3102 of the cell) of the cell. The wireless device 3105 may wait for the expiry of the first gap to start/resume/initiate the UL transmissions 3126 via the second NTN node 3102 of the cell, for example, if prior to the expiry of the first gap the wireless device 3105 successfully obtains DL synchronization and/or UL synchronization of the cell.

The wireless device 3105, at/in/during the first gap, may receive DL signals from the base station 3104 (e.g., via the second NTN node 3102). For example, the second NTN node 3102, at/in/during the first gap, may start providing coverage for the wireless device 3105. The wireless device 3105 may prior to the expiry of the first gap start UL/DL synchronizing 3124 with the second NTN node 3102 (e.g., detecting/measuring SSBs sent (e.g., transmitted) via the second NTN node 3102) and/or receiving SIB19/SIB31 sent (e.g., transmitted) via the second/first NTN node 3102/3101. The wireless device 3105 may start UL/DL data transmissions 3126 after the expiry of the first gap.

UL synchronization 3124 with the second NTN node 3102 may comprise receiving the second NTN configuration parameters (e.g., starting/restarting the validity timer of the serving cell) and/or acquiring/determining a second TA value for UL transmission via the second NTN node 3102 (e.g., starting/restarting the time alignment timer of the serving cell). For example, the wireless device 3105, at/in/during the first gap or after the expiry of the first gap, may trigger/initiate a random access (e.g., rach-based satellite switching with PCI unchanged of the serving cell) to complete UL/DL synchronization (e.g., obtaining N_TA) with/toward the second NTN node 3102. The rach-based satellite switching with PCI unchanged of the serving cell may be referred to by as a first scheme, for example, the second satellite switch method comprises (or is based on) the first scheme.

A wireless device 3105, at/in/during the first gap or after the expiry of the first gap, may avoid/skip triggering/initiating the random access (e.g., rach-less/rach-skip satellite switching with PCI unchanged of the serving cell) to complete UL/DL synchronization with/toward the second NTN node 3102. The one or more configuration parameters may indicate/configure pre-configured UL grant(s) for initial/first/earliest PUSCH transmissions to the base station 3104 via the second NTN node 3102, for example, after the expiry of the first gap. For example, the wireless device 3105 may use the N_TA of the serving cell (used prior to the satellite switch for UL transmissions) after the satellite switch for UL transmissions. The rach-less/rach-skip satellite switching with PCI unchanged of the serving cell may be referred to by as a second scheme, for example, the second satellite switch method comprises (or is based on) the second scheme.

In at least some technologies, the wireless device may execute/trigger/perform a handover procedure (e.g., with accordance to examples from FIGS. 24-28 and/or FIG. 30A/30B or FIG. 31A discussed above), for example, based on the first satellite switch method. Executing a handover procedure may comprise performing (by the wireless device) at least one of the following: releasing the RRC configuration parameters of the source cell and the MCG associated with the source cell; and/or using the RRC configuration parameters of the source base station/cell (e.g., PCell 1); and/or resetting MAC; and/or performing cell group configuration for the received MCG comprised in the RRC reconfiguration message of the PCell 1. For example, upper/higher layers (e.g., RRC layer) of the wireless device may request/trigger lower layers (e.g., MAC layer) of the wireless device to reset the MAC entity based on/at/in/during executing/performing the handover procedure (and/or SCG deactivation). In at least some technologies, resetting MAC (or resetting the MAC entity) may comprise performing/executing a first set of actions. The first set of actions may comprise one or more of the following: setting new data indicators (NDIs) for all uplink HARQ processes to the value 0; and/or setting the NDIs for all HARQ process IDs to the value 0 for monitoring PDCCH in Sidelink resource allocation mode 1; and/or stopping, if any, ongoing Random Access procedure; and/or discarding explicitly signalled contention-free Random Access Resources for 4-step RA type and 2-step RA type, if any; and/or flushing Msg3 (of the RA procedure) buffer; and/or flushing MsgA/MSGA (of the RA procedure) buffer; and/or cancelling, if any, triggered Scheduling Request procedure; cancelling, if any, triggered Buffer Status Reporting procedure; and/or cancelling, if any, triggered Power Headroom Reporting procedure; and/or cancelling, if any, triggered consistent LBT failure; and/or cancelling, if any, triggered BFR; and/or cancelling, if any, triggered Sidelink Buffer Status Reporting procedure; and/or cancelling, if any, triggered Pre-emptive Buffer Status Reporting procedure; and/or cancelling, if any, triggered Timing Advance Reporting procedure; and/or cancelling, if any, triggered Recommended bit rate query procedure; and/or cancelling, if any, triggered Configured uplink grant confirmation; and/or cancelling, if any, triggered configured sidelink grant confirmation; and/or clearing, if any, configured sidelink grants; and/or cancelling, if any, triggered Desired Guard Symbol query; and/or cancelling, if any, triggered Positioning Measurement Gap Activation/Deactivation Request procedure; and/or cancelling, if any, triggered SDT procedure; and/or cancelling, if any, triggered IAB-MT Recommended Beam Indication query; and/or cancelling, if any, triggered Desired DL TX Power Adjustment query; and/or cancelling, if any, triggered Desired IAB-MT PSD range query; and/or cancelling, if any, triggered Case-6 Timing Request query; and/or flushing the soft buffers for all DL HARQ processes, except for the DL HARQ process being used for MBS broadcast; and/or for each DL HARQ process, except for the DL HARQ process being used for MBS broadcast, considering the next received transmission for a TB as the very first transmission; and/or releasing, if any, Temporary C-RNTI; and/or resetting all LBT_COUNTERs (e.g., if upper layers indicate SCG deactivation and bfd-and-RLM with value true is not configured; and/or initializing Bj for each logical channel to zero (e.g., if the MAC reset is not due to SCG deactivation); and/or stopping (if running) all timers (e.g., except MBS broadcast DRX timers or except beamFailureDetectionTimer associated with PSCell and timeAlignmentTimers if upper layers indicate SCG deactivation and bfd-and-RLM with value true is configured for the deactivated SCG); and/or considering all timeAlignmentTimers, inactivePosSRS-TimeAlignmentTimer (e.g., a time alignment timer for positioning SRS transmission in the RRC inactive state), and cg-SDT-TimeAlignmentTimer (e.g., a time alignment timer for small data transmission), if configured.

The one or more configuration parameters (e.g., RRC messages) may configure timeAlignmentTimers, inactive PosSRS-TimeAlignmentTimer, and cg-SDT-TimeAlignmentTimer for the maintenance of UL time alignment. For example, timeAlignmentTimer (per TAG) may control/indicate how long the wireless device (e.g., MAC entity of the wireless device) considers the Serving Cells belonging to the associated TAG is uplink time aligned (for SRS/PUSCH/PUCCH transmissions). inactivePosSRS-TimeAlignmentTimer may control/indicate how long the wireless device (e.g., MAC entity of the wireless device) considers the Positioning SRS transmission in RRC_INACTIVE is uplink time aligned for positioning SRS transmissions. cg-SDT-TimeAlignmentTimer may control/indicate how long the wireless device (e.g., MAC entity of the wireless device) considers the uplink transmission for CG-SDT is uplink time aligned.

In at least some technologies, the wireless device may perform/execute a second set of actions, for example, if a timeAlignmentTimer associated with a TAG (e.g., a primary TAG or a secondary TAG) expires. The second set of actions may comprise at least one of the following: flushing all HARQ buffers for all Serving Cells; and/or notifying upper layers (e.g., RRC) of the wireless device to release PUCCH for all Serving Cells, if configured; and/or upper layers (e.g., RRC) of the wireless device to release SRS for all Serving Cells, if configured; and/or clearing any configured downlink assignments and configured uplink grants; and/or clearing any PUSCH resource for semi-persistent CSI reporting; and/or considering all running timeAlignmentTimers as expired; and/or maintaining N_{TA} of all TAGs. For example, the first set of actions may comprise the second set of actions.

A wireless device 3105, to improve efficiency in an NTN example, may perform/execute the second satellite switch procedure (e.g., the satellite/service link switch without performing HO or without changing PCI of the serving cell) for switching from the first NTN node 3101 of the serving cell to the second NTN node 3102 of the serving cell. As shown also in FIG. 31B, for (or during or after) the second satellite switch method the wireless device 3105 may avoid reconfiguring RRC configuration parameters (e.g., avoid performing the RRC reconfiguration) and/or resetting the wireless device 3105 (e.g., MAC entity of the wireless device), as the satellite switch procedure is not a handover procedure.

Based on implementations of at least some technologies, the wireless device 3105, in the second satellite switch procedure (for switching from the first NTN node 3101 of a cell to the second NTN node 3102 of the cell), may encounter difficulties to perform UL/DL synchronization with/toward the second NTN node 3102 of the cell. The wireless device 3105 may avoid performing the UL synchronization (based on the first scheme) with/toward the second NTN node 3102, for example, as it is up to implementation of the wireless device 3105 whether to initiate a new RA procedure at/in/during the ongoing RA procedure, for example, if there is an ongoing RA procedure (e.g., prior to T0 in FIG. 31B). Implementations of the at least some technologies may increase possibility of satellite switch failure.

A wireless device 3105 may prior to starting the second satellite switch (e.g., time TO in FIG. 31B) may trigger/initiate/start a first procedure. The wireless device 3105 may determine the first procedure being ongoing/pending, for example, a first trigger (corresponding to the first procedure) being pending/triggered (not being cancelled), for example, if performing the second satellite switch. The first procedure (or a first triggered procedure or the first trigger) may be at least one of the following: a Scheduling Request procedure (a pending/triggered SR); a Buffer Status Reporting procedure (a pending/triggered BSR); a Power Headroom Reporting procedure (a pending/triggered BHR); and/or a consistent LBT failure; and/or a triggered/pending BFR; and/or a triggered/pending Sidelink Buffer Status Reporting procedure; and/or a triggered/pending Pre-emptive Buffer Status Reporting procedure; and/or triggered/pending Timing Advance Reporting procedure; and/or a triggered/pending Recommended bit rate query procedure; and/or a triggered/pending Configured uplink grant confirmation; and/or a triggered/pending configured sidelink grant confirmation; and/or a triggered/pending Desired Guard Symbol query; and/or a triggered/pending Positioning Measurement Gap Activation/Deactivation Request procedure; and/or a triggered/pending SDT procedure; and/or a triggered/pending IAB-MT Recommended Beam Indication query; and/or a triggered/pending Desired DL TX Power Adjustment query; and/or a triggered/pending Desired IAB-MT PSD range query; and/or a triggered/pending Case-6 Timing Request query.

Based on implementations of at least some technology, the wireless device, in/after the satellite switch (e.g., during/after the first gap), may avoid resetting the wireless device (e.g., MAC entity of the wireless device) (e.g., avoid performing the first set of actions). The triggered first procedure (or the first procedure) may unnecessarily keep pending after the second satellite switch method is completed. New rules may be required to allow the wireless device to determine whether to cancel or not the triggered first procedure in the second satellite switch procedure. The new rules may further allow the wireless device 3105 to manage HARQ buffers of one or more HARQ processes, for example, to reduce a possibility of misalignment between the wireless device and the base station 3104 (e.g., regarding new transmission or retransmission in UL/DL after the satellite switch procedure). The new rules may further allow the wireless device to manage Msg3/MsgA buffers and/or explicitly signalled RA resources prior to starting the second satellite switch method to reduce a possibility of unnecessary transmissions/retransmissions of the Msg3/MsgA and/or wasting UL resources. Enhancements of MAC procedures (during/after the satellite switch, e.g., during/after the first gap) may improve efficiency of satellite switch and/or UL/DL communications.

In at least some technologies, a wireless device may trigger a third/initiate procedure, for example, if the wireless device not being in coverage of the first NTN node and the second NTN node (e.g., at/in/during the first gap and/or if the wireless device is performing the second satellite switch procedure). The third procedure may be at least one of: a radio failure recovery (RLM) procedure, and/or a beam failure recovery procedure, a scheduling request procedure, a buffer status reporting procedure, a handover procedure to handover to a second cell. By triggering the third procedure (e.g., the RLM procedure) the wireless device may interrupt/disrupt the (ongoing) second satellite switch procedure. Enhancements of the second satellite switch method, for example, during/after the first gap, may improve efficiency of the satellite switch for UL/DL communications.

In at least some technologies, a wireless device, at/in/during the first gap (e.g., at/in/during performing the second satellite switch method), may determine a time alignment timer (TAT) of the serving cell (e.g., PTAG) being expired/stopped. The wireless device may perform the second set of actions. The wireless device may perform the second set of actions, for example, based on (e.g., in response to) the expiry of the TAT. By performing the second set of actions, efficiency of the second satellite switch procedure may reduce. Enhancements of the second satellite switch method, for example, during/after the first gap, may improve efficiency UL/DL communications.

In at least some technologies, coverage area of NTN nodes of the first cell in the NTN (the first NTN node of the first cell and/or the second NTN node of the first cell) may be different (e.g., the coverage area of the first NTN node of the first cell may be larger than the coverage area of the second NTN node of the first cell). Based on implementation of at least some technologies, the wireless device may mistakenly/unnecessarily switch from the first NTN node of the first cell to the second NTN node of the first cell (without handover). UL/DL communications of the wireless device via the second NTN node of the cell may be erroneous, for example, if the coverage area of the first NTN node of the first cell may be larger than the coverage area of the second NTN node of the first cell. For example, if the wireless device is located around the coverage area of the first NTN node, by switching from the first NTN node of the cell to the second NTN node of the cell (without handover), UL/DL transmission efficiency of the wireless device if communicating via the cell may reduce. A second cell may provide a better coverage (e.g., higher SS-RSRPs/SS-RSRQs) compared to the cell. In at least some technologies, the UL/DL transmission efficiency of the second satellite switch procedure may reduce as the wireless device may, instead of triggering/executing the handover procedure (to handover to the second cell), trigger/start the second satellite switch procedure or. Improving the handover procedure in the NTN, may allow the wireless device to properly select whether to trigger/initiate the second satellite switch procedure (without handover) or to trigger/initiate the handover procedure. For example, the UL/DL transmission efficiency of the wireless device may improve, by avoiding the switching from the first NTN node of the cell to the second NTN node of the cell (e.g., and, instead, executing the handover procedure to handover to the second cell). Examples described herein may improve handover procedure allowing the wireless device to handover to the second cell of the NTN instead of switching from the first NTN node of a first cell to the second NTN node of the first cell.

Examples described herein may be related to an approach for determining whether to cancel/abort/stop a triggered/pending second procedure (e.g., PHR, TAR, BFD, RA, or the like) or not (e.g., continue performing the second procedure after the second satellite switch procedure is completed) if the wireless device switches from the first NTN node of the cell to the second NTN node of the cell without handover (or changing the PCI of the cell), for example, a second satellite switch method. Cancelling, stopping, and aborting, may be viewed as examples of pausing, terminating, or otherwise preventing a procedure from continuing to operate at the present time. These and other features of the present disclosure are described further below.

A wireless device may trigger/initiate an RA procedure (the second procedure) (e.g., 2-step RA procedure or a 4-step RA procedure) for transmission of a preamble (and/or Msg3 and/or MsgA) via the first NTN node of the cell. The wireless device may trigger/initiate the RA procedure, for example, based on/prior to/before starting/initiating the satellite switch procedure and/or based on/before the start of the first gap and/or based on communicating via the first NTN node. The wireless device may abort/stop/cancel the ongoing RA procedure (if ongoing). The wireless device may abort/stop/cancel the ongoing RA procedure, for example, based on (or in response to) starting (or after or during) the second satellite switch method/procedure (e.g., based on/in response to/during/after starting the first gap). The RA procedure may be ongoing, for example, if the RA procedure is not successfully/unsuccessfully completed. The RA procedure may be ongoing, for example, if a Msg4/MsgB of the RA procedure indicating a contention resolution identity of the wireless device is not received from the base station. The RA procedure may be ongoing, for example, if a random access response (RAR) corresponding to the preamble of the RA procedure is not received.

A wireless device may flush a buffer of a message of the RA procedure. The wireless device may flush the buffer of the message of the RA procedure, for example, based on (or in response to) starting (or after or during) the second satellite switch method/procedure (e.g., based on/in response to/during/after starting the first gap). The message may be a msg3/Msg3/MSG3 (message 3) of the RA procedure. The message may be a msgA/MsgA/MSGA (message A) of the RA procedure. By flushing the Msg3/MsgA buffer (of the RA procedure), the wireless device may delete/discard/remove (any) data in Msg3/MsgA buffer (e.g., empty the buffer).

A wireless device may discard/release/delete/clear at least one RA resource of the RA procedure. The wireless device may discard/release/delete/clear at least one RA resource of the RA procedure, for example, based on (or in response to) starting (or after or during) the second satellite switch method/procedure (e.g., based on/in response to/during/after starting the first gap). For example, the base station via the first NTN node of the cell may send (e.g., transmit) a message (e.g., Msg2/MsgB/Msg4) indicating the at least one RA resource. The at least one RA resource may correspond to (or be associated with) Msg3 (re-)transmission(s) and/or MsgA (re-)transmission(s). The at least one RA resource may, for example, correspond to (or be associated with) a PUCCH transmission. The at least one RA resource may correspond to (or be associated with) a PRACH transmission. The at least one RA resource may correspond to (or be associated with) the Msg2/MsgB/Msg4 (re-)transmission(s). The at least one RA resource may contention-free RA resources. The at least one RA resource may contention-based RA resources. A wireless device may, based on (or in response to) starting (or after or during) the second satellite switch method/procedure (e.g., based on/in response to/during/after starting the first gap), discard/release/delete/clear a temporary cell RNTI (TC-RNTI) of the RA procedure.

Examples described herein may improve efficiency of the satellite switch procedure without changing the PCI of the cell (e.g., the second satellite switch method) and/or reduce possibility of the second satellite switch procedure failures. For example, by stopping the ongoing RA procedure if the second satellite switch procedure is started/ongoing, the wireless device may improve a possibility of successfully completing the satellite switching procedure (e.g., completing UL/DL synchronization with/to the second NTN node of the cell). By not stopping the RA procedure if the second satellite switch procedure is started/ongoing, the wireless device may not be able to send (e.g., transmit) a preamble, via the second NTN node of the cell, to complete/perform the UL/DL synchronization with the second NTN node of the cell.

Flushing the Msg3/MsgA buffer (based on/during the second satellite switch method) may reduce a possibility of unnecessary UL transmissions (during/after) the satellite switch procedure, for example, Msg3 (re-)transmission(s) and/or MsgA (re-) transmission(s). Flushing the Msg3/MsgA buffer may improve UL spectral efficiency and/or reduce power consumption of the wireless device. Discarding/releasing/deleting/clearing the at least one RA resource of the RA procedure (based on/during the second satellite switch method) may reduce a possibility of unnecessary UL transmissions (during/after) the satellite switch procedure, for example, Msg3 (re-)transmission(s) and/or MsgA (re-)transmission(s). Discarding/releasing/deleting/clearing the at least one RA resource of the RA procedure (based on/during the second satellite switch method) may improve UL spectral efficiency and/or reduce power consumption of the wireless device.

A wireless device may trigger/initiate a second procedure (e.g., TAR, PHR, BFD, SDT, or the like). The wireless device may trigger/initiate a second procedure, for example, prior to/before starting/initiating the satellite switch procedure and/or before the start of the first gap and/or if communicating via the first NTN node. The wireless device may cancel the triggered second procedure (if pending). The wireless device may cancel the triggered second procedure (if pending), for example, based on (or in response to) starting (or after or during) the second satellite switch method/procedure (e.g., based on/in response to/during/after starting the first gap). The wireless device may avoid continuing performing the second procedure after the second satellite switch procedure is completed, for example, to reduce possibility of unnecessary UL/DL transmissions after switching to the second NTN node. The wireless device may avoid continuing performing the second procedure, for example, by canceling the triggered second procedure (based on the second satellite switch method/procedure).

A wireless device may cancel the pending/triggered second procedure. The wireless device may cancel the pending/triggered second procedure, for example, based on (e.g., in response to)/after starting the second satellite switch method/procedure (e.g., starting the first gap) and/or based on the second procedure being at least one of the following: a Power Headroom Reporting procedure (a pending/triggered PHR); and/or a consistent LBT failure; and/or a triggered/pending Timing Advance Reporting procedure; and/or a triggered/pending BFR; and/or a triggered/pending Positioning Measurement Gap Activation/Deactivation Request procedure; and/or a triggered/pending SDT procedure. The wireless device may not need to unnecessarily report the PHR after/during the satellite switch, by cancelling the triggered PHR. The triggered PHR may be outdated.

A wireless device may not need to unnecessarily report the BFR after/during the satellite switch, by cancelling the triggered BFR. The triggered BFR may be outdated (or may be mistakenly pending). The wireless device may not need to unnecessarily report the TAR after/during the satellite switch by cancelling the triggered TAR. The triggered TAR may be outdated or may be mistakenly pending. The wireless device may not use an outdated RSRP of the DL path-loss (corresponding to the first service link) after/during the satellite switch, by cancelling the triggered SDT procedure.

A wireless device may avoid/skip cancelling the pending/triggered second procedure (e.g., the wireless device may continue performing the second procedure after the second satellite switch procedure is completed). The wireless device may avoid/skip cancelling the pending/triggered second procedure (e.g., the wireless device may continue performing the second procedure after the second satellite switch procedure is completed), for example, based on (e.g., in response to)/after starting the second satellite switch method/procedure (e.g., starting the first gap), based on the second procedure being at least one of the following: a Scheduling Request procedure (a pending/triggered SR); a Buffer Status Reporting procedure (a pending/triggered BSR); and/or a consistent LBT failure; and/or a triggered/pending Timing Advance Reporting procedure; and/or a triggered/pending Sidelink Buffer Status Reporting procedure; and/or a triggered/pending Pre-emptive Buffer Status Reporting procedure; and/or a triggered/pending Recommended bit rate query procedure; and/or a triggered/pending Configured uplink grant confirmation; and/or a triggered/pending configured sidelink grant confirmation; and/or a triggered/pending Desired Guard Symbol query; and/or a triggered/pending Positioning Measurement Gap Activation/Deactivation Request procedure; and/or a triggered/pending SDT procedure; and/or a triggered/pending IAB-MT Recommended Beam Indication query; and/or a triggered/pending Desired DL TX Power Adjustment query; and/or a triggered/pending Desired IAB-MT PSD range query; and/or a triggered/pending Case-6 Timing Request query. A wireless device may, by avoiding/skipping cancelling the pending/triggered second procedure, continue performing the second procedure after the second satellite switch procedure is completed, for example, to improve efficiency of UL/DL communications via the second NTN node of the cell after the second satellite switch procedure (e.g., after the first gap expiry).

A wireless device, in the satellite switch (e.g., the first gap), may avoid/skip triggering a third procedure, for example, a PHR or a BFR or a TAR or a radio link failure/monitoring (RLF/RLM) or a scheduling request or a BSR or a (conditional) handover (e.g., to handover to the second/target cell). The wireless device may avoid/skip triggering/initiating the third procedure at/in/during the second satellite switch method/procedure, for example, until the switching from the first NTN node to the second NTN node being completed and/or until the UL synchronization of the second NTN being obtained and/or until the DL synchronization of the second NTN being obtained. The wireless device, in the satellite switch (e.g., the first gap), may avoid/skip evaluating the at least one CHO execution condition to avoid/skip triggering the CHO procedure (e.g., to handover to the second/target cell). A failure/interruption possibility of the second satellite switch method may, by avoiding/skipping triggering/initiating/executing the third procedure, reduce and/or efficiency of the second satellite switch procedure may increase.

One or more configuration parameters (e.g., the one or more messages) may comprise/indicate a third parameter. The third parameter may indicate whether the handover procedure has a higher priority than the second satellite switch procedure or not. For example, the third parameter may allow the wireless device to determine whether to perform/trigger the handover procedure to handover to the second cell or trigger/perform the second satellite switch procedure (switching NTN node without handover). The wireless device may prioritize the handover procedure (e.g., avoid performing the second satellite switch procedure), for example, performing the handover procedure. The wireless device may prioritize the handover procedure, for example, based on the third parameter being configured (or being configured by value true or being enabled or not being absent from the one or more configuration parameters or not being configured with value false or not being disabled). The wireless device may prioritize the second satellite switch procedure (e.g., avoid performing the handover procedure) trigger/perform the second satellite switch procedure. The wireless device may prioritize the second satellite switch procedure, for example, based on the third parameter not being configured (or not being configured by value true or not being enabled or being absent from the one or more configuration parameters or being configured with value false or being disabled).

A wireless device may avoid/skip triggering/starting the second satellite switch procedure/method (e.g., for switching from the first NTN node of the first cell to the second NTN node of the first cell without changing the first PCI). The wireless device may avoid/skip triggering/starting the second satellite switch procedure/method, for example, based on (e.g., in response to) receiving a handover message via the first cell. For example, the wireless device may prioritize the handover procedure (triggered/initiated based on the handover message) over/on the second satellite switch procedure, and the base station may (using the measurement report) determine the handover to the second cell. The wireless device may follow the instruction/indication (e.g., the handover message) from the network (base station) by avoiding/skipping triggering/starting the second satellite switch procedure/method.

A wireless device may avoid/skip triggering/starting the second satellite switch procedure/method (e.g., for switching from the first NTN node of the first cell to the second NTN node of the first cell without changing the first PCI) and may trigger/perform the handover procedure. The wireless device may avoid/skip triggering/starting the second satellite switch procedure/method and may trigger/perform the handover procedure, for example, based on (e.g., in response to) the handover message and the third parameter being configured (or being configured by value true or being enabled or not being absent from the one or more configuration parameters or not being configured with value false or not being disabled). The wireless device may avoid/skip triggering/starting the second satellite switch procedure/method (e.g., for switching from the first NTN node of the first cell to the second NTN node of the first cell without changing the first PCI) and may trigger/perform the handover procedure. The wireless device may avoid/skip triggering/starting the second satellite switch procedure/method and may trigger/perform the handover procedure, for example, based on (e.g., in response to) the handover message and the third parameter not being configured (or not being configured by value true or not being enabled or being absent from the one or more configuration parameters or being configured with value false or being disabled).

A wireless device may trigger/perform the second satellite switch procedure/method (e.g., for switching from the first NTN node of the first cell to the second NTN node of the first cell without changing the first PCI) and avoid/skip triggering/starting the handover procedure. A wireless device may trigger/perform the second satellite switch procedure/method and may and avoid/skip triggering/starting the handover procedure, for example, based on (e.g., in response to) the handover message and the third parameter not being configured (or not being configured by value true or not being enabled or being absent from the one or more configuration parameters or being configured with value false or being disabled). The wireless device may avoid/skip triggering/starting the second satellite switch procedure/method (e.g., for switching from the first NTN node of the first cell to the second NTN node of the first cell without changing the first PCI). The wireless device may avoid/skip triggering/starting the second satellite switch procedure/method, for example, based on/in response to a (conditional) handover procedure being ongoing/initiated/triggered. For example, the wireless device may determine the at least one CHO execution condition (e.g., the distance-based event or the time-based event) being satisfied. The wireless device may avoid/skip triggering/starting the second satellite switch procedure/method (e.g., for switching from the first NTN node of the first cell to the second NTN node of the first cell without changing the first PCI). The wireless device may avoid/skip triggering/starting the second satellite switch procedure/method, for example, in response to/based on the at least one CHO execution condition being satisfied. The wireless device may perform/execute the conditional handover based on the at least one CHO execution condition (e.g., the distance-based event or the time-based event) being satisfied.

A wireless device may determine whether to trigger/initiate/start the satellite switch procedure/method (e.g., for switching from the first NTN node of the first cell to the second NTN node of the first cell without changing the first PCI) or to trigger/initiate/execute the handover procedure. The wireless device may determine whether to trigger/initiate/start the satellite switch procedure/method or to trigger/initiate/execute the handover procedure, for example, based on the at least one CHO execution condition and a switching condition (e.g., corresponding to the second NTN node of the first cell or corresponding to the first cell). The wireless device may trigger/initiate/start the satellite switch procedure/method (e.g., for switching from the first NTN node of the first cell to the second NTN node of the first cell without changing the first PCI). The wireless device may trigger/initiate/start the satellite switch procedure/method, for example, based on the at least one CHO execution condition and the switching condition. The wireless device may trigger/initiate/execute the handover procedure to handover to the second cell. The wireless device may trigger/initiate/execute the handover procedure to handover to the second cell, for example, based on the at least one CHO execution condition and the switching condition.

A wireless device may trigger/initiate/execute the handover procedure. The wireless device may trigger/initiate/execute the handover procedure, for example, based on the at least one CHO execution condition being satisfied and the switching condition not being satisfied. The wireless device may avoid/skip triggering/starting the second satellite switch procedure/method (e.g., for switching from the first NTN node of the first cell to the second NTN node of the first cell without changing the first PCI). The wireless device may avoid/skip triggering/starting the second satellite switch procedure/method, for example, based on the at least one CHO execution condition being satisfied and the switching condition not being satisfied.

A wireless device may trigger/initiate/start the satellite switch procedure/method. The wireless device may trigger/initiate/start the satellite switch procedure/method, for example, based on the at least one CHO execution condition being satisfied and the switching condition being satisfied. The wireless device may avoid/skip triggering/initiating/performing the handover procedure. The wireless device may avoid/skip triggering/initiating/performing the handover procedure, for example, based on the at least one CHO execution condition being satisfied and the switching condition being satisfied. The wireless device may trigger/initiate/start the satellite switch procedure/method. The wireless device may trigger/initiate/start the satellite switch procedure/method, for example, based on the at least one CHO execution condition not being satisfied and the switching condition being satisfied.

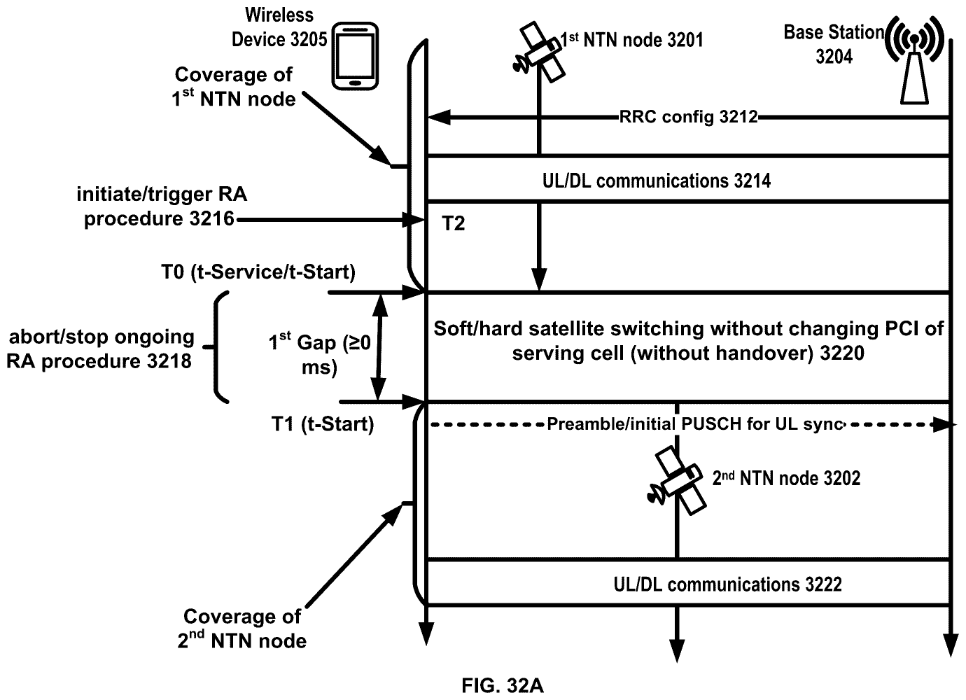

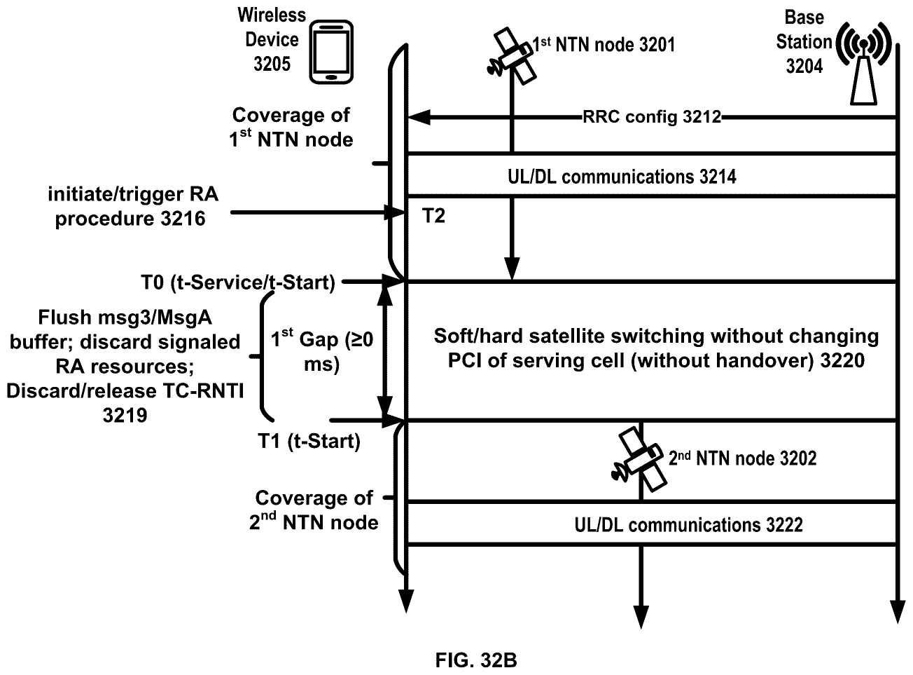

FIG. 32A and FIG. 32B show examples of satellite switching procedure for switching from the first NTN node (satellite) of a cell to the second NTN node (satellite) of the cell without handover. FIG. 32A and FIG. 32B may provide examples of the satellite switching without changing the PCI of the serving cell as discussed above (e.g., the second satellite switch method). In some cases, FIG. 32A and FIG. 32B may provide examples of random access procedure in an NTN. For example, the wireless device may be in the RRC connected state or the RRC inactive/idle state.

The wireless device may receive the one or more messages (the one or more RRC messages and/or the one or more MAC CEs and/or the one or more DCIs) from the base station, for example, via the first NTN node of the cell (serving cell). For example, the wireless device may receive the one or more messages if operating/residing in a coverage of the first NTN node of the cell (e.g., prior to/before the t-Service of the first NTN-config). The one or more messages may comprise/indicate the one or more configuration parameters.

The one or more messages may comprise HO messages. The one or more messages may comprise RRC setup message(s) and/or RRC reconfiguration message(s) and/or RRC resume/release message(s). The wireless device may receive the one or more messages as part of a handover procedure and/or initial access procedure and/or connection resume procedure and/or connection re-establishment procedure and/or radio failure recovery procedure or the like. For example, a message of the one or more messages may be a broadcast/multicast/groupcast message (e.g., NTN-specific SIB, e.g., SIB19, and/or SIB1 and/or positioning SIB). A message of the one or more messages may be dedicated (unicast) message.

The one or more configuration parameters may, for example, comprise the one or more RA configuration parameters. The one or more configuration parameters may, for example, comprise/indicate one or more serving cell (e.g., one or more Serving Cells or one or more cells) configuration parameters (e.g., ServingCellConfigCommon, ServingCellConfigCommonSIB, and/or ServingCellConfig) for configuring one or more cells (e.g., the one or more Serving Cells, e.g., the serving cell/cell). For example, the one or more cells may comprise a master (or primary) cell group (MSG) and/or a secondary cell group (SCG). In some cases, a cell of the one or more cells may be a primary secondary cell (PSCell), or a primary cell (PCell), or a secondary cell (SCell), or a special cell (SpCell). In some other cases, a cell of the one or more cells may belong to a first cell group corresponding to a primary TAG (pTAG) or a second cell group corresponding to a secondary TAG (sTAG). For example, the one or more configuration parameters may configure the wireless device for multi-cell communications and/or carrier aggregation. The cell (the serving cell) may belong to a SCG group or an MCG group. The cell may correspond to a pTAG (or a sTAG). The cell may, for example, be a PCell or a PSCell or a SpCell. The cell may be part of the NTN.

The one or more configuration parameters may comprise the NTN assistance information (e.g., comprising the first set of NTN configuration parameters, and/or comprising the at least one NTN-config), for example, one or more NTN configuration parameters. The one or more configuration parameters may comprise the NTN-config of the first NTN node (e.g., a first NTN-config) of the cell, for example, the NTN assistance information of the first NTN node of the cell (as shown in FIG. 29C). The NTN assistance information may further comprise the NTN-config of the second NTN node (e.g., a second NTN-config) of the cell, for example, the NTN assistance information of the second NTN node of the cell (as shown in FIG. 29C). A message of the one or more messages (e.g., SIB19/SIB31) may indicate the first NTN-config and the second NTN-config. In other examples, a message of the one or more messages (e.g., SIB19/SIB31) may indicate only the first NTN-config. During (or prior to staring) the satellite switching procedure the wireless device may, for example, receive/acquire via a broadcast message (e.g., SIB19/SIB31) or a dedicated message the second NTN-config (e.g., as part of synchronization process/procedure of the second NTN node of the cell). During the first gap (or prior to starting the first gap or after the expiry of the first gap) the wireless device may receive/acquire via SIB19/SIB31 or a dedicated message the second NTN-config. The wireless device may start/restart the validity timer (of the cell). The wireless device may start/restart the validity timer (of the cell), for example, Based on (e.g., in response to) receiving/acquiring the second NTN-config.

The one or more NTN configuration parameters may configure/indicate at least one of the following: t-Service (of each NTN node, e.g., the first NTN node and/or the second NTN node, of the cell) indicating a time that coverage provided by an NTN node (e.g., the first NTN node and/or the second NTN node) of the cell is stopped/finished/ended (e.g., the time information on if the cell provided via an NTN quasi-Earth fixed system, e.g., the first/second NTN node, is going to stop serving the area it is currently covering, e.g., the coverage area of the first/second NTN node); and/or the first time (t-start) indicating/configuring a time for starting the (soft/hard) satellite switching procedure (e.g., the second satellite switch procedure), for example, a time for starting searching SSBs corresponding to the second NTN node of the cell and/or a time for starting the coverage of the second NTN node; and/or the first gap (e.g., t-gap). The one or more configuration parameters may indicate whether the satellite switching procedure is hard or soft.

As shown in FIG. 32A and FIG. 32B the first NTN node 3201 may initially provide (satellite) coverage for the wireless device 3205 (e.g., prior to T0, e.g., t-Service of the first NTN node 3201), for example, a coverage area/cell that is served by the first NTN node 3201. Prior to T0 the wireless device 3205 may communicate 3214 with the base station 3204 (serving cell) via the first NTN node 3201 (e.g., to receive the one or more messages) of the cell. As also discussed in FIG. 31B above, the wireless device 3205, at/in/during the first gap (e.g., between T0 to T1 in FIG. 32A and FIG. 32B), may perform the second satellite switch method to disconnect from the first NTN node 3201 and connect to the second NTN node 3202.

As shown in FIG. 32A and FIG. 32B, at/in/during time/occasion T2 (prior to/before starting/initiating the satellite switch procedure and/or before the start of the first gap and/or if/while communicating via the first NTN node 3201) the wireless device 3205 may trigger/initiate a second procedure. The second procedure may be an RA procedure 3216 (e.g., 2-step RA procedure or a 4-step RA procedure). The wireless device 3205 may initiate the RA procedure for transmission of a preamble/Msg1 (and/or Msg3 and/or MsgA) based on the one or more RA configuration parameters. The one or more RA configuration parameters indicate/configure at least one RA resource (e.g., time/frequency) for the transmission of the preamble/Msg1 (and/or Msg3 and/or MsgA). The wireless device 3205 may (re-)send/transmit/receive (or monitor PDCCH at/in/during a time of ra-Response Window, msgB-Response Window, or a contention resolution timer to receive) one or more RA messages (e.g., a preamble or a Msg3 or Msg2/MsgB/Msg4). The wireless device 3205 may (re-)send/transmit/receive (or monitor PDCCH at/in/during a time of ra-Response Window, msgB-ResponseWindow, or a contention resolution timer to receive) one or more RA messages, for example, based on/after initiating the RA procedure. The initiated RA procedure may be based on examples from FIG. 13A/13B/13C discussed above.

The RA procedure may not be for (or as part of) the initial access (e.g., the wireless device 3205 is in the RRC connected state at/in time T2). The RA procedure may be a contention-based RA procedure. For example, the RA procedure may be a contention-free RA procedure (e.g., the base station 3204 via the first NTN node 3201 of the cell may indicate (e.g., via PDCCH order) the wireless device 3205 to trigger/start the RA procedure). The RA procedure may not be part of a handover procedure.

A wireless device 3205 may trigger/initiate the RA based on/in response to at least one of the following: an RRC connection setup/resume/establishment/re-establishment procedure; and/or DL or UL data arrival, at/in/during RRC_CONNECTED or at/in/during RRC_INACTIVE if/while SDT procedure is ongoing, if UL synchronisation status is “non-synchronised”; and/or UL data arrival, at/in/during RRC_CONNECTED or at/in/during RRC_INACTIVE SDT procedure is ongoing, if there are no PUCCH resources for SR available; and/or an SR failure; and/or an RRC Connection Resume procedure from RRC_INACTIVE; and/or for establishing/obtaining time alignment for a secondary TAG; and/or to request for Other system information (SI); and/or Beam failure recovery; and/or Consistent UL LBT failure on SpCell; and/or an SDT in RRC_INACTIVE (see clause 18); and/or Positioning purpose at/in/during RRC_CONNECTED requiring random access procedure, for example, if timing advance is needed for wireless device positioning.

A wireless device 3205 as shown in FIG. 32A may abort/stop/cancel the ongoing RA procedure (if ongoing) 3218. The wireless device 3205 may abort/stop/cancel the ongoing RA procedure, for example, based on (or in response to) starting (or after or during) the second satellite switch method/procedure (e.g., based on/in response to/during/after starting the first gap). The RA procedure may be ongoing if the RA procedure is not successfully/unsuccessfully completed. The RA procedure may, for example, be ongoing if a Msg4/MsgB of the RA procedure indicating a contention resolution identity of the wireless device 3205 is not received from the base station 3204. The RA procedure may be ongoing if a random access response (RAR) corresponding to the preamble of the RA procedure is not received. For example, based on/in response to the second satellite switch method/procedure may comprises an ongoing second satellite switch procedure.

A wireless device 3205 may, based on/in response to/after completing the second satellite switch method/procedure (e.g., the expiry of the first gap), abort/stop/cancel the RA procedure (if ongoing). The wireless device 3205 may abort/stop/cancel the RA procedure (if ongoing) 3218. The wireless device 3205 may abort/stop/cancel the RA procedure (if ongoing) 3218, for example, based on (e.g., in response to) starting the first gap.

Stopping the ongoing RA procedure may allow the wireless device 3205 to successfully complete the satellite switching procedure 3220 (e.g., complete UL/DL synchronization with/to the second NTN node 3202 of the cell), for example, the second satellite switch method based on the first scheme. As shown in FIG. 32A, completing the UL/DL synchronization with the second NTN node 3202 of the cell (e.g., for obtaining a default beam and/or N_TA for UL transmission via the second NTN node 3202 of the cell) may require a preamble transmission or an initial PUSCH transmission based on (detecting/receiving) an SSB (e.g., the default beam) corresponding to the second NTN node 3202 of the cell. The wireless device 3205 may, by not stopping the RA procedure, not be able to send (e.g., transmit) the preamble to complete the UL/DL synchronization with the second NTN node 3202 of the cell.

A wireless device 3205 may, by not stopping the RA procedure, not be able to successfully complete the RA procedure (e.g., due to change of RSRP of SSBs/CSI-RSs as a result of the satellite switch and difficulties in determining transmission powers of Msg1/Msg3 transmissions/retransmissions after the satellite switch). Further, as due to satellite switch the UE-gNB RTT of the cell may change from a first UE-gNB RTT (obtained based on the first NTN-config prior to the satellite switch) to a second UE-gNB RTT (obtained based on the second NTN-config after the satellite switch), a possibility of not receiving Msg2/MsgB/Msg4 from the base station 3204 via the second NTN node 3202 may increase.

As shown in FIG. 32B, the wireless device 3205 may flush a buffer of a message of the RA procedure 3219. The wireless device 3205 may flush a buffer of a message of the RA procedure 3219, for example, based on (or in response to) starting (or after or during) the second satellite switch method/procedure (e.g., based on/in response to/during/after starting the first gap). The wireless device 3205 may flush the buffer of the message of the RA procedure. The wireless device 3205 may flush the buffer of the message of the RA procedure, for example, based on/in response to/after completing the second satellite switch method/procedure (e.g., the expiry of the first gap). The wireless device 3205 may flush the buffer of the message of the RA procedure. The wireless device 3205 may flush the buffer of the message of the RA procedure, for example, based on (e.g., in response to) starting the first gap. The message may be a msg3/Msg3/MSG3 (message 3) of the RA procedure. The message may be a msgA/MsgA/MSGA (message A) of the RA procedure. By flushing the Msg3/MsgA buffer (of the RA procedure), the wireless device 3205 may delete/discard/remove (any) data in Msg3/MsgA buffer (e.g., empty the buffer).

Flushing the Msg3/MsgA buffer (based on/during the second satellite switch method) may reduce a possibility of unnecessary UL transmissions (during/after) the satellite switch procedure, for example, Msg3 (re-)transmission(s) and/or MsgA (re-) transmission(s). Flushing the Msg3/MsgA buffer may improve UL spectral efficiency and/or reduce power consumption of the wireless device 3205.

As shown in FIG. 32B, the wireless device 3205 may, based on (or in response to) starting (or after or during) the second satellite switch method/procedure (e.g., based on/in response to/during/after starting the first gap), discard/release/delete/clear at least one RA resource of the RA procedure. The wireless device 3205 may, based on/in response to/after completing the second satellite switch method/procedure (e.g., the expiry of the first gap), discard/release/delete/clear at least one RA resource of the RA procedure. The wireless device 3205 may discard/release/delete/clear at least one RA resource of the RA procedure. The wireless device 3205 may discard/release/delete/clear at least one RA resource of the RA procedure, for example, based on (e.g., in response to) starting the first gap. For example, the base station 3204 via the first NTN node 3201 of the cell may send (e.g., transmit) a message (e.g., Msg2/MsgB/Msg4) indicating the at least one RA resource. The at least one RA resource may (explicitly) be signaled/indicated by the base station 3204. The at least one RA resource may correspond to (or be associated with) Msg3 (re-)transmission(s) and/or MsgA (re-)transmission(s). The at least one RA resource may, for example, correspond to (or be associated with) a PUCCH transmission. The at least one RA resource may correspond to (or be associated with) a PRACH transmission. The at least one RA resource may correspond to (or be associated with) the Msg2/MsgB/Msg4 (re-)transmission(s). The at least one RA resource may contention-free RA resources. The at least one RA resource may contention-based RA resources.

Discarding/releasing/deleting/clearing the at least one RA resource of the RA procedure (based on/during the second satellite switch method) may reduce a possibility of unnecessary UL transmissions (during/after) the satellite switch procedure, for example, Msg3 (re-)transmission(s) and/or MsgA (re-)transmission(s). Discarding/releasing/deleting/clearing the at least one RA resource of the RA procedure (based on/during the second satellite switch method) may improve UL spectral efficiency and/or reduce power consumption of the wireless device 3205.

As shown in FIG. 32B, the wireless device 3205 may, based on (or in response to) starting (or after or during) the second satellite switch method/procedure (e.g., based on/in response to/during/after starting the first gap), discard/release/delete/clear a temporary cell RNTI (TC-RNTI) of the RA procedure. The wireless device 3205 may, based on/in response to/after completing the second satellite switch method/procedure (e.g., the expiry of the first gap), discard/release/delete/clear the TC-RNTI of the RA procedure. The wireless device 3205 may discard/release/delete/clear the TC-RNTI of the RA procedure. The wireless device 3205 may discard/release/delete/clear the TC-RNTI of the RA procedure, for example, based on (e.g., in response to) starting the first gap.

A wireless device 3205 may avoid triggering/initiating the RA procedure prior to starting the satellite switch (e.g., the second satellite switch procedure) and/or starting the first gap. For example, at/in/during a time window prior to starting the satellite switch (e.g., the second satellite switch procedure) and/or prior to starting the first gap, the wireless device 3205 may avoid/skip triggering/initiating the RA procedure (e.g., to reduce possibility of interruption at/in/during the RA procedure as a result of the satellite switch).

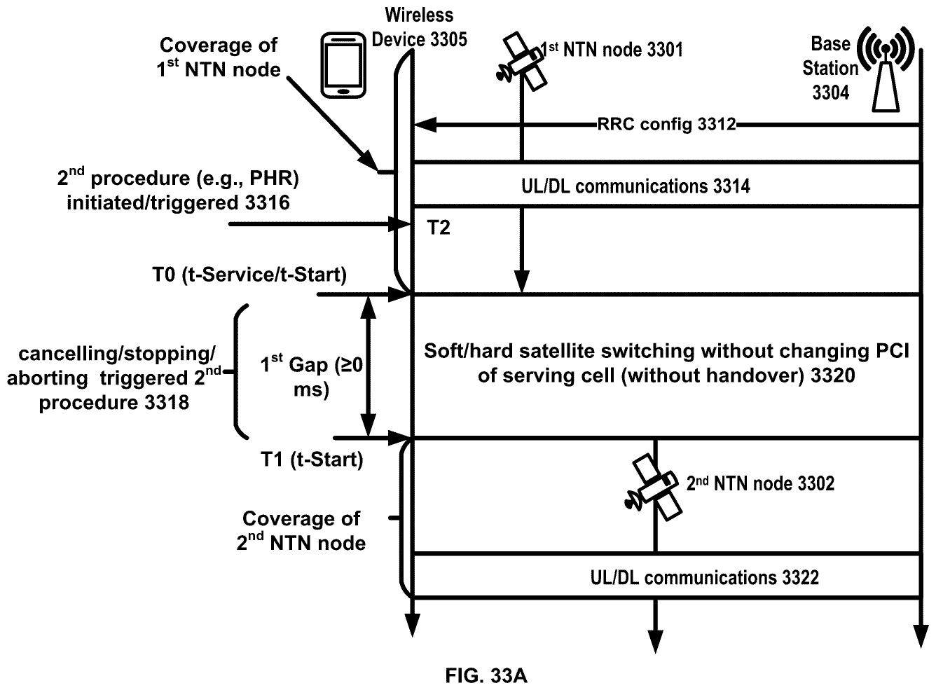

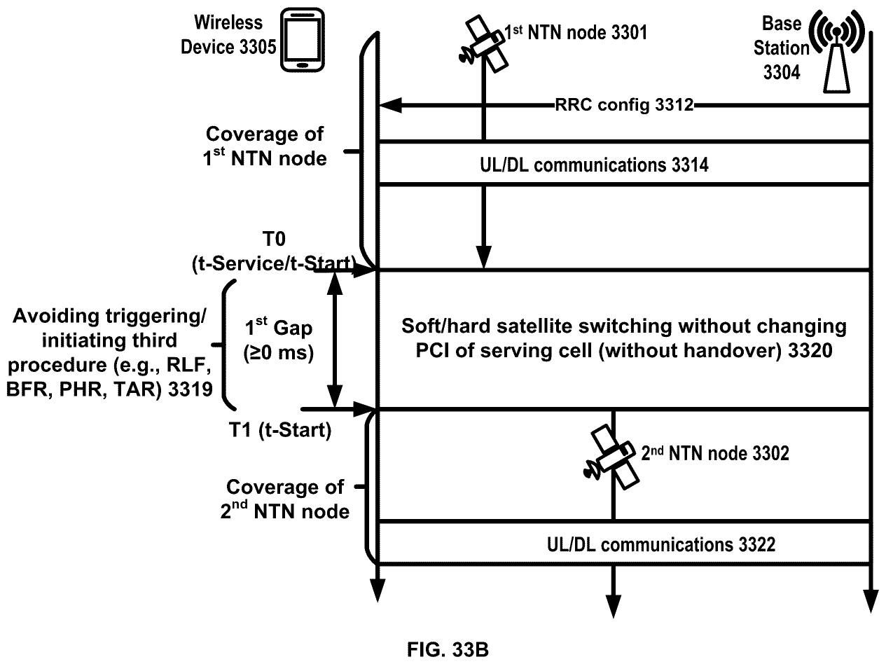

FIG. 33A and FIG. 33B show examples of satellite switching procedure for switching from the first NTN node 3301 (satellite) of a cell to the second NTN node 3302 (satellite) of the cell without handover. Examples from FIG. 33A and FIG. 33B may provide examples of the satellite switching without changing the PCI of the serving cell (e.g., the cell) as discussed above (e.g., the second satellite switch method). The wireless device 3305 may be in the RRC connected state (or the RRC inactive state). As shown in FIG. 33A and FIG. 33B, and as discussed related to examples from FIG. 32A or FIG. 32B above, the wireless device 3305 may receive the one or more messages (the one or more RRC messages or the one or more MAC CEs and/or the one or more DCIs) from the base station 3304, for example, via the first NTN node 3301 of the cell (serving cell).

A first NTN node 3301, as shown in FIG. 33A and FIG. 33B, may initially provide (satellite) coverage for the wireless device 3305 (e.g., prior to T0, e.g., t-Service of the first NTN node 3301). Prior to T0 the wireless device 3305 may communicate with the base station 3304 3314 (serving cell) via the first NTN node 3301 (e.g., to receive the one or more messages) of the cell. The wireless device 3305, as also discussed in FIG. 31B above, at/in/during the first gap (e.g., between T0 to T1 in FIG. 33B), may perform the second satellite switch method 3320 to disconnect from the first NTN node 3301 and connect to the second NTN node 3302. The length of the first gap as shown may be zero or larger than zero.

A wireless device 3305, as shown in FIG. 33A, at/in/during time/occasion T2 (prior to/before starting/initiating the satellite switch procedure and/or before the start of the first gap and/or if/while communicating via the first NTN node 3301), may trigger/initiate a second procedure 3316. The second procedure may be the first procedure (or may be one of the first procedure listed above). The wireless device 3305 may, based on (or in response to) starting (or after or during) the second satellite switch method/procedure (e.g., based on/in response to/during/after starting the first gap), cancel/abort/stop the triggered second procedure (if pending). The wireless device 3305 may, based on/in response to/after completing the second satellite switch method/procedure (e.g., the expiry of the first gap), cancel/abort/stop the triggered second procedure 3318 (if pending). The wireless device 3305 may cancel/abort/stop the triggered second procedure 3318 (if pending). The wireless device 3305 may cancel/abort/stop the triggered second procedure 3318 (if pending), for example, based on (e.g., in response to)/after starting the first gap. The wireless device 3305 may, by canceling the triggered second procedure (based on the second satellite switch method/procedure), reduce possibility of unnecessary UL/DL transmissions after switching to the second NTN node 3302.

A wireless device 3305 may selectively determine which trigger/pending second procedure needs to be cancelled/aborted/stopped, for example, if the second satellite switch procedure does not comprise the MAC reset/reconfiguration. The wireless device 3305 may determine whether to cancel/abort/stop the pending/triggered second procedure based on the second procedure (e.g., conditions/events that trigger the second procedure). The wireless device 3305 may determine whether to cancel/abort/stop the pending/triggered second procedure based on the second procedure, for example, based on (e.g., in response to)/after starting (or during) the second satellite switch method/procedure (e.g., starting/during the first gap or the expiry of the first gap). A condition/event that triggers (or the conditions/causes/events for triggering) the second procedure may be based on a condition/measurement/quality (PDSCH/PDCCH/PUSCH/PRACH/SRS/CSI-RS/SSB condition/measurement/quality). The condition may correspond to a channel or a reference signal. The condition/measurement/quality may comprise a path-loss of the channel and/or a (variation/change of) RSRP/RSRQ of a reference signal/channel and/or a beam/spatial relation of the channel. The channel may be associated with the first service link of the cell. The condition/measurement/quality may correspond to a (variation/change of) UL/DL timing associated with the first service link of the cell. The wireless device 3305 may cancel/abort/stop the triggered second procedure. The wireless device 3305 may cancel/abort/stop the triggered second procedure, for example, based on the triggering of the second channel based on the condition/measurement/quality associated with the first service link of the cell and/or based on (e.g., in response to)/after starting the second satellite switch method/procedure (e.g., starting the first gap). A condition/measurement/quality (e.g., corresponding to the second service link of the second NTN node 3302 of the cell) may change/vary, for example, if after the satellite switch and due to switching from the first service link of the cell to the second service link of the cell, The wireless device 3305 may cancel/abort/stop the triggered second procedure and/or reevaluate the condition/event that triggered the second procedure with accordance to the second service link of the second NTN node 3302 of the cell.

The wireless device 3305 may cancel the pending/triggered second procedure. The wireless device 3305 may cancel the pending/triggered second procedure, for example, based on (e.g., in response to)/after starting the second satellite switch method/procedure (e.g., starting the first gap) and/or based on the second procedure being at least one of the following: a Power Headroom Reporting procedure (a pending/triggered PHR); and/or a consistent LBT failure; and/or a triggered/pending Timing Advance Reporting procedure; and/or a triggered/pending BFR (or radio link failure recovery); and/or a triggered/pending Positioning Measurement Gap Activation/Deactivation Request procedure; and/or a triggered/pending SDT procedure.

The pending/triggered PHR prior to/before starting second satellite switch method/procedure may be based on a first channel condition (e.g., a first path loss being changed more than a configured threshold for a first RS used as pathloss reference) of the first service link (between the wireless device 3305 and the first NTN node 3301) of the cell. A second channel condition (e.g., a second path loss for a second RS used as pathloss reference) of the second service link (between the wireless device 3305 and the second NTN node 3302) of the cell may be measured/determined by the wireless device 3305, after the satellite switch (e.g., the second satellite switch method/procedure). For example, the second path loss may, after the satellite switch, may not change more than the configured threshold for the second RS used as pathloss reference of the second service link (between the wireless device 3305 and the second NTN node 3302) of the cell (e.g., as location of the first NTN node 3301 and the second NTN node 3302 are different). By cancelling the triggered PHR, the wireless device 3305 may not need to unnecessarily report the PHR after/during the satellite switch as the triggered PHR may be outdated (the first channel condition may not be valid for determining power headroom).

The triggered/pending BFR (or radio link failure recovery) prior to/before starting second satellite switch method/procedure may be based on a beam/link failure detection corresponding to a first beam (a first SSB/CSI-RS beam) of the first service link (between the wireless device 3305 and the first NTN node 3301) of the cell. A second beam (with a different beam index than the first beam or the same beam index of the first beam) may be used for the second service link (between the wireless device 3305 and the second NTN node 3302) of the cell, after the satellite switch (e.g., the second satellite switch method/procedure). For example, the wireless device 3305 may reevaluate/monitor (e.g., based on quality of the second beam, e.g., RSRP/RSRQ of the second beam corresponding to the second service link) conditions for triggering/initiating the BFR or radio link failure/monitoring, after the satellite switch and based on a change of the service link from the first service link to the second service link of the cell. The wireless device 3305 may not need to unnecessarily perform the BFR and/or radio link failure recovery by cancelling the triggered BFR and/or radio link failure recovery.

Pending/triggered Timing advance reporting (TAR) procedure prior to/before starting second satellite switch method/procedure may be based on a change of delay of the first service link (between the wireless device 3305 and the first NTN node 3301) of the cell and/or the first NTN-config (e.g., ta-Report). The change of delay of the first service link (between the wireless device 3305 and the first NTN node 3301) of the cell may not be valid for TAR procedure after the satellite switch due to switching from the first service link to the second service link. For example, the second NTN-config may not comprise TAR configurations (e.g., ta-Report) enabling/configuring the TAR via the second NTN node 3302. The wireless device 3305 may not need to unnecessarily report the TAR after/during the satellite switch as the triggered TAR may be outdated or may be mistakenly pending by cancelling the triggered TAR.

Triggered/Pending Positioning Measurement Gap Activation/Deactivation Request procedure may allow the wireless device 3305 to activate/de-active a (positioning) measurement gap for performing a positioning procedure (e.g., RSTD and/or Rx-Tx time different measurement) for measuring DL PRS resources. For example, the positioning procedure may need to be automatically deactivated/suspended based on the satellite switching procedure (the second satellite switch method). The wireless device 3305 may cancel the triggered/pending Positioning Measurement Gap Activation/Deactivation Request procedure. The wireless device 3305 may cancel the triggered/pending Positioning Measurement Gap Activation/Deactivation Request procedure, for example, based on (e.g., in response to) the positioning procedure being suspended/stopped based on (e.g., in response to) the satellite switching. The wireless device 3305 may avoid cancelling the triggered/pending Positioning Measurement Gap Activation/Deactivation Request procedure. The wireless device 3305 may avoid cancelling the triggered/pending Positioning Measurement Gap Activation/Deactivation Request procedure, for example, based on (e.g., in response to) the positioning procedure not being suspended/stopped and/or based on (e.g., in response to) the satellite switching.

The triggered/pending SDT procedure may be based on RSRP of a DL path-loss reference signal (PL-RS) corresponding to the first service link (e.g., for choosing/selecting CG-SDT or RA-SDT and/or for choosing SUL or NUL). The wireless device 3305 may reevaluate (e.g., based on RSRP of a DL PL-RS corresponding to the second service link) conditions for triggering/initiating the SDT procedure (e.g., for choosing/selecting CG-SDT or RA-SDT and/or for choosing SUL or NUL), after the second satellite switch method/procedure due to change of the service link from the first service link to the second service link of the cell. The wireless device 3305 may not use an outdated RSRP of the DL path-loss (corresponding to the first service link) after/during the satellite switch by cancelling the triggered SDT procedure.

A wireless device 3305 may avoid/skip cancelling/aborting/stopping the triggered second procedure based on (e.g., in response to)/after starting the second satellite switch method/procedure (e.g., starting the first gap) by continuing performing the second procedure after the second satellite switch procedure is completed, for example, if the conditions that trigger the second procedure are not based on a condition/quality/measurement of the first service link of the cell. The wireless device 3305 may avoid/skip cancelling/aborting/stopping the triggered second procedure, for example, based on (e.g., in response to)/after starting the second satellite switch method/procedure (e.g., starting the first gap). For example, the conditions that trigger the second procedure may be based on data arrival at the wireless device 3305. The wireless device 3305 may avoid/skip cancelling the pending/triggered second procedure. The wireless device 3305 may avoid/skip cancelling the pending/triggered second procedure, for example, based on (e.g., in response to)/after starting the second satellite switch method/procedure (e.g., starting the first gap) and/or based on the second procedure being at least one of the following: a Scheduling Request procedure (a pending/triggered SR); a Buffer Status Reporting procedure (a pending/triggered BSR); and/or a consistent LBT failure; and/or a triggered/pending Timing Advance Reporting procedure; and/or a triggered/pending Sidelink Buffer Status Reporting procedure; and/or a triggered/pending Pre-emptive Buffer Status Reporting procedure; and/or a triggered/pending Recommended bit rate query procedure; and/or a triggered/pending Configured uplink grant confirmation; and/or a triggered/pending configured sidelink grant confirmation; and/or a triggered/pending Desired Guard Symbol query; and/or a triggered/pending Positioning Measurement Gap Activation/Deactivation Request procedure; and/or a triggered/pending SDT procedure; and/or a triggered/pending IAB-MT Recommended Beam Indication query; and/or a triggered/pending Desired DL TX Power Adjustment query; and/or a triggered/pending Desired IAB-MT PSD range query; and/or a triggered/pending Case-6 Timing Request query. The wireless device 3305 may improve efficiency of UL/DL communications via the second NTN node 3302 of the cell after the second satellite switch procedure (e.g., after the first gap expiry) by avoiding/skipping cancelling the pending/triggered second procedure.

A wireless device 3305, as shown in FIG. 33B at/in/during the satellite switch 3320 (e.g., the first gap), may avoid/skip triggering a third procedure 3319, for example, a PHR and/or a BFR and/or a TAR and/or a radio link failure/monitoring (RLF/RLM) and/or SR and/or BSR and/or a (conditional) handover. The third procedure may be the second procedure. The wireless device 3305 may avoid/skip triggering/initiating the third procedure 3319 at/in/during the second satellite switch method/procedure, for example, until the switching from the first NTN node 3301 to the second NTN node 3302 being completed and/or until the UL synchronization of the second NTN being obtained and/or until the DL synchronization of the second NTN being obtained. The wireless device 3305 may not expect to evaluate/perform the first trigger at/in/during the satellite switch (e.g., at/in/during the first gap). A channel condition of service link of the cell/serving cell during the satellite switch may be transitory (e.g., because the UL/DL communications via the service link of the cell may halted/suspended at/in/during the first gap). The transitory/unstable channel condition of the service link of the cell may result in unnecessary/erroneous/fake beam failure detection/recovery and/or radio link failure/monitoring and/or a handover procedure. During the satellite switch (DL) path-loss estimation associated with the service link of the cell may be inaccurate/inapplicable, for example, for PHR or the handover. During the satellite switch (e.g., the second satellite switch method) an open-loop TA value associated with the service link of the cell may be inaccurate/inapplicable, for example, for the TAR. Triggering SR/BSR during the satellite switch may result in triggering an RA procedure, which may interrupt the second satellite switch procedure. By avoiding triggering/initiating the second procedure at/in/during the second satellite switch method/procedure, performance/efficiency of the satellite switch may improve. The wireless device 3305 may avoid triggering a new RA procedure (e.g., if there is no PUCCH resource being available or due to SR failure) by avoiding triggering/initiating the SR (and/or BSR) procedure at/in/during the satellite switch (e.g., the second satellite switch method).

A wireless device 3305, during the second satellite switch method/procedure, may avoid/skip evaluating/monitoring/examining the at least one CHO execution condition and/or trigger/initiate the (conditional) handover procedure (e.g., to handover to a second/target cell with a second PCI). The wireless device 3305 may avoid interrupting the satellite switch procedure by avoiding triggering/initiating the SR (and/or BSR) procedure at/in/during the satellite switch (e.g., the second satellite switch method).

A wireless device 3305, at/in/during the second satellite switch method/procedure, may avoid starting/restarting one or more timers. The one or more timers may correspond to (or associated with) the RLM procedure (e.g., configured/indicated by the one or more configuration parameters, e.g., rlf-TimersAndConstants) and/or handover procedure. The one or more timers may comprise at least one of: T310 timer and/or T312 and/or T311. For example, the wireless device 3305, at/in/during the second satellite switch method/procedure, may avoid incrementing one or more timers (e.g., N310 and/or N311 e.g., configured/indicated by the one or more configuration parameters, e.g., rlf-TimersAndConstants). The wireless device 3305 may, in response to/based on starting the second satellite switch procedure, may reset the one or more timers, for example, to avoid triggering the RLM.

A third procedure may be different than the second procedure. The wireless device 3305 may, at/in/during the second satellite switch method/procedure (e.g., at/in/during the first gap), trigger/initiate at least one of the following (e.g., the third procedure may be at least one of the following): a Scheduling Request procedure (a pending/triggered SR); a Buffer Status Reporting procedure (a pending/triggered BSR); and/or a consistent LBT failure; and/or a triggered/pending Timing Advance Reporting procedure; and/or a triggered/pending Sidelink Buffer Status Reporting procedure; and/or a triggered/pending Pre-emptive Buffer Status Reporting procedure; and/or a triggered/pending Recommended bit rate query procedure; and/or a triggered/pending Configured uplink grant confirmation; and/or a triggered/pending configured sidelink grant confirmation; and/or a triggered/pending Desired Guard Symbol query; and/or a triggered/pending Positioning Measurement Gap Activation/Deactivation Request procedure; and/or a triggered/pending SDT procedure; and/or a triggered/pending IAB-MT Recommended Beam Indication query; and/or a triggered/pending Desired DL TX Power Adjustment query; and/or a triggered/pending Desired IAB-MT PSD range query; and/or a triggered/pending Case-6 Timing Request query.

As described herein, “A handover procedure” may refers to “a handover from a first/source cell with a first PCI to a second/target cell with a second PCI” or “an RRC reconfiguration procedure” or “an MAC resetting procedure” or a “a layer 3 mobility”. “Switch” may refer to “switching” or “switch over” or “switchover”.

As described herein, “A handover procedure” may refer to or comprise “a service link switch from a first cell with a first PCI to a second cell with a second PCI” or “a satellite switch from a first cell with a first PCI to a second cell with a second PCI” or “a feeder link switch from a first cell with a first PCI to a second cell with a second PCI”.

As described herein, “A service link switch without changing PCI of a cell” may refer to or comprises “a service link switch from a first NTN node 3301 of the cell to a second NTN node of the cell” or “a service link switch without handover” or “a service link switch without RRC reconfiguration” or “a service link switch without resetting MAC entity”. “A service link switch without changing PCI of a cell” may not comprise “a layer 3 mobility”.

As described herein, “A service link switch” may refer to “a satellite switch” or “feeder link switch” or “a soft satellite switch” or “a hard satellite switch” or “a soft feeder link switch” or “a hard feeder link switch”. “A second satellite switch method” may refer to “a service link switch without changing PCI of serving cell”.

As described herein, “Method” may refer to “procedure” or “protocol” or “technique” or “system”. “Release” may refer to “delete” or “remove” or “discard”. For example, “releasing PUCCH/SRS” may refer to “deleting/removing/discarding PUCCH/SRS configurations in an RRC layer”.

As described herein, “Clear” may refer to “delete” or “remove” or “discard”. For example, “clearing SPS assignments” may refer to “deleting/discarding/removing SPS assignments in the MAC layer (without releasing SPS configuration in the RRC layer”. “Suspend” may refer to “halt” or “postpone” or “delay”. “Suspending a procedure during a window/duration” may refer to “avoiding performing the procedure during the duration” or “halting performing the procedure during the duration” or “delaying/postponing performing the procedure until after the duration”.

As described herein, “Performing a handover” may refer to “triggering the handover” or “initiating/starting the handover” or “executing the handover”. “Performing a satellite switch” may refer to “triggering the satellite switch” or “initiating/starting the satellite switch” or “executing the satellite switch”.

Examples may provide enhancement for the satellite switch procedure without handover to improve efficiency of the satellite switch procedure by reducing possibility of the satellite switch procedure failure and/or improving UL/DL data transmissions (or UL/DL synchronization).

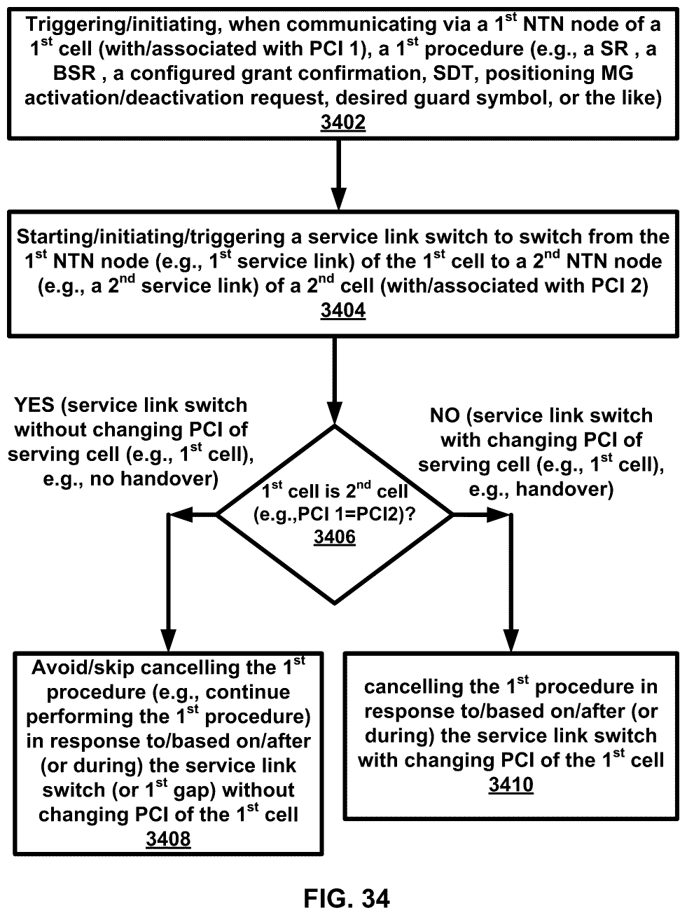

FIG. 34 shows an example flowchart of a service link switch procedure in an NTN. As shown the wireless device may trigger/initiate a first procedure 3402 (if communicating) via the first NTN node (e.g., the first service link) of a first cell (e.g., with/associated with the first PCI, PCI 1) of the NTN, for example, if the wireless device is in a coverage area/cell of (or corresponding to the first NTN node of the cell). The first procedure may be at least one of the following: a Scheduling Request procedure (a pending/triggered SR); a Buffer Status Reporting procedure (a pending/triggered BSR); and/or a consistent LBT failure; and/or a triggered/pending Timing Advance Reporting procedure; and/or a triggered/pending Sidelink Buffer Status Reporting procedure; and/or a triggered/pending Pre-emptive Buffer Status Reporting procedure; and/or a triggered/pending Recommended bit rate query procedure; and/or a triggered/pending Configured uplink grant confirmation; and/or a triggered/pending configured sidelink grant confirmation; and/or a triggered/pending Desired Guard Symbol query; and/or a triggered/pending Positioning Measurement Gap Activation/Deactivation Request procedure; and/or a triggered/pending SDT procedure; and/or a triggered/pending IAB-MT Recommended Beam Indication query; and/or a triggered/pending Desired DL TX Power Adjustment query; and/or a triggered/pending Desired IAB-MT PSD range query; and/or a triggered/pending Case-6 Timing Request query. The first procedure may be at least one of the following: Power Headroom Reporting procedure (a pending/triggered PHR); and/or a consistent LBT failure; and/or a triggered/pending Timing Advance Reporting procedure; and/or a triggered/pending BFR; and/or a triggered/pending Positioning Measurement Gap Activation/Deactivation Request procedure; and/or a triggered/pending SDT procedure.

A wireless device may initiate/trigger/start a service link switch (satellite switch) procedure 3404 for switching from the first NTN node (e.g., the first service link) of the first cell to the second NTN node (e.g., the second service link) of a second cell (e.g., with/associated with a second PCI, PCI 2) of the NTN. The wireless device may determine 3406 whether to cancel/stop/abort/terminate the (triggered) first procedure or not (e.g., whether to continue performing the first procedure or not). The wireless device may determine 3406 whether to cancel/stop/abort/terminate the (triggered) first procedure or not, for example, based on/in response to/after starting the service link switch procedure and/or whether the first cell being different than the second cell or not.

A wireless device as shown in FIG. 34 may cancel/stop/abort/terminate the (triggered) first procedure 3410. The wireless device as shown in FIG. 34 may cancel/stop/abort/terminate the (triggered) first procedure 3410 (e.g., not continue performing the first procedure), for example, based on (e.g., in response to)/after starting the service link switch procedure and/or based on the first cell being different than the second cell (e.g., PCI 1 being different than PCI 2 and/or the service link switch procedure comprising/triggering the handover procedure, e.g., the satellite switch is not the second satellite switch procedure). The wireless device may avoid/skip/refuse cancelling/stopping/aborting/terminating the (triggered) first procedure 3408. The wireless device may avoid/skip/refuse cancelling/stopping/aborting/terminating the (triggered) first procedure 3408, for example, based on (e.g., in response to)/after starting the service link switch procedure and/or based on the first cell and the second cell being the same (e.g., PCI 1 being equal to the PCI 2 and/or the service link switch procedure not comprising/triggering the handover procedure, for example, the satellite switch is the second satellite switch procedure).

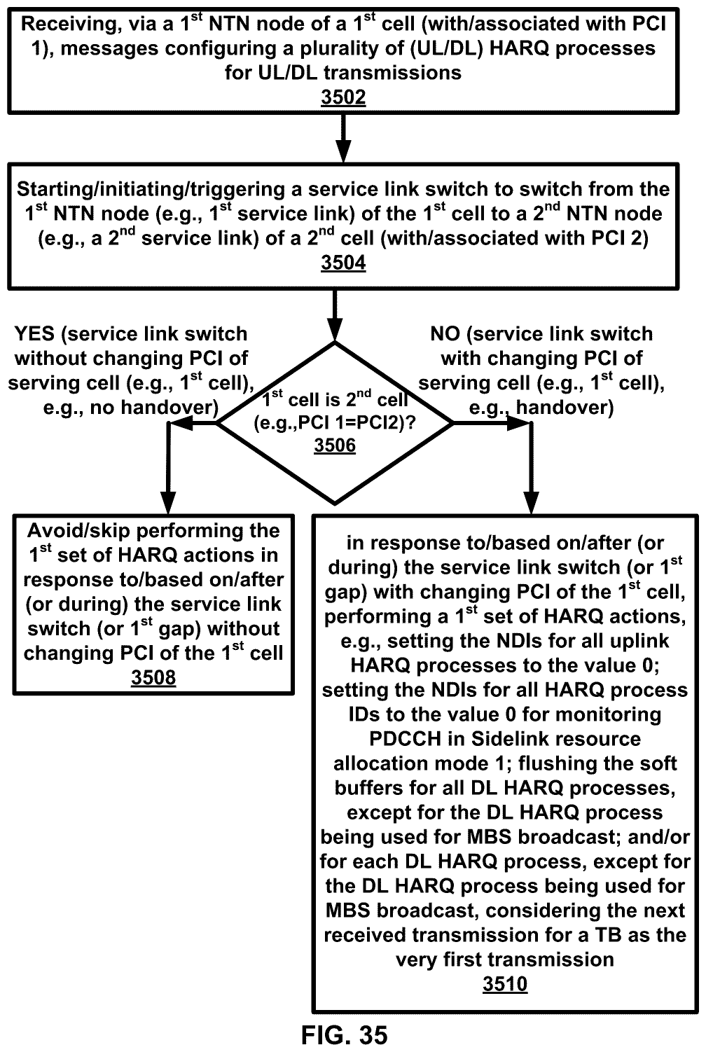

FIG. 35 shows an example flowchart of a service link switch procedure in an NTN. As shown the wireless device may receive, via the first NTN node (e.g., the first service link) of a first cell (e.g., with/associated with the first PCI, PCI 1) of the NTN, the one or more messages 3502 (comprising the one or more configuration parameters). The one or more messages may indicate/configure a plurality of HARQ processes (e.g., one or more UL HARQ processes and/or one or more DL HARQ processes) for UL/DL transmissions with the base station (e.g., via the first cell and/or the first NTN node). The wireless device may initiate/trigger/start the service link switch (satellite switch) procedure for switching from the first NTN node 3504 (e.g., the first service link) of the first cell to the second NTN node (e.g., the second service link) of a second cell (e.g., with/associated with a second PCI, PCI 2) of the NTN. The wireless device may determine whether to perform/execute a first set of HARQ operations or not 3506. The wireless device may determine whether to perform/execute a first set of HARQ operations or not 3506, for example, based on/in response to/after starting the service link switch procedure and/or whether the first cell being different than the second cell or not.

A wireless device as shown in FIG. 35 may perform/execute the first set of HARQ operations 3510. The wireless device as shown in FIG. 35 may perform/execute the first set of HARQ operations 3510, for example, based on the first cell being different than the second cell (e.g., PCI 1 being different than PCI 2 and/or the service link switch procedure comprising/triggering the handover procedure, e.g., the satellite switch is not the second satellite switch procedure), based on (e.g., in response to)/after starting the service link switch procedure and/or based on the first cell being different than the second cell (e.g., PCI 1 being different than PCI 2 and/or the service link switch procedure comprising/triggering the handover procedure, e.g., the satellite switch is not the second satellite switch procedure). The wireless device may avoid/skip/refuse performing/executing the first set of HARQ operations 3508. The wireless device may avoid/skip/refuse performing/executing the first set of HARQ operations 3508, for example, based on (e.g., in response to)/after starting the service link switch procedure and/or based on the first cell and the second cell being the same (e.g., PCI 1 being equal to the PCI 2 and/or the service link switch procedure not comprising/triggering the handover procedure, e.g., the satellite switch is the second satellite switch procedure). The wireless device may improve efficiency (or reduce delay/latency) of UL/DL data transmissions after the satellite switch, by not performing/executing the first set of HARQ operations based on the first cell and the second cell being the same (e.g., PCI 1 being equal to the PCI 2 and/or the service link switch procedure not comprising/triggering the handover procedure, e.g., the satellite switch is the second satellite switch procedure).

A first set of HARQ operations may comprise at least one of the following: setting new data indicators (NDIs) for the one or more uplink (UL) HARQ processes to the value 0; and/or setting the NDIs for at least one HARQ process (of at least one HARQ process ID) of the plurality of HARQ processes (e.g., plurality of HARQ process IDs of the plurality of HARQ processes) to the value 0 for monitoring PDCCH in Sidelink resource allocation mode 1; and/or flushing the soft buffers for the one or more DL HARQ processes (e.g., except for a DL HARQ process of the one or more HARQ processes that is used for MBS broadcast); and/or for each DL HARQ process of the one or more DL HARQ processes, except for the DL HARQ process being used for MBS broadcast, considering the next received transmission for a TB as the very first transmission.

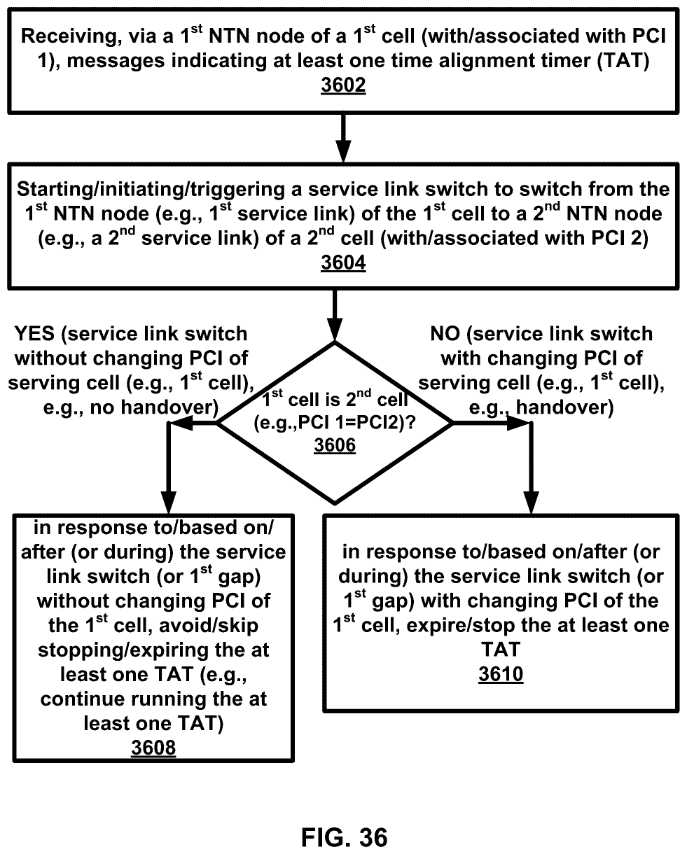

FIG. 36 shows an example flowchart of a service link switch procedure in an NTN. A wireless device as shown may receive, via the first NTN node 3602 (e.g., the first service link) of a first cell (e.g., with/associated with the first PCI, PCI 1) of the NTN, the one or more messages (comprising the one or more configuration parameters). The one or more messages may indicate/configure at least one time alignment timer (TAT). The at least one TAT may comprise timeAlignmentTimers, inactivePosSRS-TimeAlignmentTimer, and cg-SDT-TimeAlignmentTimer per at least one TAG (pTAG and/or sTAG). The at least one TAT may correspond to the first cell. The wireless device may initiate/trigger/start the service link switch (satellite switch) procedure 3604 for switching from the first NTN node (e.g., the first service link) of the first cell to the second NTN node (e.g., the second service link) of a second cell (e.g., with/associated with a second PCI, PCI 2) of the NTN. The wireless device may determine whether to stop/expire the at least one TAT or not 3606. The wireless device may determine whether to stop/expire the at least one TAT or not 3606, for example, based on/in response to/after starting the service link switch procedure and/or whether the first cell being different than the second cell or not. The wireless device may stop/expire the at least one TAT 3610 based on the first cell and the second cell being different (e.g., PCI 1 not being equal to the PCI 2 and/or the service link switch procedure comprising/triggering the handover procedure, e.g., the satellite switch is not the second satellite switch procedure). The wireless device may stop/expire the at least one TAT 3610 based on the first cell and the second cell being different, for example, based on (e.g., in response to)/after starting the service link switch procedure. The wireless device may avoid/skip/refuse stopping/expiring the at least one TAT 3608 based on the first cell and the second cell being the same (e.g., PCI 1 being equal to the PCI 2 and/or the service link switch procedure not comprising/triggering the handover procedure, e.g., the satellite switch is the second satellite switch procedure). The wireless device may avoid/skip/refuse stopping/expiring the at least one TAT 3608 based on the first cell and the second cell being the same, for example, based on (e.g., in response to)/after starting the service link switch procedure.

A wireless device may avoid/skip/refuse stopping/expiring the at least one TAT based on the first cell and the second cell being the first cell and/or a second N_TA (e.g., a TA value of the wireless device or a closed-loop TA value of the wireless device) of/corresponding to/associated with the second cell being equal to a first N_TA (e.g., a TA value of the wireless device or a closed-loop TA value of the wireless device) of/corresponding to/associated with the first cell. The wireless device may avoid/skip/refuse stopping/expiring the at least one TAT, for example, based on the first cell and the second cell being the first cell and/or a second N_TA of/corresponding to/associated with the second cell being equal to a first N_TA of/corresponding to/associated with the first cell and/or based on (e.g., in response to)/after starting the service link switch procedure. The wireless device may avoid/skip stopping/expiring the at least one TAT based on (e.g., in response to) the service link switch, for example, if the N_TA value before and after the satellite switch does not change (e.g., as the cell does not change). The wireless device may avoid/skip performing UL synchronization with/toward the second NTN node of the cell, for example, if the N_TA value before and after the satellite switch does not change (e.g., as the cell does not change). The wireless device may (before starting the satellite switch or at/in/during the satellite switch or after the satellite switch) determine a second open-loop TA value of the wireless device (using the second NTN-config and/or corresponding to the second NTN node of the first cell), regardless of whether the N_TA before and after the satellite switch is the same or not. The second open-loop TA value of the wireless device may be different than a first open-loop TA value of the wireless device (using the first NTN-config and/or corresponding to the first NTN node of the first cell).

One or more configuration parameters (e.g., the one or more messages) may comprise/indicate whether to stop/expire the at least one TAT or not (e.g., based on/in response to/after starting the service link switch procedure). The one or more configuration parameters may comprise a first parameter. The first parameter may be configured by value true or may be enabled. The wireless device may avoid/skip stopping/expiring the at least one TAT. The wireless device may avoid/skip stopping/expiring the at least one TAT, for example, based on (e.g., in response to) the service link switch, based on the first parameter being configured (or being configured by value true or being enabled or not being absent from the one or more configuration parameters or not being configured with value false or not being disabled), and/or based on (e.g., in response to)/after starting the service link switch procedure. The wireless device may stop/expire the at least one TAT based on (e.g., in response to) the service link switch. The wireless device may stop/expire the at least one TAT, for example, based on (e.g., in response to) the service link switch, based on the first parameter not being configured (or not being configured by value true or not being enabled or being absent from the one or more configuration parameters or being configured with value false or being disabled), and/or based on (e.g., in response to)/after starting the service link switch procedure.

A wireless device may avoid/skip performing/executing the second set of actions based on the first cell and the second cell being the same (e.g., PCI 1 being equal to the PCI 2 and/or the service link switch procedure not comprising/triggering the handover procedure, e.g., the satellite switch is the second satellite switch procedure), by not stopping/expiring the at least one TAT. The wireless device may improve efficiency (or reduce delay/latency) of UL/DL data transmissions after the satellite switch by not stopping/expiring the at least one TAT.

A wireless device may implement whether to continue with the ongoing procedure or start with the new procedure (e.g. for SI request), e.g., if a new Random Access procedure is triggered and another is already ongoing in the MAC entity. The wireless device, at/in/during a hard/soft satellite switchover procedure without reconfiguration (e.g., without changing PCI of the serving cell), may abort the ongoing RA procedure, for example, if a Serving Cell is part of the NTN.

A wireless device (e.g., MAC entity of the wireless device) may stop, if any, ongoing Random Access procedure; and/or discard explicitly signaled contention-free Random Access Resources for 4-step RA type and 2-step RA type, if any; and/or flush Msg3 buffer; and/or flush MSGA buffer; and/or discard temporary C-RNTI if exist, for example, if a Serving Cell is part of the NTN and/or a hard/soft satellite switching occurs (without reconfiguration and/or without changing PCI of the serving cell).

A wireless device (e.g., MAC entity of the wireless device) may stop/abort/cancel a triggered Power Headroom Reporting procedure; and/or stop/abort/cancel a triggered consistent LBT failure; and/or stop/abort/cancel a triggered triggered/pending Timing Advance Reporting procedure; and/or stop/abort/cancel a triggered triggered/pending BFR; and/or stop/abort/cancel a triggered triggered/pending Positioning Measurement Gap Activation/Deactivation Request procedure; and/or stop/abort/cancel a triggered triggered/pending SDT procedure, for example, if a Serving Cell is part of the NTN and/or a hard/soft satellite switching occurs (without reconfiguration and/or without changing PCI of the serving cell).

A wireless device (e.g., MAC entity of the wireless device) may continue performing a triggered Power Headroom Reporting procedure; and/or continue performing a triggered consistent LBT failure; and/or continue performing a triggered/pending Timing Advance Reporting procedure; and/or continue performing a triggered triggered/pending BFR; and/or continue performing a triggered triggered/pending Positioning Measurement Gap Activation/Deactivation Request procedure; and/or continue performing a triggered/pending SDT procedure, for example, if a Serving Cell is part of the NTN and/or if a hard/soft satellite switching occurs (without reconfiguration and/or without changing PCI of the serving cell).

A wireless device (e.g., MAC entity of the wireless device), at/in/during a hard/soft satellite switching occurs (without reconfiguration and/or without changing PCI of the serving cell), may avoid triggering a Power Headroom Reporting procedure; and/or avoid triggering a consistent LBT failure; and/or avoid triggering a Timing Advance Reporting procedure; and/or avoid triggering a BFR; and/or avoid triggering a Positioning Measurement Gap Activation/Deactivation Request procedure; and/or avoid triggering SDT procedure; and/or avoid triggering a Scheduling Request procedure; and/or avoid triggering a Buffer Status Reporting procedure, for example, if a Serving Cell is part of the NTN.

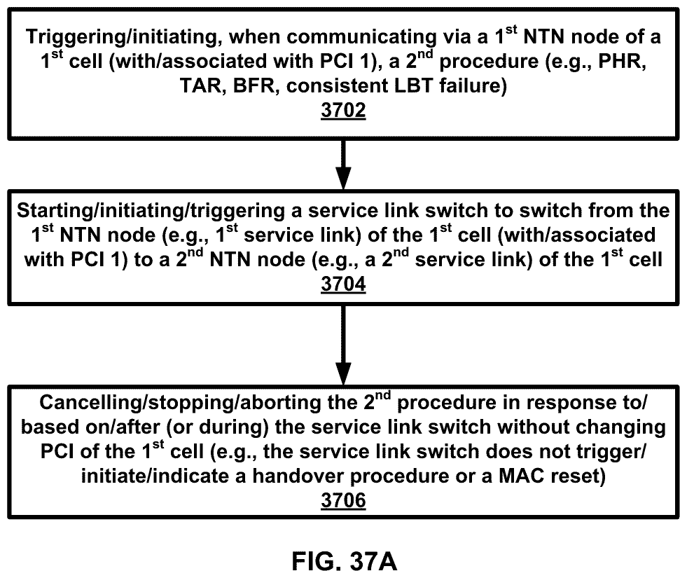

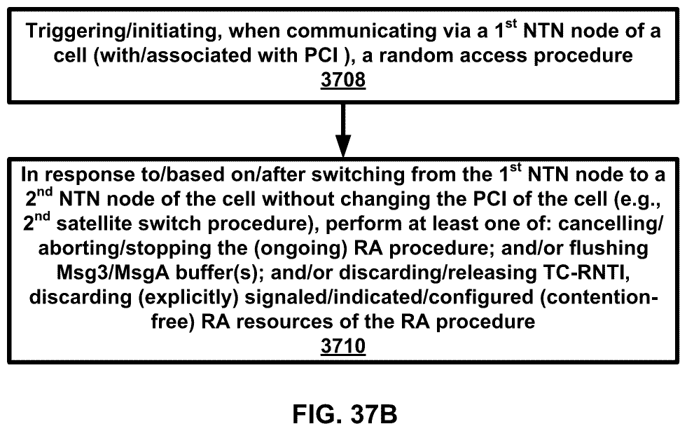

FIG. 37A shows an example flowchart of a service link switch procedure in an NTN. As shown the wireless device may trigger/initiate a second procedure 3702 if communicating via the first NTN node (e.g., the first service link) of the first cell (e.g., with/associated with the first PCI, PCI 1) of the NTN.

A second procedure may be at least one of the following: a Power Headroom Reporting procedure (a pending/triggered PHR); and/or a consistent LBT failure; and/or a triggered/pending Timing Advance Reporting procedure; and/or a triggered/pending BFR; and/or a triggered/pending Positioning Measurement Gap Activation/Deactivation Request procedure; and/or a triggered/pending SDT procedure. The second procedure may not be at least one of the following: a Scheduling Request procedure (a pending/triggered SR); a Buffer Status Reporting procedure (a pending/triggered BSR); and/or a triggered/pending Sidelink Buffer Status Reporting procedure; and/or a triggered/pending Pre-emptive Buffer Status Reporting procedure; and/or a triggered/pending Recommended bit rate query procedure; and/or a triggered/pending Configured uplink grant confirmation; and/or a triggered/pending configured sidelink grant confirmation; and/or a triggered/pending Desired Guard Symbol query; and/or a triggered/pending Positioning Measurement Gap Activation/Deactivation Request procedure; and/or a triggered/pending SDT procedure; and/or a triggered/pending IAB-MT Recommended Beam Indication query; and/or a triggered/pending Desired DL TX Power Adjustment query; and/or a triggered/pending Desired IAB-MT PSD range query; and/or a triggered/pending Case-6 Timing Request query.

A wireless device, as shown in FIG. 37A, may cancel (e.g., abort or stop or terminate) the (triggered) second procedure (if pending). The wireless device may cancel (e.g., abort or stop or terminate) the (triggered) second procedure, for example, based on (e.g., in response to)/after/based on the second satellite switch method/procedure 3704 (e.g., service link switch without changing PCI of the first cell, e.g., no handover). For example, the wireless device may avoid resetting the wireless device (e.g., MAC entity of the wireless device) in response to/after/based on the second satellite switch method/procedure (e.g., service link switch without changing PCI of the first cell, e.g., no handover).

A wireless device may cancel (e.g., abort or stop or terminate) the (triggered) second procedure 3706 (if pending). The wireless device may cancel (e.g., abort or stop or terminate) the (triggered) second procedure 370, for example, in response to/after/based on starting the second satellite switch method/procedure (e.g., starting the first gap). The wireless device may start the second satellite switch method/procedure and cancel the second procedure 370.

A wireless device may, at/in/during the second satellite switch method/procedure (e.g., at/in/during the first gap), cancel (e.g., abort or stop or terminate) the (triggered) second procedure (if pending). The wireless device may cancel the (triggered) second procedure, for example, in response to/after/based on the second satellite switch method/procedure.

A wireless device may cancel (e.g., abort or stop or terminate) the (triggered) second procedure (if pending). The wireless device may cancel (e.g., abort or stop or terminate) the (triggered) second procedure, for example, in response to/after/based on completing the second satellite switch method/procedure (e.g., expiry of the first gap). The wireless device may complete the second satellite switch method/procedure and cancel the second procedure.

A wireless device may cancel (e.g., abort or stop or terminate) the (triggered) second procedure (if pending). The wireless device may cancel (e.g., abort or stop or terminate) the (triggered) second procedure (if pending), for example, based on (e.g., in response to)/after the second satellite switch method/procedure and/or based on the second satellite switch method being a hard satellite switch procedure (or not being a soft satellite switch procedure). The wireless device may avoid/skip cancelling/aborting/stopping the triggered second procedure (if pending). The wireless device may avoid/skip cancelling/aborting/stopping the triggered second procedure (if pending), for example, based on the second satellite switch method being a soft satellite switch procedure (or not being a hard satellite switch procedure), and/or based on (e.g., in response to)/after the second satellite switch method/procedure. The wireless device may avoid/skip cancelling the triggered second procedure (if pending) based on the second satellite switch method being a soft satellite switch procedure, for example, if the wireless device cannot be able to communicate with at least one NTN node of the cell (e.g., the first NTN node or the second NTN node),

A wireless device may cancel/abort the triggered second procedure (if pending). The wireless device may cancel/abort the triggered second procedure (if pending), for example, based on (e.g., in response to)/after the second satellite switch method/procedure (e.g., starting the first gap) and/or based on the length of the first gap being non-zero (or being larger than a first threshold, e.g., 0).

The wireless device may avoid/skip cancelling/aborting the triggered second procedure (if pending) based on the length of the first gap being zero (or being smaller than or equal to the first threshold). The wireless device may avoid/skip cancelling/aborting the triggered second procedure (if pending), for example, based on (e.g., in response to)/after starting the second satellite switch method/procedure (e.g., starting the first gap) and/or based on the length of the first gap being zero (or being smaller than or equal to the first threshold). The one or more configuration parameters may configure/indicate the first threshold. Not canceling the triggered second procedure may result in inaccurate/outdated PHR and/or TAR and/or BFR and/or the LBT or the like. for example, if the length of the first gap is larger than the first threshold.

FIG. 37B shows an example flowchart of a service link switch procedure in an NTN. The wireless device as shown may (e.g., based on the one or more RA configuration parameters and/or using the at least one RA resource for transmission of a preamble) trigger/initiate an RA procedure 3708 if communicating via the first NTN node (e.g., the first service link) of a first cell (e.g., with/associated with the first PCI, PCI 1) of the NTN, for example, for transmission of a preamble via the first NTN node of the cell. The wireless device may abort/stop/cancel the ongoing RA procedure (if ongoing). The wireless device may abort/stop/cancel the ongoing RA procedure (if ongoing), for example, based on (or in response to or after) the second satellite switch method/procedure (e.g., based on/in response to/during/after starting the first gap). The wireless device may abort/stop/cancel the RA procedure 3710 (if ongoing). The wireless device may abort/stop/cancel the RA procedure 3710 (if ongoing), for example, based on/in response to/after completing the second satellite switch method/procedure (e.g., the expiry of the first gap). The wireless device may abort/stop/cancel the RA procedure (if ongoing). The wireless device may abort/stop/cancel the RA procedure (if ongoing), for example, based on (e.g., in response to) starting the first gap.

A wireless device may flush a buffer of the message of the RA procedure 3710 (e.g., Msg3/MsgA). The wireless device may flush a buffer of the message of the RA procedure 3710 (e.g., Msg3/MsgA), for example, based on (or in response to or after) the second satellite switch method/procedure (e.g., based on/in response to/during/after starting the first gap). The wireless device may flush the buffer of the message of the RA procedure. The wireless device may flush the buffer of the message of the RA procedure, for example, based on/in response to/after completing the second satellite switch method/procedure (e.g., the expiry of the first gap). The wireless device may flush the buffer of the message of the RA procedure. The wireless device may flush the buffer of the message of the RA procedure, for example, based on (e.g., in response to) starting the first gap.

A wireless device may discard/release/delete/clear the at least one RA resource of the RA procedure 3710. The wireless device may discard/release/delete/clear the at least one RA resource of the RA procedure 3710, for example, based on (or in response to or after) the second satellite switch method/procedure (e.g., based on/in response to/during/after starting first the gap). The wireless device may discard/release/delete/clear at least one RA resource of the RA procedure. The wireless device may discard/release/delete/clear at least one RA resource of the RA procedure, for example, based on/in response to/after completing the second satellite switch method/procedure (e.g., the expiry of the first gap). The wireless device may discard/release/delete/clear at least one RA resource of the RA procedure. The wireless device may discard/release/delete/clear at least one RA resource of the RA procedure, for example, based on (e.g., in response to) starting the first gap.

A wireless device may discard/release/delete/clear the TC-RNTI of the RA procedure 3710. The wireless device may discard/release/delete/clear the TC-RNTI of the RA procedure 3710, for example, based on (or in response to or after) the second satellite switch method/procedure (e.g., based on/in response to/during/after starting the first gap). The wireless device may discard/release/delete/clear the TC-RNTI of the RA procedure. The wireless device may discard/release/delete/clear the TC-RNTI of the RA procedure, for example, based on/in response to/after completing the second satellite switch method/procedure (e.g., the expiry of the first gap). The wireless device may discard/release/delete/clear the TC-RNTI of the RA procedure. The wireless device may discard/release/delete/clear the TC-RNTI of the RA procedure, for example, based on (e.g., in response to) starting the first gap.

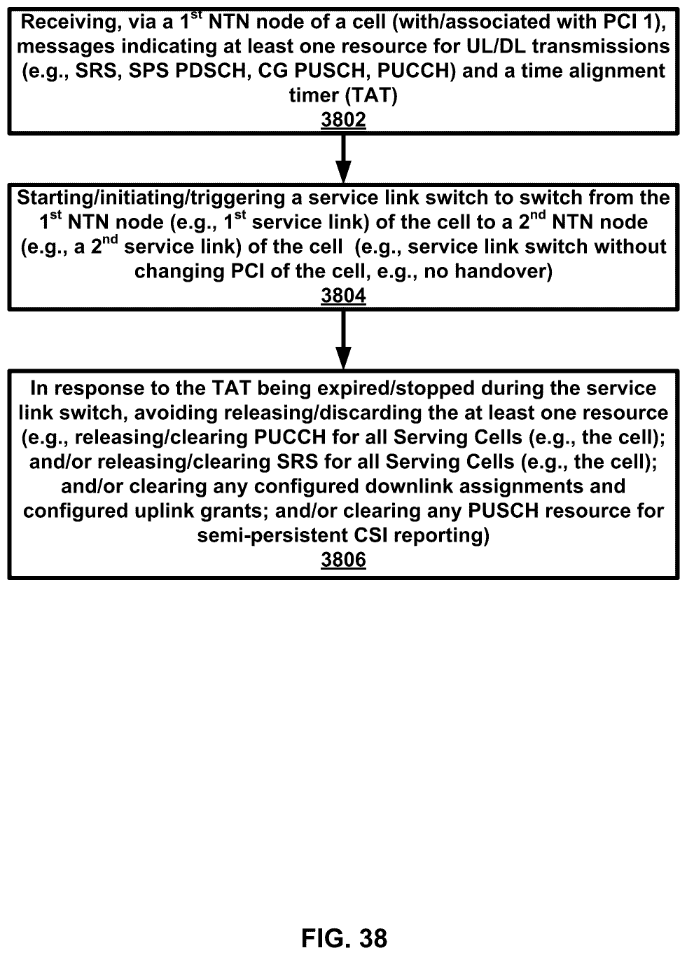

FIG. 38 shows an example flowchart of a service link switch procedure in an NTN. The wireless device as shown may receive, via the first NTN node (e.g., the first service link) of a (first) cell (e.g., with/associated with the first PCI, PCI 1) of the NTN, the one or more messages (comprising the one or more configuration parameters) 3802. The one or more messages may indicate/configure at least one resource for UL/DL transmissions with the base station (e.g., via the first cell and/or the first NTN node). The at least one resource may comprise (e.g., via the one or more configuration parameters, e.g., via SPS-Config) SPS PDSCH resource(s) for semi-persistent/periodic DL SPS transmissions. The at least one resource may comprise (e.g., via the one or more configuration parameters, e.g., via CG-Config) CG PUSCH resources (e.g., Type 1/Type 2 CG PUSCH resources) for RRC/DCI activated CG PUSCH transmissions. The at least one resource may comprise (e.g., via the one or more configuration parameters, e.g., via PUSCH-Config or PUSCH-ConfigCommon) PUSCH resources for (semi-persistent) CSI report. The at least one resource may comprise (e.g., via the one or more configuration parameters, e.g., via PUCCH-Config or PUCCH-ConfigCommon) PUCCH resources for transmission of one or more UCIs (e.g., SR, HARQ-ACK, CSI report or the like). The at least one resource may comprise (e.g., via the one or more configuration parameters, e.g., via SRS-Config) SRS resources for SRS transmissions (e.g., for beam management or power control or positioning). The one or more messages may indicate/configure the at least one TAT.

A wireless device may initiate/trigger/start the service link switch (satellite switch) procedure 3804 for switching from the first NTN node (e.g., the first service link) of the first cell to the second NTN node (e.g., the second service link) of the first cell (e.g., with/associated with the first PCI, PCI 1) of the NTN. For example, the wireless device may determine at/in/during the satellite switch procedure (e.g., the second satellite switch method/procedure, e.g., at/in/during the first gap), the at least one TAT being stopped/expired. The wireless device may avoid/skip performing the second set of actions. The wireless device may avoid/skip performing the second set of actions, for example, based on/in response to/after the service link switch procedure (e.g., the second satellite switch method) and the at least one TAT being expired/stopped.

A wireless device may avoid/skip releasing/discarding/clearing PUCCH (e.g., the PUCCH resources for transmission of one or more UCIs) for all Serving Cells 3806 (e.g., the first cell), such as avoiding/skipping performing the second set of actions. The wireless device may avoid/skip releasing/discarding/clearing the PUCCH, for example, based on/in response to/after the service link switch procedure (e.g., the second satellite switch method) and the at least one TAT being expired/stopped. The wireless device may avoid/skip releasing/discarding/clearing SRS (e.g., the SRS resources for SRS transmissions) for all Serving Cells 3806 (e.g., the first cell), for example, avoiding/skipping performing the second set of actions. The wireless device may avoid/skip releasing/discarding/clearing SRS, for example, based on/in response to/after the service link switch procedure (e.g., the second satellite switch method) and the at least one TAT being expired/stopped. The wireless device may avoid/skip clearing/releasing/discarding (any) configured downlink assignments 3806 (e.g., corresponding to the SPS PDSCH resource(s) for semi-persistent/periodic DL SPS transmissions) and/or any configured uplink grants (e.g., corresponding to the CG PUSCH resources), for example avoiding/skipping performing the second set of actions. The wireless device may avoid/skip clearing/releasing/discarding the configured downlink assignments 3806, for example, based on/in response to/after the service link switch procedure (e.g., the second satellite switch method) and the at least one TAT being expired/stopped. The wireless device may avoid/skip clearing/discarding/releasing any PUSCH resource for semi-persistent CSI reporting 3806, for example, avoiding/skipping performing the second set of actions. The wireless device may avoid/skip clearing/discarding/releasing any PUSCH resource, for example, based on/in response to/after the service link switch procedure (e.g., the second satellite switch method) and the at least one TAT being expired/stopped.

One or more configuration parameters (e.g., the one or more messages) may comprise/indicate whether to perform the second set of actions based on (e.g., in response to) stopping/expiring the at least one TAT at/in/during the service link switch procedure. The one or more configuration parameters may comprise a second parameter. The second parameter may be configured by value True or may be enabled. The wireless device may avoid/skip performing/executing the second set of actions. The wireless device may avoid/skip performing/executing the second set of actions, for example, based on the second parameter being configured (or being configured by value true or being enabled or not being absent from the one or more configuration parameters or not being configured with value false or not being disabled), and/or based on (e.g., in response to)/after the service link switch procedure (e.g., the second satellite switch method) and the at least one TAT being expired/stopped. The wireless device may perform/execute the second set of actions. The wireless device may perform/execute the second set of actions, for example, based on the second parameter not being configured (or not being configured by value true or not being enabled or being absent from the one or more configuration parameters or being configured with value false or being disabled), and/or based on (e.g., in response to)/after the service link switch procedure (e.g., the second satellite switch method) and the at least one TAT being expired/stopped.

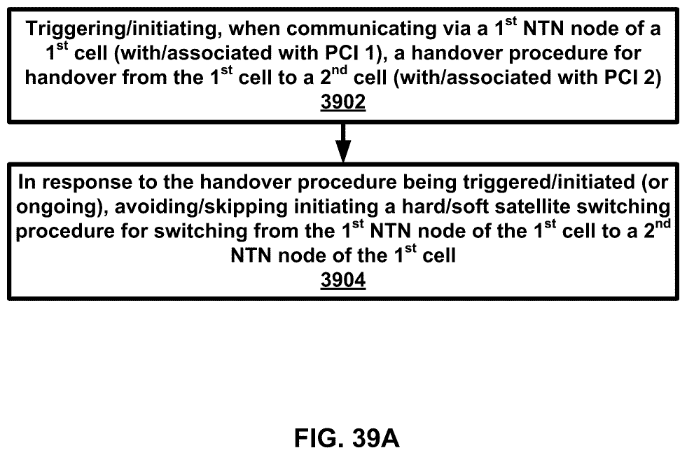

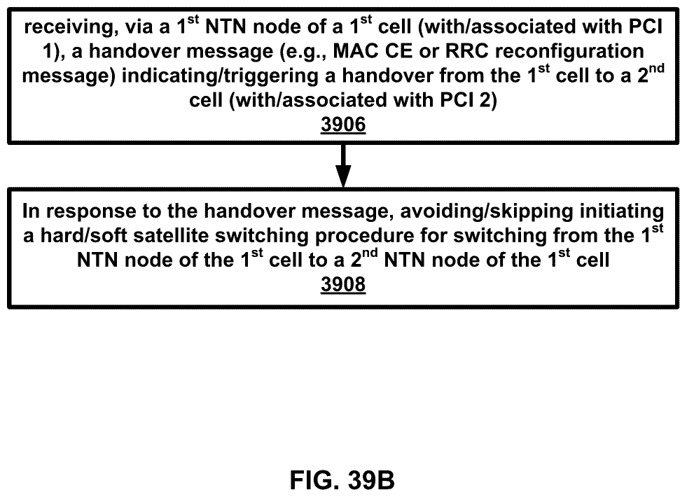

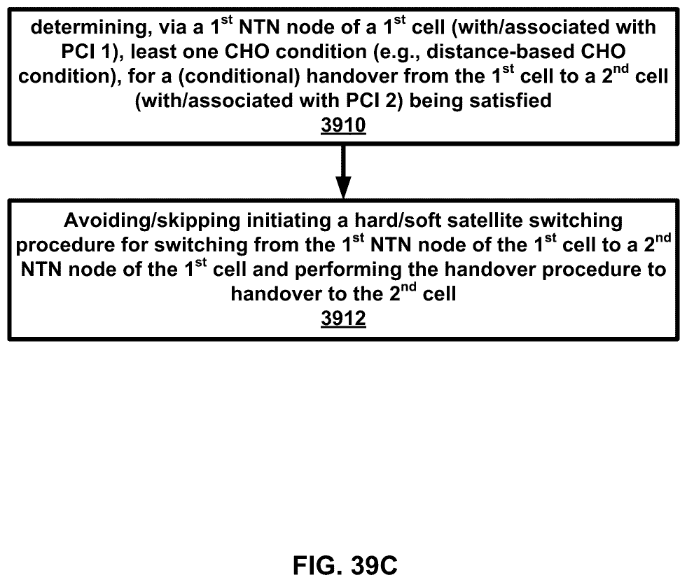

FIG. 39A shows an example flowchart of a handover procedure in an NTN. The wireless device may trigger/initiate the handover procedure 3902 if communicating via the first NTN node (e.g., the first service link) of the first cell (e.g., with/associated with the first PCI, PCI 1) of the NTN. Triggering/initiating the handover procedure (e.g., a normal handover or a conditional handover) may be based on examples from FIGS. 24-28 discussed above. The handover procedure may be for handover from the first cell to a second cell (e.g., with/associated with the second PCI, PCI 2). The second cell may be part of the NTN. The second cell may not be part of the NTN (e.g., may be part of a terrestrial network). The second cell may be different than the first cell. The wireless device may determine the second cell (target cell) for the handover based on the measurements of SSBs/CSI-RSs of the second cell. The wireless device may avoid/skip triggering/starting the second satellite switch procedure/method 3904 (e.g., for switching from the first NTN node of the first cell to the second NTN node of the first cell without changing the first PCI). The wireless device may avoid/skip triggering/starting the second satellite switch procedure/method 3904, for example, based on (e.g., in response to) the handover procedure being triggered/initiated/ongoing.

A wireless device may be able to successfully handover to the second cell, for example, by performing the HO procedure and avoiding triggering/starting the second satellite switch procedure/method (as discussed in FIGS. 39A/39B/39C). Coverage area of NTN nodes of the first cell as in the NTN (the first NTN node of the first cell and/or the second NTN node of the first cell) may be different (e.g., the coverage area of the first NTN node of the first cell being larger than the coverage area of the second NTN node of the first cell). The wireless device may determine to handover to the second cell of the NTN instead of switching from the first NTN node of the first cell to the second NTN node of the first cell.

A wireless device may be located around cell edge of the first cell. The wireless device by avoiding the switching from the first NTN node of the first cell to the second NTN node of the first cell (e.g., by executing handover to the second cell) improve UL/DL transmission efficiency, for example, if the second cell is a better candidate cell compared to the first cell.

One or more configuration parameters (e.g., the one or more messages) may comprise/indicate a third parameter. The third parameter may indicate whether the handover procedure has a higher priority than the second satellite switch procedure or not. For example, the third parameter may allow the wireless device to determine whether to perform/trigger the handover procedure to handover to the second cell or trigger/perform the second satellite switch procedure (switching NTN node without handover).

A third parameter may be configured by value True or may be enabled. The wireless device may prioritize the handover procedure (e.g., avoid performing the second satellite switch procedure), for example, perform the handover procedure. The wireless device may prioritize the handover procedure, for example, based on the third parameter being configured (or being configured by value true or being enabled or not being absent from the one or more configuration parameters or not being configured with value false or not being disabled). The wireless device may prioritize the second satellite switch procedure (e.g., avoid performing the handover procedure), for example, trigger/perform the second satellite switch procedure. The wireless device may prioritize the second satellite switch procedure, for example, based on the third parameter not being configured (or not being configured by value true or not being enabled or being absent from the one or more configuration parameters or being configured with value false or being disabled).

FIG. 39B shows an example flowchart of a handover procedure in an NTN. The wireless device may, via the first NTN node (e.g., the first service link) of the first cell (e.g., with/associated with the first PCI, PCI 1) of the NTN, receive the handover message (e.g., see FIGS. 24-28 discussed above), for example, triggering/indicating handover from the first cell to a second cell 3906 (e.g., with/associated with the second PCI, PCI 2). The wireless device may avoid/skip triggering/starting the second satellite switch procedure/method 3908 (e.g., for switching from the first NTN node of the first cell to the second NTN node of the first cell without changing the first PCI). The wireless device may avoid/skip triggering/starting the second satellite switch procedure/method 3908, for example, in response to/based on the handover message. The wireless device may prioritize the handover procedure (triggered/initiated based on the handover message) over/on the second satellite switch procedure, and the base station may (using the measurement report) determine the handover to the second cell. The wireless device may follow the instruction/indication (e.g., the handover message) from the network (base station) by avoiding/skipping triggering/starting the second satellite switch procedure/method.

A wireless device may avoid/skip triggering/starting the second satellite switch procedure/method (e.g., for switching from the first NTN node of the first cell to the second NTN node of the first cell without changing the first PCI) and may trigger/perform the handover procedure. The wireless device may avoid/skip triggering/starting the second satellite switch procedure/method and may trigger/perform the handover procedure, for example, in response to/based on the handover message and the third parameter being configured (or being configured by value true or being enabled or not being absent from the one or more configuration parameters or not being configured with value false or not being disabled). The wireless device may avoid/skip triggering/starting the second satellite switch procedure/method (e.g., for switching from the first NTN node of the first cell to the second NTN node of the first cell without changing the first PCI) and may trigger/perform the handover procedure. The wireless device may avoid/skip triggering/starting the second satellite switch procedure/method and may trigger/perform the handover procedure, for example, in response to/based on the handover message and the third parameter not being configured (or not being configured by value true or not being enabled or being absent from the one or more configuration parameters or being configured with value false or being disabled). The wireless device may trigger/perform the second satellite switch procedure/method (e.g., for switching from the first NTN node of the first cell to the second NTN node of the first cell without changing the first PCI) and avoid/skip triggering/starting the handover procedure. The wireless device may trigger/perform the second satellite switch procedure/method and avoid/skip triggering/starting the handover procedure, for example, in response to/based on the handover message and the third parameter not being configured (or not being configured by value true or not being enabled or being absent from the one or more configuration parameters or being configured with value false or being disabled).

FIG. 39C shows an example flowchart of a conditional handover procedure. The wireless device may trigger/initiate the conditional handover procedure if communicating via the first NTN node (e.g., the first service link) of the first cell (e.g., with/associated with the first PCI, PCI 1) of the NTN. Triggering/initiating the conditional handover procedure (e.g., a normal handover or a conditional handover) may be based on examples from FIG. 25 discussed above. The wireless device may avoid/skip triggering/starting the second satellite switch procedure/method (e.g., for switching from the first NTN node of the first cell to the second NTN node of the first cell without changing the first PCI). The wireless device may avoid/skip triggering/starting the second satellite switch procedure/method (e.g., for switching from the first NTN node of the first cell to the second NTN node of the first cell without changing the first PCI), for example, in response to/based on the (conditional) handover procedure being ongoing/initiated/triggered.

A wireless device may determine the at least one CHO execution condition 3910 (e.g., the distance-based event or the time-based event) being satisfied. The wireless device may avoid/skip triggering/starting the second satellite switch procedure/method 3912 (e.g., for switching from the first NTN node of the first cell to the second NTN node of the first cell without changing the first PCI). The wireless device may avoid/skip triggering/starting the second satellite switch procedure/method 3912, for example, in response to/based on the at least one CHO execution condition being satisfied. The wireless device may perform/execute the conditional handover based on the at least one CHO execution condition (e.g., the distance-based event or the time-based event) being satisfied.

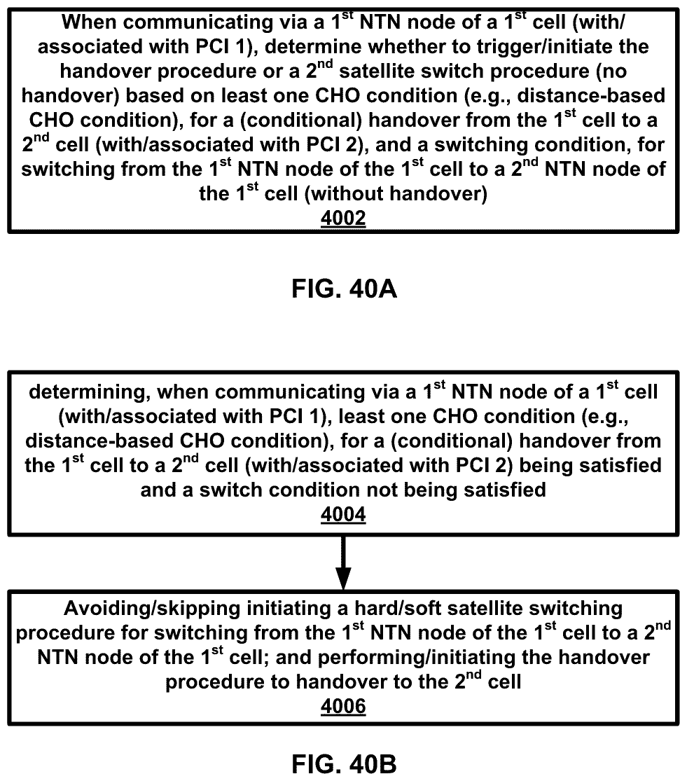

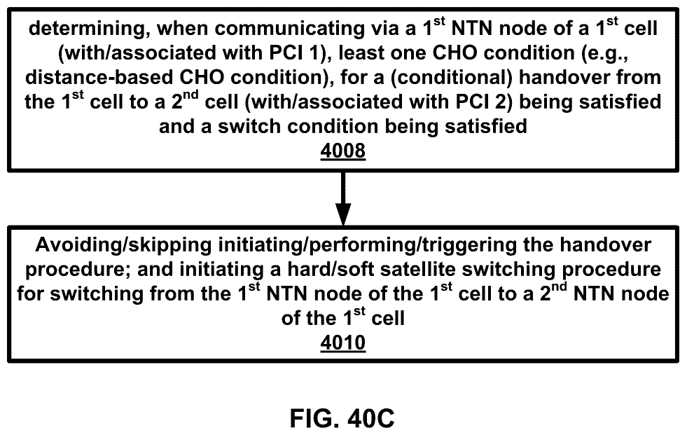

FIG. 40A shows an example flowchart of a handover procedure in an NTN. The wireless device may determine whether to trigger/initiate/start the satellite switch procedure/method 4002 (e.g., for switching from the first NTN node of the first cell to the second NTN node of the first cell without changing the first PCI) or to trigger/initiate/execute the handover procedure. The wireless device may determine whether to trigger/initiate/start the satellite switch procedure/method 4002 or to trigger/initiate/execute the handover procedure, for example, based on the at least one CHO execution condition and a switching condition (e.g., corresponding to the second NTN node of the first cell or corresponding to the first cell). The wireless device may trigger/initiate/start the satellite switch procedure/method (e.g., for switching from the first NTN node of the first cell to the second NTN node of the first cell without changing the first PCI). The wireless device may trigger/initiate/start the satellite switch procedure/method, for example, based on the at least one CHO execution condition and the switching condition. The wireless device may trigger/initiate/execute the handover procedure to handover to the second cell. The wireless device may trigger/initiate/execute the handover procedure to handover to the second cell, for example, based on the at least one CHO execution condition and the switching condition.

Switching condition may be based on the first time/occasion. The switching condition may be based on the second NTN-config (e.g., ephemeris of the second NTN node). The switching condition may be based on relative distance to a reference point of the first cell and a reference point of the second cell. The switching condition may be based on relative distance to the second NTN node of the first cell and a third NTN node of the second cell. For example, the switching condition may be based on a length (or delay or elevation angle) of/corresponding to the second service link (corresponding to the second NTN node) and a length (or delay or elevation angle) of/corresponding to a third service link (corresponding to a third NTN node of the second cell). The switching condition may be based on the third parameter.

A wireless device may determine the switching condition being satisfied based on at least one of the following: distance to a reference point of the first cell being shorter/smaller than a distance to a reference point of the second cell; and/or a time to a start of the second satellite switch method being shorter/smaller than a threshold; and/or a distance to the second NTN node of the first cell being larger than a distance to the third NTN node of the second cell; and/or a length (or delay or elevation angle) of/corresponding to the second service link (corresponding to the second NTN node) being larger than a length (or delay or elevation angle) of/corresponding to a third service link (corresponding to a third NTN node of the second cell); and/or the third parameter not being enabled/configured (or being disabled or being absent from the one or more configuration parameters).

FIG. 40B shows an example flowchart of a handover procedure in an NTN. The wireless device may trigger/initiate/execute the handover procedure. The wireless device may trigger/initiate/execute the handover procedure, for example, based on the at least one CHO execution condition being satisfied and the switching condition not being satisfied 4004. The wireless device may avoid/skip triggering/starting the second satellite switch procedure/method 4006 (e.g., for switching from the first NTN node of the first cell to the second NTN node of the first cell without changing the first PCI). The wireless device may avoid/skip triggering/starting the second satellite switch procedure/method 4006, for example, based on the at least one CHO execution condition being satisfied and the switching condition not being satisfied.

FIG. 40C shows an example flowchart of a satellite switch procedure in an NTN. The wireless device may trigger/initiate/start the satellite switch procedure/method. The wireless device may trigger/initiate/start the satellite switch procedure/method, for example, based on the at least one CHO execution condition being satisfied and the switching condition being satisfied 4008. The wireless device may avoid/skip triggering/initiating/performing the handover procedure 4010. The wireless device may avoid/skip triggering/initiating/performing the handover procedure 4010, for example, based on the at least one CHO execution condition being satisfied and the switching condition being satisfied. The wireless device may trigger/initiate/start the satellite switch procedure/method. The wireless device may trigger/initiate/start the satellite switch procedure/method, for example, based on the at least one CHO execution condition not being satisfied and the switching condition being satisfied.

A wireless device may perform a method comprising multiple operations. The wireless device may receive an indication of a time for switching from a first satellite of a first cell to a second satellite of the first cell, wherein the switching is without changing a physical cell identification of the first cell; may receive a radio resource control (RRC) reconfiguration message indicating handover from the first cell to a second cell; based on receiving the RRC reconfiguration message before the time for the switching, may initiate the handover. The wireless device may further send, based on receiving the RRC reconfiguration message before the time for the switching, a request to handover the wireless device to the second cell, wherein the receiving the RRC reconfiguration message comprises receiving the RRC reconfiguration message after the receiving the indication and before initiating the switching to the second satellite of the first cell; and wherein the method further comprises: sending, based on the switching to the second satellite of the first cell not being initiated, a request to handover the wireless device to the second cell; wherein the initiating the handover comprises sending a request to handover the wireless device to the second cell; wherein the first satellite of the first cell is associated with a first physical cell identification, and wherein the second satellite of the first cell is associated with the first physical cell identification; wherein the initiating the handover is further based on the wireless device being served by the first satellite of the first cell; wherein the initiating the handover is further based on a switch, to the second satellite of the first cell, not being initiated; wherein the receiving the indication of the time for switching from the first satellite of the first cell to the second satellite of the first cell comprises: receiving a system information block (SIB) comprising a parameter indicating the time for switching from the first satellite of the first cell to the second satellite of the first cell; wherein the receiving the indication of the time for switching from the first satellite of the first cell to the second satellite of the first cell comprises receiving: a first parameter indicating a first time to start the switching from the first satellite of the first cell to the second satellite of the first cell; and a second parameter indicating a second time for the second satellite of the first cell to start servicing the wireless device. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a base station configured to send the indication of the time for switching from the first satellite of the first cell to the second satellite of the first cell. A computer-readable medium storing instructions that, when executed, cause performance of the described method, additional operations and/or include the additional elements.

A wireless device may perform a method comprising multiple operations. The wireless device may receive an indication of a time for switching from a first node of a first cell to a second node of the first cell, wherein the switching is without changing a physical cell identification of the first cell; may receive an indication to handover the wireless device from the first cell to a second cell; may send, based on the receiving the indication to handover being before the time for the switching, a request to handover the wireless device to the second cell, wherein the first node comprises a first non-terrestrial network node, and wherein the second node comprises a second non-terrestrial network node, wherein the first non-terrestrial network node comprises a first satellite, and wherein the second non-terrestrial network node comprises a second satellite; wherein the receiving the indication to handover to the wireless device from the first cell to the second cell comprises receiving a radio resource control (RRC) reconfiguration message indicating to handover from the first cell to the second cell. The wireless device may determine whether to send the request based on: the time for the switching; and whether at least one condition for triggering the handover is satisfied; and wherein the sending the request is further based on the at least one condition being satisfied before the time for the switching. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a base station configured to send the indication of the time for switching from the first satellite of the first cell to the second satellite of the first cell. A computer-readable medium storing instructions that, when executed, cause performance of the described method, additional operations and/or include the additional elements.

A wireless device may perform a method comprising multiple operations. The wireless device may receive an indication to switch from a first node of a first cell associated with a first physical cell identification to a second node of the first cell associated with the first physical cell identification; after the receiving the indication and before initiating a switch to the second node, may receive an indication to handover the wireless device from the first cell to a second cell; may send, based on a switch to the second node not being initiated, a request to handover the wireless device to the second cell, wherein the indication to handover to the wireless device from the first cell to the second cell indicates at least one condition for sending the request to handover the wireless device to the second cell. The wireless device may skip, based on the sending the request to handover the wireless device to the second cell, the switch to the second node, wherein the first node comprises a first non-terrestrial network node, and wherein the second node comprises a second non-terrestrial network node; wherein the first non-terrestrial network node comprises a first satellite, and wherein the second non-terrestrial network node comprises a second satellite; wherein the receiving the indication to handover to the wireless device from the first cell to the second cell comprises receiving a radio resource control (RRC) reconfiguration message indicating to handover from the first cell to the second cell. The wireless device may, based on the initiated handover procedure, avoid initiating the switching at the time indicated by system information block (SIB). A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a base station configured to send the indication of the time for switching from the first satellite of the first cell to the second satellite of the first cell. A computer-readable medium storing instructions that, when executed, cause performance of the described method, additional operations and/or include the additional elements.

A wireless device may perform a method comprising multiple operations. The wireless device may receive a system information block (SIB) indicting a time for switching from a first non-terrestrial network (NTN) node of a first cell to a second NTN node of the first cell, wherein the switching is without changing a physical cell identification (PCI) of the first cell; may receive a radio resource control (RRC) reconfiguration message indicating at least one condition for triggering handover from a first cell to a second cell; may determine whether to initiate the handover based on: the time for the switching; and whether the at least one condition being satisfied; based on the at least one condition being satisfied after the time for the switching, may avoid initiating the handover. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a base station configured to send the indication of the time for switching from the first satellite of the first cell to the second satellite of the first cell. A computer-readable medium storing instructions that, when executed, cause performance of the described method, additional operations and/or include the additional elements.

A wireless device may perform a method comprising multiple operations. The wireless device may receive a system information block (SIB) indicting a time for switching from a first non-terrestrial network (NTN) node of a first cell to a second NTN node of the first cell, wherein the switching is without changing a physical cell identification (PCI) of the first cell; may receive a radio resource control (RRC) reconfiguration message indicating at least one condition for initiating handover from a first cell to a second cell; may determine whether the at least one condition being satisfied or not to determine whether to initiate the handover procedure or not; based on the handover procedure not being initiated before the time, may switch, at the time, from a first non-terrestrial network (NTN) node of the first cell to a second NTN node of the first cell. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a base station configured to send the indication of the time for switching from the first satellite of the first cell to the second satellite of the first cell. A computer-readable medium storing instructions that, when executed, cause performance of the described method, additional operations and/or include the additional elements.

A wireless device may perform a method comprising multiple operations. The wireless device may receive a system information block (SIB) indicting a time for switching from a first non-terrestrial network (NTN) node of a first cell to a second NTN node of the first cell, wherein the switching is without changing a physical cell identification (PCI) of the first cell; may receive a radio resource control (RRC) reconfiguration message indicating at least one condition for triggering handover from a first cell to a second cell; may switch at the time indicated by the time indication from the first NTN node of the first cell to the second NTN node of the first cell; based on the switching, may avoid initiating the handover in response to the at least one condition being satisfied. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a base station configured to send the indication of the time for switching from the first satellite of the first cell to the second satellite of the first cell. A computer-readable medium storing instructions that, when executed, cause performance of the described method, additional operations and/or include the additional elements.

A wireless device may perform a method comprising multiple operations. The wireless device may trigger, based on communicating via a first non-terrestrial network (NTN) node of a first cell, a first procedure; may, based on switching from the first NTN node to a second NTN node of a second cell, determine whether the first cell is the second cell or not; based on the first cell and the second cell being the same, may continue the first procedure after the switching, wherein the continuing the first procedure comprises not canceling the triggered first procedure; wherein the continuing the first procedure comprises not aborting or stopping the first procedure; wherein the first procedure is at least one of: a radio resource monitoring (RRM) procedure; a radio link monitoring (RLM) procedure; a power headroom report (PHR) procedure; a random access (RA) procedure, wherein the RA procedure is not part of a handover procedure; a small data transmission (SDT) procedure; a timing advance reporting (TAR) procedure; scheduling request (SR) procedure; or a buffer status reporting (BSR) procedure; wherein the switching from the first NTN node to the second NTN node does not comprise initiating/performing a handover procedure or a reconfiguration with sync procedure; wherein a physical cell identification (PCI) of the first cell is equal to the PCI of the second cell. The wireless device may receive, via the first NTN node of the first cell, one or more configuration parameters, wherein the one or more configuration parameters comprise a first gap for switching from the first NTN node to the second NTN node without changing PCI of the first cell; wherein the switching from the first NTN node to the second NTN node is during a first gap; wherein the one or more configuration parameters comprise one or more NTN configuration parameters corresponding to the first NTN node; wherein the switching from the first NTN node to the second NTN node is based on one or more NTN configuration parameters, wherein the one or more NTN configuration parameters indicate at least one of: a first time/occasion that a first coverage area provided by the first NTN node is stopped; a second time/occasion that a second coverage area provided by the second NTN node is started; or a time gap for the switching. The wireless device may, based on the first cell and the second cell being different, stop the first procedure after the switching; wherein the canceling the first procedure comprises at least one of: stopping the first procedure; aborting the first procedure; or cancelling the triggered first procedure. A computing device may comprise: one or more processors; and memory storing instructions that, when executed by the one or more processors, cause the computing device to perform the described method, additional operations and/or include the additional elements. A system comprising: a wireless device configured to perform the described method, additional operations and/or include the additional elements; and a base station configured to send the indication of the time for switching from the first satellite of the first cell to the second satellite of the first cell. A computer-readable medium storing instructions that, when executed, cause performance of the described method, additional operations and/or include the additional elements.

A wireless device may avoid/skip triggering/starting the second satellite switch procedure/method (e.g., for switching from the first NTN node of the first cell to the second NTN node of the cell without changing the first PCI). The wireless device may avoid/skip triggering/starting the second satellite switch procedure/method, for example, in response to/based on the at least one CHO execution condition being satisfied and a time to a start of the second satellite switch method being greater than a threshold (e.g., the switching condition not being satisfied). The wireless device may trigger/initiate/perform/execute the handover procedure. The wireless device may trigger/initiate/perform/execute the handover procedure, for example, in response to/based on the at least one CHO execution condition being satisfied and the time to the start of the second satellite switch method being greater than the threshold (e.g., the switching condition not being satisfied). For example, the one or more configuration parameters may configure/indicate the threshold. The start of the second satellite switch method may be based on the first time/occasion (e.g., the t-Start/t-start) and/or the first gap.

A wireless device may avoid/skip triggering/starting the handover procedure. The wireless device may avoid/skip triggering/starting the handover procedure, for example, in response to/based on the at least one CHO execution condition being satisfied and the time to the start of the second satellite switch method being shorter/smaller than the threshold (e.g., the switching condition being satisfied). The wireless device may trigger/initiate/perform/execute the second satellite switch procedure/method (e.g., for switching from the first NTN node of the first cell to the second NTN node of the cell without changing the first PCI). The wireless device may trigger/initiate/perform/execute the second satellite switch procedure/method, for example, in response to/based on the at least one CHO execution condition being satisfied and the time to the start of the second satellite switch method being shorter/smaller than the threshold (e.g., the switching condition being satisfied).

A wireless device, despite/irrespective of receiving the handover message from the base station, may avoid/skip initiating/performing the handover procedure based on the second satellite switch method (e.g., the switching condition being satisfied). The wireless device may avoid/skip initiating/performing the handover procedure and initiate/start the second satellite switch procedure. The wireless device may avoid/skip initiating/performing the handover procedure and initiate/start the second satellite switch procedure, for example, based on receiving the handover message at/in/during a time duration prior to the first time/occasion (e.g., the switching condition being satisfied). The length of the time duration may be based on the threshold (e.g., equal to the threshold). The wireless device may avoid/skip initiating/performing the second satellite switch procedure and initiate/start the handover procedure. The wireless device may avoid/skip initiating/performing the second satellite switch procedure and initiate/start the handover procedure, for example, based on receiving the handover message before the time duration prior to the first time/occasion (e.g., the switching condition being not satisfied).

A wireless device may trigger a first procedure, wherein the procedure may be a timing advance reporting (TAR) procedure for a transmission of TA report via a first non-terrestrial network (NTN) node of a first cell. The wireless device may switch from the first NTN node to a second NTN node of the first cell. The wireless device may send (e.g., transmit) the TA report via the second NTN node, after the switching is completed and based on the triggered first procedure.

A wireless device may trigger a first procedure, wherein the procedure may be a BSR for a transmission of BSR via a first non-terrestrial network (NTN) node of a first cell. The wireless device may switch from the first NTN node to a second NTN node of the first cell. The wireless device may send (e.g., transmit) the BSR via the second NTN node, after the switching is completed and based on the triggered first procedure.

A wireless device may trigger a first procedure, wherein the procedure may be a SR for a transmission of PUCCH comprising an SR via a first non-terrestrial network (NTN) node of a first cell. The wireless device may switch from the first NTN node to a second NTN node of the first cell. The wireless device may send (e.g., transmit) the PUCCH comprising the SR via the second NTN node, after the switching is completed and based on the triggered first procedure.

A wireless device may trigger a first procedure, wherein the first procedure may be at least one of: a PHR, a consistent LBT failure, a BFR, a TAR, for example, if communicating via a first non-terrestrial network (NTN) node of a first cell. The wireless device may determine whether the first cell is the second cell or not. The wireless device may determine whether the first cell is the second cell or not, for example, based on (e.g., in response to) switching from the first NTN node to a second NTN node of a second cell. The wireless device may continue the first procedure after the switching. The wireless device may continue the first procedure after the switching, for example, based on the first cell and the second cell being the same. The wireless device may cancel the first procedure after the switching. The wireless device may cancel the first procedure after the switching, for example, based on the first cell and the second cell being different.

A wireless device may initiate/trigger a random access (RA) procedure for transmission of a preamble via a first non-terrestrial network (NTN) node of a cell. The wireless device may, based on (e.g., in response to) switching from the first NTN node to a second NTN node of the cell for a service link switch (e.g., as a service link), abort/stop the RA procedure.

A wireless device may switch from the first NTN node to a second NTN node of the cell, for example, if communicating via a first non-terrestrial network (NTN) node of a cell. The wireless device may avoid triggering/initiating a first procedure, wherein the first procedure may be at least one of: a handover procedure; a radio failure recovery procedure; a scheduling request; a buffer status report; a power headroom reporting (PHR) procedure; a beam failure reporting (BFR) procedure; or a timing advance reporting (TAR) procedure, for example, based on (e.g., in response to) the switching being ongoing.

A wireless device may, via a first non-terrestrial network (NTN) node of a first cell, receive one or more configuration parameters indicating at least one conditional handover (CHO) execution condition to handover from the first cell to a second cell. The wireless device may execute the handover from the first cell to the second cell and avoid switching from the first NTN node to a second NTN node of the first cell for a service link switch. The wireless device may execute the handover from the first cell to the second cell and avoid switching from the first NTN node to a second NTN node of the first cell for a service link switch, for example, based on the at least one CHO execution condition being satisfied.

Communications described herein may be determined, generated, sent, and/or received using any quantity of messages, information elements, fields, parameters, values, indications, information, bits, and/or the like. While one or more examples may be described herein using any of the terms/phrases message, information element, field, parameter, value, indication, information, bit(s), and/or the like, one skilled in the art understands that such communications may be performed using any one or more of these terms, including other such terms. For example, one or more parameters, fields, and/or information elements (IEs), may comprise one or more information objects, values, and/or any other information. An information object may comprise one or more other objects. At least some (or all) parameters, fields, IEs, and/or the like may be used and can be interchangeable depending on the context. If a meaning or definition is given, such meaning or definition controls.

One or more elements in examples described herein may be implemented as modules. A module may be an element that performs a defined function and/or that has a defined interface to other elements. The modules may be implemented in hardware, software in combination with hardware, firmware, wetware (e.g., hardware with a biological element) or a combination thereof, all of which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. Additionally or alternatively, it may be possible to implement modules using physical hardware that incorporates discrete or programmable analog, digital and/or quantum hardware. Examples of programmable hardware may comprise: computers, microcontrollers, microprocessors, application-specific integrated circuits (ASICs); field programmable gate arrays (FPGAs); and/or complex programmable logic devices (CPLDs). Computers, microcontrollers and/or microprocessors may be programmed using languages such as assembly, C, C++ or the like. FPGAs, ASICs and CPLDs are often programmed using hardware description languages (HDL), such as VHSIC hardware description language (VHDL) or Verilog, which may configure connections between internal hardware modules with lesser functionality on a programmable device. The above-mentioned technologies may be used in combination to achieve the result of a functional module.

One or more features described herein may be implemented in a computer-usable data and/or computer-executable instructions, such as in one or more program modules, executed by one or more computers or other devices. Generally, program modules include routines, programs, objects, components, data structures, etc. that perform particular tasks or implement particular abstract data types if executed by a processor in a computer or other data processing device. The computer executable instructions may be stored on one or more computer readable media such as a hard disk, optical disk, removable storage media, solid state memory, RAM, etc. The functionality of the program modules may be combined or distributed as desired. The functionality may be implemented in whole or in part in firmware or hardware equivalents such as integrated circuits, field programmable gate arrays (FPGA), and the like. Particular data structures may be used to more effectively implement one or more features described herein, and such data structures are contemplated within the scope of computer executable instructions and computer-usable data described herein.

A non-transitory tangible computer readable media may comprise instructions executable by one or more processors configured to cause operations of multi-carrier communications described herein. An article of manufacture may comprise a non-transitory tangible computer readable machine-accessible medium having instructions encoded thereon for enabling programmable hardware to cause a device (e.g., a wireless device, wireless communicator, a wireless device, a base station, and the like) to allow operation of multi-carrier communications described herein. The device, or one or more devices such as in a system, may include one or more processors, memory, interfaces, and/or the like. Other examples may comprise communication networks comprising devices such as base stations, wireless devices or user equipment (wireless device), servers, switches, antennas, and/or the like. A network may comprise any wireless technology, including but not limited to, cellular, wireless, WiFi, 4G, 5G, 6G, any generation of 3GPP or other cellular standard or recommendation, any non-3GPP network, wireless local area networks, wireless personal area networks, wireless ad hoc networks, wireless metropolitan area networks, wireless wide area networks, global area networks, satellite networks, space networks, and any other network using wireless communications. Any device (e.g., a wireless device, a base station, or any other device) or combination of devices may be used to perform any combination of one or more of steps described herein, including, for example, any complementary step or steps of one or more of the above steps.

Although examples are described herein, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the descriptions herein. Accordingly, the foregoing description is by way of example only, and is not limiting.

What is claimed is:

1. A method comprising:
receiving, by a wireless device, an indication of a time for switching from a first satellite of a first cell to a second satellite of the first cell, wherein the switching is without changing a physical cell identification of the first cell;
receiving a radio resource control (RRC) reconfiguration message indicating handover from the first cell to a second cell; and
based on receiving the RRC reconfiguration message before the time for the switching, initiating the handover.

2. The method of claim 1, further comprising:
sending, based on receiving the RRC reconfiguration message before the time for the switching, a request to handover the wireless device to the second cell.

3. The method of claim 1, wherein the receiving the RRC reconfiguration message comprises receiving the RRC reconfiguration message after the receiving the indication and before initiating the switching to the second satellite of the first cell; and wherein the method further comprises:
sending, based on the switching to the second satellite of the first cell not being initiated, a request to handover the wireless device to the second cell.

4. The method of claim 1, wherein the initiating the handover comprises sending a request to handover the wireless device to the second cell.

5. The method of claim 1, wherein the first satellite of the first cell is associated with a first physical cell identification, and wherein the second satellite of the first cell is associated with the first physical cell identification.

6. The method of claim 1, wherein the initiating the handover is further based on the wireless device being served by the first satellite of the first cell.

7. The method of claim 1, wherein the initiating the handover is further based on a switch, to the second satellite of the first cell, not being initiated.

8. The method of claim 1, wherein the receiving the indication of the time for switching from the first satellite of the first cell to the second satellite of the first cell comprises:
receiving a system information block (SIB) comprising a parameter indicating the time for switching from the first satellite of the first cell to the second satellite of the first cell.

9. The method of claim 1, wherein the receiving the indication of the time for switching from the first satellite of the first cell to the second satellite of the first cell comprises receiving:
a first parameter indicating a first time to start the switching from the first satellite of the first cell to the second satellite of the first cell; and
a second parameter indicating a second time for the second satellite of the first cell to start servicing the wireless device.

10. A method comprising:
receiving, by a wireless device, an indication of a time for switching from a first node of a first cell to a second node of the first cell, wherein the switching is without changing a physical cell identification of the first cell;
receiving an indication to handover the wireless device from the first cell to a second cell; and
sending, based on the receiving the indication to handover being before the time for the switching, a request to handover the wireless device to the second cell.

11. The method of claim 10, wherein the first node comprises a first non-terrestrial network node, and wherein the second node comprises a second non-terrestrial network node.

12. The method of claim 11, wherein the first non-terrestrial network node comprises a first satellite, and wherein the second non-terrestrial network node comprises a second satellite.

13. The method of claim 10, wherein the receiving the indication to handover to the wireless device from the first cell to the second cell comprises receiving a radio resource control (RRC) reconfiguration message indicating to handover from the first cell to the second cell.

14. The method of claim 10, further comprising:
determining whether to send the request based on:
the time for the switching; and
whether at least one condition for triggering the handover is satisfied; and
wherein the sending the request is further based on the at least one condition being satisfied before the time for the switching.

15. A method comprising:
receiving, by a wireless device, an indication to switch from a first node of a first cell associated with a first physical cell identification to a second node of the first cell associated with the first physical cell identification;
after the receiving the indication and before initiating a switch to the second node, receiving an indication to handover the wireless device from the first cell to a second cell; and
sending, based on a switch to the second node not being initiated, a request to handover the wireless device to the second cell.

16. The method of claim 15, wherein the first node comprises a first non-terrestrial network node, and wherein the second node comprises a second non-terrestrial network node.

17. The method of claim 16, wherein the first non-terrestrial network node comprises a first satellite, and wherein the second non-terrestrial network node comprises a second satellite.

18. The method of claim 15, wherein the receiving the indication to handover to the wireless device from the first cell to the second cell comprises receiving a radio resource control (RRC) reconfiguration message indicating to handover from the first cell to the second cell.

19. The method of claim 15, wherein the indication to handover to the wireless device from the first cell to the second cell indicates at least one condition for sending the request to handover the wireless device to the second cell.

20. The method of claim 15, further comprising:
skipping, based on the sending the request to handover the wireless device to the second cell, the switch to the second node.
